(19) United States
(12) Patent Application Publication
(10) Pub. No.: US 2023/0092282 A1
(43) Pub. Date: Mar. 23, 2023

(54) METHODS FOR MOVING OBJECTS IN A THREE-DIMENSIONAL ENVIRONMENT

(71) Applicant: Apple Inc., Cupertino, CA (US)

(72) Inventors: Benjamin H. BOESEL, Cornelius, NC (US); Shih-Sang CHIU, Menlo Park, CA (US); Jonathan RAVASZ, Sunnyvale, CA (US); Trevor J. MCINTYRE, San Francisco, CA (US); Stephen O. LEMAY, Palo Alto, CA (US); Christopher D. MCKENZIE, Burlingame, CA (US)

(21) Appl. No.: 17/934,104

(22) Filed: Sep. 21, 2022

Related U.S. Application Data
(60) Provisional application No. 63/261,556, filed on Sep. 23, 2021.

(51) Int. Cl. G06F 3/04815; G06T 19/20; G06F 3/04845; G06F 3/0486; G06F 3/01

(52) U.S. Cl. CPC G06F 3/04815; G06T 19/20; G06F 3/04845; G06F 3/0486; G06F 3/017; G06T 2200/24; G06T 2219/2016

(57) ABSTRACT

In some embodiments, an electronic device uses different algorithms for moving objects in a three-dimensional environment based on the directions of such movements. In some embodiments, an electronic device modifies the size of an object in the three-dimensional environment as the distance between that object and a viewpoint of the user changes. In some embodiments, an electronic device selectively resists movement of an object when that object comes into contact with another object in a three-dimensional environment. In some embodiments, an electronic device selectively adds an object to another object in a three-dimensional environment based on whether the other object is a valid drop target for that object. In some embodiments, an electronic device facilitates movement of multiple objects concurrently in a three-dimensional environment. In some embodiments, an electronic device facilitates throwing of objects in a three-dimensional environment.

### CROSS-REFERENCE TO RELATED APPLICATIONS

This application claims the benefit of U.S. Provisional Application No. 63/261,556, filed Sep. 23, 2021, the content of which is incorporated herein by reference in its entirety for all purposes.

### TECHNICAL FIELD

This relates generally to computer systems with a display generation component and one or more input devices that present graphical user interfaces, including but not limited to electronic devices that facilitate movement of objects in three-dimensional environments.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects include digital images, video, text, icons, and control elements such as buttons and other graphics.

But methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious and error-prone, create a significant cognitive burden on a user, and detract from the experience with the virtual/augmented reality environment. In addition, these methods take longer than necessary, thereby wasting energy. This latter consideration is particularly important in battery-operated devices.

### SUMMARY

Accordingly, there is a need for computer systems with improved methods and interfaces for providing computer generated experiences to users that make interaction with the computer systems more efficient and intuitive for a user. Such methods and interfaces optionally complement or replace conventional methods for providing computer generated reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems with a display generation component and one or more input devices are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through stylus and/or finger contacts and gestures on the touch-sensitive surface, movement of the user's eyes and hand in space relative to the GUI or the user's body as captured by cameras and other movement sensors, and voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

There is a need for electronic devices with improved methods and interfaces for interacting with objects in a three-dimensional environment. Such methods and interfaces may complement or replace conventional methods for interacting with objects in a three-dimensional environment. Such methods and interfaces reduce the number, extent, and/or the nature of the inputs from a user and produce a more efficient human-machine interface.

In some embodiments, an electronic device uses different algorithms for moving objects in a three-dimensional environment based on the directions of such movements. In some embodiments, an electronic device modifies the size of an object in the three-dimensional environment as the distance between that object and a viewpoint of the user changes. In some embodiments, an electronic device selectively resists movement of an object when that object comes into contact with another object in a three-dimensional environment. In some embodiments, an electronic device selectively adds an object to another object in a three-dimensional environment based on whether the other object is a valid drop target for that object. In some embodiments, an electronic device facilitates movement of multiple objects concurrently in a three-dimensional environment. In some embodiments, an electronic device facilitates throwing of objects in a three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing CGR experiences in accordance with some embodiments.

FIG. 2 is a block diagram illustrating a controller of a computer system that is configured to manage and coordinate a CGR experience for the user in accordance with some embodiments.

FIG. 3 is a block diagram illustrating a display generation component of a computer system that is configured to provide a visual component of the CGR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6A is a flowchart illustrating a glint-assisted gaze tracking pipeline in accordance with some embodiments.

FIG. 6B illustrates an exemplary environment of an electronic device providing a CGR experience in accordance with some embodiments.

FIGS. 7A-7E illustrate examples of an electronic device utilizing different algorithms for moving objects in different directions in a three-dimensional environment in accordance with some embodiments.

FIGS. 8A-8K is a flowchart illustrating a method of utilizing different algorithms for moving objects in different directions in a three-dimensional environment in accordance with some embodiments.

FIGS. 9A-9E illustrate examples of an electronic device dynamically resizing (or not) virtual objects in a three-dimensional environment in accordance with some embodiments.

FIGS. 10A-10I is a flowchart illustrating a method of dynamically resizing (or not) virtual objects in a three-dimensional environment in accordance with some embodiments.

FIGS. 11A-11E illustrate examples of an electronic device selectively resisting movement of objects in a three-dimensional environment in accordance with some embodiments.

FIGS. 12A-12G is a flowchart illustrating a method of selectively resisting movement of objects in a three-dimensional environment in accordance with some embodiments.

FIGS. 13A-13D illustrate examples of an electronic device selectively adding respective objects to objects in a three-dimensional environment in accordance with some embodiments.

FIGS. 14A-14H is a flowchart illustrating a method of selectively adding respective objects to objects in a three-dimensional environment in accordance with some embodiments.

FIGS. 15A-15D illustrate examples of an electronic device facilitating the movement and/or placement of multiple virtual objects in a three-dimensional environment in accordance with some embodiments.

FIGS. 16A-16J is a flowchart illustrating a method of facilitating the movement and/or placement of multiple virtual objects in a three-dimensional environment in accordance with some embodiments.

FIGS. 17A-17D illustrate examples of an electronic device facilitating the throwing of virtual objects in a three-dimensional environment in accordance with some embodiments.

FIGS. 18A-18F is a flowchart illustrating a method of facilitating the throwing of virtual objects in a three-dimensional environment in accordance with some embodiments.

### DESCRIPTION OF EMBODIMENTS

The present disclosure relates to user interfaces for providing a computer generated reality (CGR) experience to a user, in accordance with some embodiments.

The systems, methods, and GUIs described herein provide improved ways for an electronic device to facilitate interaction with and manipulate objects in a three-dimensional environment.

In some embodiments, a computer system displays a virtual environment in a three-dimensional environment. In some embodiments, the virtual environment is displayed via a far-field process or a near-field process based on the geometry (e.g., size and/or shape) of the three-dimensional environment (e.g., which, optionally, mimics the real world environment around the device). In some embodiments, the far-field process includes introducing the virtual environment from a location farthest from the viewpoint of the user and gradually expanding the virtual environment towards the viewpoint of the user (e.g., using information about the location, position, distance, etc. of objects in the environment). In some embodiments, the near-field process includes introducing the virtual environment from a location farthest from the viewpoint of the user and expanding from the initial location outwards, without considering the distance and/or position of objects in the environment (e.g., expanding the size of the virtual environment with respect to the display generation component).

In some embodiments, a computer system displays a virtual environment and/or an atmospheric effect in a three-dimensional environment. In some embodiments, displaying an atmospheric effect includes displaying one or more lighting and/or particle effects in the three-dimensional environment. In some embodiments, in response to detecting the movement of the device, portions of the virtual environment are de-emphasized, but optionally atmospheric effects are not reduced. In some embodiments, in response to detecting the rotation of the body of the user (e.g., concurrently with the rotation of the device), the virtual environment is moved to a new location in the three-dimensional environment, optionally aligned with the body of the user.

In some embodiments, a computer system displays a virtual environment concurrently with a user interface of an application. In some embodiments, the user interface of the application is able to be moved into the virtual environment and treated as a virtual object that exists in the virtual environment. In some embodiments, the user interface is automatically resized when moved into the virtual environment based the distance of the user interface when moved into the virtual environment. In some embodiments, while displaying both the virtual environment and the user interface, a user is able to request the user interface be displayed as an immersive environment. In some embodiments, in response to the request to display the user interface as an immersive environment, the previously displayed virtual environment is replaced with the immersive environment of the user interface.

In some embodiments, a computer system displays a three-dimensional environment having one or more virtual objects. In some embodiments, in response to detecting a movement input in a first direction, the computer system moves a virtual object in a first output direction using a first movement algorithm. In some embodiments, in response to detecting a movement input in a second, different, direction, the computer system moves a virtual object in a second output direction using a second, different, movement algorithm. In some embodiments, during movement, a first object becomes aligned to a second object when the first object moves in proximity to the second object.

In some embodiments, a computer system displays a three-dimensional environment having one or more virtual objects. In some embodiments, in response to detecting a movement input directed to an object, the computer system resizes the object if the object is moved towards or away from the viewpoint of the user. In some embodiments, in response to detecting movement of the viewpoint of the user, the computer system does not resize the object even if the distance between the viewpoint and the object changes.

In some embodiments, a computer system displays a three-dimensional environment having one or more virtual objects. In some embodiments, in response to movement of a respective virtual object in a respective direction that contains another virtual object, movement of the respective virtual object is resisted when the respective virtual object comes into contact with the other virtual object. In some embodiments, the movement of the respective virtual object is resisted because the other virtual object is a valid drop target for the respective virtual object. In some embodiments, when the movement of the respective virtual object through the other virtual object exceeds a respective magnitude threshold, the respective virtual object is moved through the other virtual object in the respective direction.

In some embodiments, a computer system displays a three-dimensional environment having one or more virtual objects. In some embodiments, in response to movement of a respective virtual object to another virtual object that is a valid drop target for the respective virtual object, the respective object is added to the other virtual object. In some embodiments, in response to movement of a respective virtual object to another virtual object that is an invalid drop target for the respective virtual object, the respective virtual object is not added to the other virtual object and is moved back to a respective location from which the respective virtual object was originally moved. In some embodiments, in response to movement of a respective virtual object to a respective location in empty space in the virtual environment, the respective virtual object is added to a newly generated virtual object at the respective location in empty space.

In some embodiments, a computer system displays a three-dimensional environment having one or more virtual objects. In some embodiments, in response to movement input directed to a plurality of objects, the computer system moves the plurality of objects together in the three-dimensional environment. In some embodiments, in response to detecting an end to the movement input, the computer system separately places the objects of the plurality of objects in the three-dimensional environment. In some embodiments, the plurality of objects, while being moved, are arranged in a stack arrangement.

In some embodiments, a computer system displays a three-dimensional environment having one or more virtual objects. In some embodiments, in response to a throwing input, the computer system moves a first object to a second object if the second object was targeted as part of the throwing input. In some embodiments, if the second object was not targeted as part of the throwing input, the computer system moves the first object in the three-dimensional environment in accordance with a speed and/or direction of the throwing input. In some embodiments, targeting the second object is based on the gaze of the user and/or the direction of the throwing input.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, and/or additional techniques. These techniques also reduce power usage and improve battery life of the device by enabling the user to use the device more quickly and efficiently.

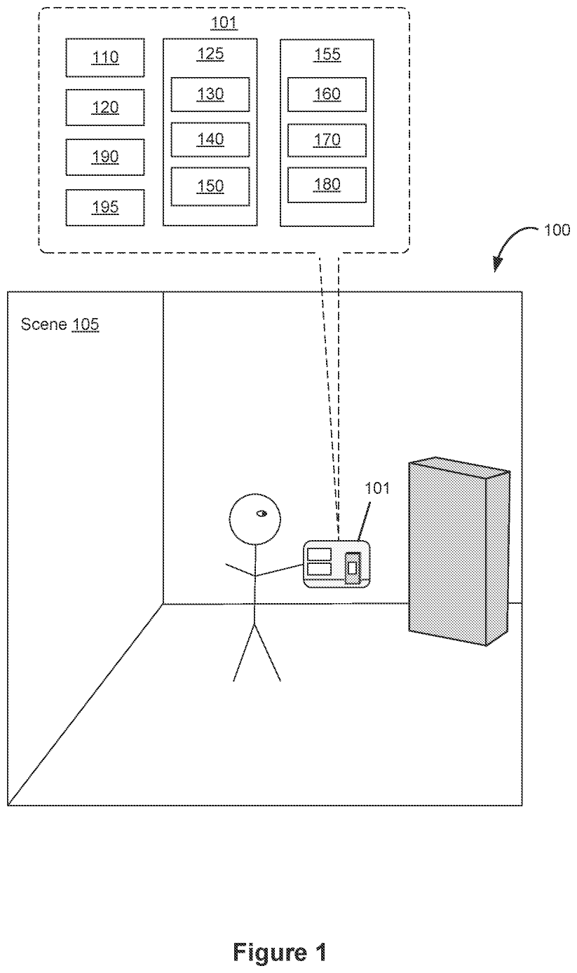

FIGS. 1-6 provide a description of example computer systems for providing CGR experiences to users (such as described below with respect to methods 800, 1000, 1200, 1400, 1600 and/or 1800). In some embodiments, as shown in FIG. 1, the CGR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a CGR experience, various terms are used to differentially refer to several related but distinct environments that the user may sense and/or with which a user may interact (e.g., with inputs detected by a computer system 101 generating the CGR experience that cause the computer system generating the CGR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality (or extended reality (XR)): In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, or 50 cm) of the point of reference in one or more dimensions (e.g., up/down, left/right, and/or forward/backward relative to the position of the point of reference).

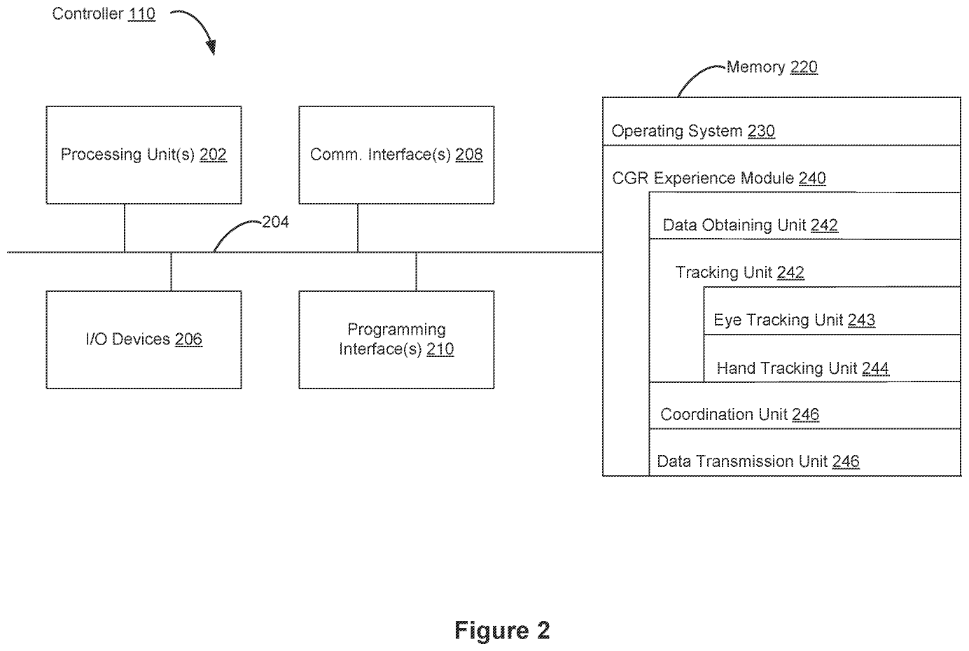

Hardware: There are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a CGR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

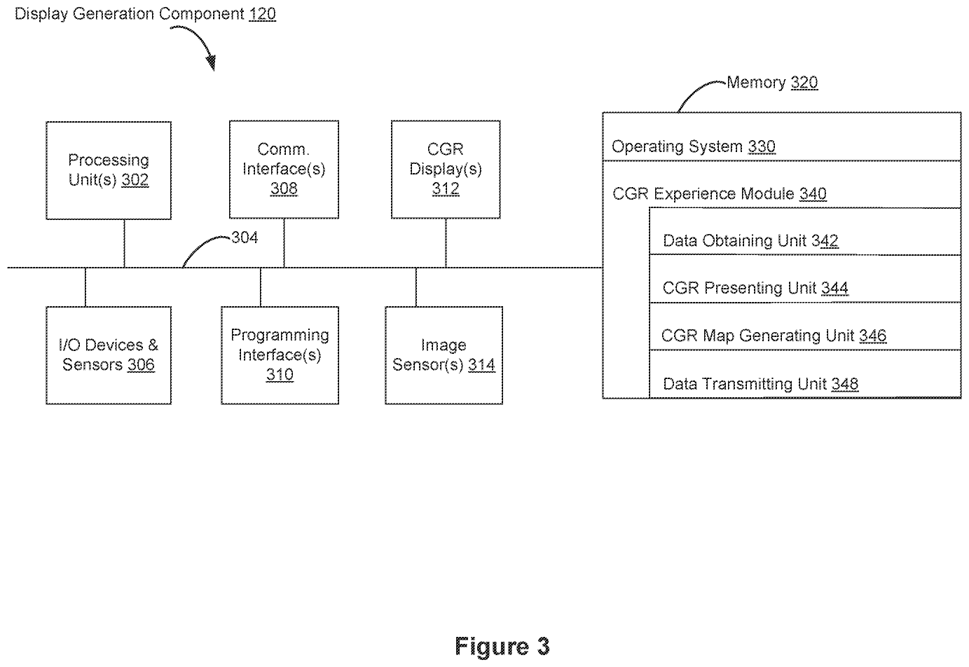

In some embodiments, the display generation component 120 is configured to provide the CGR experience (e.g., at least a visual component of the CGR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a CGR experience to the user while the user is virtually and/or physically present within the scene 105.

In some embodiments, the display generation component is worn on a part of the user's body (e.g., on his/her head, on his/her hand, etc.). As such, the display generation component 120 includes one or more CGR displays provided to display the CGR content. For example, in various embodiments, the display generation component 120 encloses the field-of-view of the user. In some embodiments, the display generation component 120 is a handheld device (such as a smartphone or tablet) configured to present CGR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a CGR chamber, enclosure, or room configured to present CGR content in which the user does not wear or hold the display generation component 120. Many user interfaces described with reference to one type of hardware for displaying CGR content (e.g., a handheld device or a device on a tripod) could be implemented on another type of hardware for displaying CGR content (e.g., an HMD or other wearable computing device). For example, a user interface showing interactions with CGR content triggered based on interactions that happen in a space in front of a handheld or tripod mounted device could similarly be implemented with an HMD where the interactions happen in a space in front of the HMD and the responses of the CGR content are displayed via the HMD. Similarly, a user interface showing interactions with CRG content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operation environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a CGR experience module 240.

The operating system 230 includes instructions for handling various basic system services and for performing hardware dependent tasks. In some embodiments, the CGR experience module 240 is configured to manage and coordinate one or more CGR experiences for one or more users (e.g., a single CGR experience for one or more users, or multiple CGR experiences for respective groups of one or more users). To that end, in various embodiments, the CGR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

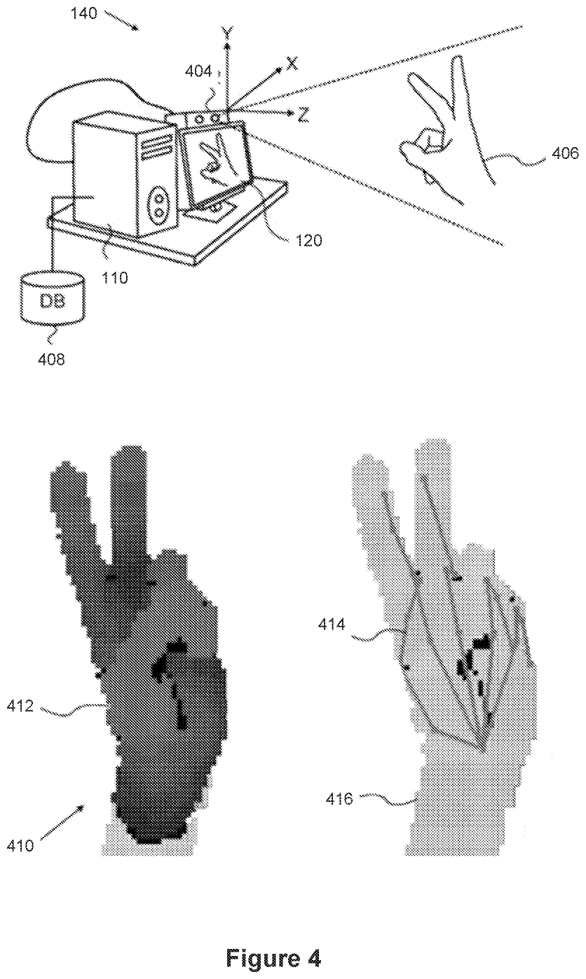

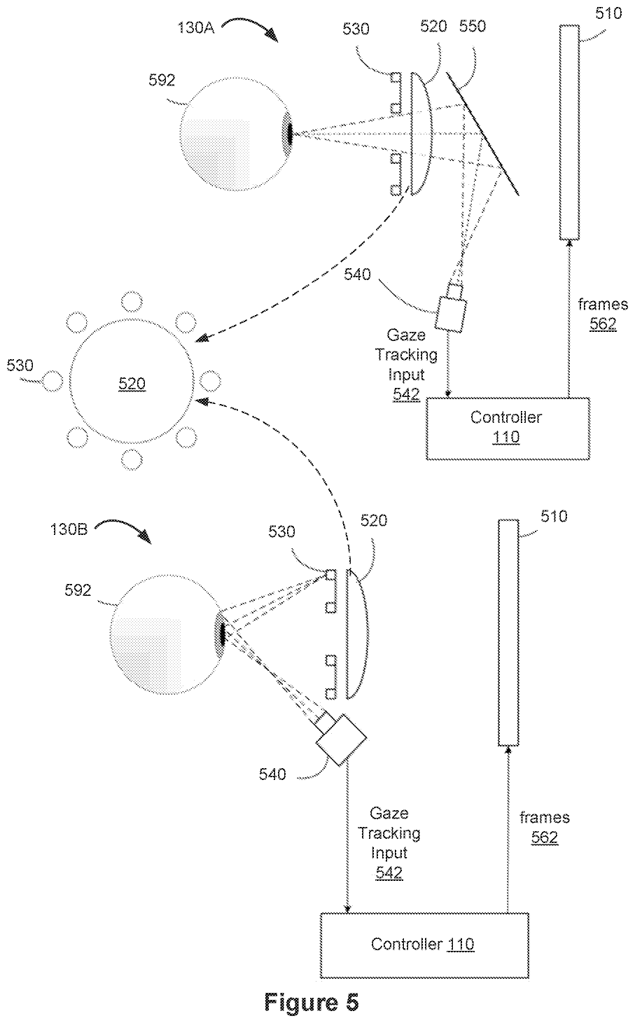

In some embodiments, the tracking unit 244 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 243 and/or eye tracking unit 245. In some embodiments, the hand tracking unit 243 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 243 is described in greater detail below with respect to FIG. 4. In some embodiments, the eye tracking unit 245 is configured to track the position and movement of the user's gaze (or more broadly, the user's eyes, face, or head) with respect to the scene 105 (e.g., with respect to the physical environment and/or to the user (e.g., the user's hand)) or with respect to the CGR content displayed via the display generation component 120. The eye tracking unit 245 is described in greater detail below with respect to FIG. 5.

In some embodiments, the coordination unit 246 is configured to manage and coordinate the CGR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the HMD 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more CGR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more CGR displays 312 are configured to provide the CGR experience to the user. In some embodiments, the one or more CGR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more CGR displays 312 correspond to diffractive, reflective, polarized, holographic, etc. waveguide displays. For example, the HMD 120 includes a single CGR display. In another example, the HMD 120 includes a CGR display for each eye of the user. In some embodiments, the one or more CGR displays 312 are capable of presenting MR and VR content. In some embodiments, the one or more CGR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the HMD 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a CGR presentation module 340.

The operating system 330 includes instructions for handling various basic system services and for performing hardware dependent tasks. In some embodiments, the CGR presentation module 340 is configured to present CGR content to the user via the one or more CGR displays 312. To that end, in various embodiments, the CGR presentation module 340 includes a data obtaining unit 342, a CGR presenting unit 344, a CGR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the CGR presenting unit 344 is configured to present CGR content via the one or more CGR displays 312. To that end, in various embodiments, the CGR presenting unit 344 includes instructions and/or logic therefor, and heuristics and metadata therefor.

In some embodiments, the CGR map generating unit 346 is configured to generate a CGR map (e.g., a 3D map of the mixed reality scene or a map of the physical environment into which computer generated objects can be placed to generate the computer generated reality) based on media content data. To that end, in various embodiments, the CGR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the CGR presenting unit 344, the CGR map generating unit 346, and the data transmitting unit 348 are shown as residing on a single device (e.g., the display generation component 120 of FIG. 1), it should be understood that in other embodiments, any combination of the data obtaining unit 342, the CGR presenting unit 344, the CGR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 243 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 outputs a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 408 and changing his hand posture.

In some embodiments, the image sensors 404 project a pattern of spots onto a scene containing the hand 406 and captures an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the hand tracking device 440 may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with a CGR or XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands)

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 440, some or all of the processing functions of the controller may be performed by a suitable microprocessor and software or by dedicated circuitry within the housing of the hand tracking device 402 or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 245 (FIG. 2) to track the position and movement of the user's gaze with respect to the scene 105 or with respect to the CGR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the CGR content for viewing by the user and a component for tracking the gaze of the user relative to the CGR content. In some embodiments, the eye tracking device 130 is separate from the display generation component 120. For example, when display generation component is a handheld device or a CGR chamber, the eye tracking device 130 is optionally a separate device from the handheld device or CGR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, a gaze tracking device 130 includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The gaze tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provide the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the CGR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lense(s) 520), eye tracking cameras (e.g., eye tracking camera(s) 540), and light sources (e.g., light sources 530 (e.g., IR or NIR LEDs), mounted in a wearable housing. The Light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g. 850 nm) and a camera 540 that operates at a different wavelength (e.g. 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

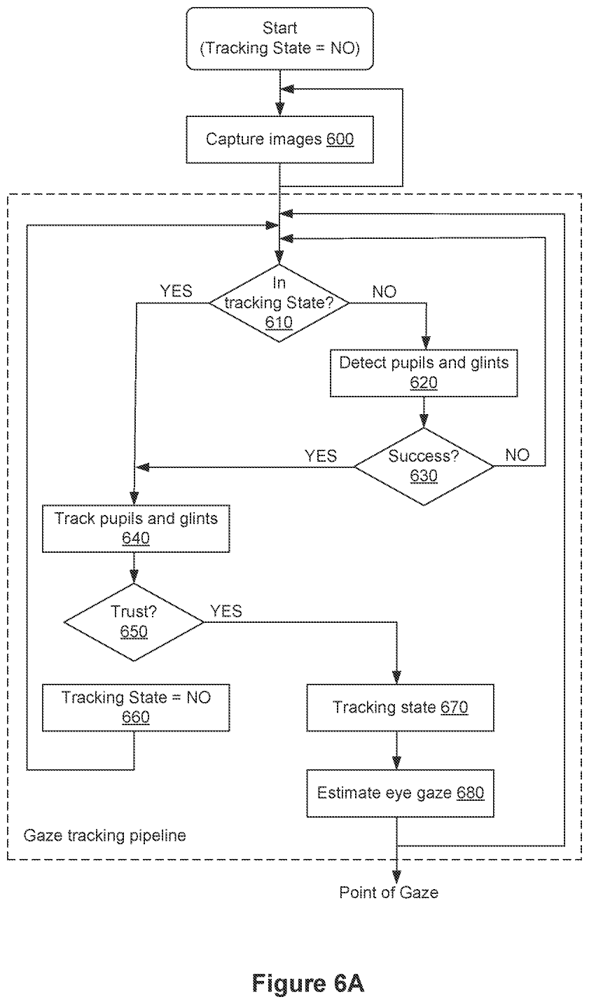

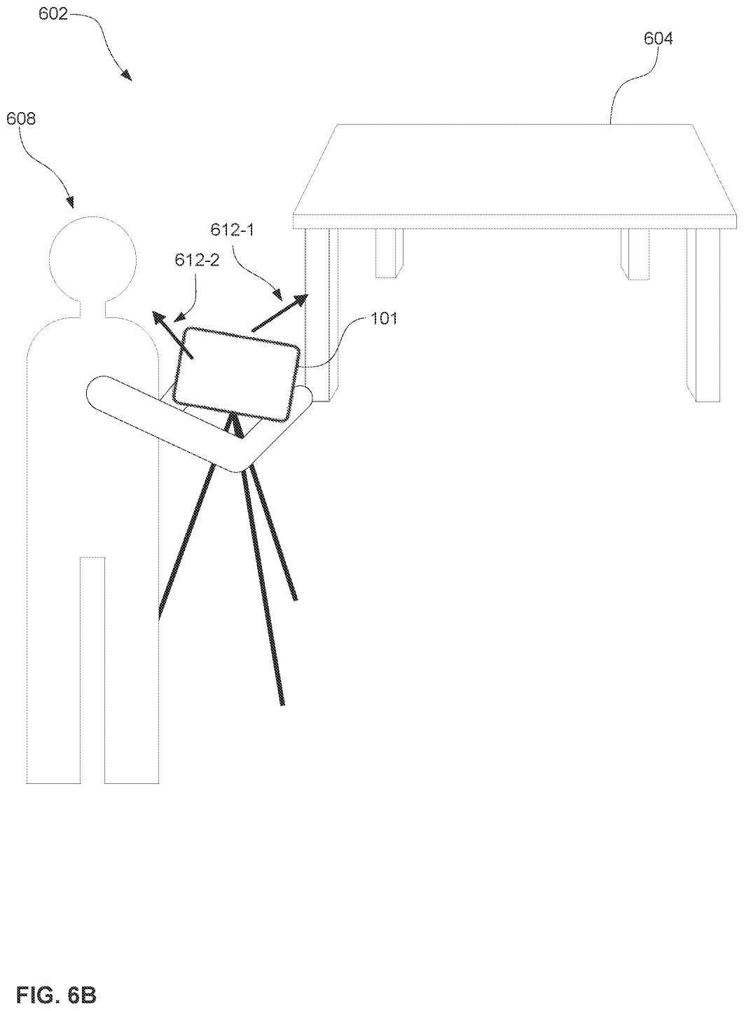

FIG. 6A illustrates a glint-assisted gaze tracking pipeline, in accordance with some embodiments. In some embodiments, the gaze tracking pipeline is implemented by a glint-assisted gaze tracing system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6A, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 410, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6A is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing CGR experiences to users, in accordance with various embodiments.

FIG. 6B illustrates an exemplary environment of an electronic device 101 providing a CGR experience in accordance with some embodiments. In FIG. 6B, real world environment 602 includes electronic device 101, user 608, and a real world object (e.g., table 604). As shown in FIG. 6B, electronic device 101 is optionally mounted on a tripod or otherwise secured in real world environment 602 such that one or more hands of user 608 are free (e.g., user 608 is optionally not holding device 101 with one or more hands). As described above, device 101 optionally has one or more groups of sensors positioned on different sides of device 101. For example, device 101 optionally includes sensor group 612-1 and sensor group 612-2 located on the “back” and “front” sides of device 101, respectively (e.g., which are able to capture information from the respective sides of device 101). As used herein, the front side of device 101 is the side that is facing user 608, and the back side of device 101 is the side facing away from user 608.

In some embodiments, sensor group 612-2 includes an eye tracking unit (e.g., eye tracking unit 245 described above with reference to FIG. 2) that includes one or more sensors for tracking the eyes and/or gaze of the user such that the eye tracking unit is able to “look” at user 608 and track the eye(s) of user 608 in the manners previously described. In some embodiments, the eye tracking unit of device 101 is able to capture the movements, orientation, and/or gaze of the eyes of user 608 and treat the movements, orientation, and/or gaze as inputs.

In some embodiments, sensor group 612-1 includes a hand tracking unit (e.g., hand tracking unit 243 described above with reference to FIG. 2) that is able to track one or more hands of user 608 that are held on the “back” side of device 101, as shown in FIG. 6B. In some embodiments, the hand tracking unit is optionally included in sensor group 612-2 such that user 608 is able to additionally or alternatively hold one or more hands on the “front” side of device 101 while device 101 tracks the position of the one or more hands. As described above, the hand tracking unit of device 101 is able to capture the movements, positions, and/or gestures of the one or more hands of user 608 and treat the movements, positions, and/or gestures as inputs.

In some embodiments, sensor group 612-1 optionally includes one or more sensors configured to capture images of real world environment 602, including table 604 (e.g., such as image sensors 404 described above with reference to FIG. 4). As described above, device 101 is able to capture images of portions (e.g., some or all) of real world environment 602 and present the captured portions of real world environment 602 to the user via one or more display generation components of device 101 (e.g., the display of device 101, which is optionally located on the side of device 101 that is facing the user, opposite of the side of device 101 that is facing the captured portions of real world environment 602).

In some embodiments, the captured portions of real world environment 602 are used to provide a CGR experience to the user, for example, a mixed reality environment in which one or more virtual objects are superimposed over representations of real world environment 602.

Thus, the description herein describes some embodiments of three-dimensional environments (e.g., CGR environments) that include representations of real world objects and representations of virtual objects. For example, a three-dimensional environment optionally includes a representation of a table that exists in the physical environment, which is captured and displayed in the three-dimensional environment (e.g., actively via cameras and displays of an electronic device, or passively via a transparent or translucent display of the electronic device). As described previously, the three-dimensional environment is optionally a mixed reality system in which the three-dimensional environment is based on the physical environment that is captured by one or more sensors of the device and displayed via a display generation component. As a mixed reality system, the device is optionally able to selectively display portions and/or objects of the physical environment such that the respective portions and/or objects of the physical environment appear as if they exist in the three-dimensional environment displayed by the electronic device. Similarly, the device is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the device optionally displays a vase such that it appears as if a real vase is placed on top of a table in the physical environment. In some embodiments, each location in the three-dimensional environment has a corresponding location in the physical environment. Thus, when the device is described as displaying a virtual object at a respective location with respect to a physical object (e.g., such as a location at or near the hand of the user, or at or near a physical table), the device displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment can interact with virtual objects that exist only in the three-dimensional environment. For example, a three-dimensional environment can include a table and a vase placed on top of the table, with the table being a view of (or a representation of) a physical table in the physical environment, and the vase being a virtual object.

Similarly, a user is optionally able to interact with virtual objects in the three-dimensional environment using one or more hands as if the virtual objects were real objects in the physical environment. For example, as described above, one or more sensors of the device optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were real physical objects in the physical environment. In some embodiments, a user is able to move his or her hands to cause the representations of the hands in the three-dimensional environment to move in conjunction with the movement of the user's hand.

In some of the embodiments described below, the device is optionally able to determine the “effective” distance between physical objects in the physical world and virtual objects in the three-dimensional environment, for example, for the purpose of determining whether a physical object is interacting with a virtual object (e.g., whether a hand is touching, grabbing, holding, etc. a virtual object or within a threshold distance from a virtual object). For example, the device determines the distance between the hands of the user and virtual objects when determining whether the user is interacting with virtual objects and/or how the user is interacting with virtual objects. In some embodiments, the device determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the device optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared against the position of the virtual object of interest in the three-dimensional environment to determine the distance between the one or more hands of the user and the virtual object. In some embodiments, the device optionally determines a distance between a physical object and a virtual object by comparing positions in the physical world (e.g., as opposed to comparing positions in the three-dimensional environment). For example, when determining the distance between one or more hands of the user and a virtual object, the device optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the device optionally performs any of the techniques described above to map the location of the physical object to the three-dimensional environment and/or map the location of the virtual object to the physical world.

In some embodiments, the same or similar technique is used to determine where and what the gaze of the user is directed to and/or where and at what a physical stylus held by a user is pointed. For example, if the gaze of the user is directed to a particular position in the physical environment, the device optionally determines the corresponding position in the three-dimensional environment and if a virtual object is located at that corresponding virtual position, the device optionally determines that the gaze of the user is directed to that virtual object. Similarly, the device is optionally able to determine, based on the orientation of a physical stylus, to where in the physical world the stylus is pointing. In some embodiments, based on this determination, the device determines the corresponding virtual position in the three-dimensional environment that corresponds to the location in the physical world to which the stylus is pointing, and optionally determines that the stylus is pointing at the corresponding virtual position in the three-dimensional environment.

Similarly, the embodiments described herein may refer to the location of the user (e.g., the user of the device) and/or the location of the device in the three-dimensional environment. In some embodiments, the user of the device is holding, wearing, or otherwise located at or near the electronic device. Thus, in some embodiments, the location of the device is used as a proxy for the location of the user. In some embodiments, the location of the device and/or user in the physical environment corresponds to a respective location in the three-dimensional environment. In some embodiments, the respective location is the location from which the “camera” or “view” of the three-dimensional environment extends. For example, the location of the device would be the location in the physical environment (and its corresponding location in the three-dimensional environment) from which, if a user were to stand at that location facing the respective portion of the physical environment displayed by the display generation component, the user would see the objects in the physical environment in the same position, orientation, and/or size as they are displayed by the display generation component of the device (e.g., in absolute terms and/or relative to each other). Similarly, if the virtual objects displayed in the three-dimensional environment were physical objects in the physical environment (e.g., placed at the same location in the physical environment as they are in the three-dimensional environment, and having the same size and orientation in the physical environment as in the three-dimensional environment), the location of the device and/or user is the position at which the user would see the virtual objects in the physical environment in the same position, orientation, and/or size as they are displayed by the display generation component of the device (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

### User Interfaces and Associated Processes

Attention is now directed towards embodiments of user interfaces (“UP”) and associated processes that may be implemented on a computer system, such as portable multifunction device or a head-mounted device, with a display generation component, one or more input devices, and (optionally) one or cameras.

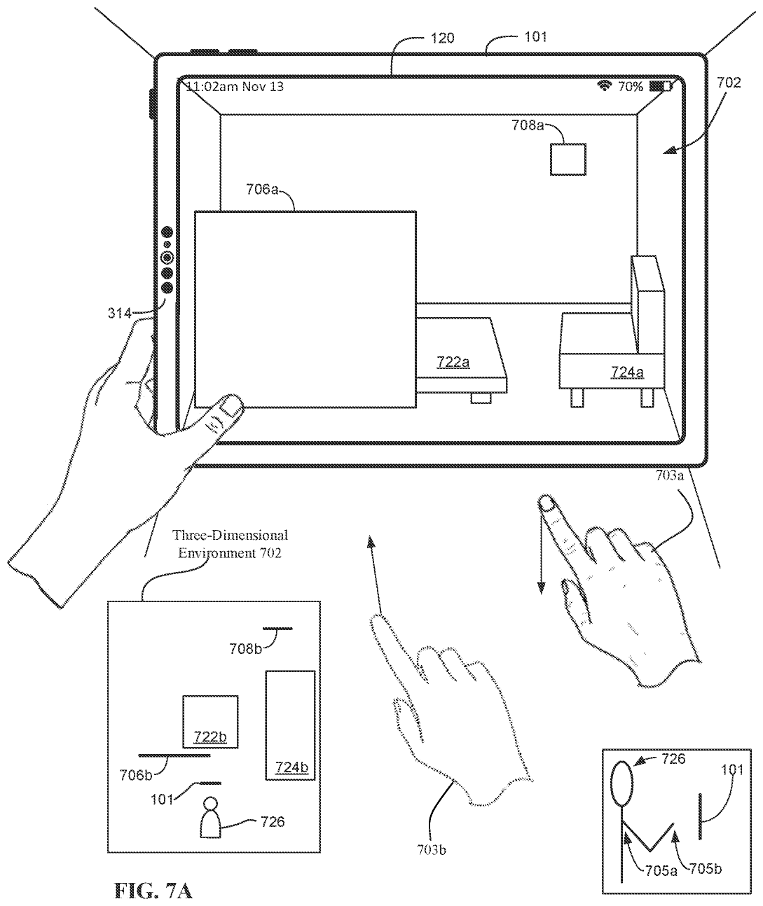

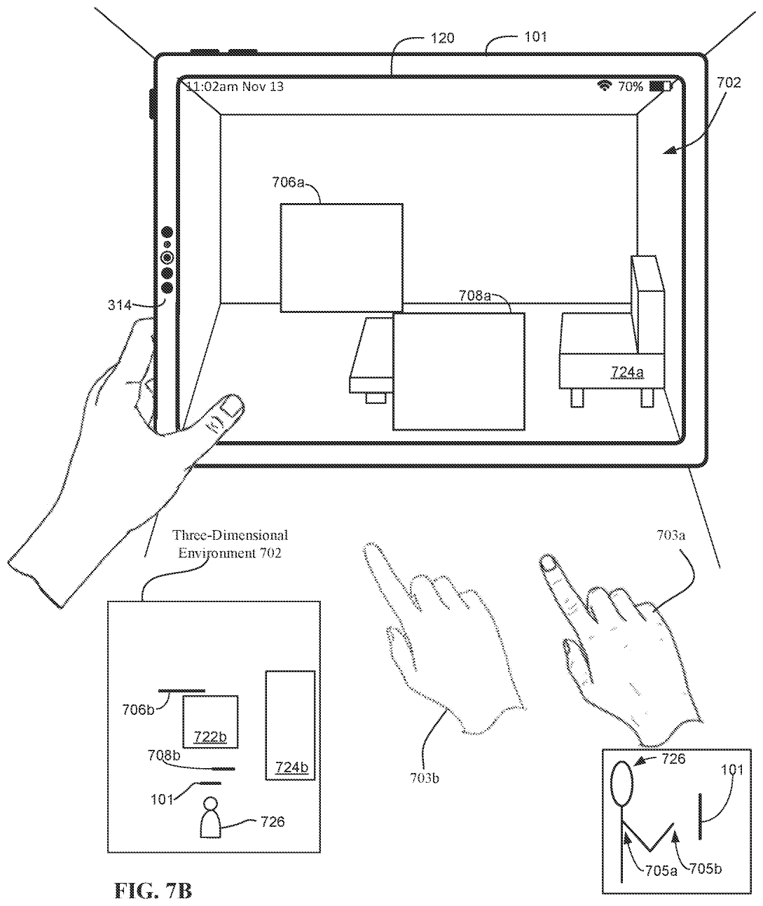

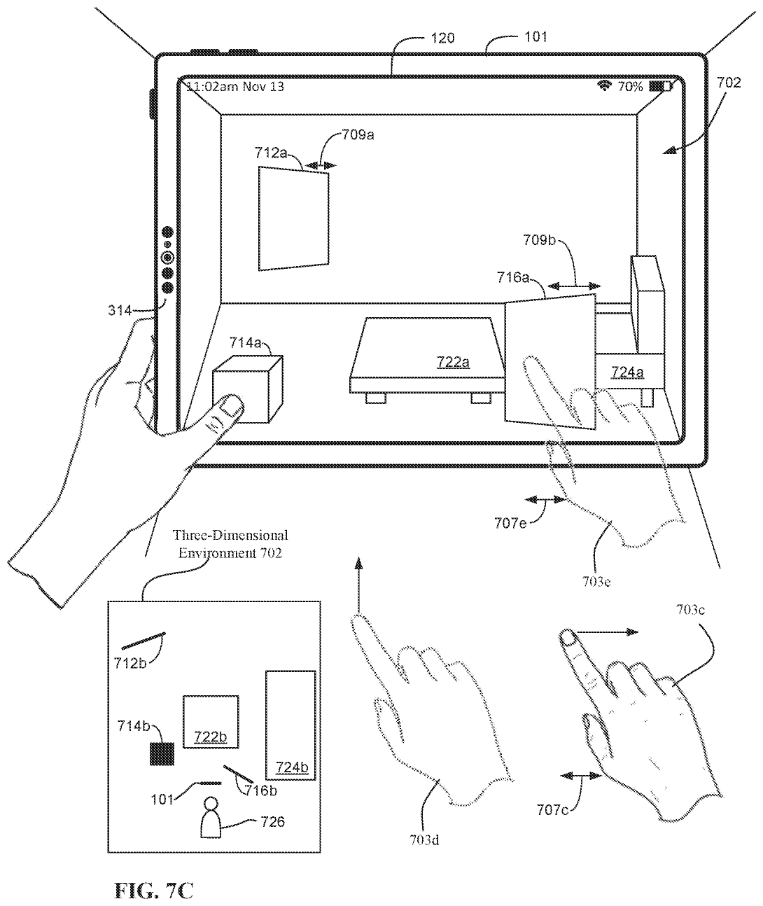

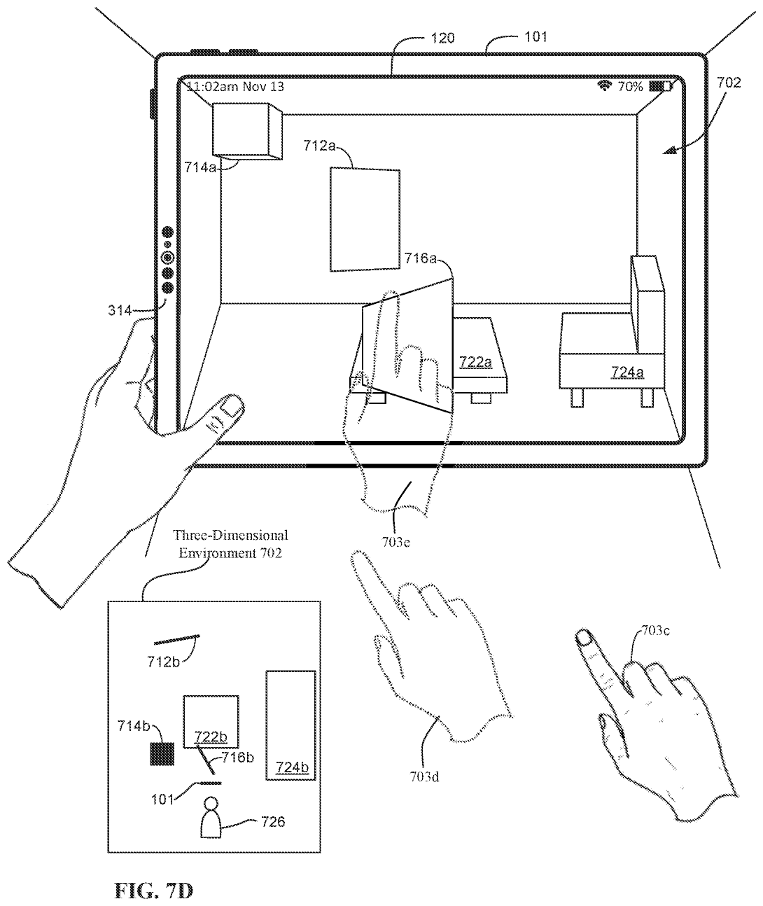

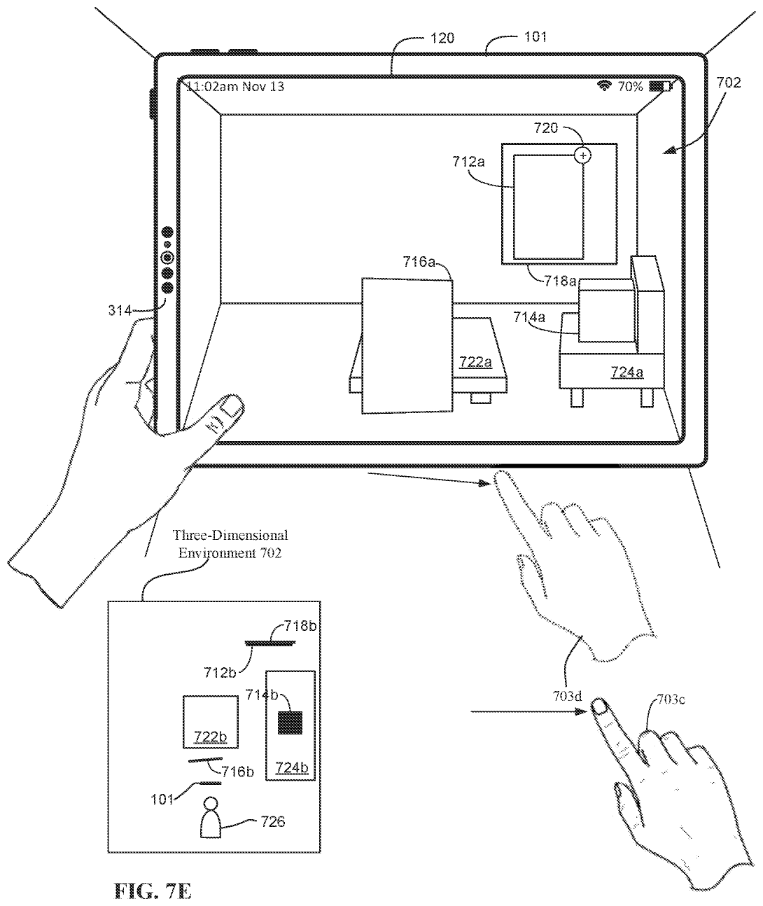

FIGS. 7A-7E illustrate examples of an electronic device utilizing different algorithms for moving objects in different directions in a three-dimensional environment in accordance with some embodiments.

FIG. 7A illustrates an electronic device 101 displaying, via a display generation component (e.g., display generation component 120 of FIG. 1), a three-dimensional environment 702 from a viewpoint of the user 726 illustrated in the overhead view (e.g., facing the back wall of the physical environment in which device 101 is located). As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user).

As shown in FIG. 7A, device 101 captures one or more images of the physical environment around device 101 (e.g., operating environment 100), including one or more objects in the physical environment around device 101. In some embodiments, device 101 displays representations of the physical environment in three-dimensional environment 702. For example, three-dimensional environment 702 includes a representation 722a of a coffee table (corresponding to table 722b in the overhead view), which is optionally a representation of a physical coffee table in the physical environment, and three-dimensional environment 702 includes a representation 724a of sofa (corresponding to sofa 724b in the overhead view), which is optionally a representation of a physical sofa in the physical environment.

In FIG. 7A, three-dimensional environment 702 also includes virtual objects 706a (corresponding to object 706b in the overhead view) and 708a (corresponding to object 708b in the overhead view). Virtual object 706a is optionally at a relatively small distance from the viewpoint of user 726, and virtual object 708a is optionally at a relatively large distance from the viewpoint of user 726. Virtual objects 706a and/or 708a are optionally one or more of user interfaces of applications (e.g., messaging user interfaces, content browsing user interfaces, etc.), three-dimensional objects (e.g., virtual clocks, virtual balls, virtual cars, etc.) or any other element displayed by device 101 that is not included in the physical environment of device 101.

In some embodiments, device 101 uses different algorithms to control the movement of objects in different directions in three-dimensional environment 702; for example, different algorithms for movement of objects towards or away from the viewpoint of the user 726, or different algorithms for movement of objects vertically or horizontally in three-dimensional environment 702. In some embodiments, device 101 utilizes sensors (e.g., sensors 314) to detect one or more of absolute positions of and/or relative positions of (e.g., relative to one another and/or relative to the object being moved in three-dimensional environment 702) one or more of the hand 705b of the user providing the movement input, the shoulder 705a of the user 726 that corresponds to hand 705b (e.g., the right shoulder if the right hand is providing the movement input), or the object to which the movement input is directed. In some embodiments, the movement of an object is based on the above-detected quantities. Details about how the above-detected quantities are optionally utilized by device 101 to control movement of objects are provided with reference to method 800.

In FIG. 7A, hand 703a is providing movement input directed to object 708a, and hand 703b is providing movement input to object 706a. Hand 703a is optionally providing input for moving object 708a closer to the viewpoint of user 726, and hand 703b is optionally providing input for moving object 706a further from the viewpoint of user 726. In some embodiments, such movement inputs include the hand of the user moving towards or away from the body of the user 726 while the hand is in a pinch hand shape (e.g., while the thumb and tip of the index finger of the hand are touching). For example, from FIGS. 7A-7B, device 101 optionally detects hand 703a move towards the body of the user 726 while in the pinch hand shape, and device 101 optionally detects hand 703b move away from the body of the user 726 while in the pinch hand shape. It should be understood that while multiple hands and corresponding inputs are illustrated in FIGS. 7A-7E, such hands and inputs need not be detected by device 101 concurrently; rather, in some embodiments, device 101 independently responds to the hands and/or inputs illustrated and described in response to detecting such hands and/or inputs independently.

In response to the movement inputs detected in FIGS. 7A-7B, device 101 moves objects 706a and 708a in three-dimensional environment 702 accordingly, as shown in FIG. 7B. In some embodiments, for a given magnitude of the movement of the hand of the user, device 101 moves the target object more if the input is an input to move the object towards the viewpoint of the user, and moves the target object less if the input is an input to move the object away from the viewpoint of the user. In some embodiments, this difference is to avoid the movement of objects sufficiently far away from the viewpoint of the user in three-dimensional environment 702 that the objects are no longer reasonably interactable from the current viewpoint of the user (e.g., are too small in the field of view of the user for reasonable interaction). In FIGS. 7A-7B, hands 703a and 703b optionally have the same magnitude of movement, but in different directions, as previously described. In response to the given magnitude of the movement of hand 703a toward the body of user 726, device 101 has moved object 708a almost the entire distance from its original location to the viewpoint of the user 726, as shown in the overhead view in FIG. 7B. In response to the same given magnitude of the movement of hand 703b away from the body of user 726, device 101 has moved object 706a, away from the viewpoint of user 726, a distance smaller than the distance covered by object 708a, as shown in the overhead view in FIG. 7B.

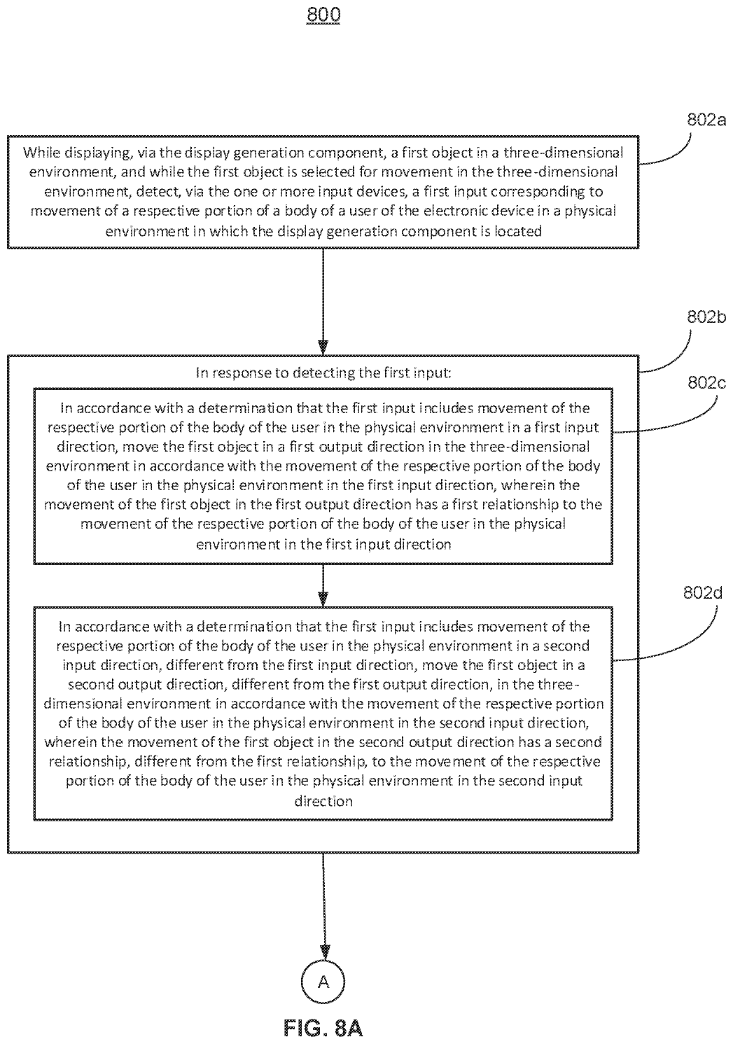

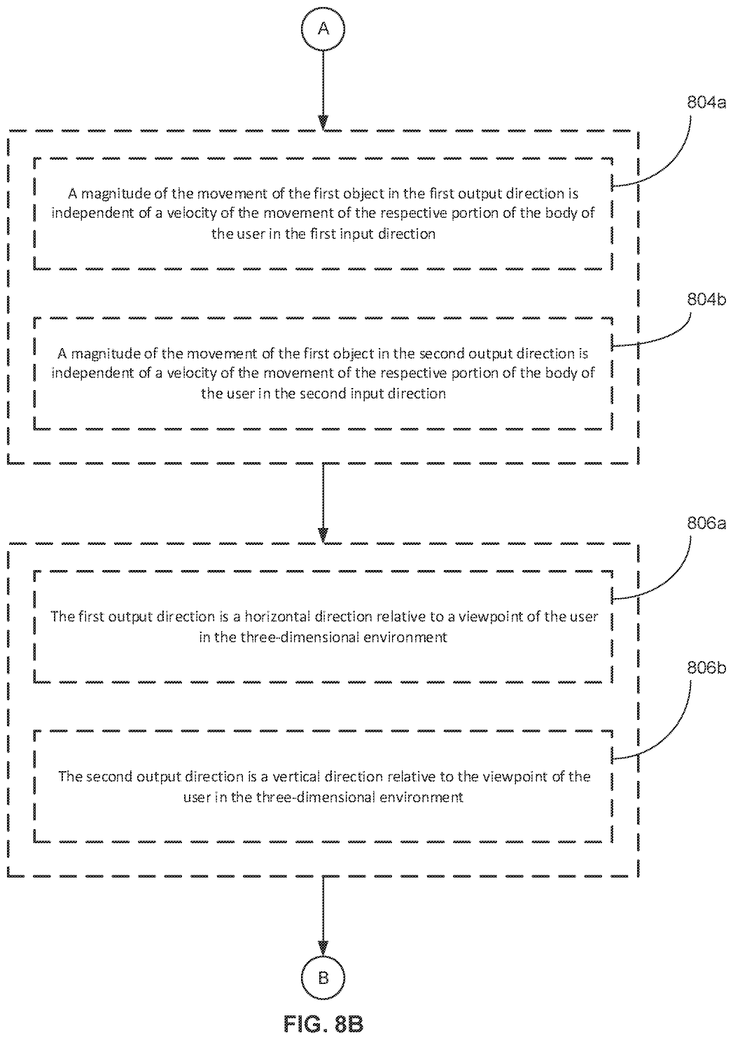

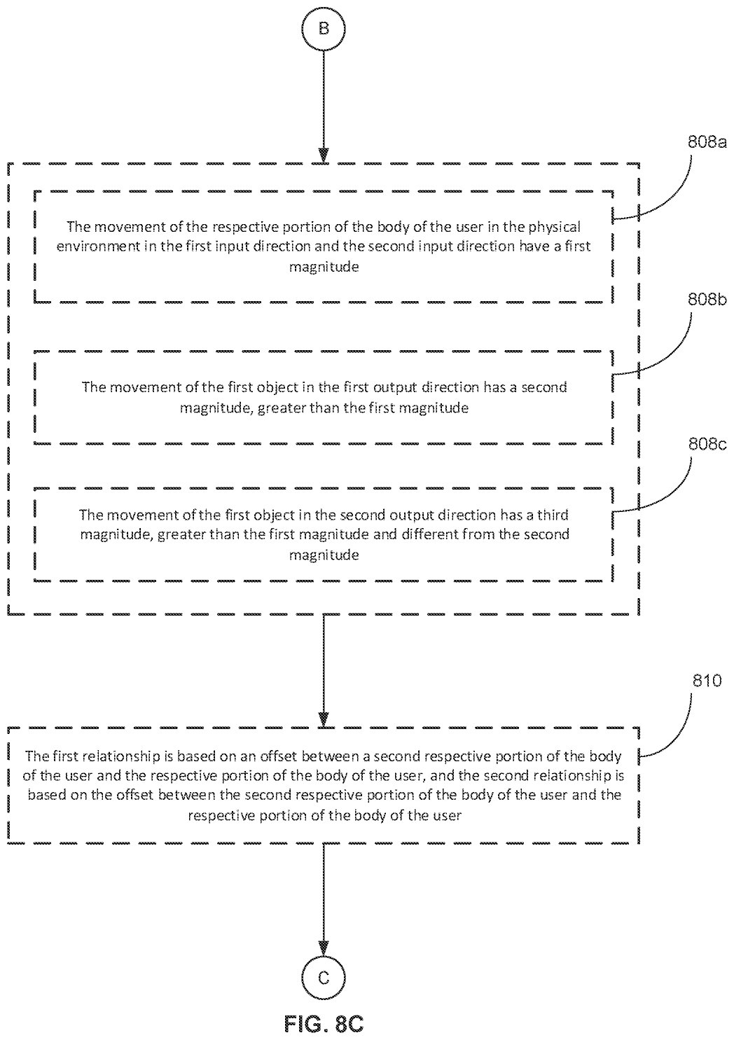

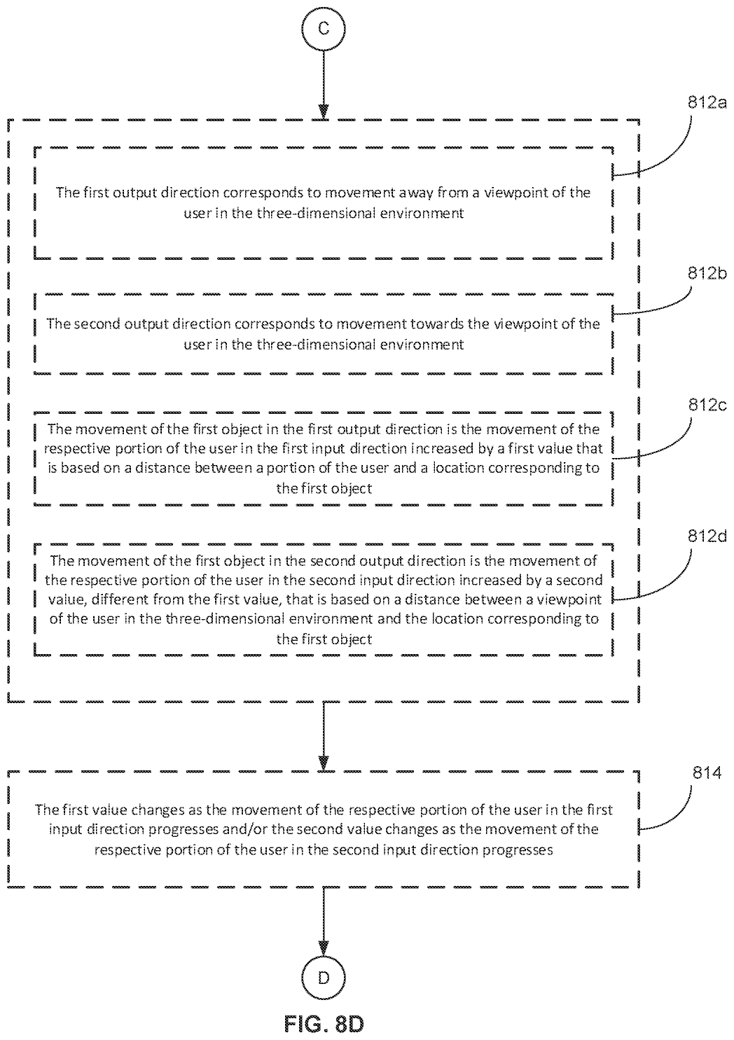

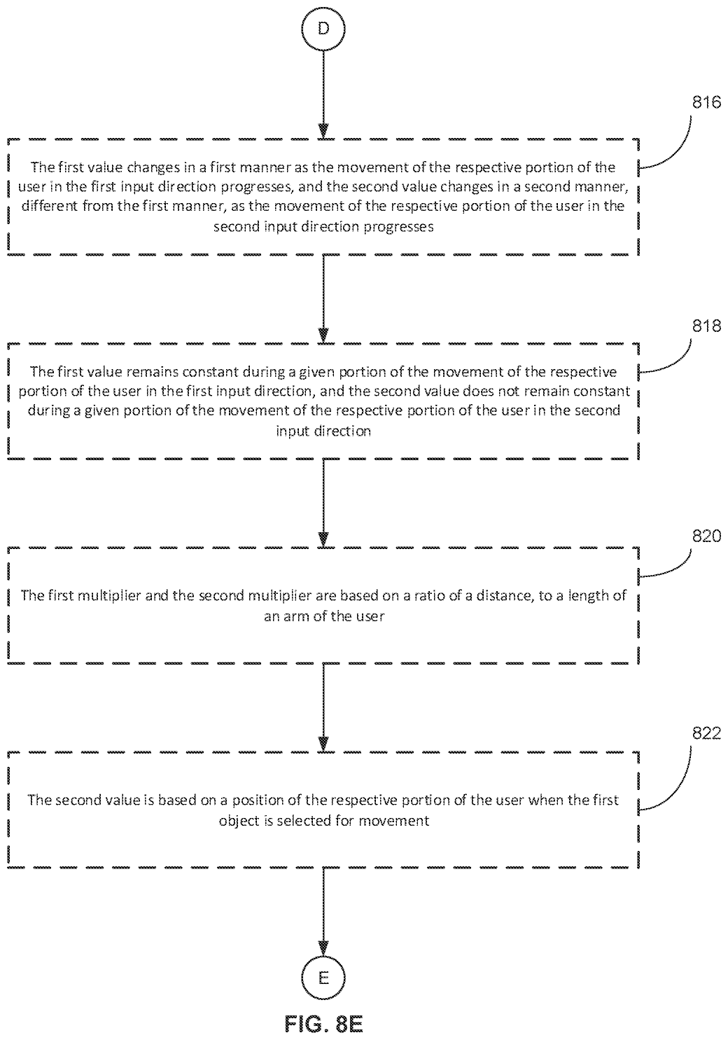

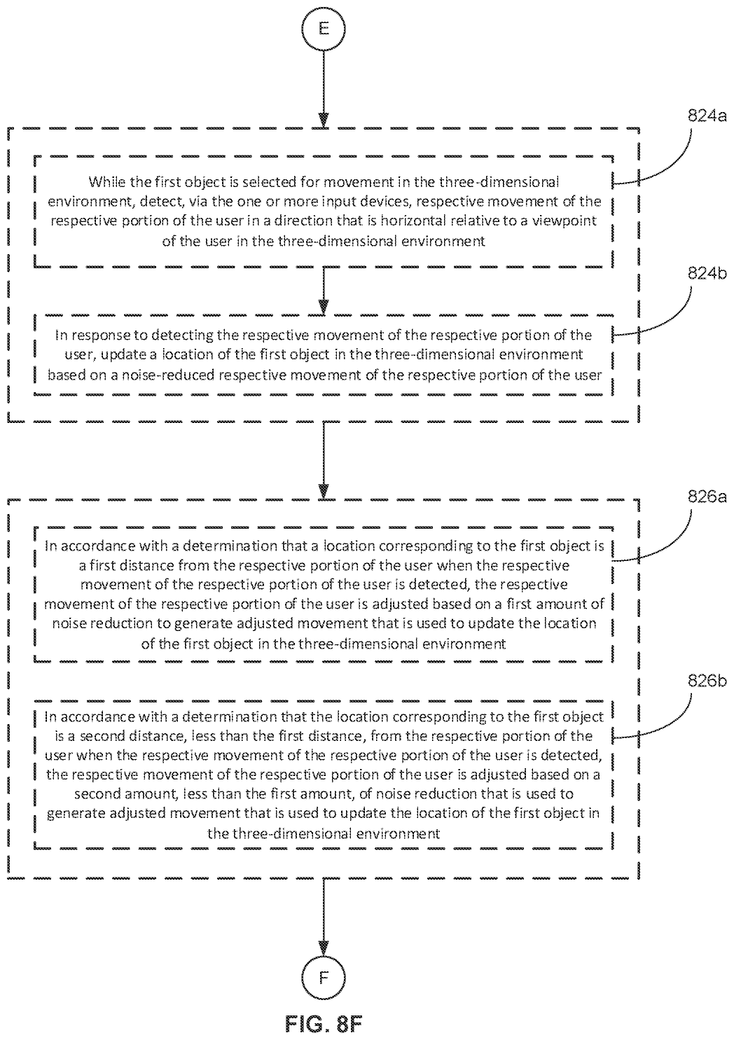

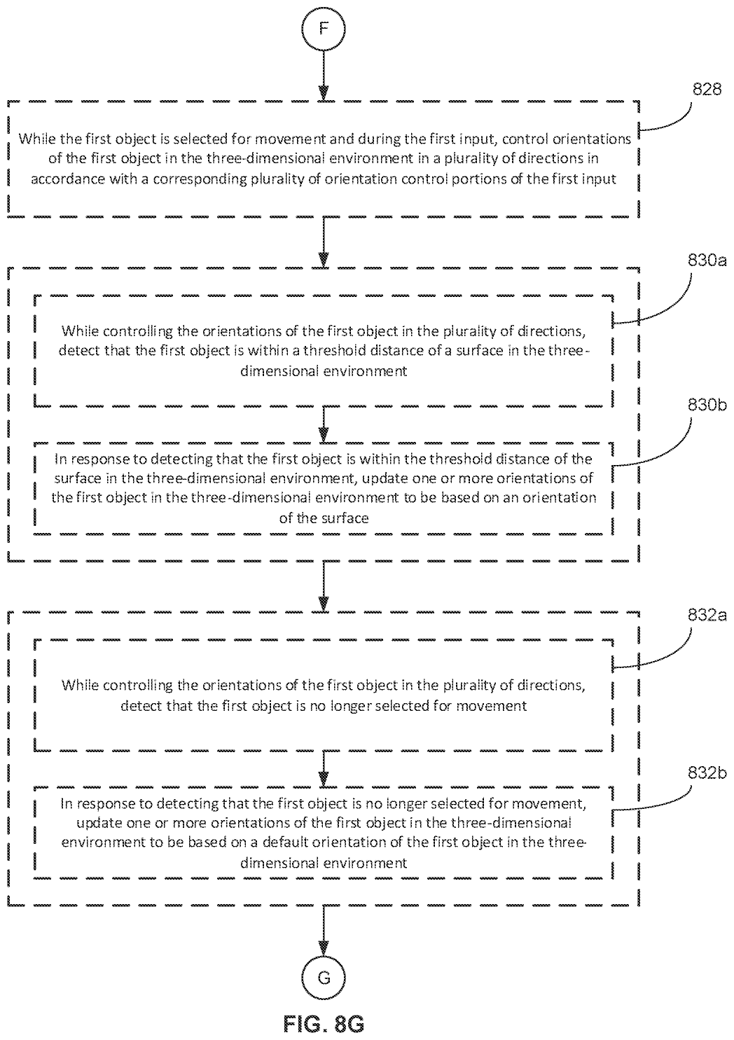

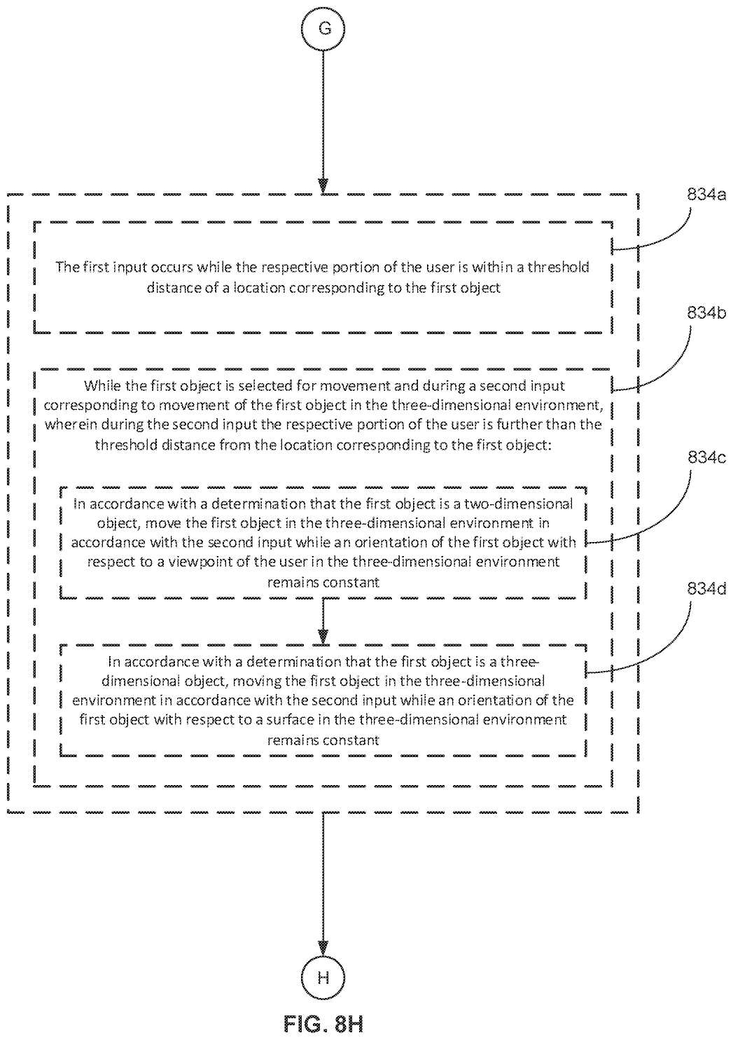

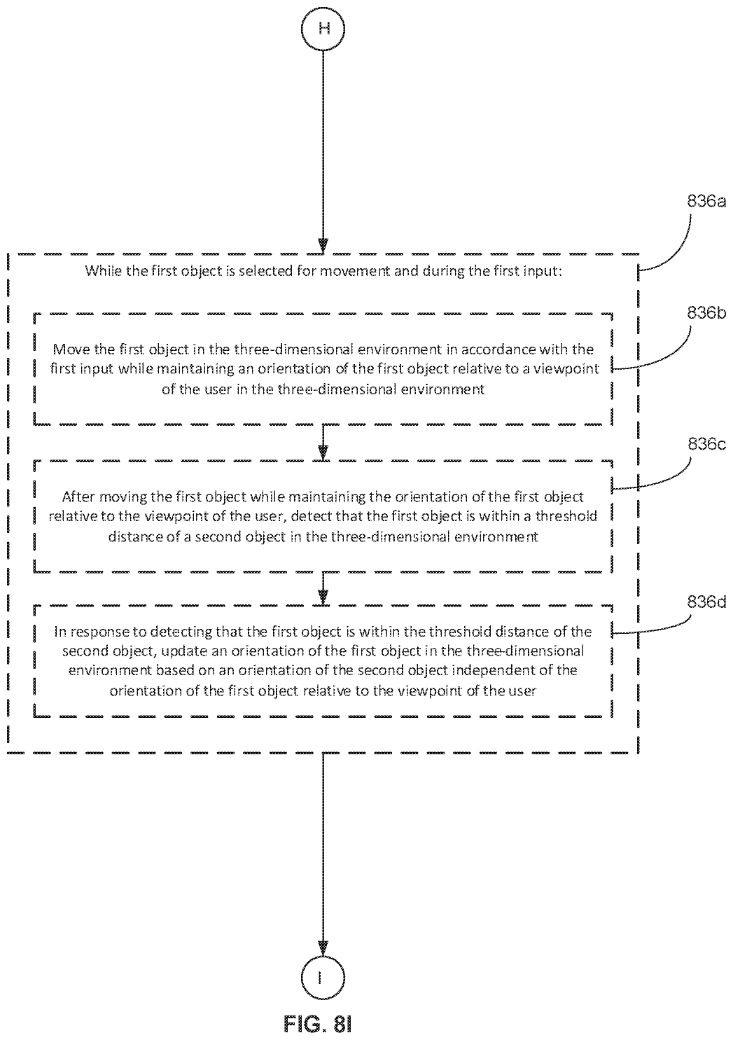

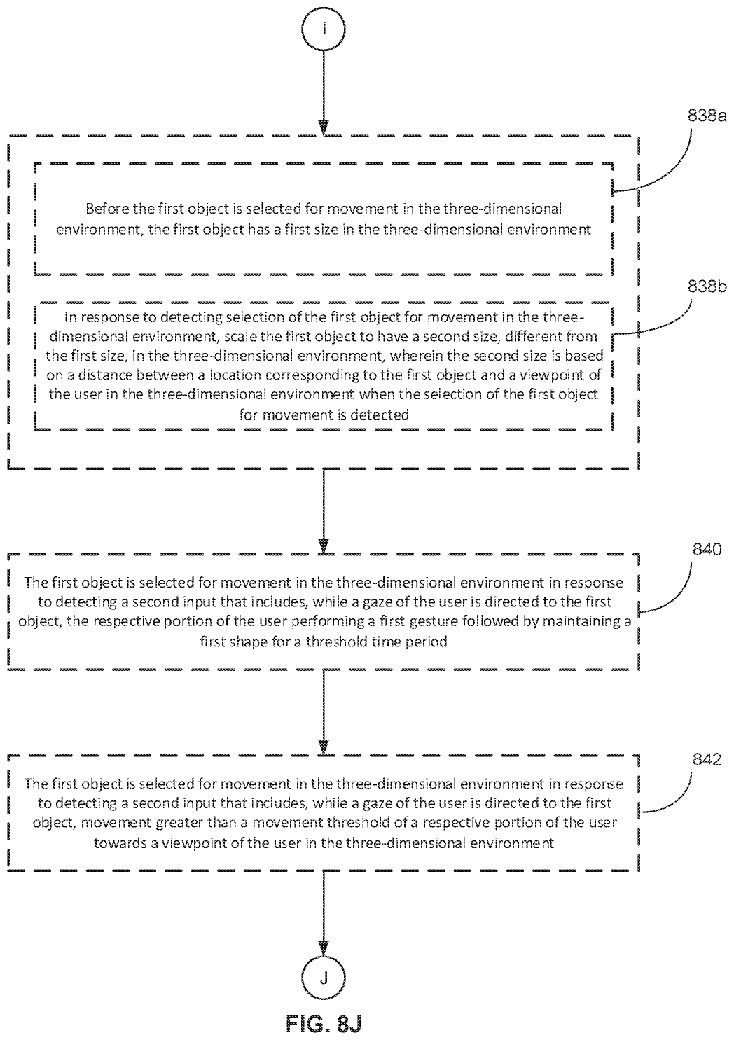

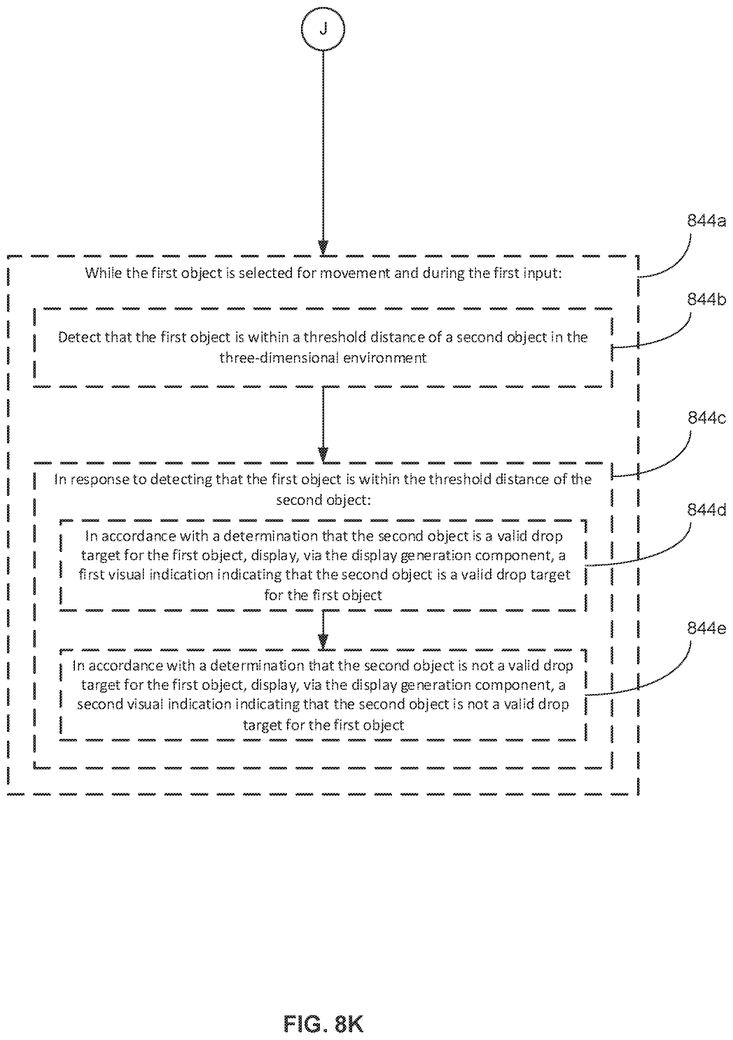

Further, in some embodiments, device 101 controls the size of an object included in three-dimensional environment 702 based on the distance of that object from the viewpoint of user 726 to avoid objects consuming a large portion of the field of view of user 726 from their current viewpoint. Thus, in some embodiments, objects are associated with appropriate or optimal sizes for their current distance from the viewpoint of user 726, and device 101 automatically changes the sizes of objects to conform with their appropriate or optimal sizes. However, in some embodiments, device 101 does not adjust the size of an object until user input for moving the object is detected. For example, in FIG. 7A, object 706a is optionally larger than its appropriate or optimal size for its current distance from the viewpoint of user 726, but device 101 has not yet automatically scaled down object 706a to that appropriate or optimal size. In response to detecting the input provided by hand 703b for moving object 706a in three-dimensional environment 702, device 101 optionally reduces the size of object 706a in three-dimensional environment 702 as shown in the overhead view in FIG. 7B. The reduced size of object 706a optionally corresponds to the current distance of object 706a from the viewpoint of user 726. Additional details about controlling the sizes of objects based on the distances of those objects from the viewpoint of the user are described with reference to the FIG. 8 series of figures and method 900.

In some embodiments, device 101 applies different amounts of noise reduction to the movement of objects depending on the distances of those objects from the viewpoint of user 726. For example, in FIG. 7C, device 101 is displaying three-dimensional environment 702 that includes object 712a (corresponding to object 712b in the overhead view), object 716a (corresponding to object 716b in the overhead view), and object 714a (corresponding to object 714b in the overhead view). Objects 712a and 716a are optionally two-dimensional objects (e.g., similar to objects 706a and 708a), and object 714a is optionally a three-dimensional object (e.g., a cube, a three-dimensional model of a car, etc.). In FIG. 7C, object 712a is further than the viewpoint of user 726 than object 716a. Hand 703e is optionally currently providing movement input to object 716a, and hand 703c is optionally currently providing movement input to object 712a. Hands 703e and 703c optionally have the same amount of noise in their respective positions (e.g., the same magnitude of shaking, trembling, or vibration of the hands, reflected in bidirectional arrows 707c and 707e having the same length/magnitude). Because device 101 optionally applies more noise reduction to the resulting movement of object 712a controlled by hand 703c than to the resulting movement of object 716a controlled by hand 703e (e.g., because object 712a is further from the viewpoint of user 726 than object 716a), the noise in the position of hand 703c optionally results in less movement of object 712a than the movement of object 716a resulting from the noise in the position of hand 703e. This difference in noise-reduced movement is optionally reflected in bidirectional arrow 709a having a smaller length/magnitude than bidirectional arrow 709b.

In some embodiments, in addition or alternatively to utilizing different algorithms for movement of objects towards and away from the viewpoint of the user, device 101 utilizes different algorithms for movement of objects horizontally and vertically in three-dimensional environment 702. For example, in FIG. 7C, hand 703d is providing an upward vertical movement input directed to object 714a, and hand 703c is providing a rightward horizontal movement input directed to object 712a. In some embodiments, in response to a given amount of hand movement, device 101 moves objects more in three-dimensional environment 702 when the movement input is a vertical movement input than if the movement input is a horizontal movement input. In some embodiments, this difference is to reduce the strain users may feel when moving their hands, as vertical hand movements may be more difficult (e.g., due to gravity and/or anatomical reasons) than horizontal hand movements. For example, in FIG. 7C, the amount of movement of hands 703c and 703d is optionally the same. In response, as shown in FIG. 7D, device 101 has moved object 714a vertically in three-dimensional environment 702 more than it has moved object 712a horizontally in three-dimensional environment 702.

In some embodiments, when objects are being moved in three-dimensional environment 702 (e.g., in response to indirect hand inputs, which optionally occur while the hand is more than a threshold distance (e.g., 1, 3, 6, 12, 24, 36, 48, 60, or 72 cm) from the object the hand is controlling, as described in more detail with reference to method 800), their orientations are optionally controlled differently depending on whether the object being moved is a two-dimensional object or a three-dimensional object. For example, while a two-dimensional object is being moved in three-dimensional environment, device 101 optionally adjusts the orientation of the object such that it remains normal to the viewpoint of user 726. For example, in FIGS. 7C-7D while object 712a is being moved horizontally, device 101 has automatically adjusted the orientation of object 712a such that it remains normal to the viewpoint of user 726 (e.g., as shown in the overhead view of three-dimensional environment). In some embodiments, the normalcy of the orientation of object 712a to the viewpoint of user 726 is optionally maintained for movement in any direction in three-dimensional environment 702. In contrast, while a three-dimensional object is being moved in three-dimensional environment, device 101 optionally maintains the relative orientation of a particular surface of the object relative to an object or surface in three-dimensional environment 702. For example, in FIGS. 7C-7D while object 714a is being moved vertically, device 101 has controlled the orientation of object 714a such that the bottom surface of object 714a remains parallel to the floor in the physical environment and/or the three-dimensional environment 702. In some embodiments, the parallel relationship between the bottom surface of object 714a and the floor in the physical environment and/or the three-dimensional environment 702 is optionally maintained for movement in any direction in three-dimensional environment 702.

In some embodiments, an object that is being moved via a direct movement input—which optionally occurs while the hand is less than a threshold distance (e.g., 1, 3, 6, 12, 24, 36, 48, 60, or 72 cm) from the object the hand is controlling, as described in more detail with reference to method 800—optionally rotates freely (e.g., pitch, yaw and/or roll) in accordance with corresponding rotation input provided by the hand (e.g., rotation of the hand about one or more axes during the movement input). This free rotation of the object is optionally in contrast with the controlled orientation of the objects described above with reference to indirect movement inputs. For example, in FIG. 7C, hand 703e is optionally providing direct movement input to object 716a. From FIG. 7C to 7D, hand 703e optionally moves leftward to move object 716a leftward in three-dimensional environment 702, and also provides a rotation (e.g., pitch, yaw and/or roll) input to change the orientation of object 716a, as shown in FIG. 7D. As shown in FIG. 7D, object 716a has rotated in accordance with the rotation input provided by hand 703e, and object 716a has not remained normal to the viewpoint of user 726.

However, in some embodiments, upon detecting an end of a direct movement input (e.g., upon detecting a release of the pinch hand shape being made by the hand, or upon detecting that the hand of the user moves further than the threshold distance from the object being controlled), device 101 automatically adjusts the orientation of the object that was being controlled depending on the above-described rules that apply to the type of object that it is (e.g., two-dimensional or three-dimensional). For example, in FIG. 7E, hand 703e has dropped object 716a in empty space in three-dimensional environment 702. In response, device 101 has automatically adjusted the orientation of object 716a to be normal to the viewpoint of user 726 (e.g., different from the orientation of the object at the moment of being dropped), as shown in FIG. 7E.

In some embodiments, device 101 automatically adjusts the orientation of an object to correspond to another object or surface when that object gets close to the other object or surface (e.g., irrespective of the above-described orientation rules for two-dimensional and three-dimensional objects). For example, from FIG. 7D to 7E, hand 703d has provided an indirect movement input to move object 714a to within a threshold distance (e.g., 0.1, 0.5, 1, 3, 6, 12, 24, 36, or 48 cm) of a surface of representation 724a of sofa, which is optionally a representation of a physical sofa in the physical environment of device 101. In response, in FIG. 7E, device 101 has adjusted the orientation of object 714a to correspond and/or be parallel to the approached surface of representation 724a (e.g., which optionally results in the bottom surface of object 714a no longer remaining parallel to the floor in the physical environment and/or the three-dimensional environment 702). Similarly, from FIG. 7D to 7E, hand 703c has provided an indirect movement input to move object 712a to within a threshold distance (e.g., 0.1, 0.5, 1, 3, 6, 12, 24, 36, or 48 cm) of a surface of virtual object 718a. In response, in FIG. 7E, device 101 has adjusted the orientation of object 712a to correspond and/or be parallel to the approached surface of object 718a (e.g., which optionally results in the orientation of object 712a no longer remaining normal to the viewpoint of user 726).

Further, in some embodiments, when a respective object is moved to within the threshold distance of the surface of an object (e.g., physical or virtual), device 101 displays a badge on the respective object that indicates whether the object is a valid or invalid drop target for the respective object. For example, a valid drop target for the respective object is one to which the respective object is able to be added and/or one that is able to contain the respective object, and an invalid drop target for the respective object is one to which the respective object is not able to be added and/or one that is not able to contain the respective object. In FIG. 7E, object 718a is a valid drop target for object 712a; therefore, device 101 displays badge 720 overlaid on the upper-right corner of object 712a that indicates that object 718a is a valid drop target for object 712a. Additional details of valid and invalid drop targets, and associated indications that are displayed and other responses of device 101, are described with reference to methods 1000, 1200, 1400 and/or 1600.

FIGS. 8A-8K is a flowchart illustrating a method 800 of utilizing different algorithms for moving objects in different directions in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while displaying, via the display generation component, a first object in a three-dimensional environment, such as object 706a or 708a in FIG. 7A (e.g., an environment that corresponds to a physical environment surrounding the display generation component) (e.g., a window of an application displayed in the three-dimensional environment, a virtual object (e.g., a virtual clock, a virtual table, etc.) displayed in the three-dimensional environment, etc. In some embodiments, the three-dimensional environment is generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.)), and while the first object is selected for movement in the three-dimensional environment, the electronic device detects (802a), via the one or more input devices, a first input corresponding to movement of a respective portion of a body of a user of the electronic device (e.g., movement of a hand and/or arm of the user) in a physical environment in which the display generation component is located, such as the inputs from hands 703a, 703b in FIG. 7A (e.g., a pinch gesture of an index finger and thumb of a hand of the user followed by movement of the hand in the pinch hand shape while the gaze of the user is directed to the first object while the hand of the user is greater than a threshold distance (e.g., 0.2, 0.5, 1, 2, 3, 5, 10, 12, 24, or 26 cm) from the first object, or a pinch of the index finger and thumb of the hand of the user followed by movement of the hand in the pinch hand shape irrespective of the location of the gaze of the user when the hand of the user is less than the threshold distance from the first object). In some embodiments, the first input has one or more of the characteristics of the input(s) described with reference to methods 1000, 1200, 1400 and/or 1600.

In some embodiments, in response to detecting the first input (802b), in accordance with a determination that the first input includes movement of the respective portion of the body of the user in the physical environment in a first input direction, such as for hand 703b in FIG. 7A (e.g., the movement of the hand in the first input includes (or only includes) movement of the hand away from the viewpoint of the user in the three-dimensional environment), the electronic device moves (802c) the first object in a first output direction in the three-dimensional environment in accordance with the movement of the respective portion of the body of the user in the physical environment in the first input direction, such as the movement of object 706a in FIG. 7B (e.g., moving the first object away from the viewpoint of the user in the three-dimensional environment based on the movement of the hand of the user), wherein the movement of the first object in the first output direction has a first relationship to the movement of the respective portion of the body of the user in the physical environment in the first input direction (e.g., the amount and/or manner in which the first object is moved away from the viewpoint of the first user is controlled by a first algorithm that translates movement of the hand of the user (e.g., away from the viewpoint of the user) into the movement of the first object (e.g., away from the viewpoint of the user), example details of which will be described later).

In some embodiments, in accordance with a determination that the first input includes movement of the respective portion of the body of the user in the physical environment in a second input direction, different from the first input direction, such as with hand 703a in FIG. 7A (e.g., the movement of the hand in the first input includes (or only includes) movement of the hand towards the viewpoint of the user in the three-dimensional environment), the electronic device moves the first object in a second output direction, different from the first output direction, in the three-dimensional environment in accordance with the movement of the respective portion of the body of the user in the physical environment in the second input direction, such as the movement of object 708a in FIG. 7B (e.g., moving the first object toward the viewpoint of the user based on the movement of the hand of the user), wherein the movement of the first object in the second output direction has a second relationship, different from the first relationship, to the movement of the respective portion of the body of the user in the physical environment in the second input direction. For example, the amount and/or manner in which the first object is moved toward the viewpoint of the first user is controlled by a second algorithm, different from the first algorithm, that translates movement of the hand of the user (e.g., toward the viewpoint of the user) into the movement of the first object (e.g., toward the viewpoint of the user), example details of which will be described later. In some embodiments, the translation of hand movement to object movement in the first and second algorithms is different (e.g., different amount of object movement for a given amount of hand movement). Thus, in some embodiments, movement of the first object in different directions (e.g., horizontal relative to the viewpoint of the user, vertical relative to the viewpoint of the user, further away from the viewpoint of the user, towards the viewpoint of the user, etc.) is controlled by different algorithms that translate movement of the hand of the user differently to movement of the first object in the three-dimensional environment. Using different algorithms to control movement of objects in three-dimensional environments for different directions of movement allows the device to utilize algorithms that are better suited for the direction of movement at issue to facilitate improved location control for objects in the three-dimensional environment, thereby reducing errors in usage and improving user-device interaction.

In some embodiments, a magnitude of the movement of the first object (e.g., object 706a) in the first output direction (e.g., the distance that the first object moves in the three-dimensional environment in the first output direction, such as away from the viewpoint as in FIG. 7B) is independent of a velocity of the movement of the respective portion of the body of the user (e.g., hand 703b) in the first input direction (804a) (e.g., the amount of movement of the first object in the three-dimensional environment is based on factors such as one or more of the amount of the movement of the hand of the user providing the input in the first input direction, the distance between the hand of the user and the shoulder of the user when providing the input in the first input direction, and/or the various factors described below, but is optionally not based on the speed with which the hand of the user moves during the input in the first input direction).

In some embodiments, a magnitude of the movement of the first object (e.g., object 708a) in the second output direction (e.g., the distance that the first object moves in the three-dimensional environment in the second output direction, such as towards the viewpoint as in FIG. 7B) is independent of a velocity of the movement of the respective portion of the body of the user (e.g., hand 703a) in the second input direction (804b). For example, the amount of movement of the first object in the three-dimensional environment is based on factors such as one or more of the amount of the movement of the hand of the user providing the input in the second input direction, the distance between the hand of the user and the shoulder of the user when providing the input in the second input direction, and/or the various factors described below, but is optionally not based on the speed with which the hand of the user moves during the input in the second input direction. In some embodiments, even though the distance the object moves in the three-dimensional environment is independent of the speed of the movement of the respective portion of the user, the speed at which the first object moves through the three-dimensional environment is based on the speed of the movement of the respective portion of the user. Making the amount of movement of the object independent of the speed of the respective portion of the user avoids situations in which sequential inputs for moving the object that would otherwise correspond to bringing the object back to its original location (if the amount of movement of the object were independent of the speed of movement of the respective portion of the object) before the inputs were received results in the object not being moved back to its original location (e.g., because the sequential inputs were provided with different speeds of the respective portion of the user), thereby improving user-device interaction.

In some embodiments, (e.g., the first input direction and) the first output direction is a horizontal direction relative to a viewpoint of the user in the three-dimensional environment (806a), such as with respect to object 712a in FIGS. 7C and 7D (e.g., the electronic device is displaying a viewpoint of the three-dimensional environment that is associated with the user of the electronic device, and the first input direction and/or the first output direction correspond to inputs and/or outputs for moving the first object in a horizontal direction (e.g., substantially parallel to the floor plane of the three-dimensional environment)). For example, the first input direction corresponds to a hand of the user moving substantially parallel to a floor (and/or substantially perpendicular to gravity) in a physical environment of the electronic device and/or display generation component, and the first output direction corresponds to movement of the first object substantially parallel to a floor plane in the three-dimensional environment displayed by the electronic device.

In some embodiments, (e.g., the second input direction) and the second output direction is a vertical direction relative to the viewpoint of the user in the three-dimensional environment (806b), such as with respect to object 714a in FIGS. 7C and 7D. For example, the second input direction and/or the second output direction correspond to inputs and/or outputs for moving the first object in a vertical direction (e.g., substantially perpendicular to the floor plane of the three-dimensional environment). For example, the second input direction corresponds to a hand of the user moving substantially perpendicular to a floor (and/or substantially parallel to gravity) in a physical environment of the electronic device and/or display generation component, and the second output direction corresponds to movement of the first object substantially perpendicular to a floor plane in the three-dimensional environment displayed by the electronic device. Thus, in some embodiments, the amount of movement of the first object for a given amount of movement of the respective portion of the user is different for vertical movements of the first object and horizontal movements of the first object. Providing for different movement amounts for vertical and horizontal movement inputs allows the device to utilize algorithms that are better suited for the direction of movement at issue to facilitate improved location control for objects in the three-dimensional environment (e.g., because vertical hand movements might be harder to complete for a user than horizontal hand movements due to gravity), thereby reducing errors in usage and improving user-device interaction.

In some embodiments, the movement of the respective portion of the body of the user in the physical environment in the first input direction and the second input direction have a first magnitude (808a), such as the magnitudes of the movements of hands 703a and 703b in FIG. 7A being the same (e.g., the hand of the user moves 12 cm in the physical environment of the electronic device and/or display generation component), the movement of the first object in the first output direction has a second magnitude, greater than the first magnitude (808b), such as shown with respect to object 706a in FIG. 7B (e.g., if the input is an input to move the first object horizontally, the first object moves horizontally by 12 cm times a first multiplier, such as 1.1, 1.2, 1.3, 1.4, 1.5, 1.6, 1.7, 1.8, 1.9, 2, 4, 6 or 10 in the three-dimensional environment), and the movement of the first object in the second output direction has a third magnitude, greater than the first magnitude and different from the second magnitude (808c), such as shown with respect to object 708a in FIG. 7B (e.g., if the input is an input to move the first object vertically, the first object moves vertically by 12 cm times a second multiplier that is greater than the first multiplier, such as 1.2, 1.2, 1.3, 1.4, 1.5, 1.6, 1.7, 1.8, 1.9, 2, 4, 6 or 10 in the three-dimensional environment). Thus, in some embodiments, inputs for moving the first object vertically (e.g., up or down) result in more movement of the first object in the three-dimensional environment for a given amount of hand movement as compared with inputs for moving the first object horizontally (e.g., left or right). It is understood that the above-described multipliers are optionally applied to the entirety of the hand movement, or only the components of the hand movement in the respective directions (e.g., horizontal or vertical). Providing for different movement amounts for vertical and horizontal movement inputs allows the device to utilize algorithms that are better suited for the direction of movement at issue to facilitate improved location control for objects in the three-dimensional environment (e.g., because vertical hand movements might be harder to complete for a user than horizontal hand movements due to gravity), thereby reducing errors in usage and improving user-device interaction.

In some embodiments, the first relationship is based on an offset between a second respective portion of the body of the user (e.g., shoulder, such as 705a) and the respective portion of the body of the user (e.g., hand corresponding to the shoulder, such as 705b), and the second relationship is based on the offset between the second respective portion of the body of the user (e.g., shoulder) and the respective portion of the body of the user (810) (e.g., hand corresponding to the shoulder). In some embodiments, the offset and/or separation and/or distance and/or angular offset between the hand of the user and the corresponding shoulder of the user is a factor in determining the movement of the first object away from and/or towards the viewpoint of the user. For example, with respect to movement of the first object away from the viewpoint of the user, the offset between the shoulder and the hand of the user is optionally recorded at the initiation of the first input (e.g., at the moment the pinchdown of the index finger and thumb of the hand is detected, such as when the tip of the thumb and the tip of the index finger are detected as coming together and touching, before movement of the hand in the pinch hand shape is detected), and this offset corresponds to a factor to be multiplied with the movement of the hand to determine how much the first object is to be moved away from the viewpoint of the user. In some embodiments, this factor has a value of 1 from 0 to 40 cm (or 5, 10, 15, 20, 30, 50 or 60 cm) of offset between the shoulder and the hand, then increases linearly from 40 (or 5, 10, 15, 20, 30, 50 or 60 cm) to 60 cm (or 25, 30, 35, 40, 50, 70 or 80 cm) of offset, then increases linearly at a greater rate from 60 cm (or 25, 30, 35, 40, 50, 70 or 80 cm) onward. With respect to movement of the first object toward the viewpoint of the user, the offset between the shoulder and the hand of the user is optionally recorded at the initiation of the first input (e.g., at the moment the pinchdown of the index finger and thumb of the hand is detected, before movement of the hand in the pinch hand shape is detected), and that offset is halved. Movement of the hand from the initial offset to the halved offset is optionally set as corresponding to movement of the first object from its current position all the way to the viewpoint of the user. Utilizing hand to shoulder offsets in determining object movement provides object movement response that is comfortable and consistent given different starting offsets, thereby reducing errors in usage and improving user-device interaction.

In some embodiments, (e.g., the first input direction and) the first output direction corresponds to movement away from a viewpoint of the user in the three-dimensional environment (812a), such as shown with object 706a in FIG. 7B. For example, the electronic device is displaying a viewpoint of the three-dimensional environment that is associated with the user of the electronic device, and the first input direction and/or the first output direction correspond to inputs and/or outputs for moving the first object further away from the viewpoint of the user (e.g., substantially parallel to the floor plane of the three-dimensional environment and/or substantially parallel to an orientation of the viewpoint of the user in the three-dimensional environment). For example, the first input direction corresponds to a hand of the user moving away from the body of the user in a physical environment of the electronic device and/or display generation component, and the first output direction corresponds to movement of the first object away from the viewpoint of the user in the three-dimensional environment displayed by the electronic device.

In some embodiments, (e.g., the second input direction and) the second output direction corresponds to movement towards the viewpoint of the user in the three-dimensional environment (812b), such as shown with object 708a in FIG. 7B. For example, the second input direction and/or the second output direction correspond to inputs and/or outputs for moving the first object closer to the viewpoint of the user (e.g., substantially parallel to the floor plane of the three-dimensional environment and/or substantially parallel to an orientation of the viewpoint of the user in the three-dimensional environment). For example, the second input direction corresponds to a hand of the user moving towards the body of the user in a physical environment of the electronic device and/or display generation component, and the second output direction corresponds to movement of the first object towards the viewpoint of the user in the three-dimensional environment displayed by the electronic device.

In some embodiments, the movement of the first object in the first output direction is the movement of the respective portion of the user in the first input direction (e.g., movement of hand 703b in FIG. 7A) increased (e.g., multiplied) by a first value that is based on a distance between a portion of the user (e.g., the hand of the user, the elbow of the user, the shoulder of the user) and a location corresponding to the first object (812c). For example, the amount that the first object moves in the first output direction in the three-dimensional environment is defined by the amount of movement of the hand of the user in the first input direction multiplied by the first value. In some embodiments, the first value is based on the distance between a particular portion of the user (e.g., the hand, shoulder, and/or elbow of the user) and the location of the first object. For example, in some embodiments, the first value increases as the distance between the first object and the shoulder corresponding to the hand of the user that is providing the input to move the object increases, and decreases as the distance between the first object and the shoulder of the user decreases. Further detail of the first value will be provided below.

In some embodiments, the movement of the first object in the second output direction is the movement of the respective portion of the user in the second input direction (e.g., movement of hand 703a in FIG. 7A) increased (e.g., multiplied) by a second value, different from the first value, that is based on a distance between a viewpoint of the user in the three-dimensional environment and the location corresponding to the first object (812d) (e.g., and is not based on the distance between the portion of the user (e.g., the hand of the user, the elbow of the user, the shoulder of the user) and the location corresponding to the first object). For example, the amount that the first object moves in the second output direction in the three-dimensional environment is defined by the amount of movement of the hand of the user in the second input direction multiplied by the second value. In some embodiments, the second value is based on the distance between the viewpoint of the user and the location of the first object at the time the movement of the respective portion of the user in the second input direction is initiated (e.g., upon detecting the hand of the user performing a pinch gesture of the thumb and index finger while the gaze of the user is directed to the first object). For example, in some embodiments, the second value increases as the distance between the first object and the viewpoint of the user increases and decreases as the distance between the first object and the user decreases. Further detail of the second value will be provided below. Providing for different multipliers for movement away from and toward the viewpoint of the user allows the device to utilize algorithms that are better suited for the direction of movement at issue to facilitate improved location control for objects in the three-dimensional environment (e.g., because the maximum movement towards the viewpoint of the user is known (e.g., limited by movement to the viewpoint of the user), while the maximum movement away from the viewpoint of the user may not be known), thereby reducing errors in usage and improving user-device interaction.

In some embodiments, the first value changes as the movement of the respective portion of the user in the first input direction (e.g., movement of hand 703b in FIG. 7A) progresses and/or the second value changes as the movement of the respective portion of the user in the second input direction progresses (814) (e.g., movement of hand 703a in FIG. 7A). In some embodiments, the first value is a function of the distance of the first object from the shoulder of the user (e.g., the first value increases as that distance increases) and the distance of the hand of the user from the shoulder of the user (e.g., the first value increases as that distance increases). Thus, in some embodiments, as the hand of the user moves in the first input direction (e.g., away from the user), the distance of the first object from the shoulder increases (e.g., in response to the movement of the hand of the user) and the distance of the hand of the user from the shoulder of the user increases (e.g., as a result of the movement of the hand of the user away from the body of the user); therefore, the first value increases. In some embodiments, the second value is additionally or alternatively a function of the distance between the first object at the time of the initial pinch performed by the hand of the user leading up to the movement of the hand of the user in the second input direction and the distance between the hand of the user and the shoulder of the user. Thus, in some embodiments, as the hand of the user moves in the second input direction (e.g., towards the body of the user), the distance of the hand of the user from the shoulder of the user decreases (e.g., as a result of the movement of the hand of the user towards the body of the user); therefore, the second value decreases. Providing for dynamic multipliers for movement away from and toward the viewpoint of the user provides precise location control in certain ranges of movement of the object while providing the ability to move the object large distances in other ranges of movement of the object, thereby reducing errors in usage and improving user-device interaction.

In some embodiments, the first value changes in a first manner as the movement of the respective portion of the user in the first input direction progresses (e.g., movement of hand 703b in FIG. 7A), and the second value changes in a second manner, different from the first manner, as the movement of the respective portion of the user in the second input direction progresses (e.g., movement of hand 703a in FIG. 7A) (816). For example, the first value changes differently (e.g., greater or smaller magnitude change and/or opposite direction of change (e.g., increase or decrease)) as a function of distances between the first object and the hand of user and/or between the hand of the user and the shoulder of the user than does the second value change as a function of the distance between the hand of the user and the shoulder of the user. Providing for differently varying multipliers for movement away from and toward the viewpoint of the user accounts for the differences in user input (e.g., hand movement(s)) needed to move an object away from the viewpoint of the user to a potentially unknown distance and user input (e.g., hand movement(s)) needed to move an object toward the viewpoint of the user to a maximum distance (e.g., limited by movement all the way to the viewpoint of the user), thereby reducing errors in usage and improving user-device interaction.

In some embodiments, the first value remains constant during a given portion of the movement of the respective portion of the user in the first input direction (e.g., movement of hand 703b in FIG. 7A), and the second value does not remain constant during a (e.g., any) given portion of the movement of the respective portion of the user in the second input direction (818) (e.g., movement of hand 703a in FIG. 7A). For example, the first value is optionally constant in a first range of distances between the first object and the hand of user and/or between the hand of the user and the shoulder of the user (e.g., at relatively low distances, such as distances below 5, 10, 20, 30, 40, 50, 60, 80, 100, or 120 cm), and optionally increases linearly as a function of distance for distances greater than the first range of distances. In some embodiments, after a threshold distance, greater than the first range of distances (e.g., after 30, 40, 50, 60, 80, 100, 120, 150, 200, 300, 400, 500, 750, or 1000 cm), the first value is locked to a constant value, greater than its value below the threshold distance. In contrast, the second value optionally varies continuously and/or exponentially and/or logarithmically as the distance between the hand of the user and the shoulder of the user changes (e.g., decreases as the distance between the hand of the user and the shoulder of the user decreases). Providing for differently varying multipliers for movement away from and toward the viewpoint of the user accounts for the differences in user input (e.g., hand movement(s)) needed to move an object away from the viewpoint of the user to a potentially unknown distance and user input (e.g., hand movement(s)) needed to move an object toward the viewpoint of the user to a maximum distance (e.g., limited by movement all the way to the viewpoint of the user), thereby reducing errors in usage and improving user-device interaction.

In some embodiments, the first multiplier and the second multiplier are based on a ratio of a distance (e.g., between a shoulder of the user and the respective portion of the user), to a length of an arm of the user (820). For example, the first value is optionally the result of multiplying two factors together. The first factor is optionally the distance between the first object and the shoulder of the user (e.g., optionally as a percentage or ratio of the total arm length corresponding to the hand providing the movement input), and the second factor is optionally the distance between the hand of the user and the shoulder of the user (e.g., optionally as a percentage or ratio of the total arm length corresponding to the hand providing the movement input). The second value is optionally the result of multiplying two factors together. The first factor is optionally the distance between the first object and the viewpoint of the user at the time of the initial pinch gesture performed by the hand of the user leading up to the movement input provided by the hand of the user (e.g., this first factor is optionally constant), and is optionally provided as a percentage or ratio of the total arm length corresponding to the hand providing the movement input, and the second factor is optionally the distance between the shoulder of the user and the hand of the user (e.g., optionally as a percentage or ratio of the total arm length corresponding to the hand providing the movement input). The second factor optionally includes determining the distance between the shoulder and the hand of the user at the initial pinch gesture performed by the hand of the user, and defining that movement of the hand of the user to half that initial distance will result in the first object moving all the way from its initial/current location to the location of the viewpoint of the user. Defining the movement multipliers as based on percentages or ratios of user arm length (e.g., rather than absolute distances) allows for predictable and consistent device response to inputs provided by users with different arm lengths, thereby reducing errors in usage and improving user-device interaction.

In some embodiments, as described herein, the electronic device utilizes different algorithms for controlling movement of the first object away from or towards the viewpoint of the user (e.g., corresponding to movement of the hand of the user away from or towards the body of the user, respectively). In some embodiments, the electronic device is continuously or periodically detecting the movement of the hand (e.g., while it remains in the pinch hand shape), averages a certain number of frames of hand movement detection (e.g., 2 frames, 3 frames, 5 frames, 10 frames, 20 frames, 40 frames or 70 frames), and determines whether the movement of the hand of the user corresponds to movement of the first object away from the viewpoint of the user during those averaged frames, or towards the viewpoint of the user during those averaged frames. As the electronic device makes these determinations, it switches between utilizing a first algorithm (e.g., an algorithm for moving the first object away from the viewpoint of the user) or a second algorithm (e.g., an algorithm for moving the first object towards the viewpoint of the user) that map movement of the hand of the user to movement of the first object in the three-dimensional environment. The electronic device optionally dynamically switches between the two algorithms based on the most-recent averaged result of detecting the movement of the hand of the user.

With respect to the first algorithm, two factors are optionally determined at the start of the movement input (e.g., upon pinchdown of the thumb and index finger of the user) and/or at the start of movement of the hand of the user away from the body of the user, and the two factors are optionally updated as their constituent parts change and/or are multiplied together with the magnitude of the movement of the hand to define the resulting magnitude of the movement of the object. The first factor is optionally an object-to-shoulder factor that corresponds to the distance between the object being moved and the shoulder of the user. The first factor optionally has a value of 1 for distances between the shoulder and the object from 0 cm to a first distance threshold (e.g., 5 cm, 10 cm, 20 cm, 30 cm, 40 cm, 50 cm, 60 cm or 100 cm), and optionally has a value that increases linearly as a function of distance up to a maximum factor value (e.g., 2, 3, 4, 5, 6, 7.5, 8, 9, 10, 15 or 20). The second factor is optionally a shoulder-to-hand factor that has a value of 1 for distances between the shoulder and the hand from 0 cm to a first distance threshold (e.g., 5 cm, 10 cm, 20 cm, 30 cm, 40 cm, 50 cm, 60 cm or 100 cm, optionally the same or different from the first distance threshold in the first factor), has a value that increases linearly at a first rate as a function of distance from the first distance threshold to a second distance threshold (e.g., 7.5 cm, 15 cm, 30 cm, 45 cm, 60 cm, 75 cm, 90 cm or 150 cm), and then has a value that increases linearly at a second rate, greater than the first rate, as a function of distance from the second distance threshold onward. In some embodiments, the first and second factors are multiplied together and with the magnitude of the movement of the hand to determine the movement of the object away from the viewpoint of the user in the three-dimensional environment. In some embodiments, the electronic device imposes a maximum magnitude for the movement of the object away from the user for a given movement of the hand of the user away from the user (e.g., 1, 3, 5, 10, 30, 50, 100 or 200 meters of movement), and thus applies a ceiling function with the maximum magnitude to the result of the above-described multiplication.

With respect to the second algorithm, a third factor is optionally determined at the start of the movement input (e.g., upon pinchdown of the thumb and index finger of the user) and/or at the start of movement of the hand of the user toward the body of the user. The third factor is optionally updated as its constituent parts change and/or is multiplied together with the magnitude of the movement of the hand to define the resulting magnitude of the movement of the object. The third factor is optionally a shoulder-to-hand factor. The initial distance between the shoulder and the hand of the user is optionally determined (“initial distance”) and recorded at the start of the movement input (e.g., upon pinchdown of the thumb and index finger of the user) and/or at the start of movement of the hand of the user toward the body of the user. The value of the third factor is defined by a function that maps movement of the hand that is half the “initial distance” to movement of the object all the way from its current position in the three-dimensional environment to the viewpoint of the user (or to a position that corresponds to the initial position of the hand of the user upon pinchdown of the index finger and thumb of the user, or a position offset from that position by a predetermined amount such as 0.1 cm, 0.5 cm, 1 cm, 3 cm, 5 cm, 10 cm, 20 cm or 50 cm). In some embodiments, the function has relatively high values for relatively high shoulder-to-hand distances, and relatively low values (e.g., 1 and above) for relatively low shoulder-to-hand distances. In some embodiments, the function is a curved line that is concave towards lower factor values.

In some embodiments, the above-described distances and/or distance thresholds in the first and/or second algorithms are optionally instead expressed as relative values (e.g., percentages of the arm length of the user) rather than as absolute distances.

In some embodiments, the (e.g., first value and/or the) second value is based on a position of the respective portion of the user (e.g., hand 703a or 703b in FIG. 7A) when the first object is selected for movement (822) (e.g., upon detecting the initial pinch gesture performed by the hand of the user, while the gaze of the user is directed to the first object, leading up to the movement of the hand of the user for moving the first object). For example, as described above, the one or more factors that define the second value are based on measurements performed by the electronic device corresponding to the distance between the first object and the viewpoint of the user at the time of the initial pinch gesture performed by the hand of the user and/or the distance between the shoulder of the user and the hand of the user at the time of the initial pinch gesture performed by the hand of the user. Defining one or more of the movement multipliers as based on arm position at the time of the selection of the first object for movement allows the device to facilitate the same amount of movement of the first object for a variety of (e.g., multiple, any) arm positions at which the movement input is initiated, rather than resulting in certain movements of the first object not being achievable depending on the initial arm position of the user at selection of the first object for movement, thereby reducing errors in usage and improving user-device interaction.

In some embodiments, while the first object is selected for movement in the three-dimensional environment, the electronic device detects (824a), via the one or more input devices, respective movement of the respective portion of the user in a direction that is horizontal relative to a viewpoint of the user in the three-dimensional environment, such as movement 707c of hand 703c in FIG. 7C. For example, movement of the hand of the user that is side-to-side relative to gravity. In some embodiments, the movement of the hand corresponds to noise in the movement of the user's hand (e.g., the hand of the user shaking or trembling). In some embodiments, the movement of the hand has a velocity and/or acceleration less than corresponding velocity and/or acceleration thresholds. In some embodiments, in response to detecting lateral hand movement that has a velocity and/or acceleration greater than the above described velocity and/or acceleration thresholds, the electronic device does not apply the below-described noise-reduction to such movement, and rather moves the first object in accordance with the lateral movement of the hand of the user without applying the noise-reduction.

In some embodiments, in response to detecting the respective movement of the respective portion of the user, the electronic device updates (824b) a location of the first object in the three-dimensional environment based on a noise-reduced respective movement of the respective portion of the user, such as described with reference to object 712a. In some embodiments, the electronic device moves the first object in the three-dimensional environment in accordance with a noise-reduced magnitude, frequency, velocity and/or acceleration of hand movement of the user (e.g., using a 1-euro filter), rather than in accordance with the non-noise-reduced magnitude, frequency, velocity and/or acceleration of the hand movement of the user. In some embodiments, the electronic device moves the first object with less magnitude, frequency, velocity and/or acceleration than it would otherwise move the first object if the noise-reduction were not applied. In some embodiments, the electronic device applies such noise reduction to lateral (and/or lateral components of) hand movement, but does not apply such noise reduction to vertical (and/or vertical components of) hand movement and/or hand movements (and/or components of hand movements) towards or away from the viewpoint of the user. Reducing the noise in hand movement for lateral hand movements reduces object movement noise, which can be more readily present in side-to-side and/or lateral movements of the hand of a user, thereby reducing errors in usage and improving user-device interaction.

In some embodiments, in accordance with a determination that a location corresponding to the first object is a first distance from the respective portion of the user when the respective movement of the respective portion of the user is detected, such as object 712a in FIG. 7C (e.g., the first object is the first distance from the hand of the user during the respective lateral movement of the hand), the respective movement of the respective portion of the user is adjusted based on a first amount of noise reduction to generate adjusted movement that is used to update the location of the first object in the three-dimensional environment (826a), such as described with reference object 712a in FIG. 7C, and in accordance with a determination that the location corresponding to the first object is a second distance, less than the first distance, from the respective portion of the user when the respective movement of the respective portion of the user is detected, such as object 716a in FIG. 7C (e.g., the first object is the second distance from the hand of the user during the respective lateral movement of the hand), the respective movement of the respective portion of the user is adjusted based on a second amount, less than the first amount, of noise reduction that is used to generate adjusted movement that is used to update the location of the first object in the three-dimensional environment (826b), such as described with reference to object 716a in FIG. 7C. Thus, in some embodiments, the electronic device applies more noise reduction to side to side and/or lateral movements of the hand of the user when the movement is directed to an object that is further away from the hand of the user than when the movement is directed to an object that is closer to the hand of the user. Applying different amounts of noise reduction depending on the distance of the object from the hand and/or viewpoint of the user allows for less filtered/more direct response while objects are at distances at which alterations to the movement inputs can be more easily perceived, and more filtered/less direct response while objects are at distances at which alterations to the movement inputs can be less easily perceived, thereby reducing errors in usage and improving user-device interaction.

In some embodiments, while the first object is selected for movement and during the first input, the electronic device controls (828) orientations of the first object in the three-dimensional environment in a plurality of directions (e.g., one or more of pitch, yaw or roll) in accordance with a corresponding plurality of orientation control portions of the first input, such as with respect to object 716a in FIGS. 7C-7D. For example, while the hand of the user is providing movement input to the first object, input from the hand of the user for changing the orientation(s) of the first object causes the first object to change orientation(s) accordingly. For example, an input from the hand while the hand is directly manipulating the first object (e.g., the hand is closer than a threshold distance (e.g., 0.2, 0.5, 1, 2, 3, 5, 10, 12, 24, or 26 cm) to the first object during the first input) to rotate the first object, tilt the object, etc. causes the electronic device to rotate, tilt, etc. the first object in accordance with such input. In some embodiments, such inputs include rotation of the hand, tilting of the hand, etc. while the hand is providing the movement input to the first object. Thus, in some embodiments, during the movement input, the first object tilts, rotates, etc. freely in accordance with movement input provided by the hand. Changing the orientation of the first object in accordance with orientation-change inputs provided by the hand of the user during movement input allows for the first object to more fully respond to inputs provided by a user, thereby reducing errors in usage and improving user-device interaction.

In some embodiments, while controlling the orientations of the first object in the plurality of directions (e.g., while the electronic device allows input from the hand of the user to control the pitch, yaw and/or roll of the first object), the electronic device detects (830a) that the first object is within a threshold distance (e.g., 0.1, 0.5, 1, 3, 5, 10, 20, 40, or 50 cm) of a surface in the three-dimensional environment, such as object 712a with respect to object 718a or object 714a with respect to representation 724a in FIG. 7E. For example, the movement input provided by the hand of the user moves the first object to within the threshold distance of a virtual or physical surface in the three-dimensional environment. For example, a virtual surface is optionally a surface of a virtual object that is in the three-dimensional environment (e.g., the top of a virtual table, the table not existing in the physical environment of the display generation component and/or electronic device). A physical surface is optionally a surface of a physical object that is in the physical environment of the electronic device, and of which a representation is displayed in the three-dimensional environment by the electronic device (e.g., via digital passthrough or physical passthrough, such as through a transparent portion of the display generation component), such as the top of a physical table that is in the physical environment.

In some embodiments, in response to detecting that the first object is within the threshold distance of the surface in the three-dimensional environment, the electronic device updates (830b) one or more orientations of the first object in the three-dimensional environment to be based on an orientation of the surface, such as described with reference to objects 712a and 714a in FIG. 7E (e.g., and not based on the plurality of orientation control portions of the first input). In some embodiments, the orientation of the first object changes to an orientation defined by the surface. For example, if the surface is a wall (e.g., physical or virtual), the orientation of the first object is optionally updated to be parallel to the wall, even if no hand input is provided to change the orientation of the first object (e.g., to be parallel to the wall). If the surface is a table top (e.g., physical or virtual), the orientation of the first object is optionally updated to be parallel to the table top, even if no hand input is provided to change the orientation of the first object (e.g., to be parallel to the table top). Updating the orientation of the first object to be based on the orientation of a nearby surface provides a quick way to position the first object relative to the surface in complementary way, thereby reducing errors in usage and improving user-device interaction.

In some embodiments, while controlling the orientations of the first object in the plurality of directions (e.g., while the electronic device allows input from the hand of the user to control the pitch, yaw and/or roll of the first object), the electronic device detects (832a) that the first object is no longer selected for movement, such as with respect to object 716a in FIG. 7E (e.g., detecting that the hand of the user is no longer in the pinch hand pose in which the index finger tip is touching the tip of the thumb and/or that the hand of the user has performed the gesture of the index finger tip moving away from the tip of the thumb). In some embodiments, in response to detecting that the first object is no longer selected for movement, the electronic device updates (832b) one or more orientations of the first object in the three-dimensional environment to be based on a default orientation of the first object in the three-dimensional environment, such as described with reference to object 716a in FIG. 7E. For example, in some embodiments, the default orientation for an object is defined by the three-dimensional environment, such that absent user input to change the orientation of the object, the object has the default orientation in the three-dimensional environment. For example, the default orientation for three-dimensional objects in the three-dimensional environment is optionally that the bottom surface of such an object should be parallel to the floor of the three-dimensional environment. During the movement input, the hand of the user is optionally able to provide orientation-change inputs that cause the bottom surface of the object to not be parallel to the floor. However, upon detecting an end of the movement input, the electronic device optionally updates the orientation of the object such that the bottom surface of the object is parallel to the floor, even if no hand input is provided to change the orientation of the object. Two-dimensional objects in the three-dimensional environment optionally have a different default orientation. In some embodiments, the default orientation for a two-dimensional object is one in which the normal to the surface of the object is parallel with the orientation of the viewpoint of the user in the three-dimensional environment. During the movement input, the hand of the user is optionally able to provide orientation-change inputs that cause the normal of the surface of the object to not be parallel to the orientation of the viewpoint of the user. However, upon detecting an end of the movement input, the electronic device optionally updates the orientation of the object such that the normal to the surface of the object is parallel to the orientation of the viewpoint of the user, even if no hand input is provided to change the orientation of the object. Updating the orientation of the first object to a default orientation ensures that objects do not, over time, end up in unusable orientations, thereby reducing errors in usage and improving user-device interaction.

In some embodiments, the first input occurs while the respective portion of the user (e.g., hand 703e in FIG. 7C) is within a threshold distance (e.g., 0.2, 0.5, 1, 2, 3, 5, 10, 12, 24, or 26 cm) of a location corresponding to the first object (834a) (e.g., the first input during which the electronic device allows input from the hand of the user to control the pitch, yaw and/or roll of the first object is a direct manipulation input from the hand directed to the first object). In some embodiments, while the first object is selected for movement and during a second input corresponding to movement of the first object in the three-dimensional environment, wherein during the second input the respective portion of the user is further than the threshold distance from the location corresponding to the first object (834b) (e.g., the second input is an indirect manipulation input from the hand directed to the first object), in accordance with a determination that the first object is a two-dimensional object (e.g., the first object is an application window/user interface, a representation of a picture, etc.), the electronic device moves (834c) the first object in the three-dimensional environment in accordance with the second input while an orientation of the first object with respect to a viewpoint of the user in the three-dimensional environment remains constant, such as described with reference to object 712a in FIGS. 7C-7D (e.g., for two-dimensional objects, an indirect movement input optionally causes the position of the two-dimensional object to change in the three-dimensional environment in accordance with the input, but the orientation of the two-dimensional object is controlled by the electronic device such that the normal of the surface of the two-dimensional object remains parallel to the orientation of the viewpoint of the user).

In some embodiments, in accordance with a determination that the first object is a three-dimensional object, the electronic device moves (834d) the first object in the three-dimensional environment in accordance with the second input while an orientation of the first object with respect to a surface in the three-dimensional environment remains constant, such as described with reference to object 714a in FIGS. 7C-7D (e.g., for three-dimensional objects, an indirect movement input optionally causes the position of the three-dimensional object to change in the three-dimensional environment in accordance with the input, but the orientation of the three-dimensional object is controlled by the electronic device such that the normal of the bottom surface of the three-dimensional object remains perpendicular to the floor in the three-dimensional environment). Controlling orientation of objects during movement inputs ensures that objects do not, over time, end up in unusable orientations, thereby reducing errors in usage and improving user-device interaction.

In some embodiments, while the first object is selected for movement and during the first input (836a), the electronic device moves (836b) the first object in the three-dimensional environment in accordance with the first input while maintaining an orientation of the first object relative to a viewpoint of the user in the three-dimensional environment, such as described with reference to object 712a in FIGS. 7C-7D. For example, during an indirect movement manipulation of a two-dimensional object, maintain the normal of the surface of the object to be parallel to the orientation of the viewpoint of the user as the object is moved to different positions in the three-dimensional environment.

In some embodiments, after moving the first object while maintaining the orientation of the first object relative to the viewpoint of the user, the electronic device detects (836c) that the first object is within a threshold distance (e.g., 0.1, 0.5, 1, 3, 5, 10, 20, 40, or 50 cm) of a second object in the three-dimensional environment, such as object 712a with respect to object 718a in FIG. 7E. For example, the first object is moved to within the threshold distance of a physical or virtual surface in the three-dimensional environment, as previously described, such as an application window/user interface, a surface of a wall, table, floor, etc.

In some embodiments, in response to detecting that the first object is within the threshold distance of the second object, the electronic device updates (836d) an orientation of the first object in the three-dimensional environment based on an orientation of the second object independent of the orientation of the first object relative to the viewpoint of the user, such as described with reference to object 712a in FIG. 7E. For example, when the first object is moved to within the threshold distance of the second object, the orientation of the first object is no longer based on the viewpoint of the user, but rather is updated to be defined by the second object. For example, the orientation of the first object is updated to be parallel to the surface of the second object, even if no hand input is provided to change the orientation of the first object. Updating the orientation of the first object to be based on the orientation of a nearby object provides a quick way to position the first object relative to the object in complementary way, thereby reducing errors in usage and improving user-device interaction.

In some embodiments, before the first object is selected for movement in the three-dimensional environment, the first object has a first size (e.g., a size in the three-dimensional environment) in the three-dimensional environment (838a). In some embodiments, in response to detecting selection of the first object for movement in the three-dimensional environment (e.g., in response to detecting the hand of the user performing a pinch hand gesture while the gaze of the user is directed to the first object), the electronic device scales (838b) the first object to have a second size, different from the first size, in the three-dimensional environment, wherein the second size is based on a distance between a location corresponding to the first object and a viewpoint of the user in the three-dimensional environment when the selection of the first object for movement is detected, such as with respect to objects 706a and/or 708a. For example, objects optionally have defined sizes that are optimal or ideal for their current distance from the viewpoint of the user (e.g., to ensure objects remain interactable by the user at their current distance from the user). In some embodiments, upon detecting the initial selection of an object for movement, the electronic device changes the size of the object to be such an optimal or ideal size for the object based on the current distance between the object and the viewpoint of the user, even without receiving an input from the hand to change the size of the first object. Additional details of such rescaling of objects and/or distance-based sizes are described with reference to method 1000. Updating the size of the first object to be based on the distance of the object from the viewpoint of the user provides a quick way to ensure that the object is interactable by the user, thereby reducing errors in usage and improving user-device interaction.

In some embodiments, the first object is selected for movement in the three-dimensional environment in response to detecting a second input that includes, while a gaze of the user is directed to the first object, the respective portion of the user (e.g., hand 703a or 703b) performing a first gesture followed by maintaining a first shape for a threshold time period (840) (e.g., 0.2, 0.4, 0.5, 1, 2, 3, 5 or 10 seconds). For example, if the first object is currently located in unoccupied space in the three-dimensional environment (e.g., not included in a container or application window window) the selection of the first object for movement is optionally in response to a pinch hand gesture performed by the hand of the user while the gaze of the user is directed to the first object, followed by the hand of the user maintaining the pinch hand shape for the threshold time period. After the second input, movement of the hand while maintaining the pinch hand shape optionally causes the first object to move in the three-dimensional environment in accordance with the movement of the hand. Selecting the first object for movement in response to a gaze+long pinch gesture provides a quick way to select the first object for movement while avoiding unintentional selection of objects for movement, thereby reducing errors in usage and improving user-device interaction.

In some embodiments, the first object is selected for movement in the three-dimensional environment in response to detecting a second input that includes, while a gaze of the user is directed to the first object, movement greater than a movement threshold (e.g., 0.1, 0.3, 0.5, 1, 2, 3, 5, 10, or 20 cm) of a respective portion of the user (e.g., a hand of the user providing the movement input, such as hand 703a) towards a viewpoint of the user in the three-dimensional environment (842). For example, if the first object is included within another object (e.g., an application window), the selection of the first object for movement is optionally in response to a pinch hand gesture performed by the hand of the user while the gaze of the user is directed to the first object, followed by the hand of the user moving towards the user corresponding to movement of the first object towards the viewpoint of the user. In some embodiments, the movement of the hand towards the user needs to correspond to movement more than the movement threshold—otherwise, the first object optionally does not get selected for movement. After the second input, movement of the hand while maintaining the pinch hand shape optionally causes the first object to move in the three-dimensional environment in accordance with the movement of the hand. Selecting the first object for movement in response to a gaze+pinch+pluck gesture provides a quick way to select the first object for movement while avoiding unintentional selection of objects for movement, thereby reducing errors in usage and improving user-device interaction.

In some embodiments, while the first object is selected for movement and during the first input (844a), the electronic device detects (844b) that the first object is within a threshold distance of a second object in the three-dimensional environment (e.g., 0.1, 0.5, 1, 3, 5, 10, 20, 40, or 50 cm). For example, the first object is moved to within the threshold distance of a physical or virtual surface in the three-dimensional environment, as previously described, such as an application window/user interface, a surface of a wall, table, floor, etc. In some embodiments, in response to detecting that the first object is within the threshold distance of the second object (844c), in accordance with a determination that the second object is a valid drop target for the first object (e.g., the second object can contain or accept the first object, such as the second object being a messaging user interface of a messaging application, and the first object being a representation of something that can be sent via the messaging application to another user such as a representation of a photo, a representation of a video, a representation of textual content, etc.), the electronic device displays (844d), via the display generation component, a first visual indication indicating that the second object is a valid drop target for the first object, such as described with reference to object 712a in FIG. 7E (e.g., and not displaying the second visual indication described below). For example, displaying a badge (e.g., a circle that includes a + symbol) overlaid on the upper-right corner of the first object that indicates that the second object is a valid drop target, and that releasing the first object at its current location will cause the first object to be added to the second object.

In some embodiments, in accordance with a determination that the second object is not a valid drop target for the first object (e.g., the second object cannot contain or accept the first object, such as the second object being a messaging user interface of a messaging application, and the first object being a user interface of another application or being a three-dimensional object), the electronic device displays (844e), via the display generation component, a second visual indication indicating that the second object is not a valid drop target for the first object, such as displaying this indication instead of indication 720 in FIG. 7E (e.g., and not displaying the first visual indication described above). For example, displaying a badge (e.g., a circle that includes an X symbol) overlaid on the upper-right corner of the first object that indicates that the second object is not a valid drop target, and that releasing the first object at its current location will not cause the first object to be added to the second object. Indicating whether the second object is a valid drop target for the first object quickly conveys the result of dropping the first object at its current position, thereby reducing errors in usage and improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein.

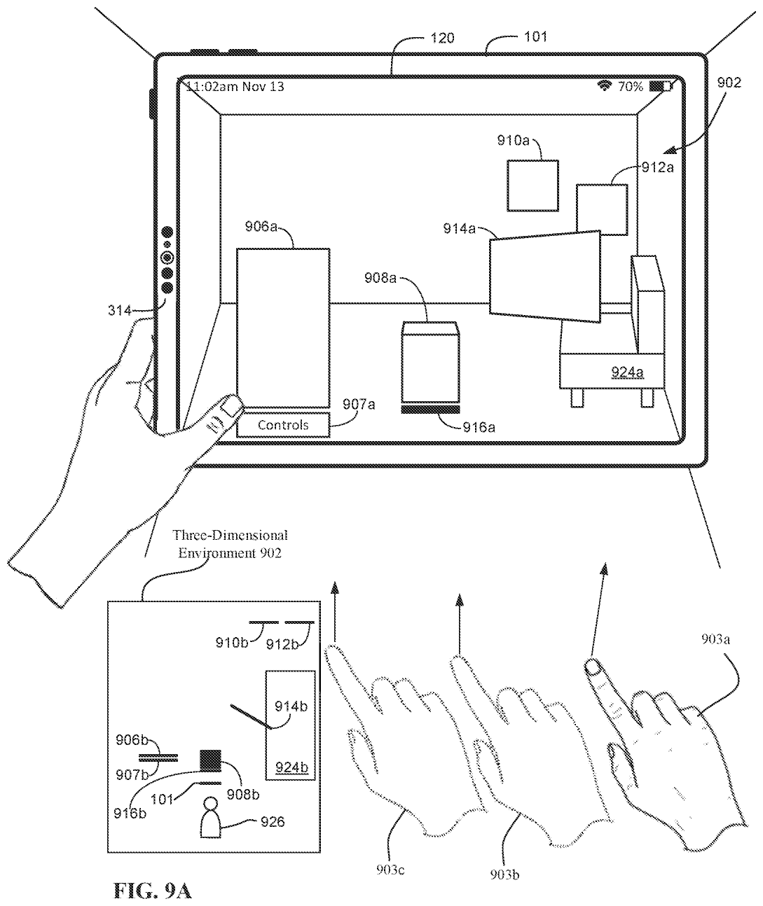

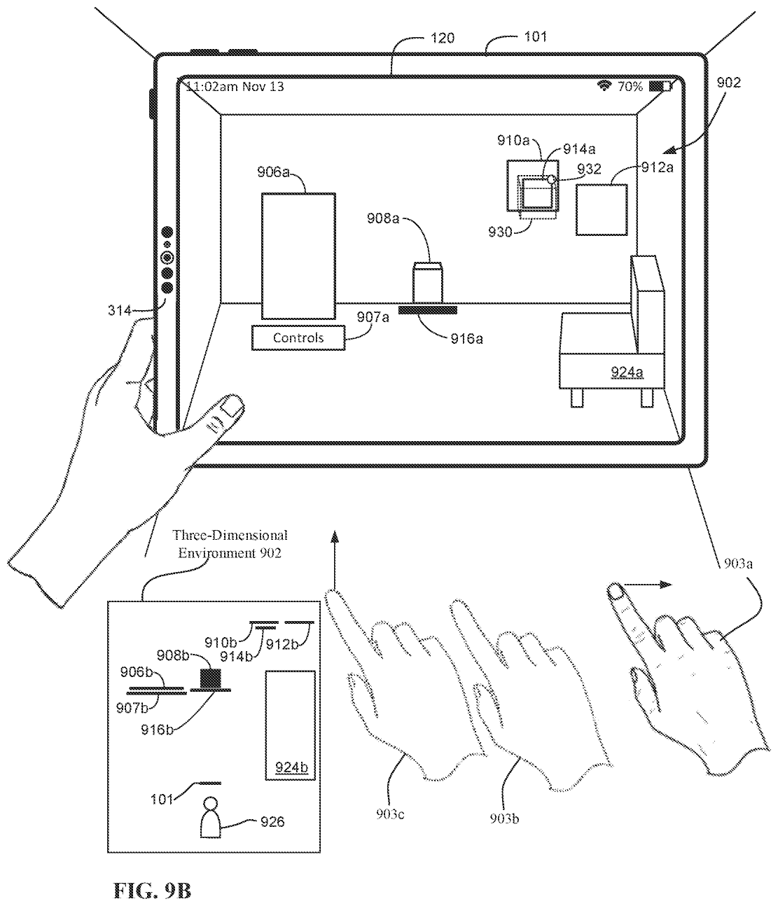

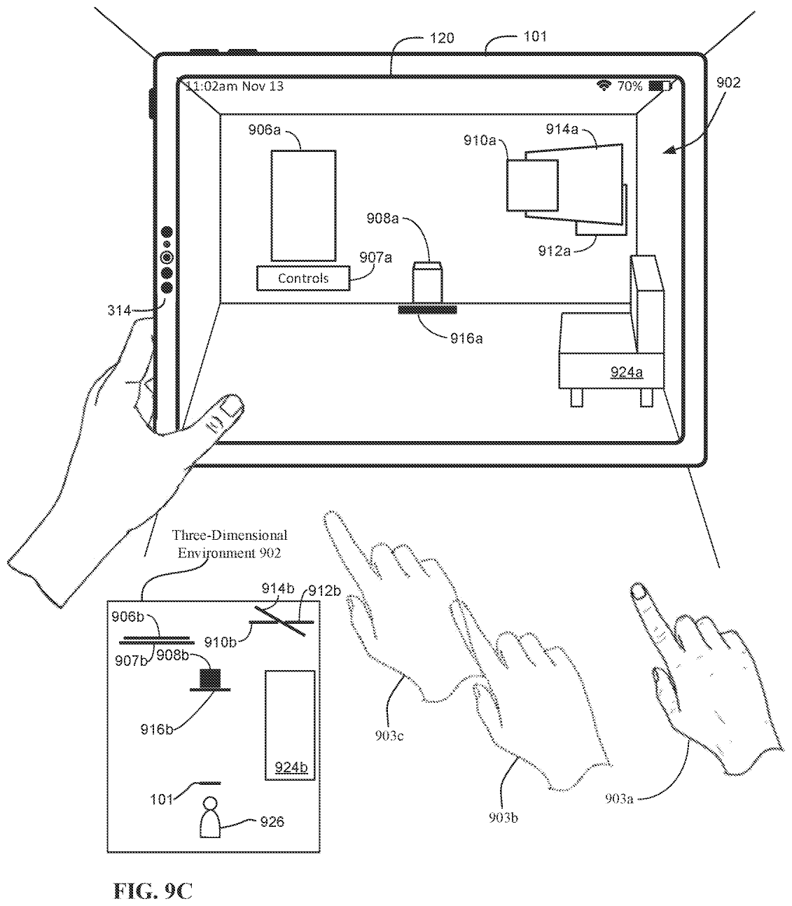

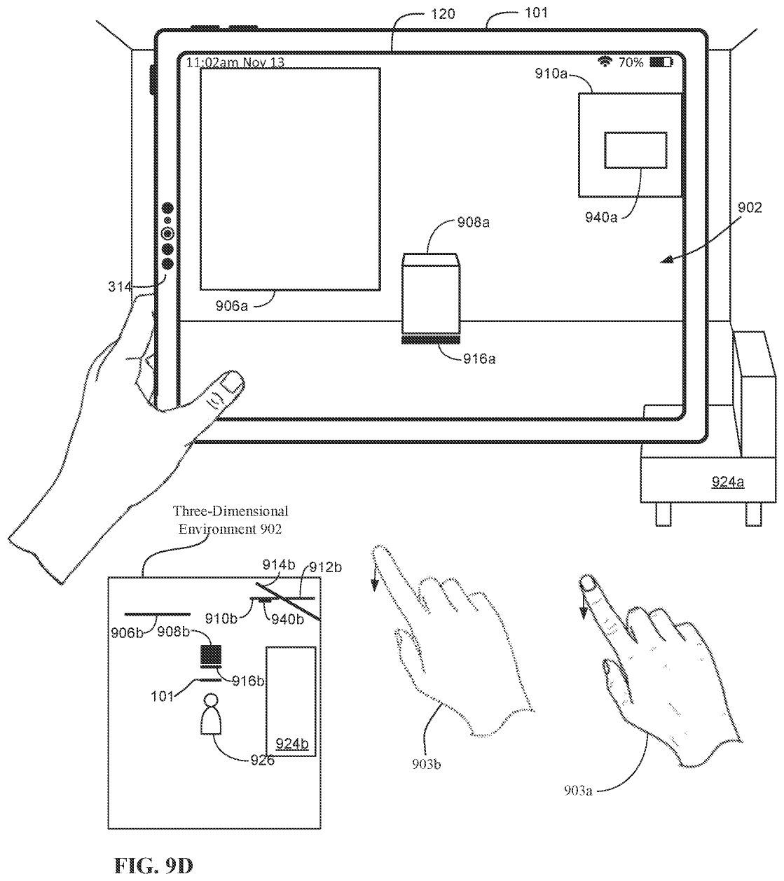

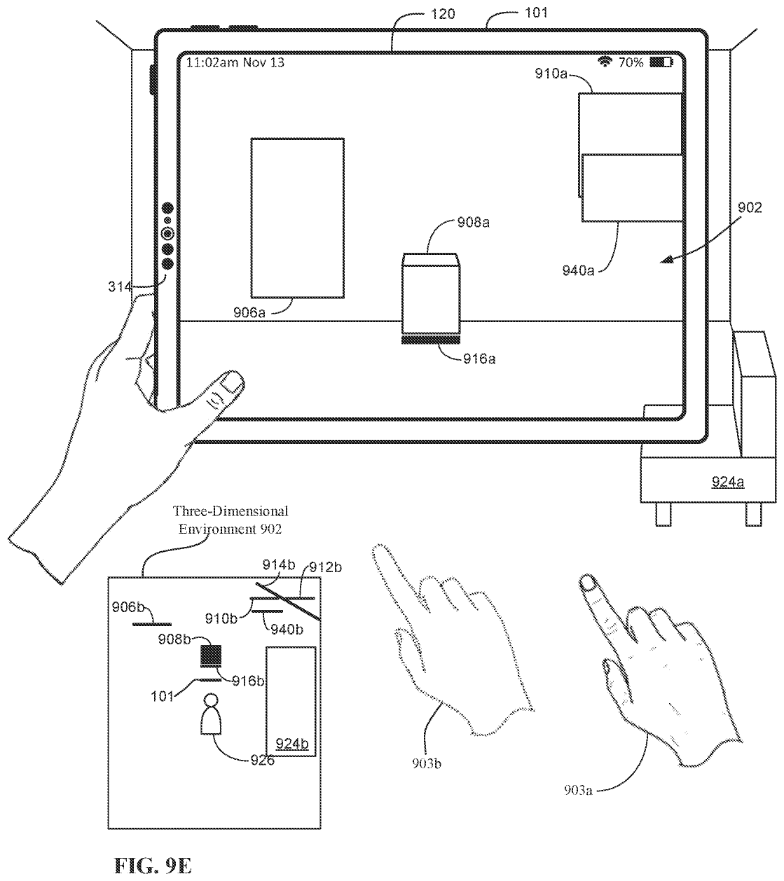

FIGS. 9A-9E illustrate examples of an electronic device dynamically resizing (or not) virtual objects in a three-dimensional environment in accordance with some embodiments.

FIG. 9A illustrates an electronic device 101 displaying, via a display generation component (e.g., display generation component 120 of FIG. 1), a three-dimensional environment 902 from a viewpoint of the user 926 illustrated in the overhead view (e.g., facing the back wall of the physical environment in which device 101 is located). As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user).

As shown in FIG. 9A, device 101 captures one or more images of the physical environment around device 101 (e.g., operating environment 100), including one or more objects in the physical environment around device 101. In some embodiments, device 101 displays representations of the physical environment in three-dimensional environment 902. For example, three-dimensional environment 902 includes a representation 924a of a sofa (corresponding to sofa 924b in the overhead view), which is optionally a representation of a physical sofa in the physical environment.

In FIG. 9A, three-dimensional environment 902 also includes virtual objects 906a (corresponding to object 906b in the overhead view), 908a (corresponding to object 908b in the overhead view), 910a (corresponding to object 910b in the overhead view), 912a (corresponding to object 912b in the overhead view), and 914a (corresponding to object 914b in the overhead view). In FIG. 9A, objects 906a, 910a, 912a and 914a are two-dimensional objects, and object 908a is a three-dimensional object (e.g., a cube). Virtual objects 906a, 908a, 910a, 912a and 914a are optionally one or more of user interfaces of applications (e.g., messaging user interfaces, content browsing user interfaces, etc.), three-dimensional objects (e.g., virtual clocks, virtual balls, virtual cars, etc.) or any other element displayed by device 101 that is not included in the physical environment of device 101. In some embodiments, object 906a is a user interface for playing back content (e.g., a video player), and is displayed with controls user interface 907a (corresponding to object 907b in the overhead view). Controls user interface 907a optionally includes one or more selectable options for controlling the playback of the content being presented in object 906a. In some embodiments, controls user interface 907a is displayed underneath object 906a and/or slightly in front of (e.g., closer to the viewpoint of the user than) object 906a. In some embodiments, object 908a is displayed with grabber bar 916a (corresponding to object 916b in the overhead view). Grabber bar 916a is optionally an element to which user-provided input is directed to control the location of object 908a in three-dimensional environment 902. In some embodiments, input is directed to object 908a (and not directed to grabber bar 916a) to control the location of object 908a in three-dimensional environment. Thus, in some embodiments, the existence of grabber bar 916a indicates that object 908a is able to be independently positioned in three-dimensional environment 902, as described in more detail with reference to method 1600. In some embodiments, grabber bar 916a is displayed underneath and/or slightly in front of (e.g., closer to the viewpoint of the user than) object 908a.

In some embodiments, device 101 dynamically scales the sizes of objects in three-dimensional environment 902 as the distances of those objects from the viewpoint of the user change. Whether and/or how much device 101 scales the sizes of the objects is optionally based on the type of object (e.g., two-dimensional or three-dimensional) that is being moved in three-dimensional environment 902. For example, in FIG. 9A, hand 903c is providing a movement input to object 906a to move object 906a further from the viewpoint of user 926 in three-dimensional environment 902, hand 903b is providing a movement input to object 908a (e.g., directed to grabber bar 916a) to move object 908a further from the viewpoint of user 926 in three-dimensional environment 902, and hand 903a is providing a movement input to object 914a to move object 914a further from the viewpoint of user 926 in three-dimensional environment 902. In some embodiments, such movement inputs include the hand of the user moving towards or away from the body of the user 926 while the hand is in a pinch hand shape (e.g., while the thumb and tip of the index finger of the hand are touching). For example, from FIGS. 9A-9B, device 101 optionally detects hands 903a, 903b and/or 903c move away from the body of the user 926 while in the pinch hand shape. It should be understood that while multiple hands and corresponding inputs are illustrated in FIGS. 9A-9E, such hands and inputs need not be detected by device 101 concurrently; rather, in some embodiments, device 101 independently responds to the hands and/or inputs illustrated and described in response to detecting such hands and/or inputs independently.

In response to the inputs detected in FIG. 9A, device 101 moves objects 906a, 908a and 914a away from the viewpoint of user 926, as shown in FIG. 9B. For example, device 101 has moved object 906a further away from the viewpoint of user 926. In some embodiments, in order to maintain interactability with an object as it is moved further from the viewpoint of the user (e.g., by avoiding the display size of the object from becoming unreasonably small), device 101 increases the size of the object in three-dimensional environment 902 (e.g., and similarly decreases the size of the object in three-dimensional environment 902 as the object is moved closer to the viewpoint of the user). However, to avoid user confusion and/or disorientation, device 101 optionally increases the size of the object by an amount that ensures that the object is displayed at successively smaller sizes as it is moved further from the viewpoint of the user, though the decrease in display size of the object is optionally less than it would be if device 101 did not increase the size of the object in three-dimensional environment 902. Further, in some embodiments, device 101 applies such dynamic scaling to two-dimensional objects but not to three-dimensional objects.

Thus, for example in FIG. 9B, as object 906a has been moved further from the viewpoint of user 926, device 101 has increased the size of object 906a in three-dimensional environment 902 (e.g., as indicated by the increased size of object 906b in the overhead view as compared with the size of object 906b in FIG. 9A), but has increased the size of object 906a in a sufficiently small manner to ensure that the area of the field of view of three-dimensional environment 902 consumed by object 906a has decreased from FIG. 9A to FIG. 9B. In this way, interactability with object 906a is optionally maintained as it is moved further from the viewpoint of user 926 while avoiding user confusion and/or disorientation that would optionally result from the display size of object 906a not getting smaller as object 906a is moved further from the viewpoint of user 926.

In some embodiments, controls such as system controls displayed with object 906a are not scaled or are scaled differently than object 906a by device 101. For example, in FIG. 9B, controls user interface 907a moves along with object 906a, away from the viewpoint of user 926 in response to the movement input directed to object 906a. However, in FIG. 9B, device 101 has increased the size of controls user interface 907a in three-dimensional environment 902 (e.g., as reflected in the overhead view) sufficiently such that the display size of (e.g., the portion of the field of view consumed by) controls user interface 907a remains constant as object 906a and controls user interface 907a are moved further from the viewpoint of user 926. For example, in FIG. 9A, controls user interface 907a had a width approximately the same as the width of object 906a, but in FIG. 9B, device 101 has sufficiently increased the size of controls user interface 907a such that the width of controls user interface 907a is larger than the width of object 906a. Thus, in some embodiments, device 101 increases the size of controls user interface 907a more than it increases the size of object 906a as object 906a and controls user interface 907a are moved further from the viewpoint of user 926—and device 101 optionally analogously decreases the size of controls user interface 907a more than it decreases the size of object 906a as object 906a and controls user interface 907a are moved closer to the viewpoint of user 926. Device 101 optionally similarly scales grabber bar 916a associated with object 908a, as shown in FIG. 9B.

However, in some embodiments, device 101 does not scale three-dimensional objects in three-dimensional environment 902 as they are moved further from or closer to the viewpoint of user 926. Device 101 optionally does this so that three-dimensional objects mimic the appearance and/or behavior of physical objects as they are moved closer to or further away from a user in a physical environment. For example, as reflected in the overhead view of three-dimensional environment 902, object 908b remains the same size in FIG. 9B as it was in FIG. 9A. As a result, the display size of object 908b has been reduced more than the display size of object 906a from FIGS. 9A to 9B. Thus, for the same amount of movement of objects 906a and 908a away from the viewpoint of user 926, the portion of the field of view of user 926 consumed by object 906a is optionally reduced less than the portion of the field of view of user 926 consumed by object 908a from FIGS. 9A to 9B.

In FIG. 9B, object 910a is associated with a drop zone 930 for adding objects to object 910a. Drop zone 930 is optionally a volume (e.g., cube or prism) of space in three-dimensional environment 902 adjacent to and/or in front of object 910a. The boundaries or volume of drop zone 930 are optionally not displayed in three-dimensional environment 902; in some embodiments, the boundaries or volume of drop zone 930 are displayed in three-dimensional environment 902 (e.g., via outlines, highlighting of volume, shading of volume, etc.). When an object is moved to within drop zone 930, device 101 optionally scales that object based on the drop zone 930 and/or the object associated with the drop zone 930. For example, in FIG. 9B, object 914a has moved to within drop zone 930. As a result, device 101 has scaled down object 914a to fit within drop zone 930 and/or object 910a. The amount by which device 101 has scaled object 914a is optionally different (e.g., different in magnitude and/or different in direction) than the scaling of object 914a performed by device 101 as a function of the distance of object 914a from the viewpoint of user 926 (e.g., as described with reference to object 906a). Thus, in some embodiments, the scaling of object 914a is optionally based on the size of object 910a and/or drop zone 930, and is optionally not based on the distance of object 914a from the viewpoint of user 926. Further, in some embodiments, device 101 displays a badge or indication 932 overlaid on the upper-right portion of object 914a indicating whether object 910a is a valid drop target for object 914a. For example, if object 910a is a picture frame container and object 914a is a representation of a picture, object 910a is optionally a valid drop target for object 914a—and indication 932 optionally indicates as much—whereas if object 914a is an application icon, object 910a is optionally an invalid drop target for object 914a—and indication 932 optionally indicates as much. Additionally, in FIG. 9B, device 101 has adjusted the orientation of object 914a to be aligned with object 910a (e.g., parallel to object 910a) in response to object 914a moving into drop zone 930. If object 914a had not been moved into drop zone 930, object 914a would optionally have a different orientation (e.g., corresponding to the orientation of object 914a in FIG. 9A), as will be discussed with reference to FIG. 9C.

In some embodiments, if object 914a is removed from drop zone 930, device 101 automatically scales object 914a to a size that is based on the distance of object 914a from the viewpoint of user 926 (e.g., as described with reference to object 906a) and/or reverts the orientation of object 914a to the orientation it would have had if not for becoming aligned with object 910a, such as shown in FIG. 9C. In some embodiments, device 101 displays object 914a with this same size and/or orientation if object 910a is an invalid drop target for object 914a, even if object 914a had been moved to within drop zone 930 and/or proximate to object 910a. For example, in FIG. 9C, object 914a has been removed from drop zone 930 (e.g., in response to movement input from hand 903a in FIG. 9B) and/or object 910a is not a valid drop target for object 914a. As a result, device 101 displays object 914a at a size in three-dimensional environment 902 that is based on the distance of object 914a from the viewpoint of user 926 (e.g., and not based on object 910a), which is optionally larger than the size of object 914a in FIG. 9B. Further, device 101 additionally or alternatively displays object 914a at an orientation that is optionally based on orientation input from hand 903a and is optionally not based on the orientation of object 910a, which is optionally a different orientation than the orientation of object 914a in FIG. 9B.

From FIGS. 9B to 9C, hand 903c has also provided further movement input directed to object 906a to cause device 101 to further move object 906a further from the viewpoint of user 926. Device 101 has further increased the size of object 906a as a result (e.g., as shown in the overhead view of three-dimensional environment 902), while not exceeding the limit of such scaling as it relates to the display size of object 906a, as previously described. Device 101 also optionally further scales controls user interface 907a (e.g., as shown in the overhead view of three-dimensional environment 902) to maintain the display size of controls user interface 907a, as previously described.

In some embodiments, whereas device 101 scales some objects as a function of the distance of those objects from the viewpoint of user 926 when those changes in distance result from input (e.g., from user 926) for moving those objects in three-dimensional environment 902, device 101 does not scale those objects as a function of the distance of those objects from the viewpoint of user 926 when those changes in distance result from movement of the viewpoint of user 926 in three-dimensional environment 902 (e.g., as opposed to movement of the objects in three-dimensional environment 902). For example, in FIG. 9D, the viewpoint of user 926 has moved towards objects 906a, 908a and 910a in three-dimensional environment 902 (e.g., corresponding to movement of the user in the physical environment towards the back wall of the room). In response, device 101 updates display of three-dimensional environment 902 to be from the updated viewpoint of user 926, as shown in FIG. 9D.

As shown in the overhead view of three-dimensional environment 902, device 101 has not scaled objects 906a, 908a or 910a in three-dimensional environment 902 as a result of the movement of the viewpoint of user 926 in FIG. 9D. The display sizes of object 906a, 908a and 908c have increased due to the decrease in the distances between the viewpoint of user 926 and objects 906a, 908a and 910a.

However, whereas device 101 has not scaled object 908a in FIG. 9D, device 101 has scaled grabber bar 916a (e.g., decreased its size, as reflected in the overhead view of three-dimensional environment 902) based on the decreased distance between grabber bar 916a and the viewpoint of user 926 (e.g., to maintain the display size of grabber bar 916a). Thus, in some embodiments, in response to movement of the viewpoint of user 926, device 101 does not scale non-system objects (e.g., application user interfaces, representations of content such as pictures or movies, etc.), but does scale system objects (e.g., grabber bar 916a, controls user interface 907a, etc.) as a function of the distance between the viewpoint of user 926 and those system objects.

In some embodiments, in response to device 101 detecting a movement input directed to an object that currently has a size that is not based on the distance between the object and the viewpoint of user 926, device 101 scales that object to have a size that is based on the distance between the object and the viewpoint of user 926. For example, in FIG. 9D, device 101 detects hand 903b providing a movement input directed to object 906a. In response, in FIG. 9E, device 101 has scaled down object 906a (e.g., as reflected in the overhead view of three-dimensional environment 902) to a size that is based on the current distance between the viewpoint of user 926 and object 906a.

Similarly, in response to device 101 detecting removal of an object from a container object (e.g., a drop target) where the size of the object is based on the container object and not based on the distance between the object and the viewpoint of user 926, device 101 scales that object to have a size that is based on the distance between the object and the viewpoint of user 926. For example, in FIG. 9D, object 940a is included in object 910a, and has a size that is based on object 910a (e.g., as previously described with reference to object 914a and object 910a). In FIG. 9D, device 101 detects a movement input from hand 903a directed to object 940a (e.g., towards the viewpoint of user 926) for removing object 940a from object 910a. In response, as shown in FIG. 9E, device 101 has scaled up object 940a (e.g., as reflected in the overhead view of three-dimensional environment 902) to a size that is based on the current distance between the viewpoint of user 926 and object 940a.

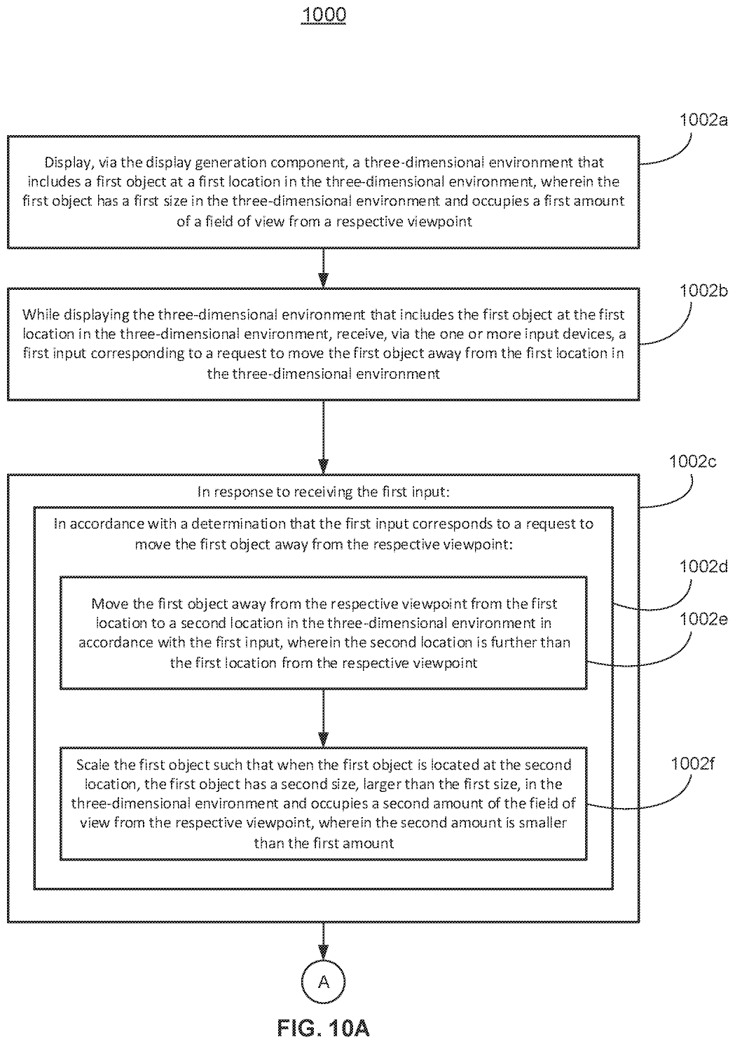

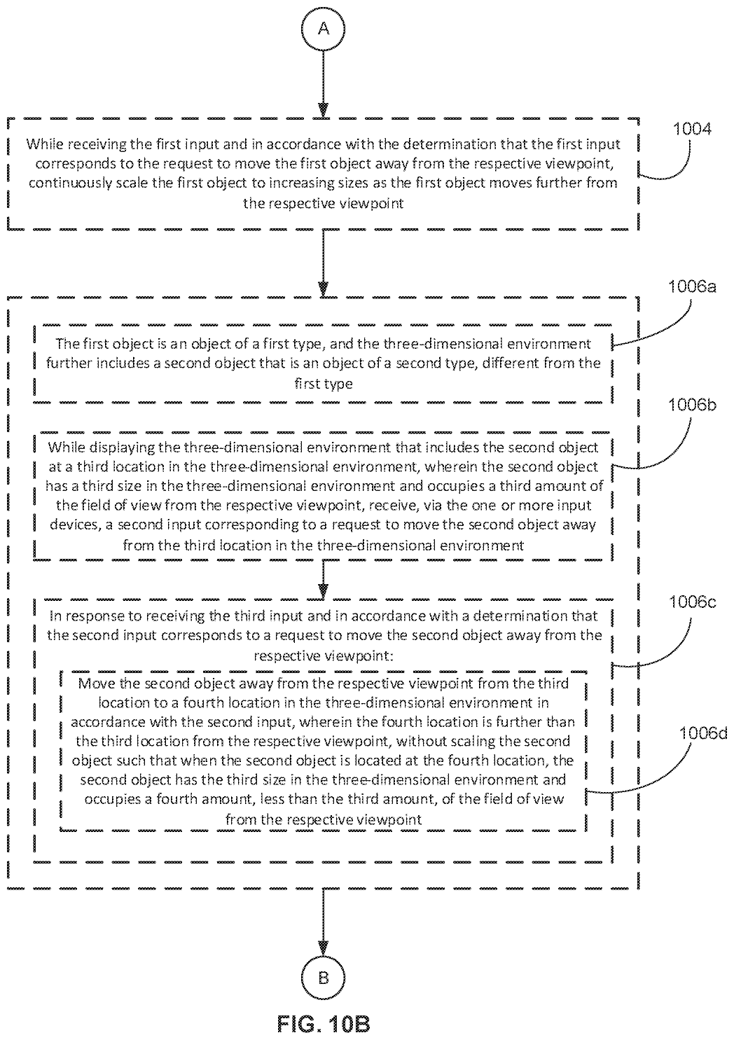

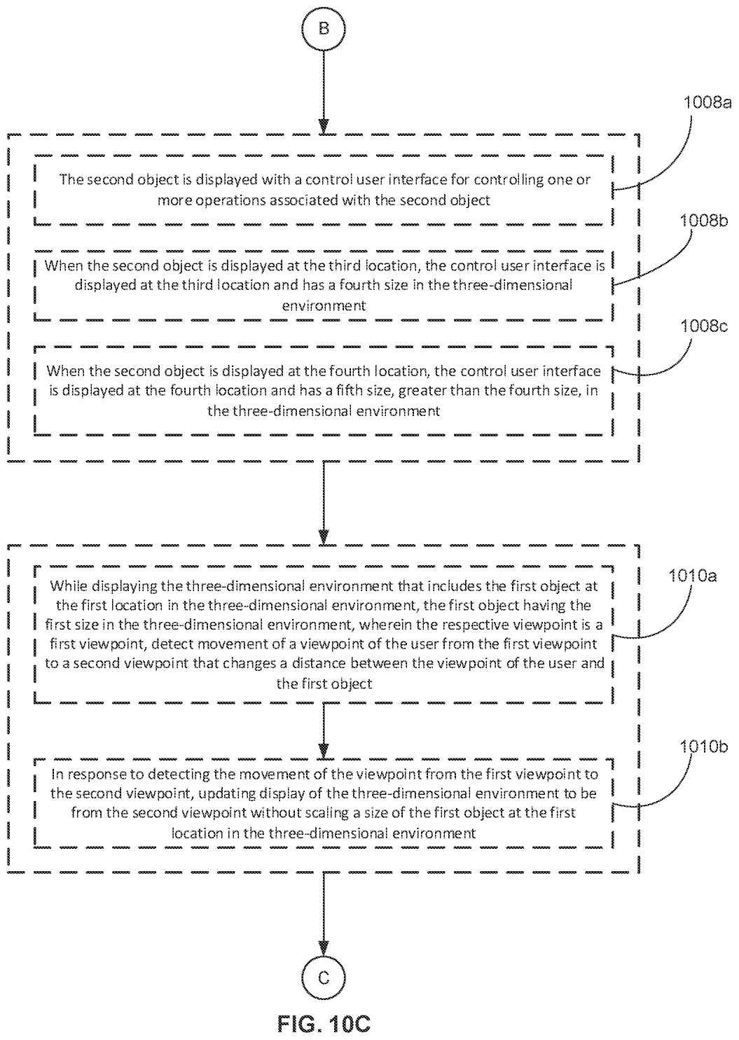

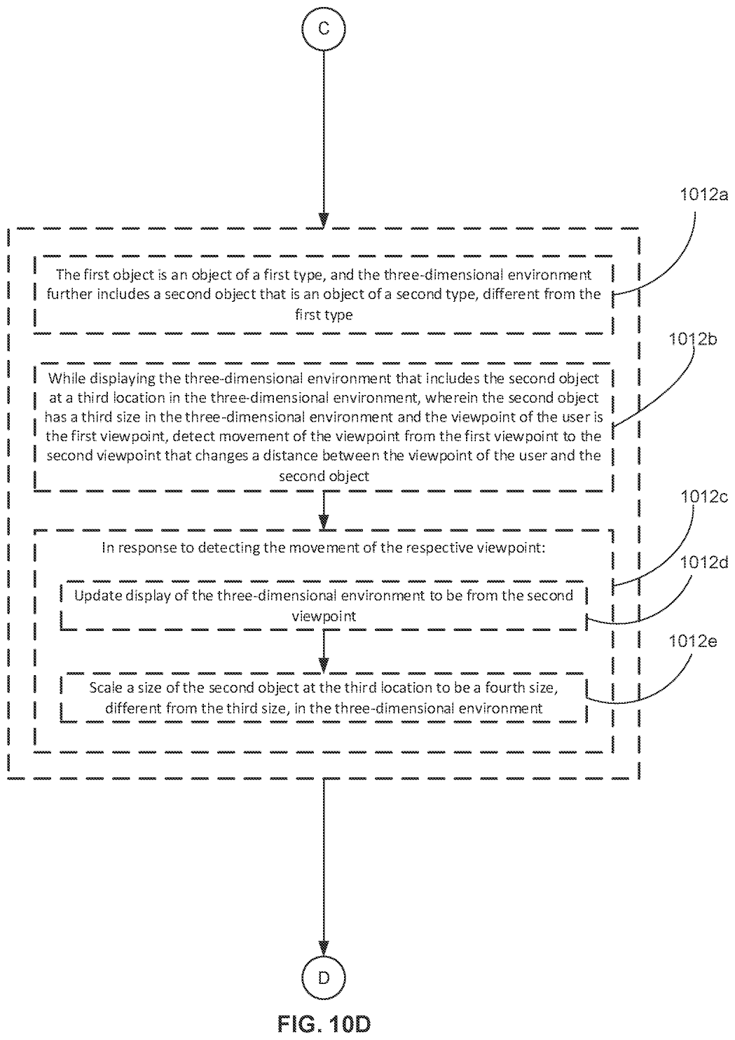

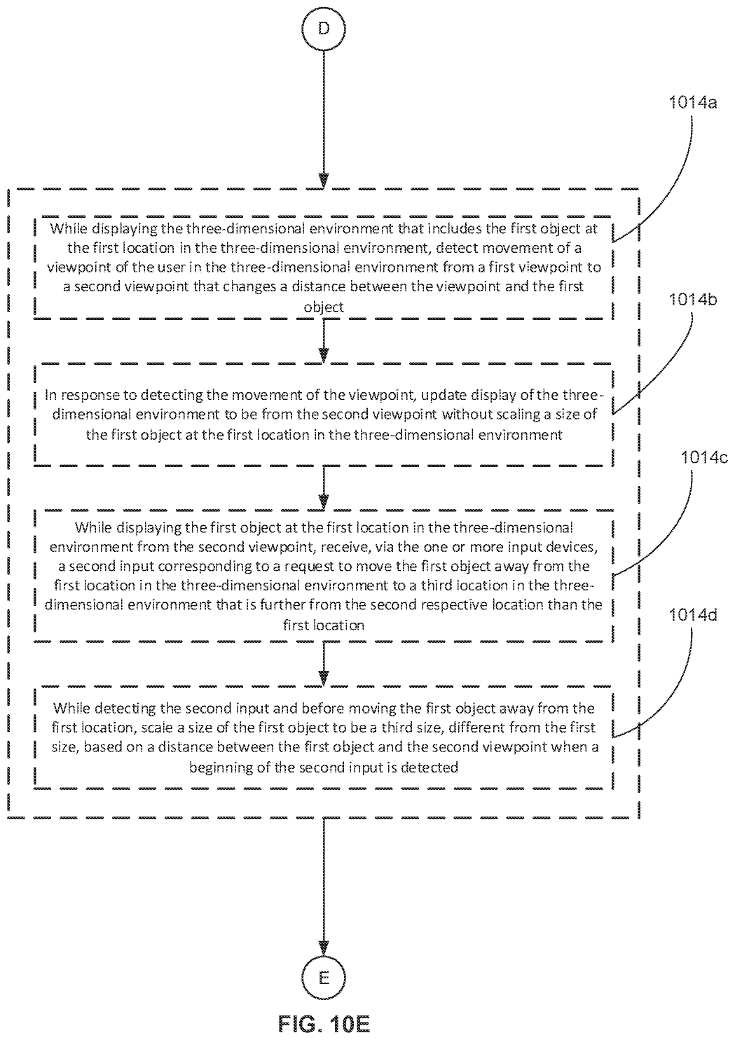

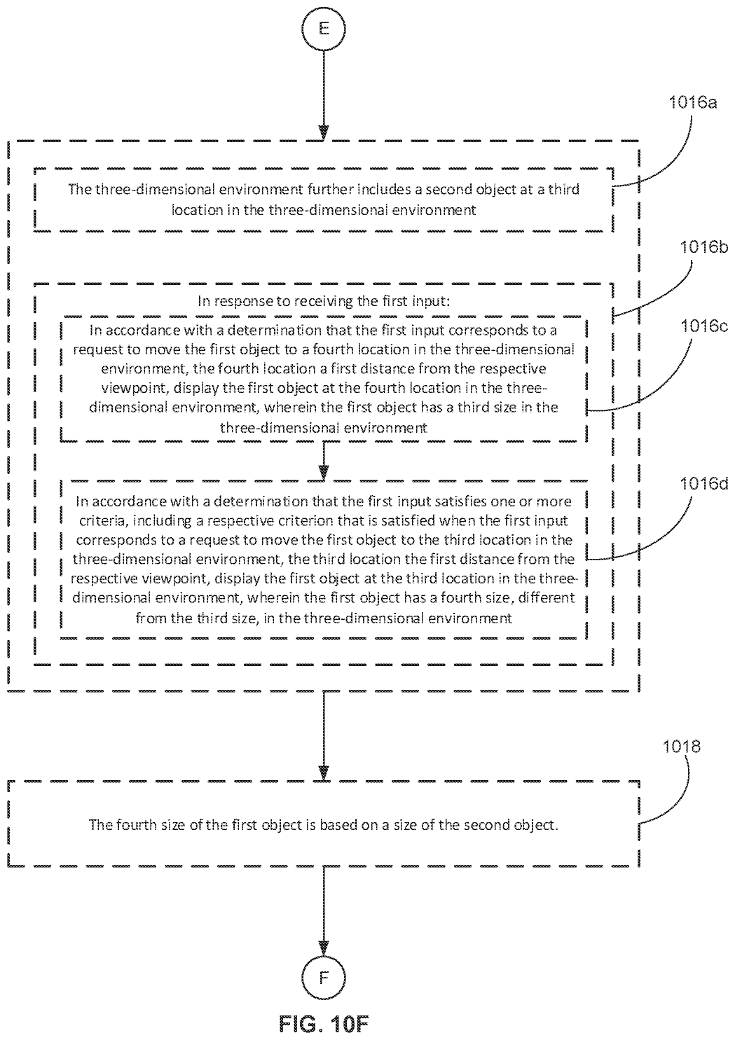

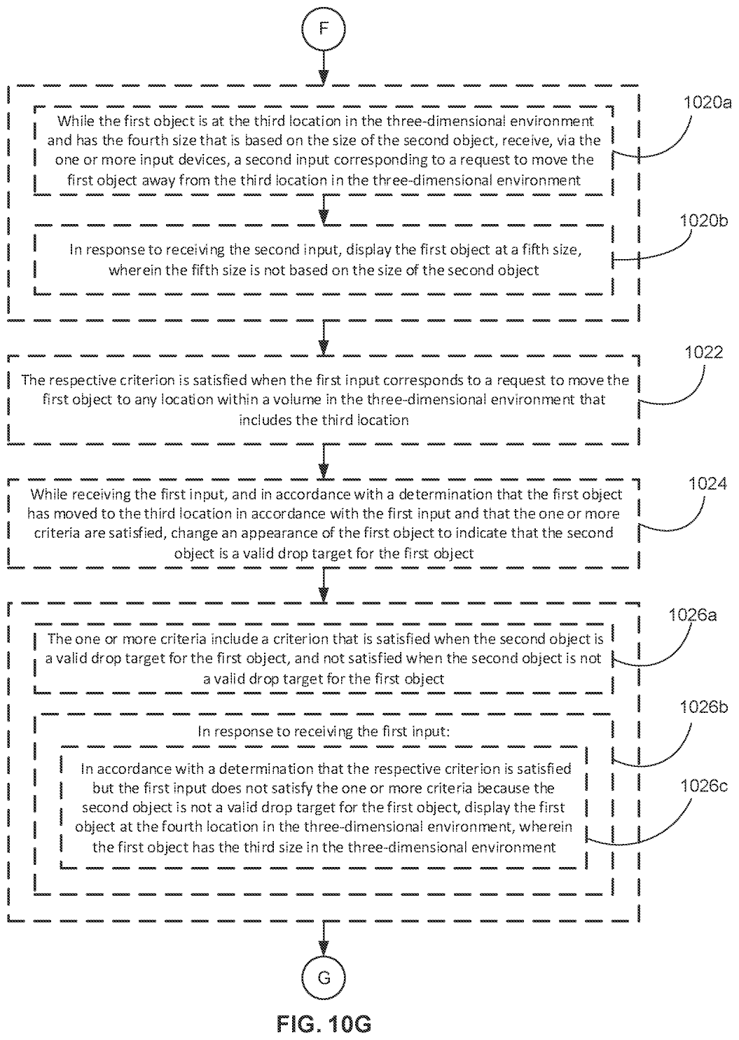

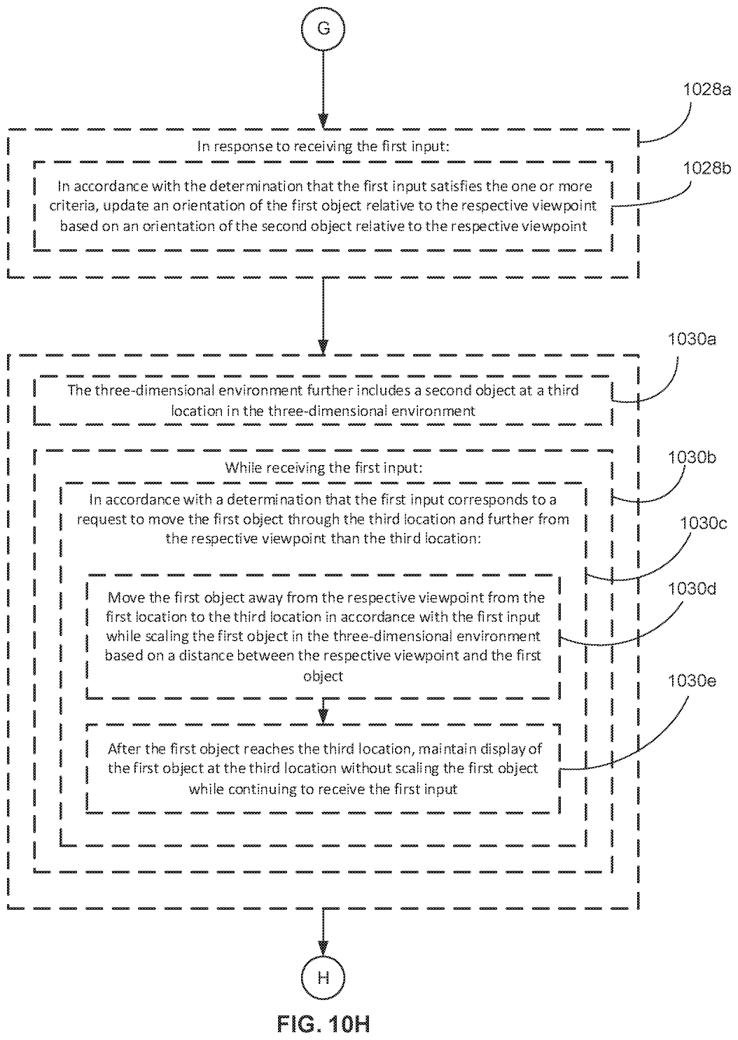

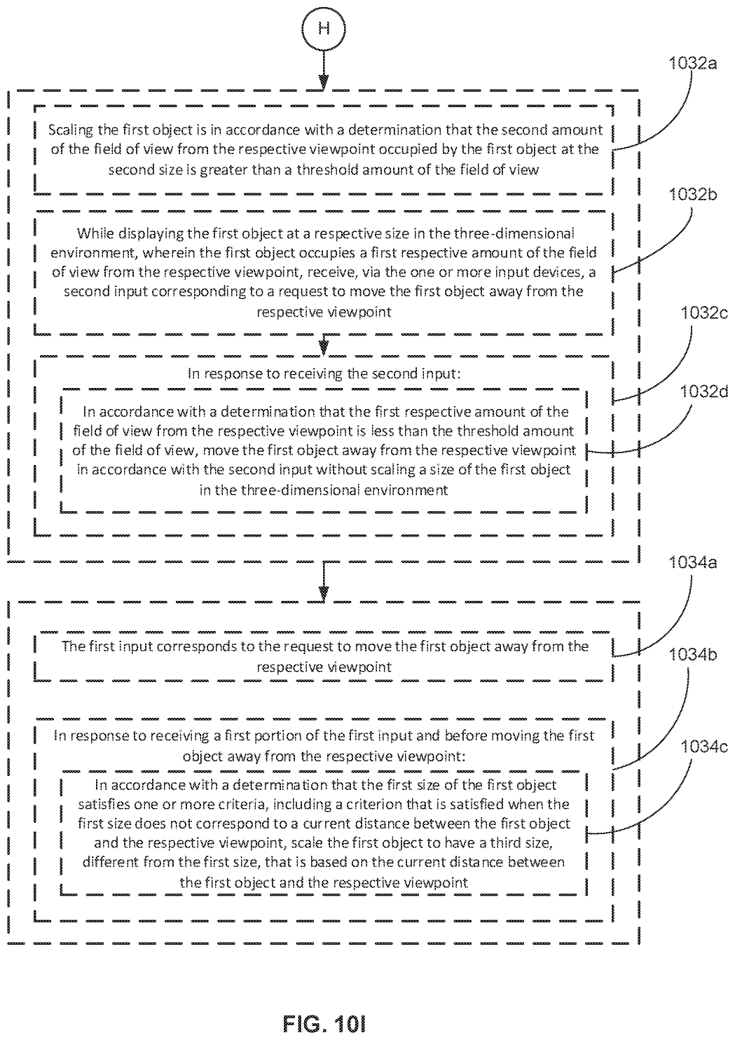

FIGS. 10A-10I is a flowchart illustrating a method 1000 of dynamically resizing (or not) virtual objects in a three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1002a), via the display generation component, a three-dimensional environment that includes a first object (e.g., a three-dimensional virtual object such as a model of a car, or a two-dimensional virtual object such as a user interface of an application on the electronic device) at a first location in the three-dimensional environment, such as object 906a in FIG. 9A (e.g., the three-dimensional environment is optionally generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.)), wherein the first object has a first size in the three-dimensional environment and occupies a first amount of a field of view (e.g., the display size of the first object and/or the angular size of the first object from the current location of the viewpoint of the user) from a respective viewpoint, such as the size and display size of object 906a in FIG. 9A (e.g., a viewpoint of a user of the electronic device in the three-dimensional environment). For example, the size of the first object in the three-dimensional environment optionally defines the space/volume the first object occupies in the three-dimensional environment, and is not a function of the distance of the first object from a viewpoint of a user of the device into the three-dimensional environment. The size at which the first object is displayed via the display generation component (e.g., the amount of display area and/or field of view occupied by the first object via the display generation component) is optionally based on the size of the first object in the three-dimensional environment and the distance of the first object from the viewpoint of the user of the device into the three-dimensional environment. For example, a given object with a given size in the three-dimensional environment is optionally displayed at a relatively large size (e.g., occupies a relatively large portion of the field of view from the respective viewpoint) via the display generation component when relatively close to the viewpoint of the user, and is optionally displayed at a relatively small size (e.g., occupies a relatively small portion of the field of view from the respective viewpoint) via the display generation component when relatively far from the viewpoint of the user.

In some embodiments, while displaying the three-dimensional environment that includes the first object at the first location in the three-dimensional environment, the electronic device receives (1002b), via the one or more input devices, a first input corresponding to a request to move the first object away from the first location in the three-dimensional environment, such as the input from hand 903c directed to object 906a in FIG. 9A. For example, a pinch gesture of an index finger and thumb of a hand of the user followed by movement of the hand in the pinch hand shape while the gaze of the user is directed to the first object while the hand of the user is greater than a threshold distance (e.g., 0.2, 0.5, 1, 2, 3, 5, 10, 12, 24, or 26 cm) from the first object, or a pinch of the index finger and thumb of the hand of the user followed by movement of the hand in the pinch hand shape irrespective of the location of the gaze of the user when the hand of the user is less than the threshold distance from the first object. The movement of the hand is optionally away from the viewpoint of the user, which optionally corresponds to a request to move the first object away from the viewpoint of the user in the three-dimensional environment. In some embodiments, the first input has one or more of the characteristics of the input(s) described with reference to methods 800, 1200, 1400 and/or 1600.

In some embodiments, in response to receiving the first input (1002c), in accordance with a determination that the first input corresponds to a request to move the first object away from the respective viewpoint (1002d), such as the input from hand 903c directed to object 906a in FIG. 9A (e.g., a request to move the first object further away from the location in the three-dimensional environment from which the electronic device is displaying the three-dimensional environment), the electronic device moves (1002e) the first object away from the respective viewpoint from the first location to a second location in the three-dimensional environment in accordance with the first input, wherein the second location is further than the first location from the respective viewpoint, such as shown with object 906a in FIG. 9B (e.g., if the first input corresponds to an input to move the first object from a location that is 10 meters from the viewpoint of the user to a location that is 20 meters from the viewpoint of the user, moving the first object in the three-dimensional environment from the location that is 10 meters from the viewpoint of the user to the location that is 20 meters from the viewpoint of the user). In some embodiments, the electronic device scales (10020 the first object such that when the first object is located at the second location, the first object has a second size, larger than the first size, in the three-dimensional environment, such as shown with object 906a in FIG. 9B (e.g., increasing the size, in the three-dimensional environment, of the first object as the first object moves further from the viewpoint of the user, and optionally decreasing the size, in the three-dimensional environment, of the first object as the first object moves closer to the viewpoint of the user) and occupies a second amount of the field of view from the respective viewpoint, wherein the second amount is smaller than the first amount, such as shown with object 906a in FIG. 9B. For example, increasing the size of the first object in the three-dimensional environment as the first object moves away from the viewpoint of the user less than an amount that would cause the display area occupied by the first object via the display generation component to remain the same or increase as the first object moves away from the viewpoint of the user. In some embodiments, the first object is increased in size in the three-dimensional environment as it moves further from the viewpoint of the user to maintain the ability of the user to interact with the first object, which would optionally become too small to interact with if not scaled up as it moves further from the viewpoint of the user. However, to avoid the sense that the first object is not actually moving further away from the viewpoint of the user (e.g., which would optionally occur if the display size of the first object remained the same or increased as the first object moved further away from the viewpoint of the user), the amount of scaling of the first object performed by the electronic device is sufficiently low to ensure that the display size of the first object (e.g., the amount of the field of view from the respective viewpoint occupied by the first object) decreases as the first object moves further away from the viewpoint of the user. Scaling the first object as a function of the distance of the first object from the viewpoint of the user while maintaining that the display or angular size of the first object increases (when the first object is moving towards the viewpoint of the user) or decreases (when the first object is moving away from the viewpoint of the user) ensures continued interactability with the first object at a range of distances from the viewpoint of the user while avoiding disorienting presentation of the first object in the three-dimensional environment, thereby improving the user-device interaction.

In some embodiments, while receiving the first input and in accordance with the determination that the first input corresponds to the request to move the first object away from the respective viewpoint, continuously scaling the first object to increasing sizes (e.g., larger than the first size) as the first object moves further from the respective viewpoint (1004), such as described with reference to object 906a in FIG. 9B. Thus, in some embodiments, the change in size of the first object occurs continuously as the distance of the first object from the respective viewpoint changes (e.g., whether the first object is being scaled down in size because the first object is getting closer to the respective viewpoint, or the first object is being scaled up in size because the first object is getting further away from the respective viewpoint). In some embodiments, the size of the first object that increases as the first object moves further from the respective viewpoint is the size of the first object in the three-dimensional environment, which is optionally a different quantity than the size of the first object in the field of the view of the user from the respective viewpoint, as will be described in more detail below. Scaling the first object continuously as the distance between the first object and the respective viewpoint changes provides immediate feedback to the user about the movement of the first object, thereby improving the user-device interaction.

In some embodiments, the first object is an object of a first type, such as object 906a which is a two-dimensional object (e.g., the first object is a two-dimensional object in the three-dimensional environment, such as a user interface of a messaging application for messaging other users), and the three-dimensional environment further includes a second object that is an object of a second type, different from the first type (1006a), such as object 908a which is a three-dimensional object (e.g., the second object is a three-dimensional object, such as a virtual three-dimensional representation of a car, a building, a clock, etc. in the three-dimensional environment). In some embodiments, while displaying the three-dimensional environment that includes the second object at a third location in the three-dimensional environment, wherein the second object has a third size in the three-dimensional environment and occupies a third amount of the field of view from the respective viewpoint, the electronic device receives (1006b), via the one or more input devices, a second input corresponding to a request to move the second object away from the third location in the three-dimensional environment, such as the input from hand 903b directed to object 908a in FIG. 9A. For example, a pinch gesture of an index finger and thumb of a hand of the user followed by movement of the hand in the pinch hand shape while the gaze of the user is directed to the second object while the hand of the user is greater than a threshold distance (e.g., 0.2, 0.5, 1, 2, 3, 5, 10, 12, 24, or 26 cm) from the third object, or a pinch of the index finger and thumb of the hand of the user followed by movement of the hand in the pinch hand shape irrespective of the location of the gaze of the user when the hand of the user is less than the threshold distance from the third object. The movement of the hand is optionally away from the viewpoint of the user, which optionally corresponds to a request to move the third object away from the viewpoint of the user in the three-dimensional environment, or is a movement of the hand towards the viewpoint of the user, which optionally corresponds to a request to move the third object towards the viewpoint of the user. In some embodiments, the second input has one or more of the characteristics of the input(s) described with reference to methods 800, 1200, 1400 and/or 1600.

In some embodiments, in response to receiving the third input and in accordance with a determination that the second input corresponds to a request to move the second object away from the respective viewpoint (1006c), such as the input from hand 903b directed to object 908a in FIG. 9A (e.g., a request to move the third object further away from the location in the three-dimensional environment from which the electronic device is displaying the three-dimensional environment), the electronic device moves (1006d) the second object away from the respective viewpoint from the third location to a fourth location in the three-dimensional environment in accordance with the second input, wherein the fourth location is further than the third location from the respective viewpoint, without scaling the second object such that when the second object is located at the fourth location, the second object has the third size in the three-dimensional environment and occupies a fourth amount, less than the third amount, of the field of view from the respective viewpoint, such as shown with object 908a in FIG. 9B. For example, three-dimensional objects are optionally not scaled based on their distance from the viewpoint of the user (as compared with two-dimensional objects, which are optionally scaled based on their distance from the viewpoint of the user). Therefore, if a three-dimensional object is moved further from the viewpoint of the user, the amount of the field of view occupied by the three-dimensional object is optionally reduced, and if the three-dimensional object is moved closer to the viewpoint of the user, the amount of the field of view occupied by the three-dimensional object is optionally increased. Scaling two-dimensional objects but not three-dimensional objects treats three-dimensional objects similar to physical objects, which is familiar to users and results in behavior that is expected by users, thereby improving the user-device interaction and reducing errors in usage.

In some embodiments, the second object is displayed with a control user interface for controlling one or more operations associated with the second object (1008a), such as object 907a or 916a in FIG. 9A. For example, the second object is displayed with a user interface element that is selectable and moveable to cause the second object to move in the three-dimensional environment in a manner corresponding to the movement. For example, the user interface element is optionally a grabber bar displayed below the second object and that is grabbable to move the second object in the three-dimensional environment. The control user interface optionally is or includes one or more of a grabber bar, a selectable option that is selectable to cease display of the second object in the three-dimensional environment, a selectable option that is selectable to share the second object with another user, etc.

In some embodiments, when the second object is displayed at the third location, the control user interface is displayed at the third location and has a fourth size in the three-dimensional environment (1008b). In some embodiments, when the second object is displayed at the fourth location (e.g., in response to the second input for moving the second object), the control user interface is displayed at the fourth location and has a fifth size, greater than the fourth size, in the three-dimensional environment (1008c), such as shown with objects 907a and 916a. For example, the control user interface moves along with the second object in accordance with the same second input. In some embodiments, even though the second object is not scaled in the three-dimensional environment based on the distance between the second object and the viewpoint of the user, the control user interface displayed with the second object is scaled in the three-dimensional environment based on the distance between the control user interface and the viewpoint of the user (e.g., in order to ensure continued interactability of the control user interface element by the user). In some embodiments, the control user interface element is scaled in the same way the first object is scaled based on movement towards/away from the viewpoint of the user. In some embodiments, the control user interface is scaled less than or more than the way the first object is scaled based on movement towards/away from the viewpoint of the user. In some embodiments, the control user interface is scaled such that the amount of the field of view of the user occupied by the control user interface does not change as the second object is moved towards/away from the viewpoint of the user. Scaling the control user interface of a three-dimensional object ensures that the user is able to interact with the control user interface element regardless of the distance between three-dimensional object and the viewpoint of the user, thereby improving the user-device interaction and reducing errors in usage.

In some embodiments, while displaying the three-dimensional environment that includes the first object at the first location in the three-dimensional environment, the first object having the first size in the three-dimensional environment, wherein the respective viewpoint is a first viewpoint, the electronic device detects (1010a) movement of a viewpoint of the user from the first viewpoint to a second viewpoint that changes a distance between the viewpoint of the user and the first object, such as the movement of the viewpoint of user 926 in FIG. 9D. For example, the user moves in the physical environment of the electronic device and/or provides input to the electronic device to move the viewpoint of the user from a first respective location to a second respective location in the three-dimensional environment such that the electronic device displays the three-dimensional environment from the updated viewpoint of the user. The movement of the viewpoint optionally causes the viewpoint to be closer to, or further away from, the first object as compared with the distance when the viewpoint was the first viewpoint.

In some embodiments, in response to detecting the movement of the viewpoint from the first viewpoint to the second viewpoint, the electronic device updates (1010b) display of the three-dimensional environment to be from the second viewpoint without scaling a size of the first object at the first location in the three-dimensional environment, such as described with reference to objects 906a, 908a and 910a in FIG. 9D. For example, the first object remains the same size in the three-dimensional environment as it was when the viewpoint was the first viewpoint, but the amount of the field of view occupied by the first object when the viewpoint is the second viewpoint is optionally greater than (if the viewpoint moved closer to the first object) or less than (if the viewpoint moved further away from the first object) the amount of the field of view occupied by the first object when the viewpoint was the first viewpoint. Forgoing scaling the first object in response to changes in the distance between the first object and the respective viewpoint of the user as a result of movement of the viewpoint (as opposed to movement of the object) ensures that changes in the three-dimensional environment occur when expected (e.g., in response to user input) and reduces disorientation of a user, thereby improving the user-device interaction and reducing errors in usage.

In some embodiments, the first object is an object of a first type (e.g., a content object, such as a two-dimensional user interface of an application on the electronic device, a three-dimensional representation of an object, such as a car, etc.—more generally, an object that is or corresponds to content, rather than an object that is or corresponds to a system (e.g., operating system) user interface of the electronic device), and the three-dimensional environment further includes a second object that is an object of a second type, different from the first type (1012a), such as object 916a in FIG. 9C (e.g., a control user interface for a respective object, as described previously, such as a grabber bar for moving the respective object in the three-dimensional environment). In some embodiments, while displaying the three-dimensional environment that includes the second object at a third location in the three-dimensional environment (e.g., displaying a grabber bar for the respective object that is also at the third location in the three-dimensional environment), wherein the second object has a third size in the three-dimensional environment and the viewpoint of the user is the first viewpoint, the electronic device detects (1012b) movement of the viewpoint from the first viewpoint to the second viewpoint that changes a distance between the viewpoint of the user and the second object, such as the movement of the viewpoint of user 926 in FIG. 9D. For example, the user moves in the physical environment of the electronic device and/or provides input to the electronic device to move the viewpoint of the user from a first respective location to a second respective location in the three-dimensional environment such that the electronic device displays the three-dimensional environment from the updated viewpoint of the user. The movement of the viewpoint optionally causes the viewpoint to be closer to, or further away from, the second object as compared with the distance when the viewpoint was the first viewpoint.

In some embodiments, in response to detecting the movement of the respective viewpoint (1012c), the electronic device updates (1012d) display of the three-dimensional environment to be from the second viewpoint, such as shown in FIG. 9D. In some embodiments, the electronic device scales (1012e) a size of the second object at the third location to be a fourth size, different from the third size, in the three-dimensional environment, such as scaling object 916a in FIG. 9D. For example, the second object is scaled in response to the movement of the viewpoint of the user based on the updated distance between the viewpoint of the user and the second object. In some embodiments, if the viewpoint of the user gets closer to the second object, the second object is decreased in size in the three-dimensional environment, and if the viewpoint of the user gets further from the viewpoint of the user, the second object is increased in size. The amount of the field of view occupied by the second object optionally remains constant or increases or decreases in manners described herein. Scaling some types of objects in response to movement of the viewpoint of the user ensures that the user is able to interact with the object regardless of the distance between the object and the viewpoint of the user, even if the change in distance is due to movement of the viewpoint, thereby improving the user-device interaction and reducing errors in usage.

In some embodiments, while displaying the three-dimensional environment that includes the first object at the first location in the three-dimensional environment, the electronic device detects (1014a) movement of a viewpoint of the user in the three-dimensional environment from a first viewpoint to a second viewpoint that changes a distance between the viewpoint and the first object, such as the movement of the viewpoint of user 926 in FIG. 9D. For example, the user moves in the physical environment of the electronic device and/or provides input to the electronic device to move the viewpoint of the user to the second viewpoint in the three-dimensional environment such that the electronic device displays the three-dimensional environment from the updated viewpoint of the user. The movement of the viewpoint optionally causes the viewpoint to be closer to, or further away from, the first object as compared with the distance when the viewpoint was at the first viewpoint.

In some embodiments, in response to detecting the movement of the viewpoint, the electronic device updates (1014b) display of the three-dimensional environment to be from the second viewpoint without scaling a size of the first object at the first location in the three-dimensional environment, such as shown with objects 906a, 908a or 910a in FIG. 9D. The first object optionally is not scaled in response to movement of the viewpoint, as previously described.

In some embodiments, while displaying the first object at the first location in the three-dimensional environment from the second viewpoint, the electronic device receives (1014c), via the one or more input devices, a second input corresponding to a request to move the first object away from the first location in the three-dimensional environment to a third location in the three-dimensional environment that is further from the second respective location than the first location, such as the movement input directed to object 906a in FIG. 9D. For example, a pinch gesture of an index finger and thumb of a hand of the user followed by movement of the hand in the pinch hand shape while the gaze of the user is directed to the first object while the hand of the user is greater than a threshold distance (e.g., 0.2, 0.5, 1, 2, 3, 5, 10, 12, 24, or 26 cm) from the first object, or a pinch of the index finger and thumb of the hand of the user followed by movement of the hand in the pinch hand shape irrespective of the location of the gaze of the user when the hand of the user is less than the threshold distance from the first object. The movement of the hand is optionally away from the viewpoint of the user, which optionally corresponds to a request to move the first object away from the viewpoint of the user in the three-dimensional environment. In some embodiments, the second input has one or more of the characteristics of the input(s) described with reference to methods 800, 1200, 1400 and/or 1600.

In some embodiments, while detecting the second input and before moving the first object away from the first location (e.g., in response to detecting the pinchdown of the index finger and the thumb of the user, such as when the tip of the thumb and the tip of the index finger are detected as coming together and touching, before detecting movement of the hand while maintaining the pinch hand shape), the electronic device scales (1014d) a size of the first object to be a third size, different from the first size, based on a distance between the first object and the second viewpoint when a beginning of the second input is detected, such as the scaling of object 906a in FIG. 9E before object 906a is moved (e.g., when the pinchdown of the index finger and the thumb of the user is detected). If the viewpoint moved to a location closer to the first object, the first object is optionally scaled down in size, and if the viewpoint moved to a location further from the first object, the first object is optionally scaled up in size. The amount of scaling of the first object (and/or the resulting amount of the field of view of the viewpoint occupied by the first object) is optionally as described previously with reference to the first object. Thus, in some embodiments, even though the first object is not scaled in response to movement of the viewpoint of the user, it is scaled upon detecting initiation of a subsequent movement input to be based on the current distance between the first object and the viewpoint of the user. Scaling the first object upon detecting the movement input ensures that the first object is sized appropriately for its current distance from the viewpoint of the user, thereby improving the user-device interaction.

In some embodiments, the three-dimensional environment further includes a second object at a third location in the three-dimensional environment (1016a). In some embodiments, in response to receiving the first input (1016b), in accordance with a determination that the first input corresponds to a request to move the first object to a fourth location in the three-dimensional environment (e.g., a location in the three-dimensional environment that does not include another object), the fourth location a first distance from the respective viewpoint, the electronic device displays (1016c) the first object at the fourth location in the three-dimensional environment, wherein the first object has a third size in the three-dimensional environment. For example, the first object is scaled based on the first distance, as previously described.

In some embodiments, in accordance with a determination that the first input satisfies one or more criteria, including a respective criterion that is satisfied when the first input corresponds to a request to move the first object to the third location in the three-dimensional environment, such as the input directed to object 914a in FIG. 9A (e.g., movement of the first object to the second object, where the second object is a valid drop target for the first object. Valid and invalid drop targets are described in more detail with reference to methods 1200 and/or 1400), the third location the first distance from the respective viewpoint (e.g., the second object is the same distance from the viewpoint of the user as is the distance of the fourth location from the viewpoint of the user), the electronic device displays (1016d) the first object at the third location in the three-dimensional environment, wherein the first object has a fourth size, different from the third size, in the three-dimensional environment, such as shown with object 914a in FIG. 9B. In some embodiments, when the first object is moved to an object (e.g., a window)—or within a threshold distance such as 0.1, 0.2, 0.5, 1, 2, 3, 5, 10, 20, 30, or 50 cm of the object— that is a valid drop target for the first object, the electronic device scales the first object differently than it scales the first object when the first object is not moved to an object (e.g., scales the first object not based on the distanced between the viewpoint of the user and the first object). Thus, even though the first object is still the first distance from the viewpoint of the user when it is moved to the third location, it has a different size—and thus occupies a different amount of the field of view of the user—than when the first object is moved to the fourth location. Scaling the first object differently when it is moved to another object provides visual feedback to a user that the first object has been moved to another object, which is potentially a drop target/container for the first object, thereby improving the user-device interaction and reducing errors in usage.

In some embodiments, the fourth size of the first object is based on a size of the second object (1018), such as shown with object 914a in FIG. 9B. For example, the first object is sized to fit within the second object. If the second object is a user interface of a messaging application, and the first object is a representation of a photo, the first object is optionally scaled up or down to become an appropriate size for inclusion/display in the second object, for example. In some embodiments, the first object is scaled such that it is a certain proportion of (e.g., 1%, 5%, 10%, 20%, 30%, 40%, 50%, 60%, or 70% of) the size of the second object. Scaling the first object based on the size of the second object ensures that the first object is appropriately sized relative to the second object (e.g., not too large to obstruct the second object, and not too small to be appropriately visible and/or interactable within the second object), thereby improving the user-device interaction and reducing errors in usage.

In some embodiments, while the first object is at the third location in the three-dimensional environment and has the fourth size that is based on the size of the second object (e.g., while the first object is contained within the second object, such as a representation of a photo contained within a photo browsing and viewing user interface), the electronic device receives (1020a), via the one or more input devices, a second input corresponding to a request to move the first object away from the third location in the three-dimensional environment, such as with respect to object 940a in FIG. 9D (e.g., an input to remove the first object from the second object, such as movement of the first object more than a threshold distance such as 0.1, 0.2, 0.5, 1, 2, 5, 10, 20, or 30 cm from the second object). For example, a pinch gesture of an index finger and thumb of a hand of the user followed by movement of the hand in the pinch hand shape while the gaze of the user is directed to the first object while the hand of the user is greater than a threshold distance (e.g., 0.2, 0.5, 1, 2, 3, 5, 10, 12, 24, or 26 cm) from the first object, or a pinch of the index finger and thumb of the hand of the user followed by movement of the hand in the pinch hand shape irrespective of the location of the gaze of the user when the hand of the user is less than the threshold distance from the first object. The movement of the hand is optionally towards the viewpoint of the user, which optionally corresponds to a request to move the first object towards the viewpoint of the user (e.g., and/or away from the second object) in the three-dimensional environment. In some embodiments, the second input has one or more of the characteristics of the input(s) described with reference to methods 800, 1200, 1400 and/or 1600.

In some embodiments, in response to receiving the second input, the electronic device displays (1020b) the first object at a fifth size, wherein the fifth size is not based on the size of the second object, such as shown with object 940a in FIG. 9E. In some embodiments, the electronic device immediately scales the first object when it is removed from the second object (e.g., before detecting movement of the first object away from the third location). In some embodiments, the size to which the electronic device scales the first object is based on the distance between the first object and the viewpoint of the user (e.g., at the moment the first object is removed from the second object), and is no longer based on or proportional to the size of the second object. In some embodiments, the fifth size is the same size at which the first object was displayed right before reaching/being added to the second object during the first input. Scaling the first object to not be based on the size of the second object when the first object is removed from the second object ensures that the first object is appropriately sized for its current distance from the viewpoint of the user, thereby improving the user-device interaction and reducing errors in usage.

In some embodiments, the respective criterion is satisfied when the first input corresponds to a request to move the first object to any location within a volume in the three-dimensional environment that includes the third location (1022), such as within volume 930 in FIG. 9B. In some embodiments, the drop zone for the second object is a volume in the three-dimensional environment (e.g., the bounds of which are optionally not displayed in the three-dimensional environment) that encompasses a portion but not all, or encompasses at least some of including all, of the second object. In some embodiments, the volume extends out from a surface of the second object, towards the viewpoint of the user. In some embodiments, moving the first object anywhere within the volume causes the first object to be scaled based on the size of the second object (e.g., rather than based on the distance between the first object and the viewpoint of the user). In some embodiments, detecting an end of the first input (e.g., detecting a release of the pinch hand shape by the hand of the user) while the first object is within the volume causes the first object to be added to the second object, such as described with reference to methods 1200 and/or 1400. Providing a volume in which the first object is scaled based on the second object facilitates easier interaction between the first object and the second object, thereby improving the user-device interaction and reducing errors in usage.

In some embodiments, while receiving the first input (e.g., and before detecting the end of the first input, as described previously), and in accordance with a determination that the first object has moved to the third location in accordance with the first input and that the one or more criteria are satisfied, the electronic device changes (1024) an appearance of the first object to indicate that the second object is a valid drop target for the first object, such as described with reference to object 914a in FIG. 9B. For example, changing the size of the first object, changing a color of the first object, changing a translucency or brightness of the first object, displaying a badge with a “+” symbol overlaid on the upper-right corner of the first object, and/or etc., to indicate that the second object is a valid drop target for the first object. The change in appearance of the first object is optionally as described with reference to methods 1200 and/or 1400 in the context of valid drop targets. Changing the appearance of the first object to indicate it has been moved to a valid drop target provides visual feedback to a user that the first object will be added to the second object if the user terminates the movement input, thereby improving the user-device interaction and reducing errors in usage.

In some embodiments, the one or more criteria include a criterion that is satisfied when the second object is a valid drop target for the first object, and not satisfied when the second object is not a valid drop target for the first object (1026a) (e.g., examples of valid and invalid drop targets are described with reference to methods 1200 and/or 1400). In some embodiments, in response to receiving the first input (1026b), in accordance with a determination that the respective criterion is satisfied but the first input does not satisfy the one or more criteria because the second object is not a valid drop target for the first object (e.g., the first object has been moved to a location that would otherwise allow the first object to be added to the second object if the second object were a valid drop target for the first object), the electronic device displays (1026c) the first object at the fourth location in the three-dimensional environment, wherein the first object has the third size in the three-dimensional environment, such as shown with object 914a in FIG. 9C. For example, because the second object is not a valid drop target for the first object, the first object is not scaled based on the size of the second object, but rather is scaled based on the current distance between the viewpoint of the user and the first object. Forgoing scaling of the first object based on the second object provides visual feedback to a user that the second object is not a valid drop target for the first object, thereby improving the user-device interaction and reducing errors in usage.

In some embodiments, in response to receiving the first input (1028a), in accordance with the determination that the first input satisfies the one or more criteria (e.g., the first object has been moved to a drop location for the second object, and the second object is a valid drop target for the first object), the electronic device updates (1028b) an orientation of the first object relative to the respective viewpoint based on an orientation of the second object relative to the respective viewpoint, such as shown with object 914a with respect to object 910a in FIG. 9B. Additionally or alternatively to scaling the first object when the first object is moved to a valid drop target, the electronic device updates/changes the pitch, yaw and/or roll of the first object to be aligned with an orientation of the second object. For example, if the second object is a planar object or has a planar surface (e.g., is a three-dimensional object that has a planar surface), when the first object is moved to the second object, the electronic device changes the orientation of the first object such that it (or a surface on it, if the first object is a three-dimensional object) is parallel to the second object (or the surface of the second object). Changing the orientation of the first object when it is moved to the second object ensures that the first object will be appropriately placed within the second object if dropped within the second object, thereby improving the user-device interaction.

In some embodiments, the three-dimensional environment further includes a second object at a third location in the three-dimensional environment (1030a). In some embodiments, while receiving the first input (1030b), in accordance with a determination that the first input corresponds to a request to move the first object through the third location and further from the respective viewpoint than the third location (1030c) (e.g., an input that corresponds to movement of the first object through the second object, such as described with reference to method 1200), the electronic device moves (1030d) the first object away from the respective viewpoint from the first location to the third location in accordance with the first input while scaling the first object in the three-dimensional environment based on a distance between the respective viewpoint and the first object, such as moving and scaling object 914a from FIG. 9A to 9B until it reaches object 910a. For example, the first object is freely moved backwards, away from the viewpoint of the user in accordance with the first input until it reaches the second object, such as described with reference to method 1200. Because the first object is moving further away from the viewpoint of the user as it is moving backwards towards the second object, the electronic device optionally scales the first object based on the current, changing distance between the first object and the viewpoint of the user, as previously described.

In some embodiments, after the first object reaches the third location, the electronic device maintains (1030e) display of the first object at the third location without scaling the first object while continuing to receive the first input, such as if input from hand 903a directed to object 914a corresponded to continued movement through object 910a while object 914a remained within volume 930 in FIG. 9B. For example, similar to as described with reference to method 1200, the first object resists movement through the second object when it collides with and/or reaches the second object, even if further input from the hand of the user for moving the first object through the second object is detected. While the first object remains at the second location/third location, because the distance between the viewpoint of the user and the first object is not changing, the electronic device stops scaling the first object in the three-dimensional environment in accordance with the further input for moving the first object through/past the second object. If sufficient magnitude of input through the second object is received to break through the second object (e.g., as described with reference to method 1200), the electronic device optionally resumes scaling the first object based on the current, changing distance between the first object and the viewpoint of the user. Forgoing scaling the first object when it is pinned against the second object provides feedback to the user that the first object is no longer moving in the three-dimensional environment, thereby improving the user-device interaction.

In some embodiments, scaling the first object is in accordance with a determination that the second amount of the field of view from the respective viewpoint occupied by the first object at the second size is greater than a threshold amount of the field of view (1032a) (e.g., the electronic device scales the first object based on the distance between the first object and the viewpoint of the user as long as the amount of the field of view of the user that the first object occupies is greater than a threshold amount, such as 0.1%, 0.5%, 1%, 3%, 5%, 10%, 20%, 30%, or 50% of the field of view). In some embodiments, while displaying the first object at a respective size in the three-dimensional environment, wherein the first object occupies a first respective amount of the field of view from the respective viewpoint, the electronic device receives (1032b), via the one or more input devices, a second input corresponding to a request to move the first object away from the respective viewpoint. For example, a pinch gesture of an index finger and thumb of a hand of the user followed by movement of the hand in the pinch hand shape while the gaze of the user is directed to the first object while the hand of the user is greater than a threshold distance (e.g., 0.2, 0.5, 1, 2, 3, 5, 10, 12, 24, or 26 cm) from the first object, or a pinch of the index finger and thumb of the hand of the user followed by movement of the hand in the pinch hand shape irrespective of the location of the gaze of the user when the hand of the user is less than the threshold distance from the first object. The movement of the hand is optionally away from the viewpoint of the user, which optionally corresponds to a request to move the first object away from the viewpoint of the user in the three-dimensional environment. In some embodiments, the second input has one or more of the characteristics of the input(s) described with reference to methods 800, 1200, 1400 and/or 1600.

In some embodiments, in response to receiving the second input (1032c), in accordance with a determination that the first respective amount of the field of view from the respective viewpoint is less than the threshold amount of the field of view (e.g., the first object has been moved to a distance from the viewpoint of the user in the three-dimensional environment at which the amount of the field of view occupied by the first object has reached and/or is below the threshold amount of the field of view), the electronic device moves (1032d) the first object away from the respective viewpoint in accordance with the second input without scaling a size of the first object in the three-dimensional environment, such as if device 101 ceased scaling object 906a from FIG. 9B to 9C. In some embodiments, the electronic device no longer scales the size of the first object in the three-dimensional environment based on the distance between the first object and the viewpoint of the user when the first object is sufficiently far from the viewpoint of the user such that the amount of the field of view occupied by the first object is less than the threshold amount. In some embodiments, at this point, the size of the first object remains constant in the three-dimensional environment as the first object continues to get further from the viewpoint of the user. In some embodiments, if the first object is subsequently moved closer to the viewpoint of the user such that the amount of the field of view that is occupied by the first object reaches and/or exceeds the threshold amount, the electronic device resumes scaling the first object based on the distance between the first object and the viewpoint of the user. Forgoing scaling the first object when it consumes less than the threshold field of view of the user conserves processing resources of the device when interaction with the first object is not effective, thereby reducing power usage of the electronic device.

In some embodiments, the first input corresponds to the request to move the first object away from the respective viewpoint (1034a). In some embodiments, in response to receiving a first portion of the first input and before moving the first object away from the respective viewpoint (1034b) (e.g., in response to detecting the hand of the user performing the pinch down gesture of the tip of the index finger coming closer to and touching the tip of the thumb, and before the hand in the pinch hand shapes subsequently moves), in accordance with a determination that the first size of the first object satisfies one or more criteria, including a criterion that is satisfied when the first size does not correspond to a current distance between the first object and the respective viewpoint (e.g., if the current size of the first object when the first portion of the first input is detected is not based on the distance between the viewpoint of the user and the first object), the electronic device scales (1034c) the first object to have a third size, different from the first size, that is based on the current distance between the first object and the respective viewpoint, such as if object 906a were not sized based on the current distance between the object and the viewpoint of user 926 in FIG. 9A. Thus, in some embodiments, in response to the first portion of the first input, the electronic device appropriately sizes the first object to be based on the current distance between the first object and the viewpoint of the user. The third size is optionally greater than or less than the first size depending on the current distance between the first object and the viewpoint of the user. Scaling the first object upon detecting the first portion of the movement input ensures that the first object is sized appropriately for its current distance from the viewpoint of the user, facilitating subsequent interaction with the first object, thereby improving the user-device interaction.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

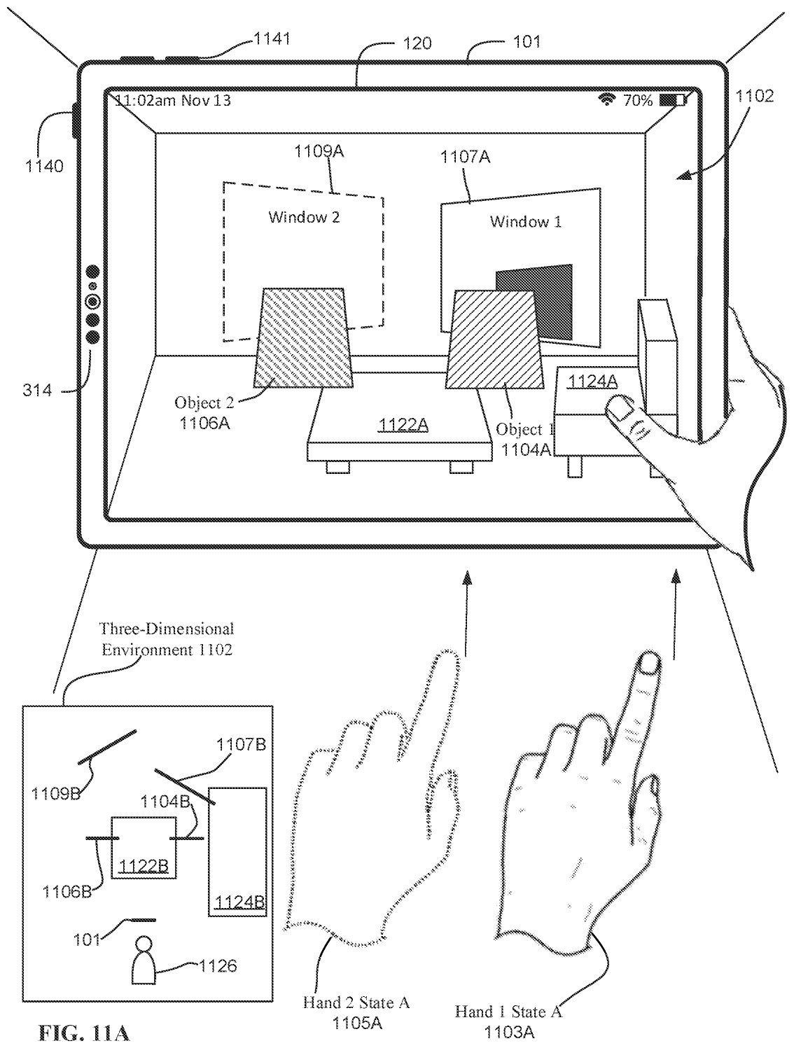

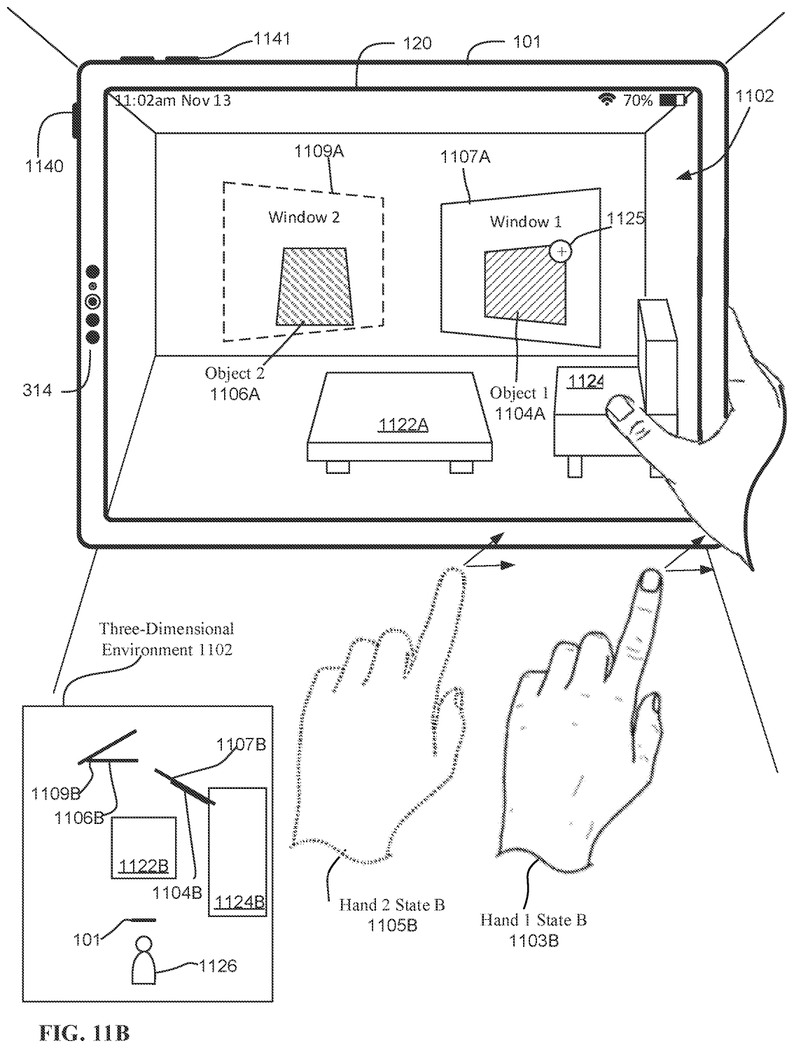

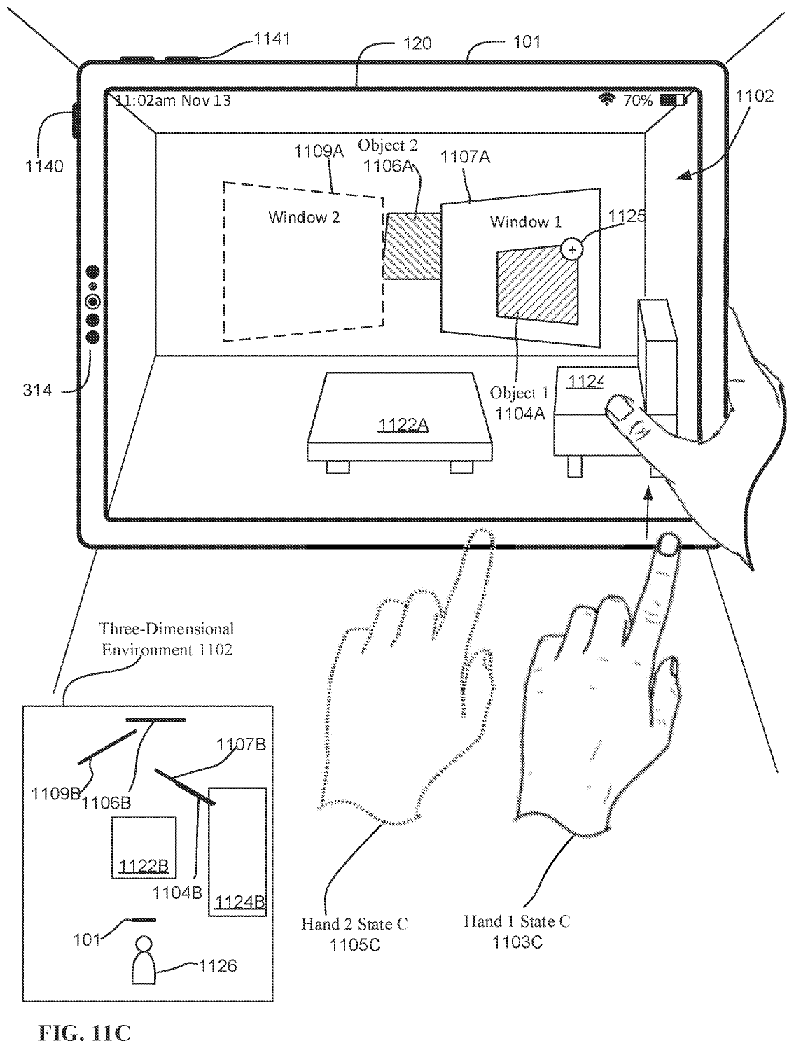

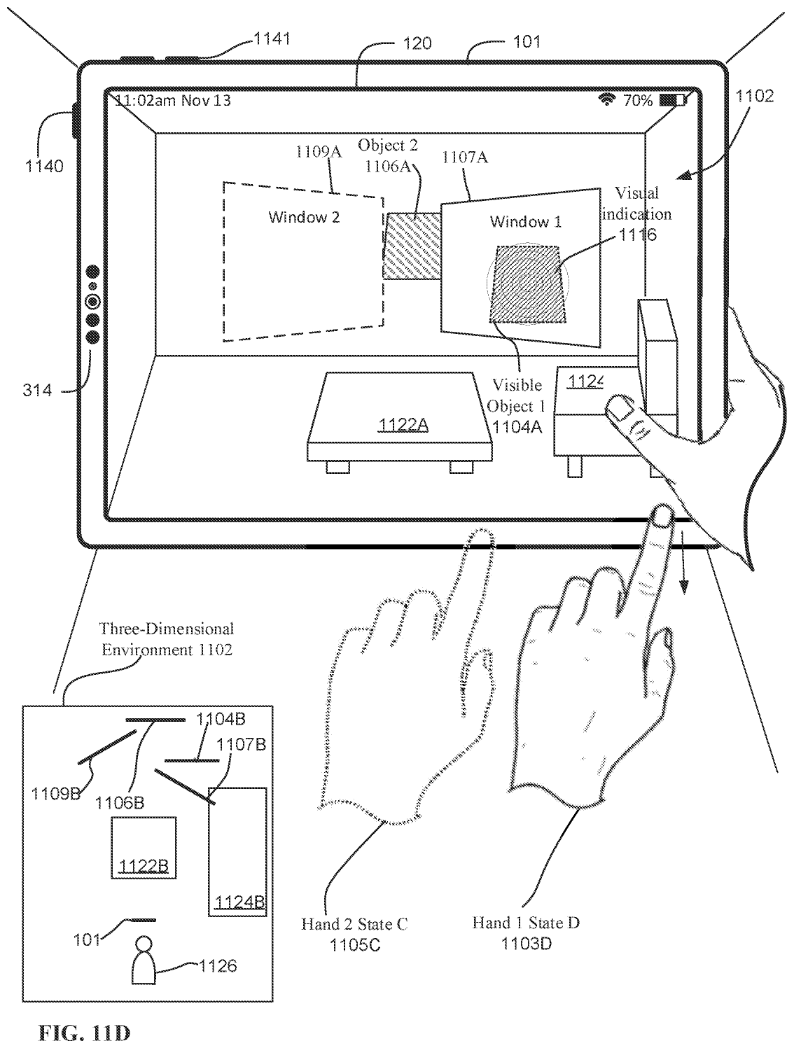

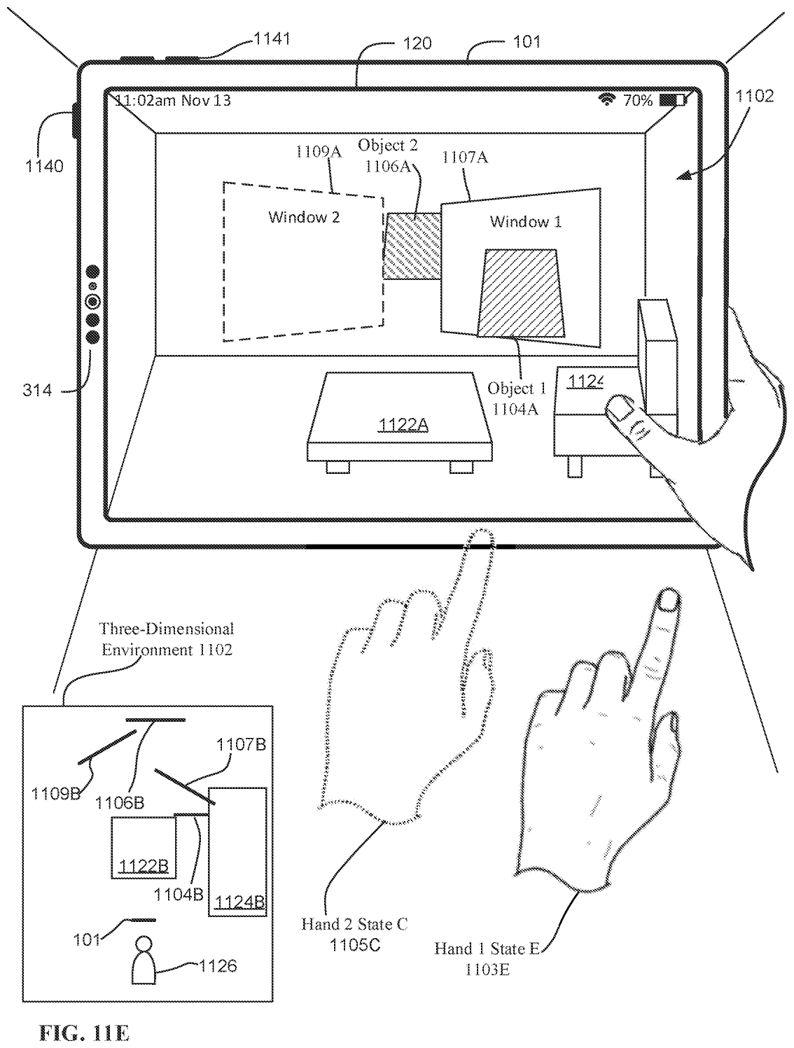

FIGS. 11A-11E illustrate examples of an electronic device selectively resisting movement of objects in a three-dimensional environment in accordance with some embodiments.

FIG. 11A illustrates an electronic device 101 displaying, via a display generation component (e.g., display generation component 120 of FIG. 1), a three-dimensional environment 1102 from a viewpoint of the user 1126 illustrated in the overhead view (e.g., facing the back wall of the physical environment in which device 101 is located). As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user). Device 101 optionally includes one or more buttons (e.g., physical buttons), which are optionally a power button 1140 and volume control buttons 1141.

As shown in FIG. 11A, device 101 captures one or more images of the physical environment around device 101 (e.g., operating environment 100), including one or more objects in the physical environment around device 101. In some embodiments, device 101 displays representations of the physical environment in three-dimensional environment 1102. For example, three-dimensional environment 1102 includes a representation 1122a of a coffee table (corresponding to table 1122b in the overhead view), which is optionally a representation of a physical coffee table in the physical environment, and three-dimensional environment 1102 includes a representation 1124a of sofa (corresponding to sofa 1124b in the overhead view), which is optionally a representation of a physical sofa in the physical environment.

In FIG. 11A, three-dimensional environment 1102 also includes virtual objects 1104a (corresponding to object 1104b in the overhead view), 1106a (corresponding to object 1106b in the overhead view), 1107a (corresponding to object 1107b in the overhead view), and 1109a (corresponding to object 1109b in the overhead view). Virtual objects 1104a and 1106a are optionally at a relatively small distance from the viewpoint of user 1126, and virtual objects 1107a and 1109a are optionally at a relatively large distance from the viewpoint of user 1126. In FIG. 11A, virtual object 1109a is the furthest distance from the viewpoint of user 1126. In some embodiments, virtual object 1107a is a valid drop target for virtual object 1104a, and virtual object 1109a is an invalid drop target for virtual object 1106a. For example, virtual object 1107a is a user interface of an application (e.g., messaging user interface) that is configured to accept and/or display virtual object 1104a, which is optionally a two-dimensional photograph. Virtual object 1109a is optionally a user interface of an application (e.g., content browsing user interface) that cannot accept and/or display virtual object 1106a, which is optionally also a two-dimensional photograph. In some embodiments, virtual objects 1104a and 1106a are optionally one or more of user interfaces of applications containing content (e.g., quick look windows displaying photographs), three-dimensional objects (e.g., virtual clocks, virtual balls, virtual cars, etc.) or any other element displayed by device 101 that is not included in the physical environment of device 101.

In some embodiments, virtual objects are displayed in three-dimensional environment 1102 with respective orientations relative to the viewpoint of user 1126 (e.g., prior to receiving input interacting with the virtual objects, which will be described later, in three-dimensional environment 1102). As shown in FIG. 11A, virtual objects 1104a and 1106a have first orientations (e.g., the front-facing surfaces of virtual objects 1104a and 1106a that face the viewpoint of user 1126 are tilted/slightly angled upward relative to the viewpoint of user 1126), virtual object 1107a has a second orientation, different from the first orientation (e.g., the front-facing surface of virtual object 1107a that faces the viewpoint of user 1126 is tilted/slightly angled leftward relative to the viewpoint of user 1126, as shown by 1107b in the overhead view), and virtual object 1109a has a third orientation, different from the first orientation and the second orientation (e.g., the front-facing surface of virtual object 1109a that faces the viewpoint of user 1126 is tilted/slightly angled rightward relative to the viewpoint of user 1126, as shown by 1109b in the overhead view). It should be understood that the orientations of the objects in FIG. 11A are merely exemplary and that other orientations are possible; for example, the objects optionally all share the same orientation in three-dimensional environment 1102.

In some embodiments, a shadow of a virtual object is optionally displayed by device 101 on a valid drop target for that virtual object. For example, in FIG. 11A, a shadow of virtual object 1104a is displayed overlaid on virtual object 1107a, which is a valid drop target for virtual object 1104a. In some embodiments, a relative size of the shadow of virtual object 1104a optionally changes in response to changes in position of virtual object 1104a with respect to virtual object 1107a; thus, in some embodiments, the shadow of virtual object 1104a indicates the distance between object 1104a and 1107a. For example, movement of virtual object 1104a closer to virtual object 1107a (e.g., further from the viewpoint of user 1126) optionally decreases the size of the shadow of virtual object 1104a overlaid on virtual object 1107a, and movement of virtual object 1104a further from virtual object 1107a (e.g., closer to the viewpoint of user 1126) optionally increases the size of the shadow of virtual object 1104a overlaid on virtual object 1107a. In FIG. 11A, a shadow of virtual object 1106a is not displayed overlaid on virtual object 1109a because virtual object 1109a is an invalid drop target for virtual object 1106a.

In some embodiments, device 101 resists movement of objects along certain paths or in certain directions in three-dimensional environment 1102; for example, device 101 resists movement of objects along a path containing another object, and/or in a direction through another object in three-dimensional environment 1102. In some embodiments, the movement of a first object through another object is resisted in accordance with a determination that the other object is a valid drop target for the first object. In some embodiments, the movement of the first object through another object is not resisted in accordance with a determination that the other object is an invalid drop target for the first object. Additional details about the above object movements are provided below and with reference to method 1200.

In FIG. 11A, hand 1103a (e.g., in Hand State A) is providing movement input directed to object 1104a, and hand 1105a (e.g., in Hand State A) is providing movement input to object 1106a. Hand 1103a is optionally providing input for moving object 1104a further from the viewpoint of user 1126 and in the direction of virtual object 1107a in three-dimensional environment 1102, and hand 1105a is optionally providing input for moving object 1106a further from the viewpoint of user 1126 and in the direction of virtual object 1109a in three-dimensional environment 1102. In some embodiments, such movement inputs include the hand of the user moving away from the body of the user 1126 while the hand is in a pinch hand shape (e.g., while the thumb and tip of the index finger of the hand are touching). For example, from FIGS. 11A-11B, device 101 optionally detects hand 1103a move away from the body of the user 1126 while in the pinch hand shape, and device 101 optionally detects hand 1105a move away from the body of the user 1126 while in the pinch hand shape. It should be understood that while multiple hands and corresponding inputs are illustrated in FIGS. 11A-11E, such hands and inputs need not be detected by device 101 concurrently; rather, in some embodiments, device 101 independently responds to the hands and/or inputs illustrated and described in response to detecting such hands and/or inputs independently.

In response to the movement inputs detected in FIG. 11A, device 101 moves objects 1104a and 1106a in three-dimensional environment 1102 accordingly, as shown in FIG. 11B. In FIG. 11A, hands 1104a and 1106a optionally have the same magnitude of movement in the same direction, as previously described. In response to the given magnitude of the movement of hand 1103a away from the body of user 1126, device 101 has moved object 1104a away from the viewpoint of user 1126 and in the direction of virtual object 1107a, where the movement of virtual object 1104a has been halted by virtual object 1107a in three-dimensional environment 1102 (e.g., when virtual object 1104a reached and/or collided with virtual object 1107a), as shown in the overhead view in FIG. 11B. In response to the same given magnitude of the movement of hand 1105a away from the body of user 1126, device 101 has moved object 1106a, away from the viewpoint of user 1126 a distance greater than the distance covered by object 1104a, as shown in the overhead view in FIG. 11B. As discussed above, virtual object 1107a is optionally a valid drop target for virtual object 1104a, and virtual object 1109a is optionally an invalid drop target for virtual object 1106a. Accordingly, as virtual object 1104a is moved by device 101 in the direction of virtual object 1107a in response to the given magnitude of the movement of hand 1103a, when virtual object 1104a reaches/contacts at least a portion of the surface of virtual object 1107a, movement of virtual object 1104a through virtual object 1107a is optionally resisted by device 101, as shown in the overhead view of FIG. 11B. On the other hand, as virtual object 1106a is moved by device 101 in the direction of virtual object 1109a in response to the given magnitude of movement of hand 1105a, movement of virtual object 1106a is not resisted if virtual object 1106a reaches/contacts the surface of virtual object 1109a—though in FIG. 11B, virtual object 1106a has not yet reached virtual object 1109a, as shown in the overhead view of FIG. 11B.

Further, in some embodiments, device 101 automatically adjusts the orientation of an object to correspond to another object or surface when that object gets close to the other object or surface if the other object is a valid drop target for that object. For example, when virtual object 1104a is moved to within a threshold distance (e.g., 0.1, 0.5, 1, 3, 6, 12, 24, 36, or 48 cm) of the surface of virtual object 1107a in response to the given magnitude of movement of hand 1103a, device 101 optionally adjusts the orientation of virtual object 1104a to correspond and/or be parallel to the approached surface of virtual object 1107a (e.g., as shown in the overhead view in FIG. 11B) because virtual object 1107a is a valid drop target for virtual object 1104a. In some embodiments, device 101 forgoes automatically adjusting the orientation of an object to correspond to another object or surface when that object gets close to the other object or surface if the other object is an invalid drop target for that object. For example, when virtual object 1106a is moved to within a threshold distance (e.g., 0.1, 0.5, 1, 3, 6, 12, 24, 36, or 48 cm) of the surface of virtual object 1109a in response to the given magnitude of movement of hand 1105a, device 101 forgoes adjusting the orientation of virtual object 1106a to correspond and/or be parallel to the approached surface of virtual object 1109a (e.g., as shown in the overhead view in FIG. 11B) because virtual object 1109a is an invalid drop target for virtual object 1106a.

Further, in some embodiments, when a respective object is moved to within the threshold distance of the surface of an object (e.g., physical or virtual), device 101 displays a badge on the respective object that indicates whether the object is a valid or invalid drop target for the respective object. In FIG. 11B, object 1107a is a valid drop target for object 1104a; therefore, device 101 displays badge 1125 overlaid on the upper-right corner of object 1104a that indicates that object 1107a is a valid drop target for object 1104a when virtual object 1104a is moved within the threshold distance (e.g., 0.1, 0.5, 1, 3, 6, 12, 24, 36, or 48 cm) of the surface of virtual object 1107a. In some embodiments, the badge 1125 optionally includes one or more symbols or characters (e.g., a “+” sign indicating virtual object 1107a is a valid drop target for virtual object 1104a). In another example, if virtual object 1107a were an invalid drop target for virtual object 1104a, badge 1125 would optionally include one or more symbols or characters (e.g., a “−” sign or “x” symbol) indicating virtual object 1107a is an invalid drop target for virtual object 1104a. In some embodiments, when a respective object is moved to within the threshold distance of an object, if the object is a valid drop target for the respective object, device 101 resizes the respective object to indicate that the object is a valid drop target for the respective object. For example, in FIG. 11B, virtual object 1104a is scaled down (or up) in (e.g., angular) size in three-dimensional environment 1102 when virtual object 1104a is moved to within the threshold distance of the surface of virtual object 1107a. The size to which object 1104a is scaled is optionally based on the size of object 1107a and/or the size of the region within object 1107a that is able to accept object 1104a (e.g., the larger that object 1107a is, the larger the scaled size of object 1104a is). Additional details of valid and invalid drop targets, and associated indications that are displayed and other responses of device 101, are described with reference to methods 1000, 1200, 1400 and/or 1600.

Further, in some embodiments, device 101 controls the size of an object included in three-dimensional environment 1102 based on the distance of that object from the viewpoint of user 1126 to avoid objects consuming a large portion of the field of view of user 1126 from their current viewpoint. Thus, in some embodiments, objects are associated with appropriate or optimal sizes for their current distance from the viewpoint of user 1126, and device 101 automatically changes the sizes of objects to conform with their appropriate or optimal sizes. However, in some embodiments, device 101 does not adjust the size of an object until user input for moving the object is detected. For example, in FIG. 11A, objects 1104a and 1106a are displayed by device 101 at a first size in three-dimensional environment. In response to detecting the inputs provided by hand 1103a for moving object 1104a in three-dimensional environment 1102 and hand 1105a for moving object 1106a in three-dimensional environment 1102, device 101 optionally increases the sizes of objects 1104a and 1106a in three-dimensional environment 1102, as shown in the overhead view in FIG. 11B. The increased sizes of objects 1104a and 1106a optionally correspond to the current distances of objects 1104a and 1106a from the viewpoint of user 1126. Additional details about controlling the sizes of objects based on the distances of those objects from the viewpoint of the user are described with reference to the FIG. 9 series of figures and method 1000.

In some embodiments, device 101 applies varying levels of resistance to the movement of a first object along a surface of a second object depending on whether the second object is a valid drop target for the first object. For example, in FIG. 11B, hand 1103b (e.g., in Hand State B) is providing upward diagonal movement input directed to object 1104a, and hand 1105b (e.g., in Hand State B) is providing upward diagonal movement input to object 1106a while object 1104a is already in contact with object 1107a. In Hand State B (e.g., while the hand is in a pinch hand shape (e.g., while the thumb and tip of the index finger of the hand are touching)), hand 1103b is optionally providing input for moving object 1104a further from the viewpoint of user 1126 and diagonally into (e.g., rightward across) the surface of virtual object 1107a in three-dimensional environment 1102, and hand 1105b is optionally providing input for moving object 1106a further from the viewpoint of user 1126 and diagonally into (e.g., rightward across) the surface of virtual object 1109a in three-dimensional environment 1102.

In some embodiments, in response to a given amount of hand movement, device 101 moves a first object a different amount in three-dimensional environment 1102 depending on whether the first object is contacting a surface of a second object, and whether the second object is a valid drop target for the first object. For example, in FIG. 11B, the amount of movement of hands 1103b and 1105b is optionally the same. In response, as shown in FIG. 11C, device 101 has moved object 1106a diagonally in three-dimensional environment 1102 more than it has moved object 1104a laterally and/or away from the viewpoint of user 1126 in three-dimensional environment 1102. In particular, in FIG. 11C, in response to the movement of hand 1103b diagonally in three-dimensional environment 1102 which optionally includes a rightward lateral component and a component away from the viewpoint of user 1126, device 101 has resisted (e.g., not allowed) movement of object 1104a away from the viewpoint of user 1126 (e.g., in accordance with the component of the movement of hand 1303b that is away from the viewpoint of user 1126), because object 1104a is in contact with object 1107a and object 1107a is a valid drop target for object 1104a, and the component of movement of hand 1303b away from the viewpoint of user 1126 isn't sufficient to break through object 1107a as will be described later. Further, in FIG. 11C, device 101 has moved object 1104a across the surface of object 1107a (e.g., in accordance with the rightward lateral component of the movement of hand 1303b) by a relatively small amount (e.g., less than the lateral movement of object 1106a) because object 1104a is in contact with object 1107a and object 1107a is a valid drop target for object 1104a. Additionally or alternatively, in FIG. 11C, in response to the movement of hand 1105b, device 101 has moved virtual object 1106a diagonally in three-dimensional environment 1102, such that virtual object 1106a is displayed by device 101 behind virtual objects 1109a and 1107a from the viewpoint of user 1126, as shown in the overhead view in FIG. 11C. Because virtual object 1109a is an invalid drop target for virtual object 1106a, movement of virtual object 1106a diagonally through virtual object 1109a is optionally not resisted by device 101, and the lateral movement of object 1106a and the movement of object 1106a away from the viewpoint of user 1126 (e.g., in accordance with the rightward lateral component of the movement of hand 1105b and in accordance with the component of the movement of hand 1303b that is away from the viewpoint of user 1126, respectively) are greater than the lateral movement of object 1104a and the movement of object 1104a away from the viewpoint of user 1126.

In some embodiments, device 101 requires at least a threshold magnitude of motion of a respective object through an object to allow the respective object to pass through the object when the respective object is contacting the surface of the object. For example, in FIG. 11C, hand 1103c (e.g., in Hand State C) is providing movement input directed to virtual object 1104a for moving virtual object 1104a through the surface of virtual object 1107a from the viewpoint of user 1126. In Hand State C (e.g., while the hand is in a pinch hand shape (e.g., while the thumb and tip of the index finger of the hand are touching)), hand 1103c is optionally providing input for moving object 1104a further from the viewpoint of user 1126 and into (e.g., perpendicularly into) the surface of virtual object 1107a in three-dimensional environment 1102. In response to a first portion of the movement input moving virtual object 1104a into/through virtual object 1107a, device 101 optionally resists movement of virtual object 1104a through virtual object 1107a. As hand 1103c applies greater magnitudes of motion moving virtual object 1104a through virtual object 1107a in a second portion of the movement input, device 101 optionally resists the movement at increasing levels of resistance, which are optionally proportional to the increasing magnitudes of motion. In some embodiments, once the magnitude of motion directed to virtual object 1104a reaches and/or exceeds a respective magnitude threshold (e.g., corresponding to 0.3, 0.5, 1, 2, 3, 5, 10, 20, 40, or 50 cm of movement), device 101 moves virtual object 1104a through virtual object 1107a, as shown in FIG. 11D.

In FIG. 11D, in response to detecting that the movement input directed to virtual object 1104a exceeds the respective magnitude threshold, device 101 forgoes resisting the movement of virtual object 1104a through virtual object 1107a and allows virtual object 1104a to pass through virtual object 1107a. In FIG. 11D, virtual object 1104a is moved by device 101 to a location behind virtual object 1107a in three-dimensional environment 1102, as shown in the overhead view in FIG. 11D. In some embodiments, upon detecting that the movement input directed to virtual object 1104a exceeds the respective magnitude threshold, device 101 provides a visual indication 1116 in three-dimensional environment 1102 (e.g., on the surface of object 1107a at the location through which object 1104a passed) indicating virtual object 1104a has moved through the surface of virtual object 1107a from the viewpoint of user 1126. For example, in FIG. 11D, device 101 displays a ripple 1116 on the surface of virtual object 1107a from the viewpoint of user 1126 indicating that virtual object 1104a has moved through virtual object 1107a in accordance with the movement input.

In some embodiments, device 101 provides a visual indication of the presence of virtual object 1104a behind virtual object 1107a in three-dimensional environment 1102. For example, in FIG. 11D, device 101 alters an appearance of virtual object 1104a and/or an appearance of virtual object 1107a, such that a respective location of virtual object 1104a is identifiable from the viewpoint of user 1126 even though virtual object 1104a is located behind virtual object 1107a in three-dimensional environment 1102. In some embodiments, the visual indication of virtual object 1104a behind virtual object 1107a in three-dimensional environment 1102 is a faded or ghosted version of object 1104a displayed through (e.g., overlaid on) object 1107a, an outline of object 1104a displayed through (e.g., overlaid on) object 1107a, etc. In some embodiments, device 101 increases a transparency of virtual object 1107a to provide the visual indication of the presence of virtual object 1104a behind virtual object 1107a in three-dimensional environment 1102.

In some embodiments, while a respective object is behind an object in three-dimensional environment 1102, lateral movement of the respective object or movement of a respective object further from the viewpoint of user 1126 is unresisted by device 101. For example, in FIG. 11E, if hand 1103d were to provide movement input directed to virtual object 1104a for moving virtual object 1104a laterally rightward to a new location behind virtual object 1107a in three-dimensional environment 1102, device 101 would optionally move object 1104a to the new location without resisting the movement in accordance with the movement input. Further, in some embodiments, device 101 would update display of the visual indication of object 1104a (e.g., the ghost, outline, etc. of virtual object 1104a) in three-dimensional environment 1102 to have a different size based on the updated distance of object 1104a from the viewpoint of user 1126 and/or to have a new portion through the surface of virtual object 1107a that corresponds to the new location of object 1104a behind virtual object 1107a from the viewpoint of user 1126.

In some embodiments, movement of virtual object 1104a from behind virtual object 1107a to a respective location in front of virtual object 1107a (e.g., through virtual object 1107a) from the viewpoint of user 1126 is unresisted by device 101. In FIG. 11D, hand 1103d (e.g., in Hand State D) is providing movement input directed to virtual object 1104a for moving virtual object 1104a from behind virtual object 1107a to a respective location in front of virtual object 1107a from the viewpoint of user 1126 along a path through virtual object 1107a, as shown in FIG. 11E. In Hand State D (e.g., while the hand is in a pinch hand shape (e.g., while the thumb and tip of the index finger of the hand are touching)), hand 1103d is optionally providing input for moving object 1104a closer to the viewpoint of user 1126 and into (e.g., perpendicularly into) a rear surface of virtual object 1107a in three-dimensional environment 1102.

In FIG. 11E, in response to detecting movement of virtual object 1104a from behind virtual object 1107a to in front of virtual object 1107a, device 101 moves virtual object 1104a through virtual object 1107a to a respective location in front of virtual object 1107a in three-dimensional environment 1102 from the viewpoint of user 1126, as shown in the overhead view of FIG. 11E. In FIG. 11E, movement of virtual object 1104a through virtual object 1107a is unresisted by device 101 as virtual object 1104a is moved to the respective location in three-dimensional environment 1102. It should be understood that, in some embodiments, subsequent movement of virtual object 1104a (e.g., in response to movement input provided by hand 1103e) back toward virtual object 1107a in three-dimensional environment 1102 (e.g., away from the viewpoint of user 1126) causes device 101 to resist movement of virtual object 1104a when virtual object 1104a reaches/contacts the surface of virtual object 1107a from the viewpoint of user 1126, as previously described.

In some embodiments, movement of a first virtual object from behind a second virtual object through the second virtual object to a location in front of the second virtual object is unresisted irrespective of whether the second virtual object is a valid drop target for the first virtual object. For example, in FIG. 11E, if virtual object 1106a were moved (e.g., in response to movement input provided by hand 1105c) from behind virtual object 1109a, which is optionally an invalid drop target for virtual object 1106a, through virtual object 1109a to a respective location in front of virtual object 1109a from the viewpoint of user 1126, device 101 would optionally forgo resisting movement of virtual object 1106a through virtual object 1109a to the respective location in front of virtual object 1109a in three-dimensional environment 1102.

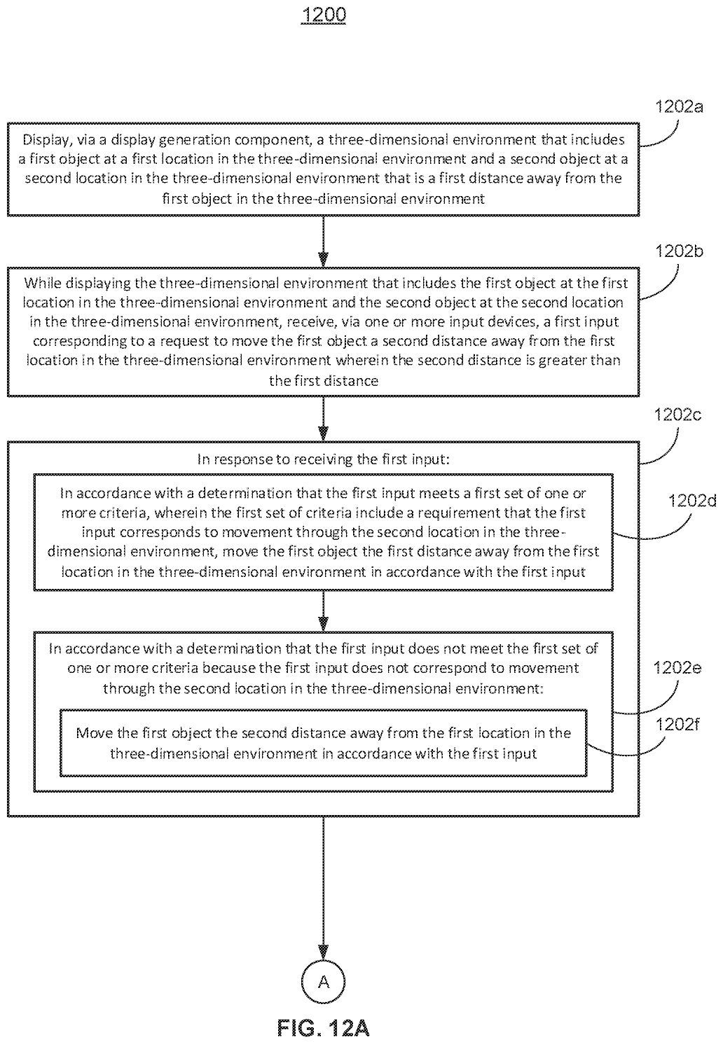

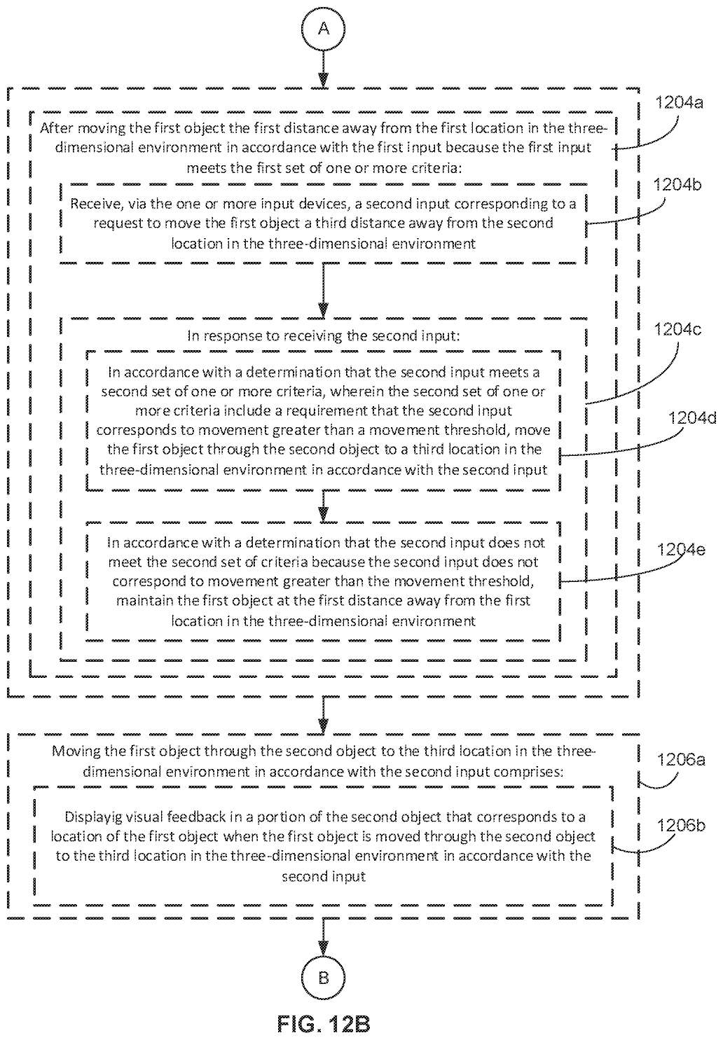

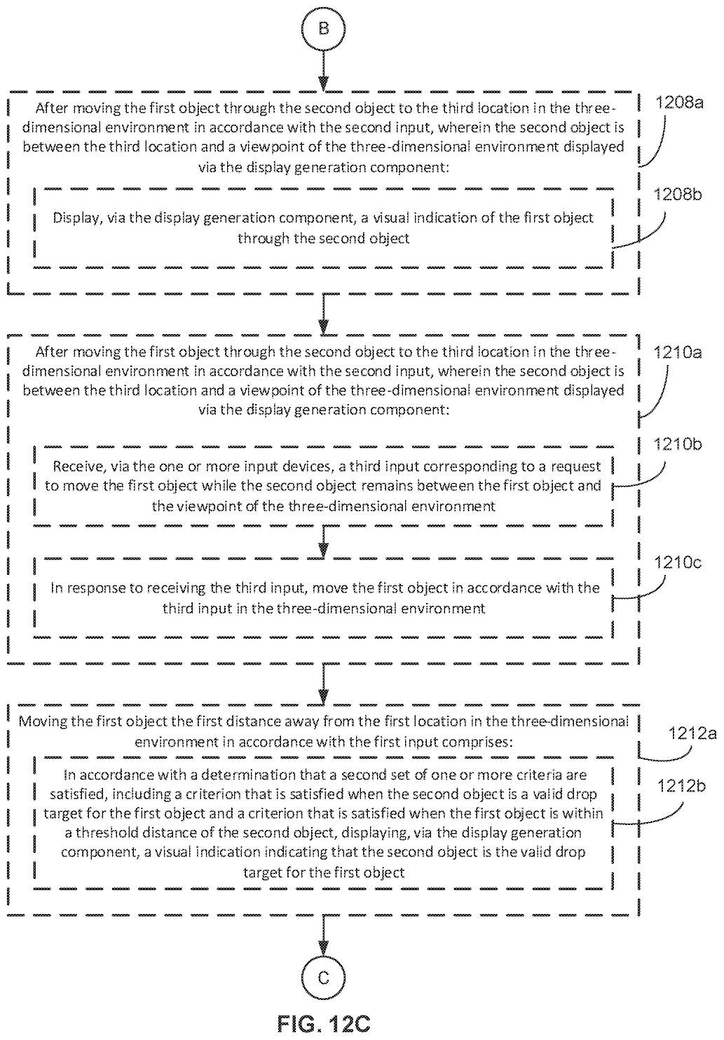

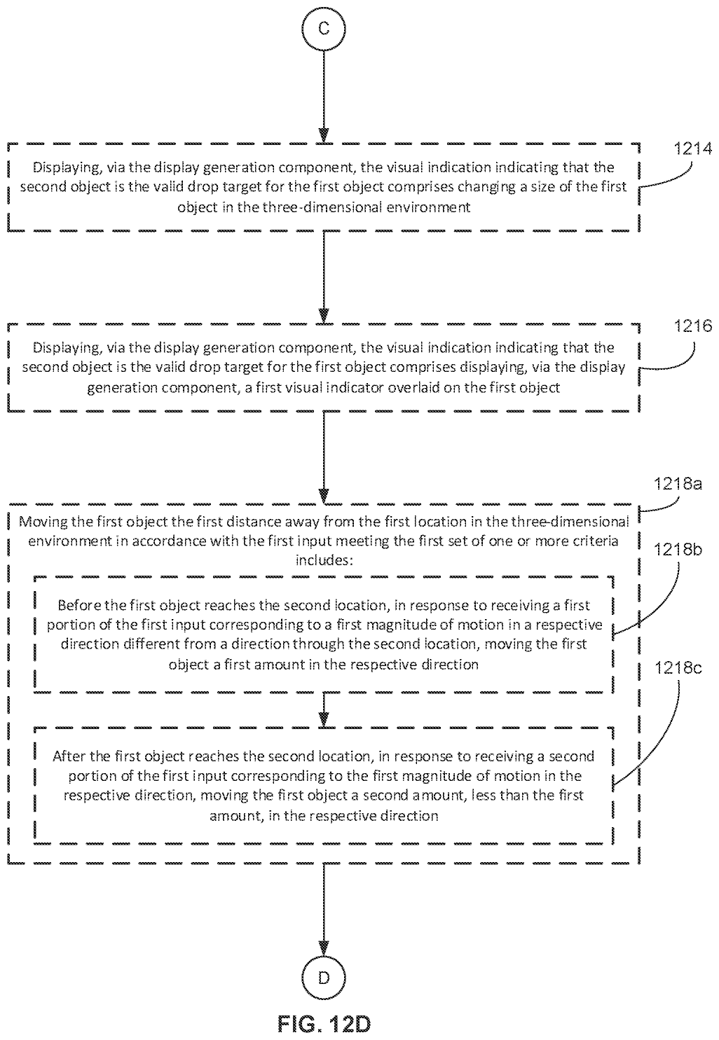

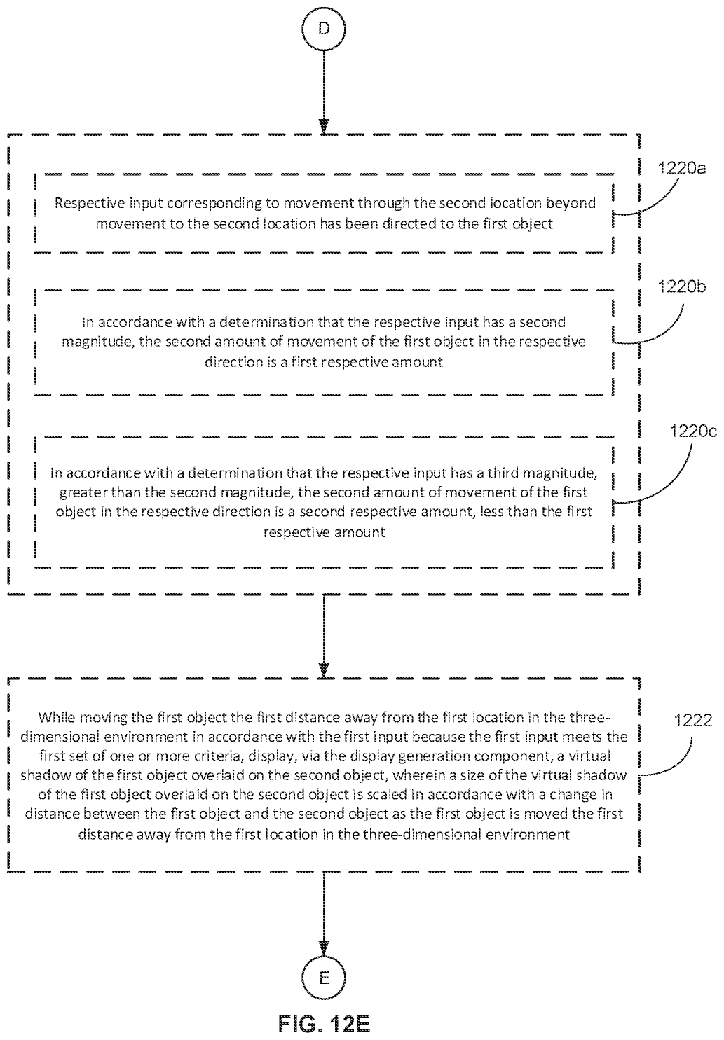

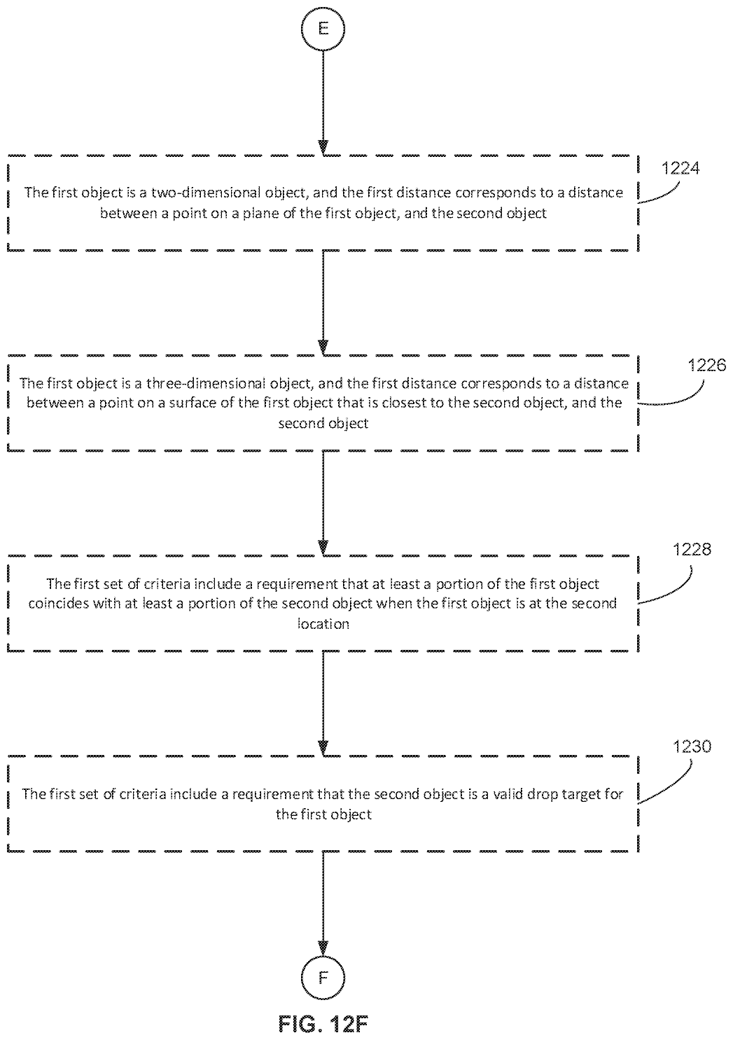

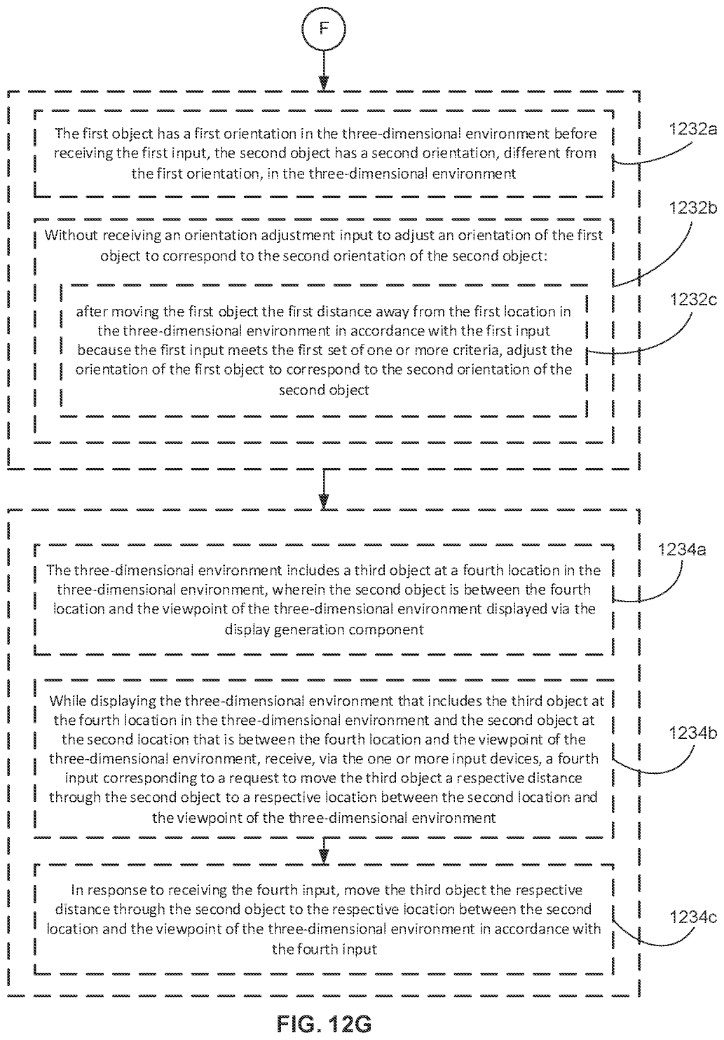

FIGS. 12A-12G is a flowchart illustrating a method 1200 of selectively resisting movement of objects in a three-dimensional environment in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1202a), via the display generation component, a three-dimensional environment (e.g., three-dimensional environment 1102 in FIG. 11A) that includes a first object at a first location in the three-dimensional environment (e.g., virtual objects 1104a and/or 1106a in FIG. 11A) and a second object at a second location in the three-dimensional environment that is a first distance away from the first object in the three-dimensional environment (e.g., virtual object 1107a and/or 1109a in FIG. 11A). In some embodiments, the three-dimensional environment is generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.). For example, the first object is a photograph (or a representation of a photograph) that can be dropped into the second object, which is optionally a container that can accept and/or display the photograph (e.g., the second object is a user interface of a messaging application that includes a text entry field into which the photograph can be dropped to be added to the messaging conversation displayed in the second object) and which is located the first distance (e.g., 1, 2, 3, 5, 10, 12, 24, 26, 50, or 100 cm) away from the first object (e.g., behind the first object from the perspective of the viewpoint of the user of the device in the three-dimensional environment and, therefore, farther than the first object from the viewpoint of the user).

In some embodiments, while displaying the three-dimensional environment that includes the first object at the first location in the three-dimensional environment and the second object at the second location in the three-dimensional environment, the electronic device receives (1202a), via the one or more input devices, a first input corresponding to a request to move the first object a second distance away from the first location in the three-dimensional environment (e.g., to a third location in the three-dimensional environment), wherein the second distance is greater than the first distance, such as movement of virtual object 1104a by hand 1103a and/or movement of virtual object 1106a by hand 1105a in FIG. 11A (e.g., while the gaze of the user is directed to the first object, a pinch gesture of an index finger and thumb of a hand of the user, subsequently followed by movement of the hand in the pinched hand shape toward a third location in the three-dimensional environment, where the third location is optionally a second distance (e.g., 2, 3, 5, 10, 12, 24, 26, or 30 cm) away from the first location, and where the second distance is optionally greater than the first distance. In some embodiments, during the first input, the hand of the user is greater than a threshold distance (e.g., 0.2, 0.5, 1, 2, 3, 5, 10, 12, 24, or 26 cm) from the first object. In some embodiments, the first input is a pinch of the index finger and thumb of the hand of the user followed by movement of the hand in the pinched hand shape toward the third location in the three-dimensional environment, irrespective of the location of the gaze of the user when the hand of the user is less than the threshold distance from the first object. In some embodiments, the first input corresponds to movement of the first object further away from the viewpoint of the user in the three-dimensional environment. In some embodiments, the first input has one or more of the characteristics of the input(s) described with reference to methods 800, 1000, 1400, 1600 and/or 1800.).

In some embodiments, in response to receiving the first input (1202c), in accordance with a determination that the first input meets a first set of one or more criteria, wherein the first set of criteria include a requirement that the first input corresponds to movement through the second location in the three-dimensional environment, such as movement of virtual object 1104a toward virtual object 1107a as shown in FIG. 11A (e.g., the movement of the hand corresponds to movement of the first object sufficiently far and/or through the second location in the three-dimensional environment. In some embodiments, the first set of one or more criteria are not satisfied if movement of the first object is not through the second location in the three-dimensional environment because, for example, the movement is in a direction other than towards the second location), the electronic device moves (1202d) the first object the first distance away from the first location in the three-dimensional environment in accordance with the first input (e.g., movement of virtual object 1104a away from the field of view of user 1126 as shown in FIG. 11B). For example, the first object is moved from the first location in the three-dimensional environment the first distance to the second object at the second location in the three-dimensional environment, and collides with (or remains within a threshold distance of, such as 0.1, 0.2, 0.5, 1, 2, 3, 5, 10, or 20 cm) the second object at the second location, as the first object is being moved toward the third location in the three-dimensional environment. In some embodiments, once the first object collides with the second object, additional movement of the hand corresponding to movement of the first object farther than the first distance optionally does not result in further movement of the first object (e.g., past the second object).

In some embodiments, in accordance with a determination that the first input does not meet the first set of one or more criteria because the first input does not correspond to movement through the second location in the three-dimensional environment (1202e) (e.g., the second location of the second object is not behind the first location of the first object, or the second location of the second object is not in the path between the first location of the first object and the third location (e.g., the movement of the hand does not correspond to movement of the first object towards the second location). In some embodiments, no other object (e.g., no other valid drop target) is in the path between the first location of the first object and the third location associated with the input).), the electronic device moves (12020 the first object the second distance away from the first location in the three-dimensional environment in accordance with the first input (e.g., movement of virtual object 1106a away from the field of view of user 1126 as shown in FIG. 11B). For example, the first object is moved to the second distance away from the first location (e.g., to a third location in the three-dimensional environment) in accordance with the first input, without the movement of the first object being resisted or cut short due to an intervening valid drop target object. Adjusting movement of an object in the three-dimensional environment when that object touches or is within a threshold distance of a valid drop target for that object facilitates user input for adding the object to the drop target and/or facilitates discovery that the drop target is a valid drop target, thereby improving the user-device interaction.

In some embodiments, after moving the first object the first distance away from the first location in the three-dimensional environment in accordance with the first input because the first input meets the first set of one or more criteria (1204a) (e.g., the first object is located at the second location within the three-dimensional environment after being moved away from the first location in the three-dimensional environment and is in contact with (or remains within a threshold distance of, such as 0.1, 0.2, 0.5, 1, 2, 3, 5, 10, or 20 cm) the second object.), the electronic device receives (1204b), via the one or more input devices, a second input corresponding to a request to move the first object a third distance away from the second location in the three-dimensional environment, such as movement of virtual object 1104a by hand 1103c as shown in FIG. 11C (e.g., while the gaze of the user is directed to the first object, a pinch gesture of an index finger and thumb of a hand of the user, subsequently followed by movement of the hand in the pinched hand shape corresponding to movement a third distance away from the second location in the three-dimensional environment. In some embodiments, during the second input, the hand of the user is greater than a threshold distance (e.g., 0.2, 0.5, 1, 2, 3, 5, 10, 12, 24, or 26 cm) from the first object. In some embodiments, the second input is a pinch of the index finger and thumb of the hand of the user followed by movement of the hand in the pinched hand shape irrespective of the location of the gaze of the user when the hand of the user is less than the threshold distance from the first object. In some embodiments, the second input corresponds to movement of the first object further away from the viewpoint of the user in the three-dimensional environment. In some embodiments, the second input has one or more of the characteristics of the input(s) described with reference to methods 800, 1000, 1400, 1600 and/or 1800.).

In some embodiments, in response to receiving the second input (1204c), in accordance with a determination that the second input meets a second set of one or more criteria, wherein the second set of one or more criteria include a requirement that the second input corresponds to movement greater than a movement threshold (e.g., the movement of the hand corresponds to movement of the first object sufficiently far and/or through the second object in the three-dimensional environment. In some embodiments, the second set of one or more criteria are not satisfied if movement of the first object is not sufficiently far and/or through the second object in the three-dimensional environment because, for example, the movement is in a direction other than towards the second object. In some embodiments, the movement threshold corresponds to movement of the first object 1, 3, 5, 10, 20, 40, 50, or 100 cm in the three-dimensional environment if the first object were not in contact with the second object), the electronic device moves (1204d) the first object through the second object to a third location in the three-dimensional environment in accordance with the second input (e.g., movement of virtual object 1104a through virtual object 1107a as shown in FIG. 11D). For example, the first object is moved from the second location in the three-dimensional environment through the second object to a third location in the three-dimensional environment (e.g., to a location behind the second object in the three-dimensional environment from the perspective of the viewpoint of the user).

In some embodiments, in accordance with a determination that the second input does not meet the second set of criteria because the second input does not correspond to movement greater than the movement threshold (e.g., the movement of the hand does not correspond to movement of the first object sufficiently far and/or through the second object in the three-dimensional environment.), the electronic device maintains (1204e) the first object at the first distance away from the first location in the three-dimensional environment (e.g., display of virtual object 1104a as shown in FIG. 11C). For example, the first object is displayed at the second location in the three-dimensional environment and/or in contact with the second object (e.g., the first object is not moved to a location behind the second object in the three-dimensional environment). Resisting movement of the object through the valid drop target for that object facilitates user input for confirming that the object is to be moved through the valid drop target and/or facilitates discover that the object can be moved through the valid drop target, thereby improving user-device interaction.

In some embodiments, moving the first object through the second object to the third location in the three-dimensional environment in accordance with the second input comprises (1206a) displaying visual feedback in a portion of the second object that corresponds to a location of the first object (e.g., changing an appearance of a portion of the second object that is in front of the first object from the viewpoint of the user) when the first object is moved through the second object to the third location in the three-dimensional environment in accordance with the second input (1206b) (e.g., display of visual indication 1116 as shown in FIG. 11D). For example, when the first object is moved to the third location in the three-dimensional environment (e.g., the first object is moved through the second object to a location behind the second object), visual feedback is provided to indicate to the user that the first object has been moved through the second object. In some embodiments, a portion of the second object changes in appearance (e.g., a location of the movement through the second object is displayed with a ripple effect for a threshold amount of time (e.g., 0.5, 0.7, 0.9, 1, 1.5, or 2 seconds) after the first object moves through the second object). Adjusting an appearance of the valid drop target after the object is moved through the valid drop target facilitates discover that the object has been moved behind the valid drop target, thereby improving the user-device interaction.

In some embodiments, after moving the first object through the second object to the third location in the three-dimensional environment in accordance with the second input, wherein the second object is between the third location and a viewpoint of the three-dimensional environment displayed via the display generation component (1208a), the electronic device displays (1208b), via the display generation component, a visual indication of the first object (e.g., a visual indication of a location of the first object) through the second object (e.g., visibility of virtual object 1104a as shown in FIG. 11D). For example, when the first object is moved to the third location in the three-dimensional environment (e.g., the first object is moved through the second object to a location behind the second object), and the second object is between the first object and a viewpoint of the user (e.g., viewing of the first object is obstructed by the second object), a visual indication of the first object is displayed through the second object. In some embodiments, at least a portion of the first object (e.g., an outline of the first object) is displayed through and/or on the second object (e.g., at least a portion of the second object corresponding to the location of the first object is slightly transparent). Adjusting an appearance of the object and/or an appearance of the valid drop target after the object is moved through the valid drop target facilitates user input for additional movement of the object that is now behind the valid drop target and/or facilitates discovery that the object that is behind the valid drop target can continue being moved, thereby improving the user-device interaction.

In some embodiments, after moving the first object through the second object to the third location in the three-dimensional environment in accordance with the second input, wherein the second object is between the third location and a viewpoint of the three-dimensional environment displayed via the display generation component (1210a) (e.g., the first object is located at the third location within the three-dimensional environment after being moved away from the second location in the three-dimensional environment and through the second object. In some embodiments, the second object is between the first object at the third location and a viewpoint of the user (e.g., viewing of the first object is obstructed by the second object).), the electronic device receives (1210b), via the one or more input devices, a third input corresponding to a request to move the first object while the second object remains between the first object and the viewpoint of the three-dimensional environment, such as movement of virtual object 1104a in FIG. 11D (e.g., the gaze of the user continues to be directed to the first object, subsequently followed by movement of the hand in the pinched hand shape away from the third location in the three-dimensional environment. In some embodiments, during the third input, the hand of the user is greater than a threshold distance (e.g., 0.2, 0.5, 1, 2, 3, 5, 10, 12, 24, or 26 cm) from the first object. In some embodiments, the third input is a pinch of the index finger and thumb of the hand of the user followed by movement of the hand in the pinched hand shape away from the third location in the three-dimensional environment, irrespective of the location of the gaze of the user when the hand of the user is less than the threshold distance from the first object. In some embodiments, the third input corresponds to movement of the first object further away from the viewpoint of the user in the three-dimensional environment. In some embodiments, the third input has one or more of the characteristics of the input(s) described with reference to methods 800, 1000, 1400, 1600 and/or 1800.).

In some embodiments, in response to receiving the third input, the electronic device moves (1210c) the first object in accordance with the third input in the three-dimensional environment, as described previously with reference to FIG. 11D. For example, the first object is moved away from the third location in the three-dimensional environment behind the second object to a new location (e.g., a fourth location) in the three-dimensional environment (e.g., to a location further behind the second object in the three-dimensional environment or a location to a side of the second object in the three-dimensional environment). In some embodiments, the second object remains at the second location while the first object is moved away from the third location in the three-dimensional environment. In some embodiments, the first object remains behind the second object in response to the third input (e.g., the third input corresponds to movement of the first object further away from the user and/or further behind the second object. Allowing movement of the object while the object is behind the valid drop target for the object facilitates user input for moving the object back in front of the valid drop target and/or to a new location in the three-dimensional environment, thereby improving the user-device interaction.

In some embodiments, moving the first object the first distance away from the first location in the three-dimensional environment in accordance with the first input comprises (1212a), in accordance with a determination that a second set of one or more criteria are satisfied, including a criterion that is satisfied when the second object is a valid drop target for the first object and a criterion that is satisfied when the first object is within a threshold distance of the second object (e.g., the second object is a valid drop target for the first object, such as an object that can accept and/or contain the first object, and the first object is moved within a threshold distance of the second object, such as 0.5, 1, 1.5, 2, 2.5, 3, or 5 cm. In some embodiments, the second set of one or more criteria are not satisfied if the second object is not a valid drop target for the first object and/or if the first object is not within the threshold distance of the second object), displaying, via the display generation component, a visual indication indicating that the second object is the valid drop target for the first object (1212b) (e.g., badge 1125 in FIGS. 11B and 11C). For example, a visual indication (e.g., a change in appearance of the first object and/or of the second object) is displayed indicating to the user that the second object can accept and/or contain the first object. In some embodiments, the visual indication is displayed within a threshold amount of time (e.g., 0.5, 0.7, 0.9, 1, 1.5, or 2 seconds) after the first object is moved the first distance to the second object at the second location. Providing a visual indication that a drop target in the three-dimensional environment is a valid drop target for the object facilitates user input for adding the object to the valid drop target and/or facilitates discovery that the drop target is a valid drop target, thereby improving the user-device interaction.

In some embodiments, displaying, via the display generation component, the visual indication indicating that the second object is the valid drop target for the first object comprises changing a size of the first object in the three-dimensional environment (1214) (e.g., changing size of virtual object 1104a as shown in FIG. 11B). For example, the visual indication displayed via the display generation component is optionally a change in size of the first object, such as described with reference to method 1000. In some embodiments, when the first object is moved the first distance to the second object, and the second object is a valid drop target for the first object, the first object is scaled down in (e.g., angular) size within the three-dimensional environment. In some embodiments, the first object is not scaled down in (e.g., angular) size within the three-dimensional environment if the second object is not a valid drop target for the first object. Changing a size of the object to indicate that the drop target is a valid drop target for the object facilitates user input for adding the object to and displaying the object within the valid drop target and/or facilitates discovery that the drop target is a valid drop target, thereby improving the user-device interaction.

In some embodiments, displaying, via the display generation component, the visual indication indicating that the second object is the valid drop target for the first object comprises displaying, via the display generation component, a first visual indicator overlaid on the first object (1216) (e.g., badge 1125 in FIGS. 11B and 11C). For example, the visual indication displayed via the display generation component is optionally a badge (e.g., a “+” indicator) overlaid on the first object, where the badge has one or more of the characteristics of the badge described with reference to method 1600. In some embodiments, when the first object is moved the first distance to the second object, and the second object is a valid drop target for the first object, the badge is displayed in a top corner/edge of the first object in the three-dimensional environment. In some embodiments, the badge is not displayed overlaid on the first object if the second object is not a valid drop target for the first object. Displaying a badge overlaid on the object to indicate that the drop target is a valid drop target for the object facilitates user input for adding the object to the valid drop target and/or facilitates discovery that the drop target is a valid drop target, thereby improving the user-device interaction.

In some embodiments, moving the first object the first distance away from the first location in the three-dimensional environment in accordance with the first input meeting the first set of one or more criteria includes (1218a) before the first object reaches the second location, in response to receiving a first portion of the first input corresponding to a first magnitude of motion in a respective direction different from a direction through the second location, such as the diagonal component of the movement of virtual object 1104a by hand 1103b in FIG. 11B (e.g., as the first object is moved the first distance to the second object at the second location in the three-dimensional environment, movement of the hand a first magnitude in the pinched hand shape includes movement in a direction different from a direction through the second location. In some embodiments, the movement of the hand in the pinched hand shape is in a direction parallel to a surface of the second object at the second location and/or has a component of the movement that is parallel to the surface of the second object.), moving the first object a first amount in the respective direction (1218b), such as movement of virtual object 1104a as shown in FIG. 11C (e.g., the first object is moved in the direction of the movement of the hand. In some embodiments, the first object is moved an amount proportional to the first magnitude. In some embodiments, the first object does not yet contact the second object after the first object is moved the first amount in the respective direction.).

In some embodiments, after the first object reaches the second location (e.g., and while the first object remains at the second location in contact with the second object), in response to receiving a second portion of the first input corresponding to the first magnitude of motion in the respective direction, such as the horizontal component of the movement of virtual object 1104a by hand 1103b in FIG. 11B (e.g., after the first object is moved the first distance to the second object at the second location in the three-dimensional environment, movement of the hand in the pinched hand shape includes movement in the direction different from the direction through the second location. In some embodiments, the movement of the hand in the pinched in shape is in the direction parallel to the surface of the object at the second location and/or has a component of the movement that is parallel to the surface of the second object.), the electronic device moves the first object a second amount, less than the first amount, in the respective direction (1218c) (e.g., movement of virtual object 1104a as shown in FIG. 11C). For example, the first object is moved in the direction of the movement of the hand in accordance with the second portion of the first input but is moved less than the first amount during the first portion of the first input. In some embodiments, the movement of the first object is resisted in the respective direction when the first object is contacting the second object, or is moved within a threshold distance of the second object (e.g., 0.5, 1, 1.5, 2, 2.5, 3, or 5 cm), which optionally causes the first object to be moved an amount less than before in the respective direction. Decreasing responsiveness of movement of the object in respective directions different from a direction through the valid drop target for the object facilitates and/or encourages user input for adding the object to the valid drop target, thereby improving user-device interaction.

In some embodiments, respective input corresponding to movement through the second location beyond movement to the second location has been directed to the first object (1220a) (e.g., movement of the hand in the pinched shape corresponds to movement through the second location, such that the respective input corresponds to movement of the first object through the second object. In some embodiments, the respective input corresponds to movement of the hand after the first object has been moved the second amount in the respective direction to the second object. In some embodiments, even after the respective input has been received, the first object remains in contact with the second object (e.g., has not broken through the second object).), in accordance with a determination that the respective input has a second magnitude, the second amount of movement of the first object in the respective direction is a first respective amount (1220b), such as the amount of movement of virtual object 1104a as shown in FIG. 11B (e.g., the movement of the hand in the pinched shape corresponding to movement through the second location (e.g., through the second object) has a second magnitude. In some embodiments, the second magnitude is greater than or less than the first magnitude. In some embodiments, when movement input directed to the first object corresponding to movement through the second object has the second magnitude, without the first object having yet broken through the second object, movement of the hand in the pinched hand shape in a direction parallel to a surface of the second object at the second location and/or having a component of the movement that is parallel to the surface of the second object results in the first object moving laterally on the surface of the second object by the first respective amount. In some embodiments, the first respective amount is less than the first amount. For example, the movement of the first object is resisted in the respective direction when the first object is contacting the second object, or is moved within a threshold distance of the second object (e.g., 0.5, 1, 1.5, 2, 2.5, 3, or 5 cm). In some embodiments, the first object is moved in the respective direction a first respective amount that is proportional to the first magnitude and/or inversely proportional to the second magnitude.).

In some embodiments, in accordance with a determination that the respective input has a third magnitude, greater than the second magnitude, the second amount of movement of the first object in the respective direction is a second respective amount, less than the first respective amount (1220c), such as the amount of movement of virtual object 1104a as shown in FIG. 11C (e.g., the movement of the hand in the pinched shape corresponding to movement through the second location (e.g., through the second object) has a third magnitude. In some embodiments, the third magnitude is greater than the second magnitude. In some embodiments, when movement input directed to the first object corresponding to movement through the second object has the third magnitude, without the first object having yet broken through the second object, movement of the hand in the pinched hand shape in a direction parallel to a surface of the second object at the second location and/or having a component of the movement that is parallel to the surface of the second object results in the first object moving laterally on the surface of the second object by the second respective amount, less than the first respective amount. For example, the movement of the first object is resisted a greater amount in the respective direction when the first object is contacting the second object, or is moved within a threshold distance of the second object (e.g., 0.5, 1, 1.5, 2, 2.5, 3, or 5 cm), which optionally causes the first object to be moved an amount less than it would have moved before (e.g., when the respective input has the second magnitude) in the respective direction. In some embodiments, the first object is moved in the respective direction a second respective amount that is proportional to the first magnitude and/or inversely proportional to third magnitude. For example, movement of the first object in the respective direction is optionally resisted at greater levels the harder (e.g., the farther) the first object is moved into the second location and/or second object.). Increasing resistance to movement of the object along the surface of the drop target for the object facilitates and/or encourages user input for adding the object to the drop target and/or facilitates discovery that the drop target is a valid drop target for the object, thereby improving user-device interaction.

In some embodiments, while moving the first object the first distance away from the first location in the three-dimensional environment in accordance with the first input because the first input meets the first set of one or more criteria, the electronic device displays (1222), via the display generation component, a virtual shadow of the first object overlaid on the second object, wherein a size of the virtual shadow of the first object overlaid on the second object is scaled in accordance with a change in distance between the first object and the second object as the first object is moved the first distance away from the first location in the three-dimensional environment (e.g., display of the shadow of virtual object 1104a as shown in FIG. 11A). For example, as the first object is moved the first distance away from the first location in the three-dimensional environment because the first input meets the first set of one or more criteria (e.g., the first input corresponds to movement through the second location), a virtual shadow of the first object is displayed on the second object. In some embodiments, the size of the virtual shadow of the first object is optionally scaled according to a change in distance between the first object and the second object. For example, as the first object is moved closer to the second object from the first location in the three-dimensional environment, a size of the virtual shadow of the first object overlaid on the second object decreases; thus, the shadow optionally indicates the distance between the first object and the second object. Displaying a shadow of an object overlaid on a potential drop target for the object as the object is moved toward the drop target provides a visual indication of distance from the object to the drop target and/or provides visual guidance for facilitating movement of the object to the drop target, thereby improving user-device interaction.

In some embodiments, the first object is a two-dimensional object, and the first distance corresponds to a distance between a point on a plane of the first object, and the second object (1224), (e.g., a distance between a point on the surface of virtual object 1104a and a point on the surface of virtual object 1107a in FIG. 11A). For example, the first object in the three-dimensional environment is optionally a two-dimensional object (e.g., a photograph). In some embodiments, the first distance between the first object and the second object is defined by a distance between a point (e.g., an x,y coordinate) on a plane of the two-dimensional first object and a point on a plane of the second object (e.g., if the second object is also a two-dimensional object). For example, if the second object is a three-dimensional object, the point on the second object corresponds to a point on a surface of the second object that is closest to the first object (e.g., the point on the second object that will first collide/come into contact with the first object as the first object is moved back towards the second object). Adjusting movement of a two-dimensional object in the three-dimensional environment when that two-dimensional object touches or is within a threshold distance of a potential drop target for that two-dimensional object facilitates user input for adding the two-dimensional object to the drop target and/or facilitates discovery that the drop target is a valid drop target, thereby improving the user-device interaction.

In some embodiments, the first object is a three-dimensional object, and the first distance corresponds to a distance between a point on a surface of the first object that is closest to the second object, and the second object (1226), such as a distance between a point on a surface of virtual object 1104a that is closest to virtual object 1107a and a point on the surface of virtual object 1107a in FIG. 11A. For example, the first object in the three-dimensional environment is optionally a three-dimensional object (e.g., a model of a cube). In some embodiments, the first distance between the first object and the second object is defined by a distance between a point (e.g., an x,y coordinate) on a surface of the first object that is closest to the second object (e.g., a point on a respective side of the cube, such as a point on the first object that will first collide/come into contact with the second object as the first object is moved back towards the second object), and a point on a plane of the second object (e.g., if the second object is a two-dimensional object). For example, if the second object is a three-dimensional object, the point on the second object corresponds to a point on a surface of the second object that is closest to the first object (e.g., closest to the respective side of the cube, such as a point on the second object that will first collide/come into contact with the first object as the first object is moved back towards the second object). Adjusting movement of a three-dimensional object in the three-dimensional environment when that three-dimensional object touches or is within a threshold distance of a potential drop target for that three-dimensional object facilitates user input for adding the three-dimensional object to the drop target and/or facilitates discovery that the drop target is a valid drop target, thereby improving the user-device interaction.

In some embodiments, the first set of criteria include a requirement that at least a portion of the first object coincides with at least a portion of the second object when the first object is at the second location (1228), such as overlap of virtual object 1104a with virtual object 1107a as shown in FIG. 11B. For example, the first set of criteria includes a requirement that at least a portion of the first object overlaps with at least a portion of the second object at the second location in the three-dimensional environment when the first object is moved to the second location in the three-dimensional environment. In some embodiments, the requirement is not met when at least a portion of the first object does not overlap with at least a portion of the second object at the second location in the three-dimensional environment. In some embodiments, the first set of criteria is satisfied when only a portion of the first object coincides with/comes into contact with the second object, even if other portions of the first object do not. Imposing a requirement that an object must at least partially overlap a potential drop target in order for the drop target to accept the object and/or affect the movement of the object facilitates user input for adding the object to the drop target, thereby improving the user-device interaction.

In some embodiments, the first set of criteria include a requirement that the second object is a valid drop target for the first object (1230) (e.g., virtual object 1107a being a valid drop target for object 1104a in FIG. 11A). For example, the first set of criteria includes a requirement that the second object is a valid drop target for the first object, such as an object that can accept and/or contain the first object. In some embodiments, the requirement is not met when the second object is an invalid drop target for the first object, such as an object that cannot accept and/or contain the first object. Additional details of valid and invalid drop targets are described with reference to methods 1000, 1400, 1600 and/or 1800. Imposing a requirement that a drop target must be a valid drop target in order for the drop target to affect the movement of the object facilitates user input for adding the object to drop targets that are valid drop targets, and avoids movement of the object to drop targets that are not valid drop targets, thereby improving user-device interaction.

In some embodiments, the first object has a first orientation (e.g., pitch, yaw and/or roll) in the three-dimensional environment before receiving the first input (e.g., the orientation of virtual object 1104a in FIG. 11A), the second object has a second orientation (e.g., pitch, yaw and/or roll), different from the first orientation, in the three-dimensional environment (1232a), such as the orientation of virtual object 1107a in FIG. 11A (e.g., the first object has an initial orientation (e.g., vertical, tilted, etc.) at the first location in the three-dimensional environment relative to the viewpoint of the user in the three-dimensional environment, and the second object has an initial orientation, different from the initial orientation of the first object, at the second location in the three-dimensional environment relative to the viewpoint of the user in the three-dimensional environment. For example, the first and second objects are not parallel to one another and/or are rotated with respect to one another).

In some embodiments, without receiving an orientation adjustment input to adjust an orientation of the first object to correspond to the second orientation of the second object (1232b) (e.g., as the first object is moved the first distance away from the first location in the three-dimensional environment and to the second object at the second location in the three-dimensional environment, no input is received to intentionally change the orientation of the first object to align to the orientation of the second object (e.g., no input is received to make the first and second objects parallel to one another and/or no input is received to make the first and second objects not rotated with respect to one another). In some embodiments, the orientation of the first object maintains its initial orientation as the first object is moved the first distance away from the first location, and the orientation of the second object maintains its initial orientation as the first object is moved the first distance away from the first location. In some embodiments, the orientation (e.g., pitch, yaw and/or roll) of the first object is changed in response to and/or during the first input because the first input includes input intentionally changing the orientation of the first object, but the change in orientation in response to or during that input is not the same as the change in orientation that occurs when the first object contacts (or remains with a threshold distance of, such as 0.1, 0.2, 0.5, 1, 2, 3, 5, 10, or 20 cm) the second object. In other words, the input changing the orientation of the first object does not intentionally change the orientation of the first object to align to the orientation of the second object.), after moving the first object the first distance away from the first location in the three-dimensional environment in accordance with the first input because the first input meets the first set of one or more criteria (e.g., the first object is located at the second location and/or second object in the three-dimensional environment after being moved the first distance away from the second location in the three-dimensional environment because the first input corresponded to movement of the first object through the second location in the three-dimensional environment.), the electronic device adjusts (1232c) the orientation of the first object to correspond to (e.g., align to) the second orientation of the second object (e.g., adjusting the orientation of virtual object 1104a to correspond to the orientation of virtual object 1107a as shown in FIG. 11B). For example, the first object is in contact with (or remains within a threshold distance of, such as 0.1, 0.2, 0.5, 1, 2, 3, 5, 10, or 20 cm) the second object. In some embodiments, the first object aligns to the second object, such that a current orientation of the first object at the second location in the three-dimensional environment corresponds to the current orientation of the second object, without adjusting the orientation of the second object. For example, the first object orientation is changed such that the first object becomes parallel to the second object and/or is no longer rotated with respect to the second object. In some embodiments, the current orientation of the second object is the initial orientation of the second object. Aligning an orientation of an object to an orientation of a potential drop target when the object is moved to the drop target facilitates user input for adding the object to the drop target and/or facilitates discovery that the drop target is a valid drop target for the object, thereby improving user-device interaction.

In some embodiments, the three-dimensional environment includes a third object at a fourth location in the three-dimensional environment, wherein the second object is between the fourth location and the viewpoint of the three-dimensional environment displayed via the display generation component (1234a), such as virtual object 1104a in FIG. 11D (e.g., the three-dimensional environment includes a third object, which is optionally a photograph (or a representation of a photograph) and which is located at the fourth location in the three-dimensional environment. In some embodiments, the fourth location a third distance (e.g., 1, 2, 3, 5, 10, 12, 24, 26, 50, or 100 cm) away from the second object (e.g., behind the second object from the perspective of the viewpoint of the user of the device in the three-dimensional environment and, therefore, farther than the second object from the viewpoint of the user). In some embodiments, the third object was initially pushed through the second object to the fourth location in the three-dimensional environment from a respective location in front of the second object, and in some embodiments, the third object was not initially pushed through the second object to the fourth location in the three-dimensional environment.).

In some embodiments, while displaying the three-dimensional environment that includes the third object at the fourth location in the three-dimensional environment and the second object at the second location that is between the fourth location and the viewpoint of the three-dimensional environment, the electronic device receives (1234b), via the one or more input devices, a fourth input corresponding to a request to move the third object a respective distance through the second object to a respective location (e.g., to a fifth location in the three-dimensional environment) between the second location and the viewpoint of the three-dimensional environment, such as movement of virtual object 1104a by hand 1103d in FIG. 11D (e.g., while the gaze of the user is directed to the third object, a pinch gesture of an index finger and thumb of a hand of the user, subsequently followed by movement of the hand in the pinched hand shape toward a fifth location in the three-dimensional environment, where the fifth location is optionally located between the second location in the three-dimensional environment and the viewpoint of the three-dimensional environment. In some embodiments, during the fourth input, the hand of the user is greater than a threshold distance (e.g., 0.2, 0.5, 1, 2, 3, 5, 10, 12, 24, or 26 cm) from the third object. In some embodiments, the fourth input is a pinch of the index finger and thumb of the hand of the user followed by movement of the hand in the pinched hand shape toward the fifth location in the three-dimensional environment, irrespective of the location of the gaze of the user when the hand of the user is less than the threshold distance from the third object. In some embodiments, the fourth input corresponds to movement of the third object toward the viewpoint of the user in the three-dimensional environment. In some embodiments, the respective distance corresponds to an amount of the movement of the hands of the user during the fourth input. In some embodiments, the fourth input has one or more of the characteristics of the input(s) described with reference to methods 800, 1000, 1400, 1600 and/or 1800.).

In some embodiments, in response to receiving the fourth input, the electronic device moves (1234c) the third object the respective distance through the second object to the respective location between the second location and the viewpoint of the three-dimensional environment in accordance with the fourth input (e.g., movement of virtual object 1104a as shown in FIG. 11E). For example, the third object is moved from the fourth location in the three-dimensional environment through the second object to the fifth location in the three-dimensional environment (e.g., to a location in front of the second object in the three-dimensional environment from the perspective of the viewpoint of the user). In some embodiments, movement of the third object from behind the second object to in front of the second object in the three-dimensional environment is optionally unresisted, such that the movement of the third object is not halted when the third object contacts or is within a threshold distance (e.g., 0.1, 0.2, 0.5, 1, 2, 3, 5, 10, or 20 cm) of a rear surface of the second object, and the respective distance that the third object moves in the three-dimensional environment towards the viewpoint of the user is the same as the distance that the third object would have moved in the three-dimensional environment had the same fourth input been detected while the second object (e.g., and no other object) was not between the fourth location and the respective location (e.g., the fourth input was not an input for moving the third object through another object). Thus, in some embodiments, the third object moves in the three-dimensional environment as if it were unobstructed. Forgoing adjustment of movement of an object in the three-dimensional environment when that object touches or is within a threshold distance of a rear surface of a drop target facilitates easy movement of the object to within clear view of the user, which facilitates further input for moving the object to a respective location in the three-dimensional environment, thereby improving the user-device interaction.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

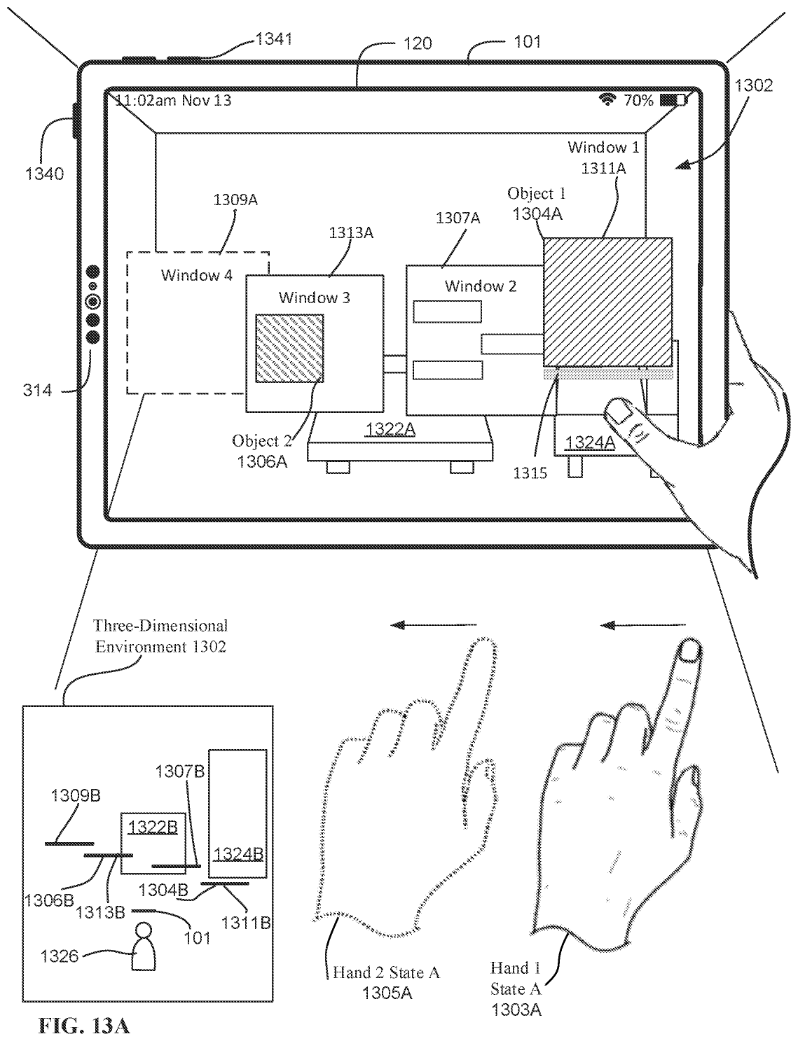

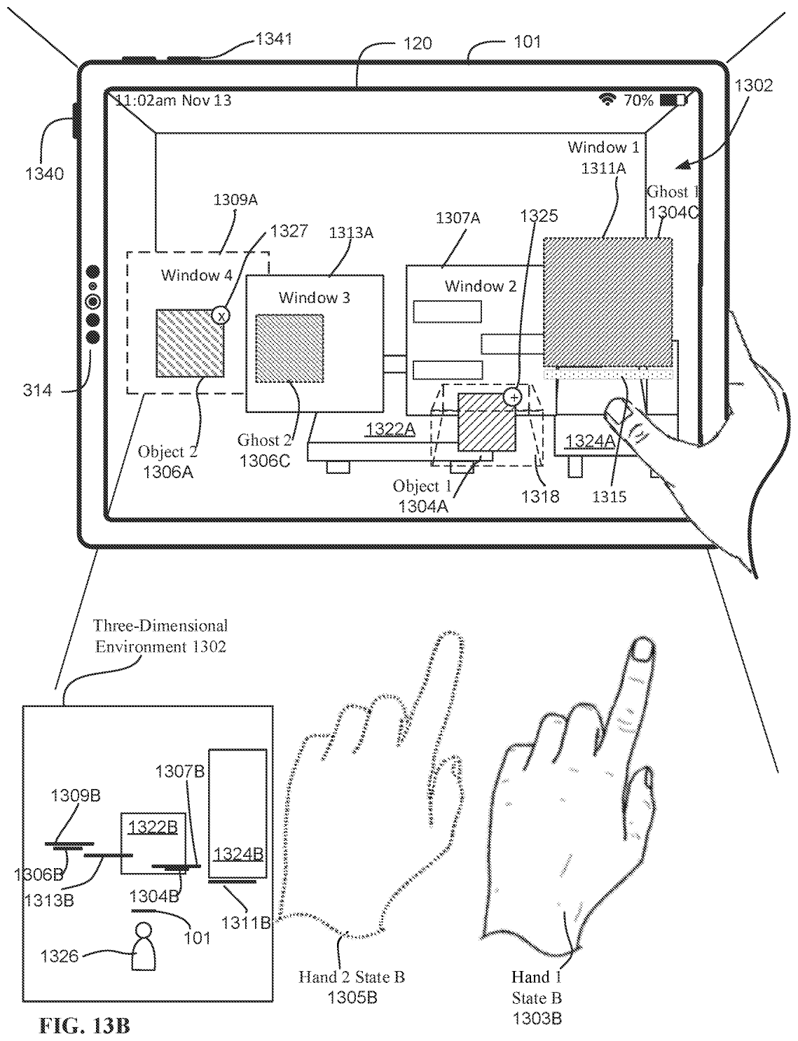

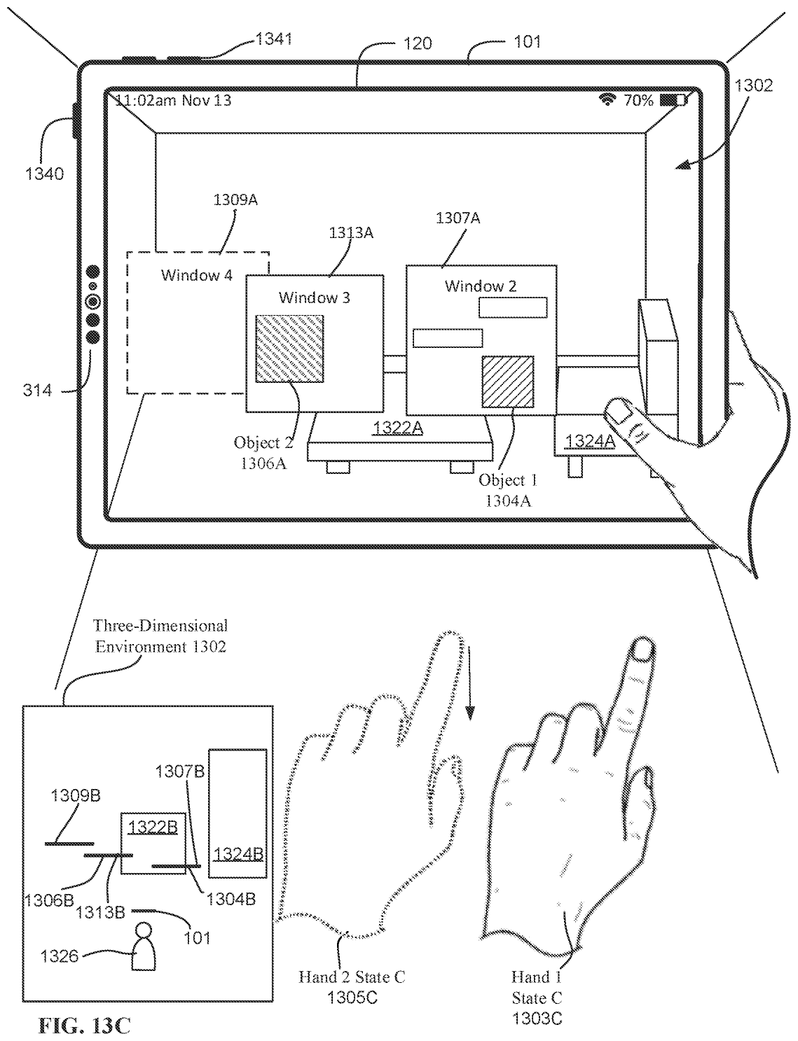

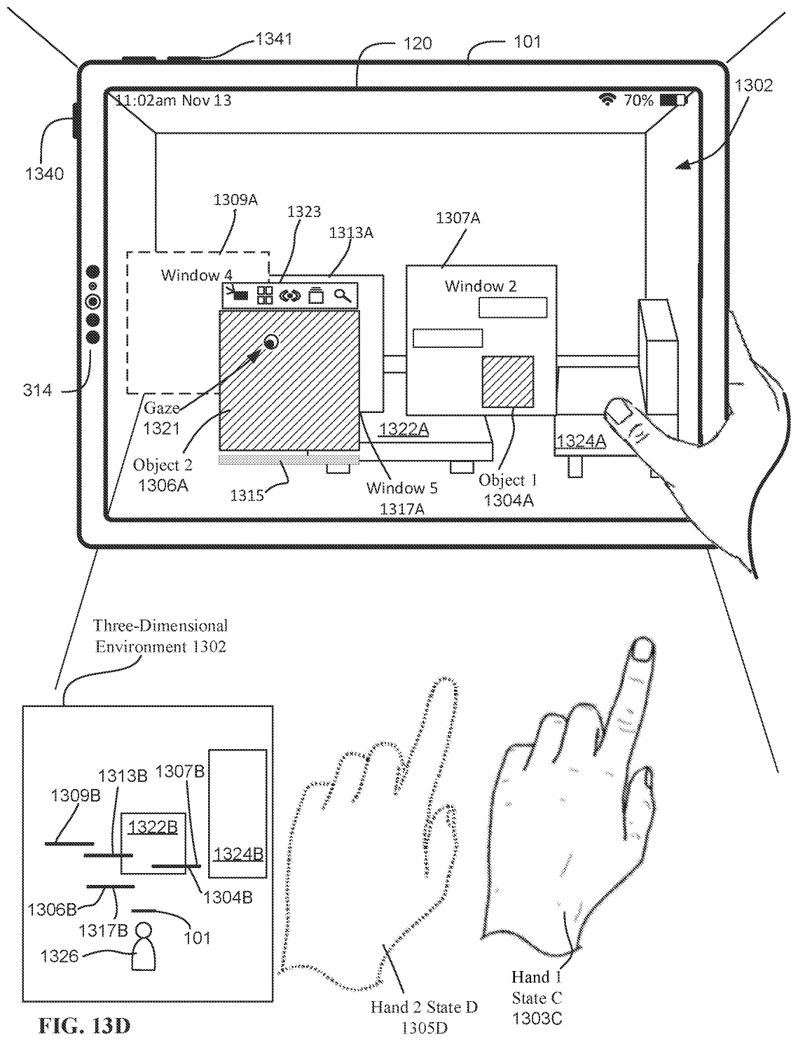

FIGS. 13A-13D illustrate examples of an electronic device selectively adding respective objects to objects in a three-dimensional environment in accordance with some embodiments.

FIG. 13A illustrates an electronic device 101 displaying, via a display generation component (e.g., display generation component 120 of FIG. 1), a three-dimensional environment 1302 from a viewpoint of the user 1326 illustrated in the overhead view (e.g., facing the back wall of the physical environment in which device 101 is located). As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user). Device 101 optionally includes one or more buttons (e.g., physical buttons), which are optionally a power button 1340 and volume control buttons 1341.

As shown in FIG. 13A, device 101 captures one or more images of the physical environment around device 101 (e.g., operating environment 100), including one or more objects in the physical environment around device 101. In some embodiments, device 101 displays representations of the physical environment in three-dimensional environment 1302. For example, three-dimensional environment 1302 includes a representation 1322a of a coffee table (corresponding to table 1322b in the overhead view), which is optionally a representation of a physical coffee table in the physical environment, and three-dimensional environment 1302 includes a representation 1324a of sofa (corresponding to sofa 1324b in the overhead view), which is optionally a representation of a physical sofa in the physical environment.

In FIG. 13A, three-dimensional environment 1302 also includes virtual objects 1304a (e.g., Object 1, corresponding to object 1304b in the overhead view), 1306a (e.g., Object 2, corresponding to object 1306b in the overhead view), 1307a (e.g., Window 2, corresponding to object 1307b in the overhead view), 1309a (e.g., Window 4, corresponding to object 1309b in the overhead view), 1311a (e.g., Window 1, corresponding to object 1311b in the overhead view) and 1313a (e.g., Window 3, corresponding to object 1313b in the overhead view). Virtual object 1311a is optionally containing and/or displaying virtual object 1304a, and virtual object 1313a is optionally containing and/or displaying virtual object 1306a. Virtual object 1311a is optionally located in empty space in three-dimensional environment 1302 and is a quick look window displaying virtual object 1304a, which is optionally a two-dimensional photograph, as will be described in more detail below and with reference to method 1400. In FIG. 13A, virtual object 1311a is displayed with a respective user interface element 1315, which is optionally a grabber or handlebar, that is selectable (e.g., by user 1326) to cause device 101 to initiate movement of virtual object 1311a containing virtual object 1304a in three-dimensional environment 1302. Virtual object 1313a is optionally a user interface of an application (e.g., web browsing application) containing virtual object 1306a, which is optionally also a representation of a two-dimensional photograph. In FIG. 13A, because virtual object 1309a is not a quick look window, virtual object 1309a is not displayed with the respective user interface element 1315.

In some embodiments, virtual object 1307a is a valid drop target for virtual object 1304a and/or virtual object 1311a, and virtual object 1309a is an invalid drop target for virtual object 1306a. For example, virtual object 1307a is a user interface of an application (e.g., messaging user interface) that is configured to accept and/or display virtual object 1304a to add virtual object 1304a to the conversation displayed on the messaging user interface. Virtual object 1309a is optionally a user interface of an application (e.g., content browsing user interface) that cannot accept and/or display virtual object 1306a. In some embodiments, virtual objects 1304a and 1306a are optionally one or more of three-dimensional objects (e.g., virtual clocks, virtual balls, virtual cars, etc.), two-dimensional objects, user interfaces of applications, or any other element displayed by device 101 that is not included in the physical environment of device 101.

In some embodiments, device 101 selectively adds respective objects (and/or contents of the respective objects) to other objects in three-dimensional environment 1302; for example, device 101 adds a first object (and/or the contents of the first object) to a second object in response to movement of the first object to the second object in three-dimensional environment 1302. In some embodiments, device 101 adds a first object (and/or the contents of the first object) to another object in accordance with a determination that the other object is a valid drop target for the first object. In some embodiments, device 101 forgoes adding the first object (and/or the contents of the first object) to another object in accordance with a determination that the other object is an invalid drop target for the first object. Additional details about the above object movements are provided below and with reference to method 1400.

In FIG. 13A, hand 1303a (e.g., in Hand State A) is providing movement input directed to object 1311a, and hand 1305a (e.g., in Hand State A) is providing movement input to object 1306a. In Hand State A, hand 1303a is optionally providing input for moving object 1311a toward virtual object 1307a for adding the contents of object 1311a (e.g., object 1304a) to object 1307a in three-dimensional environment 1302, and hand 1305a is optionally providing input for moving object 1306a toward virtual object 1309a for adding virtual object 1306a to object 1309a in three-dimensional environment 1302. In some embodiments, such movement inputs include the hand of the user moving while the hand is in a pinch hand shape (e.g., while the thumb and tip of the index finger of the hand are touching). For example, from FIGS. 13A-13B, device 101 optionally detects hand 1303a move horizontally relative to the body of the user 1326 while in the pinch hand shape, and device 101 optionally detects hand 1305a move horizontally relative to the body of the user 1326 while in the pinch hand shape. In some embodiments, hand 1303a provides movement input directed directly to virtual objects 1304a and/or 1311a (e.g., toward the surfaces of virtual objects 1304a and/or 1311a), and in some embodiments, hand 1303a provides movement input directed to respective user interface element 1315. It should be understood that while multiple hands and corresponding inputs are illustrated in FIGS. 13A-13D, such hands and inputs need not be detected by device 101 concurrently; rather, in some embodiments, device 101 independently responds to the hands and/or inputs illustrated and described in response to detecting such hands and/or inputs independently.

In response to the movement inputs detected in FIG. 13A, device 101 moves objects 1304a and 1306a in three-dimensional environment 1302 accordingly, as shown in FIG. 13B. In FIG. 13A, hands 1303a and 1305a optionally have different magnitudes of movement in the direction of each hand's respective target; for example, a magnitude of movement of hand 1303a moving object 1304a to object 1307a is optionally larger than a magnitude of movement of hand 1305a moving object 1306a to object 1309a in three-dimensional environment 1302. In response to the given magnitude of the movement of hand 1303a, device 101 has moved object 1304a horizontally relative to the viewpoint of user 1326 to virtual object 1307a in three-dimensional environment 1302, as shown in the overhead view in FIG. 13B. In response to the given magnitude of the movement of hand 1305a, device 101 has removed object 1306a from object 1313a, and has moved object 1306a a distance smaller than the distance covered by object 1304a, as shown in the overhead view in FIG. 13B. As discussed above, virtual object 1307a is optionally a valid drop target for virtual object 1304a, and virtual object 1309a is optionally an invalid drop target for virtual object 1306a. Accordingly, as virtual object 1304a is moved by device 101 in the direction of virtual object 1307a in response to the given magnitude of the movement of hand 1303a, when virtual object 1304a reaches/contacts at least a portion of the surface of virtual object 1307a, device 101 initiates addition of virtual object 1304a to virtual object 1307a, as discussed below. On the other hand, as virtual object 1306a is moved by device 101 in the direction of virtual object 1309a in response to the given magnitude of movement of hand 1305a, when virtual object 1306a reaches/contacts at least a portion of the surface of virtual object 1309a, device 101 forgoes initiating addition of virtual object 1306a to virtual object 1309a, as discussed below.

In some embodiments, while device 101 is moving a respective virtual object in response to movement input directed to the respective virtual object, device 101 displays a ghost representation of the respective virtual object at the original location of the respective virtual object in three-dimensional environment 1302. For example, in FIG. 13B, as device 101 moves virtual object 1304a (e.g., Object 1) and/or virtual object 1311a (e.g., Window 1) in accordance with the movement input provided by hand 1303a, device 101 displays representation 1304c, which is optionally a ghost or faded representation of virtual object 1304a, in virtual object 1311a. Similarly, in FIG. 13B, after device 101 removes virtual object 1306a (e.g., Object 2) from virtual object 1313a (e.g., Window 3) in accordance with the movement input provided by hand 1305a, device 101 displays representation 1306c, which is optionally a ghost or faded representation of virtual object 1306a, in virtual object 1309a. In some embodiments, the ghost representation of a respective virtual object is displayed at a respective location in three-dimensional environment 1302 corresponding to a location of the respective virtual object prior to movement of the respective virtual object. For example, in FIG. 13B, representation 1304c is displayed at a respective location of virtual object 1304a (e.g., as shown in FIG. 13A) prior to movement of virtual object 1304a in three-dimensional environment 1302. Likewise, representation 1306c is displayed in virtual object 1309a at a respective location of virtual object 1306a (e.g., as shown in FIG. 13A) prior to movement of virtual object 1306a in three-dimensional environment 1302.

Further, in some embodiments, device 101 alters display of objects in three-dimensional environment 1302 during movement of the objects in three-dimensional environment 1302. For example, as described above, virtual object 1311a (e.g., Window 1) is optionally a quick look window displaying object 1304a. Virtual object 1311a optionally serves as a temporary placeholder for object 1304a in three-dimensional environment 1304a. Accordingly, during movement of virtual object 1311a and/or virtual object 1304a in three-dimensional environment 1302, as shown in FIG. 13B, device 101 alters an appearance of virtual object 1311a in three-dimensional environment 1302. For example, device 101 fades or ceases display of grabber/handlebar 1315 in three-dimensional environment 1302.

In some embodiments, objects that are drop targets include and/or are associated with drop zones configured to accept/receive the respective objects. For example, in FIG. 13B, virtual object 1307a includes drop zone 1318 that extends from the surface of object 1307a toward the viewpoint of user 1326. Drop zone 1318 is optionally a volume in three-dimensional environment 1302 into which objects to be added to object 1307a can be dropped to add those objects to object 1307a, such as the movement of object 1304a/1311a to within drop zone 1318 in FIG. 13B. In some embodiments, drop zone 1318 is displayed in three-dimensional environment 1302 (e.g., the outline and/or the volume of drop zone are displayed in three-dimensional environment 1302, and in some embodiments, drop zone 1318 is not displayed in three-dimensional environment 1302). In some embodiments, device 101 resizes object 1304a to correspond to the size of drop zone 1318 when virtual object 1304a is moved within the drop zone 1318, as shown in FIG. 13B. Additional details of valid and invalid drop targets, and associated indications that are displayed and other responses of device 101, are described with reference to methods 1000, 1200, 1400 and/or 1600.

Further, in some embodiments, when a respective object is moved to within the threshold distance of the surface of an object (e.g., physical or virtual), device 101 displays a badge on the respective object that indicates whether the object is a valid or invalid drop target for the respective object. In FIG. 13B, object 1307a is a valid drop target for object 1304a; therefore, device 101 displays badge 1325 overlaid on the upper-right corner of object 1304a that indicates that object 1307a is a valid drop target for object 1304a when virtual object 1304a is moved within a threshold distance (e.g., 0.1, 0.5, 1, 3, 6, 12, 24, 36, or 48 cm) of the surface and/or drop zone 1318 of virtual object 1307a. In some embodiments, the badge 1325 includes one or more symbols or characters (e.g., a “+” sign indicating virtual object 1307a is a valid drop target for virtual object 1304a). In FIG. 13B, object 1309a is an invalid drop target for object 1306a; therefore, device 101 displays badge 1327 overlaid on the upper-right corner of object 1306a that indicates that object 1309a is an invalid drop target for object 1306a when virtual object 1306a is moved within a threshold distance (e.g., 0.1, 0.5, 1, 3, 6, 12, 24, 36, or 48 cm) of the surface and/or drop zone 1318 of virtual object 1309a. In some embodiments, the badge 1327 includes one or more symbols or characters (e.g., a “x” symbol or “−” sign) indicating virtual object 1309a is an invalid drop target for virtual object 1306a.

Further, in some embodiments, when a respective object is moved to within a threshold distance of an object (e.g., within a threshold distance of a drop zone of an object), device 101 selectively resizes the respective object depending on whether the object is a valid or invalid drop target for the respective object. For example, in FIG. 13B, virtual object 1304a is scaled down (or up) in (e.g., angular) size in three-dimensional environment 1302 when virtual object 1304a is moved to within a threshold distance (e.g., 0.1, 0.5, 1, 3, 6, 12, 24, 36, or 48 cm) of the surface and/or drop zone 1318 of virtual object 1307a, which is a valid drop target for object 1304a. The size to which object 1304a is scaled is optionally based on the size of object 1307a and/or the size of the region (e.g., drop zone 1318) within object 1307a that is able to accept object 1304a (e.g., the larger that object 1307a is, the larger the scaled size of object 1304a is). On the other hand, as shown in FIG. 13B, device 101 does not resize virtual object 1306a in three-dimensional environment 1302 when virtual object 1306a is moved to within the threshold distance of the surface and/or a drop zone of virtual object 1309a, which is an invalid drop target for object 1306a.

In some embodiments, device 101 selectively initiates addition of a first object to a second object depending on whether the second object is a valid drop target for the first object. For example, in FIG. 13B, hand 1303b (e.g., in Hand State B) is providing an input corresponding to a release of object 1304a (e.g., Hand State B corresponds to the state of the hand after releasing the pinch hand shape, including the thumb and tip of the index finger of the hand moving apart from one another), and hand 1305b (e.g., in Hand State B) is providing in input corresponding to a release of object 1306a. The input from hand 1303b optionally corresponds to a request to add virtual object 1304a to virtual object 1307a in three-dimensional environment 1302, and the input from hand 1305b optionally corresponds to a request to add virtual object 1306a to virtual object 1309a in three-dimensional environment 1302. As described above, virtual object 1307a is optionally a valid drop target for virtual object 1304a, and virtual object 1309a is optionally an invalid drop target for virtual object 1306a.

In FIG. 13C, in response to detecting the inputs corresponding to requests to add virtual objects 1304a and 1306a to virtual objects 1307a and 1309a, respectively, device 101 adds virtual object 1304a to virtual object 1307a and forgoes adding virtual object 1306a to virtual object 1309a. In FIG. 13C, device 101 displays virtual object 1304a in virtual object 1307a in response to detecting the release of virtual object 1304a, because virtual object 1307a is a valid drop target for virtual object 1304a, and device 101 redisplays virtual object 1306a in virtual object 1313a in response to detecting the release of virtual object 1306a because virtual object 1309a is an invalid drop target for virtual object 1306a. In some embodiments, in response to detecting an input corresponding to a request to add a respective virtual object to a virtual object that is an invalid drop target for the respective virtual object, device 101 displays an animation in three-dimensional environment 1302 of the respective virtual object returning to a respective location prior to detecting the input. For example, in response to detecting the input corresponding to the request to add virtual object 1306a to virtual object 1309a, which is optionally an invalid drop target for virtual object 1306a, device 101 optionally animates the movement of virtual object 1306a from a location at or near the surface of virtual object 1309a back to an originating location in virtual object 1306a (e.g., corresponding to location of virtual object 1306a in FIG. 13A), and does not display virtual object 1306a in virtual object 1309a.

Further in some embodiments, after adding object 1304a to object 1307a, device 101 ceases display of object 1311a in three-dimensional environment 1302. For example, as described above, in FIGS. 13A-13B, virtual object 1311a (e.g., Window 1) is a quick look window displaying virtual object 1304a. In FIG. 13C, after adding virtual object 1304a to virtual object 1307a, device 101 ceases display of virtual object 1311a in three-dimensional environment 1302. In some embodiments, if virtual object 1311a was not a quick look window, device 101 optionally would not have ceased display of virtual object 1311a in three-dimensional environment 1302 after adding virtual object 1304a to virtual object 1307a. Further, in some embodiments, if virtual object 1311a were not a quick look window, in response to detecting an input adding virtual object 1311a containing virtual object 1304a to virtual object 1307a, device 101 would have added both virtual object 1311a and virtual object 1304a to virtual object 1307a in three-dimensional environment 1302.

In some embodiments, device 101 displays a respective object that is dropped in empty space within a newly created object in three-dimensional environment 1302. For example, in FIG. 13C, hand 1305c (e.g., in Hand State C) is providing movement input directed to virtual object 1306a (e.g., Object 2). In Hand State C (e.g., while the hand is in a pinch hand shape (e.g., while the thumb and tip of the index finger of the hand are touching)), hand 1305c is optionally providing input for moving object 1306a out of object 1313a and toward the viewpoint of user 1326 for moving object 1306a to empty space (e.g., a respective location that does not contain an object (e.g., physical or virtual)) in three-dimensional environment 1302.

In FIG. 13D, in response to detecting the movement input directed to virtual object 1306a, device 101 removes object 1306a from object 1313a and moves virtual object 1306a to a respective location in front of virtual object 1313a from the viewpoint of user 1326 in accordance with the movement input, as shown in the overhead view. As described above, in some embodiments, moving virtual object 1306a to the respective location in front of virtual object 1313a includes removing virtual object 1306a from virtual object 1313a. In FIG. 13D, after the input moving virtual object 1306a to the respective location in front of virtual object 1313a, device 101 detects release of virtual object 1306a at the respective location in three-dimensional environment 1302 (e.g., via release of the pinch hand shape of hand 1305d such that the thumb and top of the index finger of the hand are no longer touching, corresponding to Hand State D). As described above, the respective location in front of virtual object 1313a from the viewpoint of user 1326 optionally corresponds to empty space in three-dimensional environment 1302.

In some embodiments, after detecting release of virtual object 1306a in empty space in three-dimensional environment 1302, device 101 generates a new object (e.g., a new window) to contain virtual object 1306a. In FIG. 13D, device 101 has added virtual object 1306a to new object 1317a (e.g., Window 5) in response to detecting release of virtual object 1306a in empty space, such that object 1306a is displayed in new object 1317a in three-dimensional environment 1302. In some embodiments, the new object in three-dimensional environment 1302 is a quick look window. Accordingly, virtual object 1317a is displayed with the respective user interface element (e.g., grabber or handlebar) 1315 that is selectable to cause device 101 to initiate movement of virtual object 1317a containing object 1306a in three-dimensional environment 1302.

In some embodiments, device 101 selectively displays one or more interface elements associated with an object in three-dimensional environment 1302 if the object is a quick look window. For example, in FIG. 13D, a gaze 1321 of user 1326 (e.g., corresponding to a detected focus of an eye of user 1326) is directed to virtual object 1306a in virtual object 1317a in three-dimensional environment 1302. In response to detecting that the gaze 1321 is directed to virtual object 1306a, device 101 optionally displays a toolbar 1323 disposed above object 1317a in three-dimensional environment 1302. In some embodiments, toolbar 1323 includes one or more interface elements that are selectable (e.g., via selection input provided by a hand of user 1326) to perform one or more actions associated with virtual object 1306a. For example, the one or more interface elements of toolbar 1323 are optionally one or more controls for controlling the placement, display, or other characteristics of virtual object 1306a. In some embodiments, intent is required to cause device 101 to display the one or more interface elements associated with virtual object 1306a. For example, if intent is required, in FIG. 13D, toolbar 1323 would only be displayed when device 101 detects that gaze 1321 is directed to virtual object 1306a and/or when device 101 detects that hand 1305d is raised and/or in a ready hand shape (e.g., in a pre-pinch hand shape in which the thumb and index finger of the hand are curled towards each other but not touching) directed toward virtual object 1306a in three-dimensional environment 1302.

In some embodiments, device 101 cancels a movement input directed to a respective object in response to detecting input corresponding to movement of the respective object back to the object in which the respective object was located when the movement input was detected. For example, in FIG. 13D, if hand 1303c were to provide movement input directed to virtual object 1304a to move virtual object 1304a away from virtual object 1307a, device 101 would optionally remove virtual object 1304a from virtual object 1307a and would optionally display a ghost representation of virtual object 1304a in virtual object 1307a (e.g., as similarly shown in FIG. 13B). If hand 1303c were to then provide movement input moving virtual object 1304a back to virtual object 1307a and release virtual object 1304a within a threshold distance (e.g., 0.1, 0.5, 1, 3, 6, 12, 24, 36, or 48 cm) of the surface of virtual object 1307a and/or within drop zone 1318, device 101 would optionally cancel the movement input directed to object 1304a, and would optionally redisplay virtual object 1304a at its prior position within virtual object 1307a.

Further, in some embodiments, device 101 cancels a movement input directed to a respective object in response to detecting input corresponding to movement of the respective object to an invalid location for the respective object. For example, in FIG. 13D, if hand 1303c were to provide movement input directed to virtual object 1304a to move virtual object 1304a away from virtual object 1307a to a respective location outside the boundaries of the field of view of the viewpoint of user 1326, device 101 would optionally forgo movement of virtual object 1304a to the respective location because the respective location is optionally undetectable by device 101 in the current field of view of user 1326. Accordingly, in response to detecting such a movement input, device 101 would optionally maintain display of virtual object 1304a in virtual object 1307a (e.g., display an animation of object 1304a moving back to its initial position within object 1307a). Thus, as described herein, device 101 optionally forgoes movement of a respective object away from an object containing the respective object in response to detecting input corresponding to movement of the respective object to an invalid location for the respective object (e.g., to second object that is an invalid drop target for the respective object or a location outside the boundaries of the field of view of the viewpoint of user 1326), or movement of the respective object back to the object.

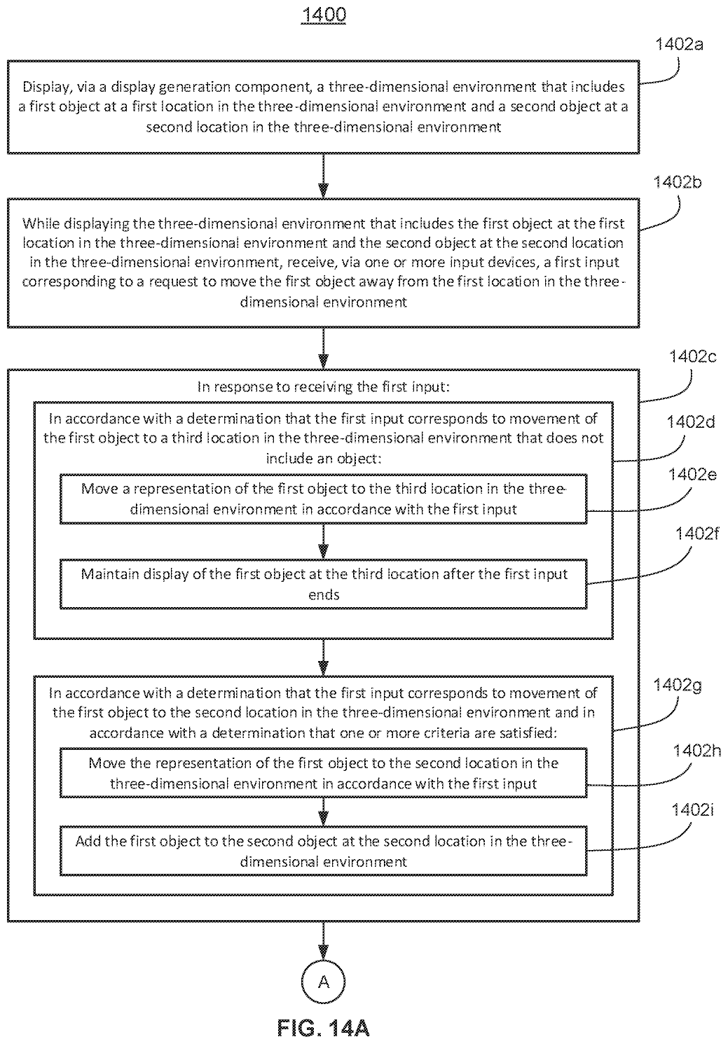

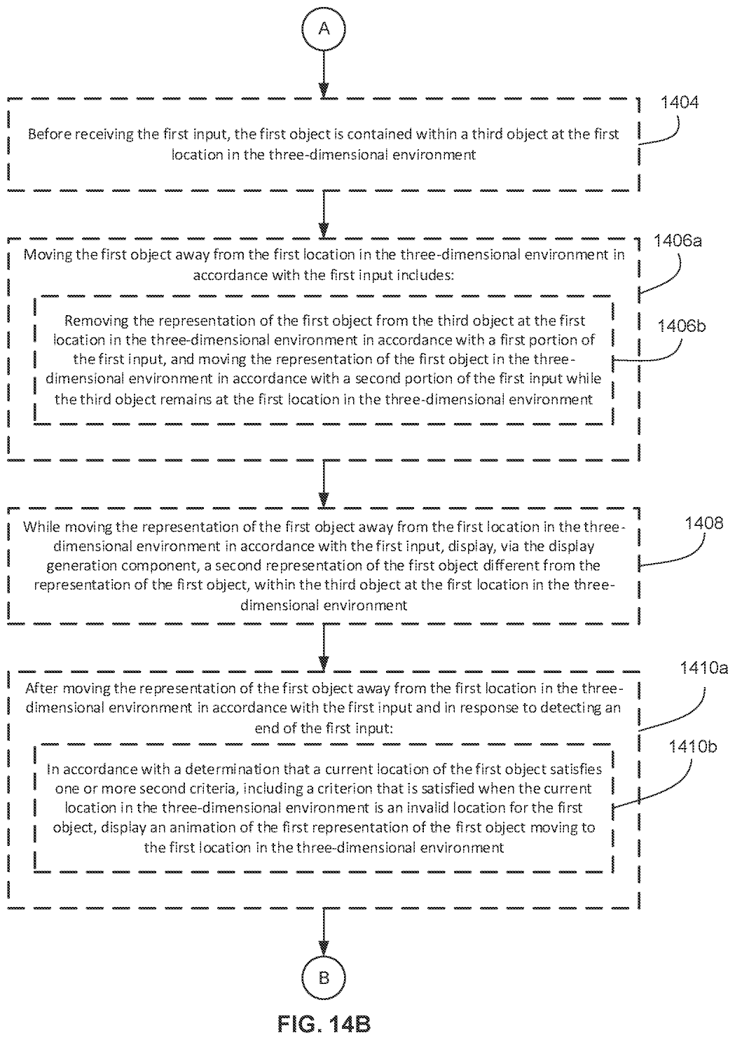

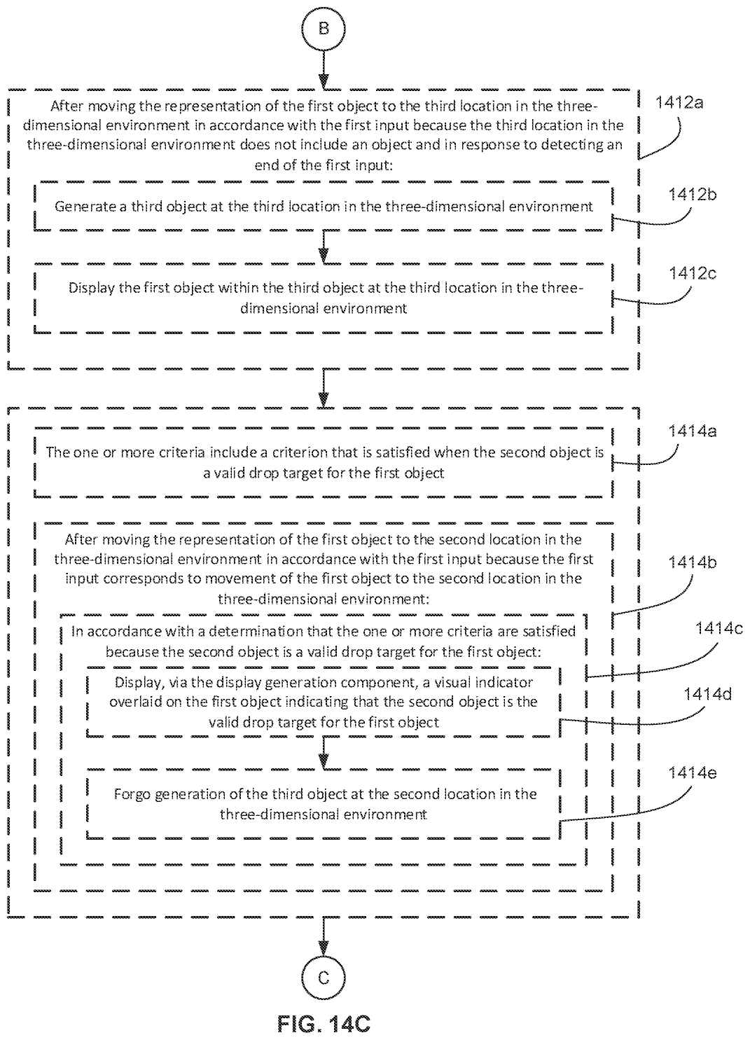

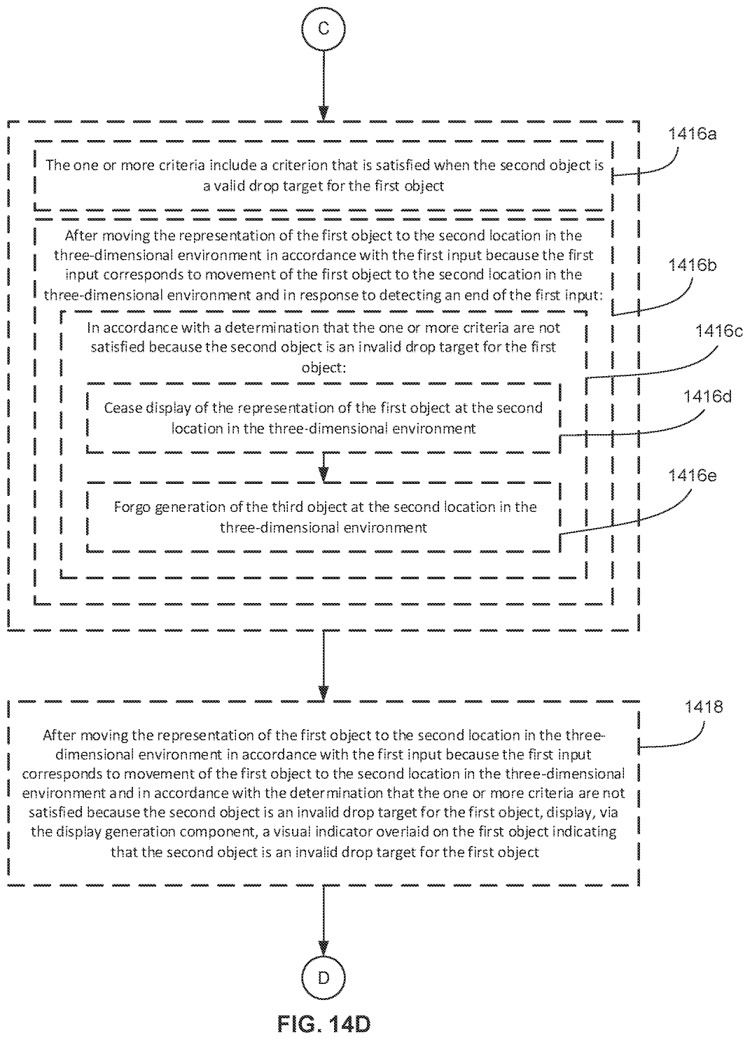

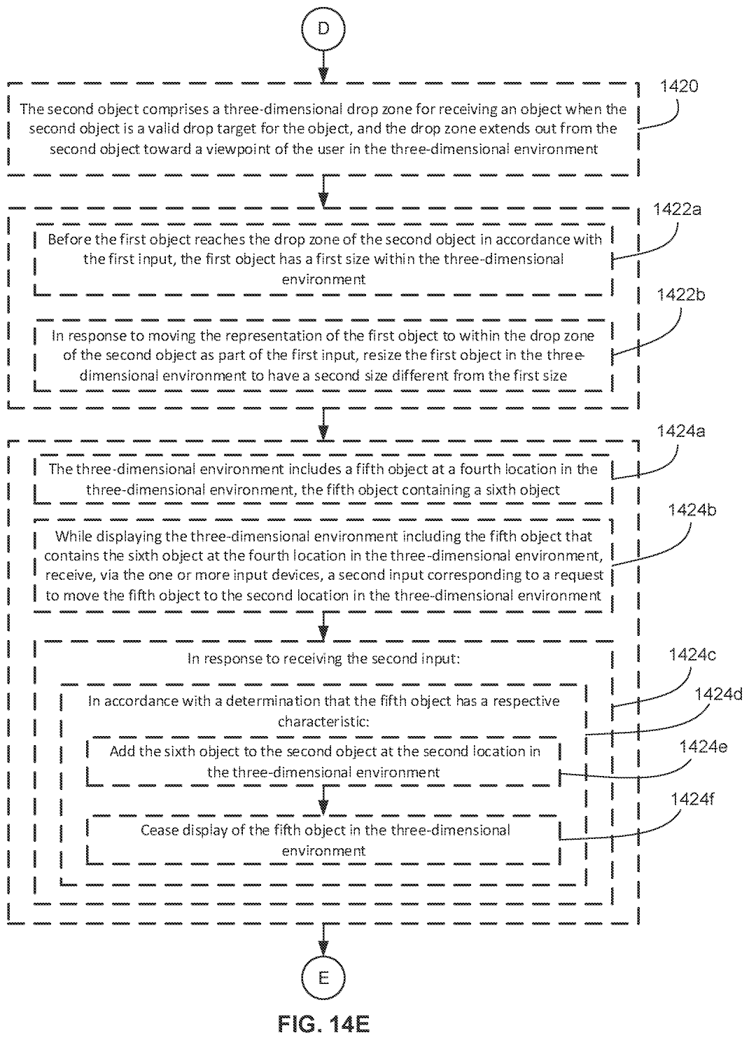

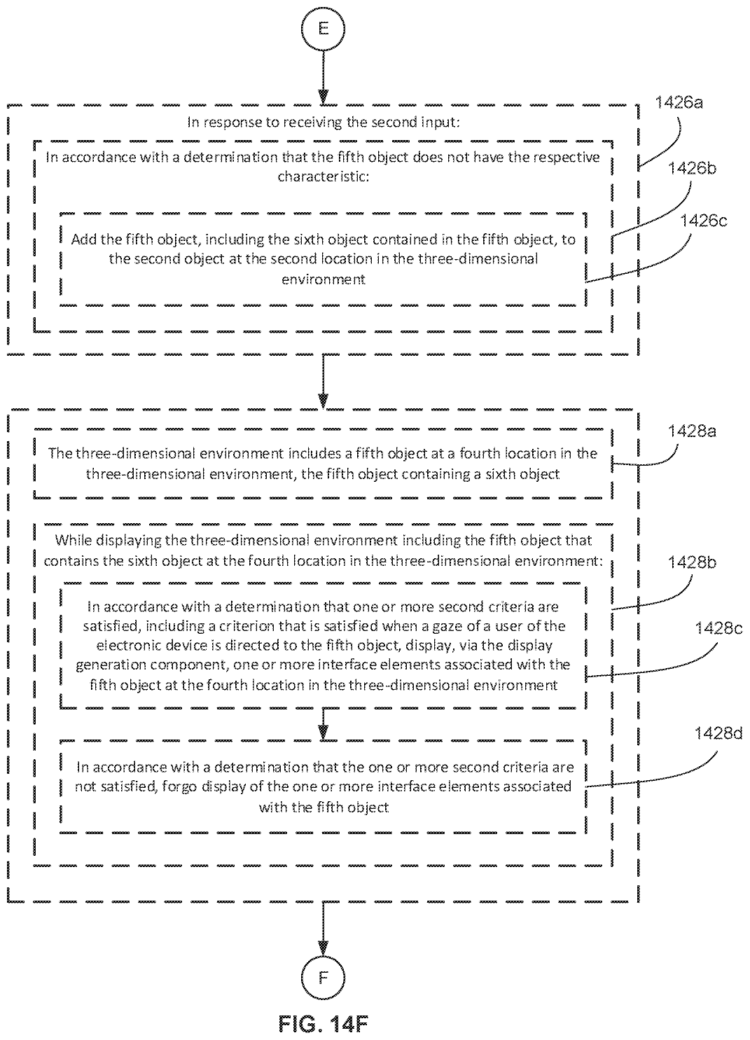

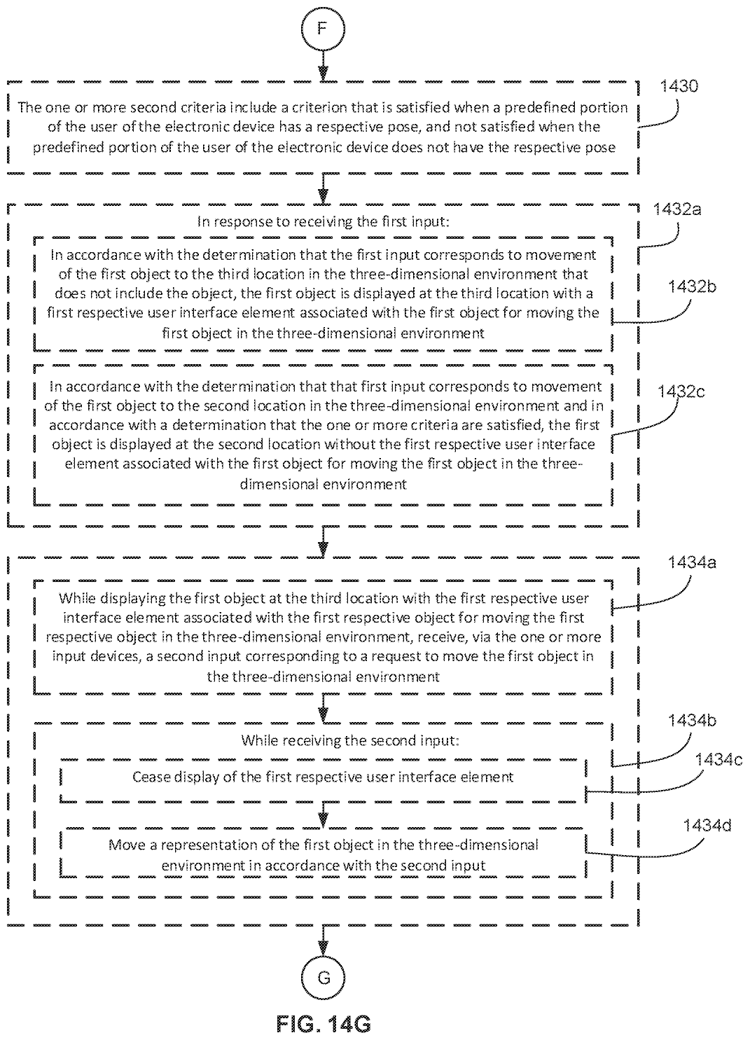

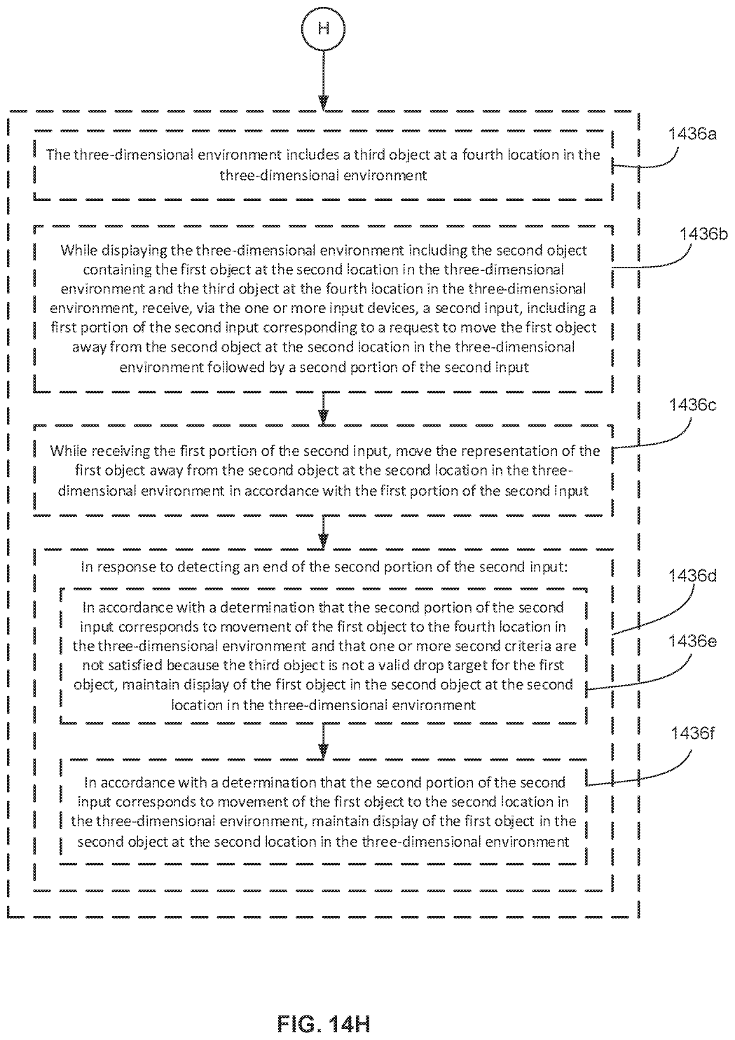

FIGS. 14A-14H is a flowchart illustrating a method 1400 of selectively adding respective objects to other objects in a three-dimensional environment in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1402a), via the display generation component, a three-dimensional environment (e.g., three-dimensional environment 1302) that includes a first object at a first location in the three-dimensional environment (e.g., virtual object 1304a and/or virtual object 1306a in FIG. 13A) and a second object at a second location in the three-dimensional environment (e.g., virtual object 1307a and/or virtual object 1309a in FIG. 13A). In some embodiments, the three-dimensional environment is generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.). For example, the first object is optionally a photograph (or a representation of a photograph). In some embodiments, the first object is any of one or more of content, such as video content (e.g., film or TV show clips), web-based content (e.g., a website URL or link), three-dimensional content (e.g., a three-dimensional virtual clock, virtual car, virtual tent, etc.), a user interface of an application (e.g., a user interface of a messaging application, a user interface of a web browser application, a user interface of a music browsing and/or playback application, etc.), an icon (e.g., an application icon selectable to display a user interface of the application, a virtual environment icon selectable to display a virtual environment in the three-dimensional environment, etc.) and the like. In some embodiments, the first object is optionally displayed in a third object (e.g., the third object is a web page of a web browser application that is displaying the photograph, or a user interface of an email application or messaging application that is displaying the photograph). In some embodiments, the second object is optionally another container that can accept and/or display the first object (e.g., the photograph). For example, the second object is optionally a user interface of a messaging application that includes a text entry field into which the photograph can be dropped to be added to the messaging conversation displayed in the second object.

In some embodiments, while displaying the three-dimensional environment that includes the first object at the first location in the three-dimensional environment and the second object at the second location in the three-dimensional environment, the electronic device receives (1402b), via the one or more input devices, a first input corresponding to a request to move the first object away from the first location in the three-dimensional environment, such as movement of virtual object 1304a by hand 1303a and/or movement of virtual object 1306a by hand 1305a in FIG. 13A (e.g., while the gaze of the user is directed to the first object, a pinch gesture of an index finger and thumb of a hand of the user, subsequently followed by movement of the hand in the pinched hand shape toward a respective location (e.g., away from the first location) in the three-dimensional environment. In some embodiments, during the first input, the hand of the user is greater than a threshold distance (e.g., 0.2, 0.5, 1, 2, 3, 5, 10, 12, 24, or 26 cm) from the first object. In some embodiments, the first input is a pinch of the index finger and thumb of the hand of the user followed by movement of the hand in the pinched hand shape toward the respective location in the three-dimensional environment, irrespective of the location of the gaze of the user when the hand of the user is less than the threshold distance from the first object. In some embodiments, the first input has one or more of the characteristics of the input(s) described with reference to methods 800, 1000, 1200, 1600 and/or 1800.).

In some embodiments, in response to receiving the first input (1402c), in accordance with a determination that the first input corresponds to movement of the first object to a third location in the three-dimensional environment that does not include an object (1402d), such as movement of virtual object 1306a by hand 1305c in FIG. 13C (e.g., the movement of the hand corresponds to movement of the first object to a third location in the three-dimensional environment, where the third location does not include an object (e.g., the third location optionally corresponds to “empty” space within the three-dimensional environment). In some embodiments, the movement of the hand alternatively corresponds to movement of the first object to a location that does include an object, but the object is not a valid drop target for the first object (e.g., the object is not an object that can contain, accept and/or display the first object).), the electronic device moves (1402e) a representation of the first object to the third location in the three-dimensional environment in accordance with the first input (e.g., movement of virtual object 1306a as shown in FIG. 13D). For example, a representation of the first object (e.g., a faded or ghosted representation of the first object, a copy of the first object, etc.) is moved from the first location in the three-dimensional environment to the third location in the three-dimensional environment in accordance with the first input.

In some embodiments, the electronic device maintains (1402f) display of the first object at the third location after the first input ends (e.g., display of virtual object 1306a as shown in FIG. 13D). For example, the first object is displayed at the third location in the three-dimensional environment (e.g., the first object is displayed within “empty” space within the three-dimensional environment).

In some embodiments, in accordance with a determination that the first input corresponds to movement of the first object to the second location in the three-dimensional environment, such as movement of virtual object 1304a by hand 1303a in FIG. 13A (e.g., the movement of the hand corresponds to movement of the first object to/toward the second object at the second location in the three-dimensional environment) and in accordance with a determination that one or more criteria are satisfied (1402g) (e.g., the second object is a valid drop target for the first object, such as an object that can accept and/or contain the first object. For example, the second object is optionally a user interface of a messaging application that includes a text entry field into which the photograph can be dropped to be added to the messaging conversation displayed in the second object. In some embodiments, the one or more criteria are not satisfied if the second object is not a valid drop target for the first object), the electronic device moves (1402h) the representation of the first object to the second location in the three-dimensional environment in accordance with the first input (e.g., movement of virtual object 1304a as shown in FIG. 13B. For example, the representation of the first object is moved from the first location in the three-dimensional environment to the second location in the three-dimensional environment in accordance with the input, where the second location includes the second object.

In some embodiments, the electronic device adds (1402i) the first object to the second object at the second location in the three-dimensional environment, such as addition of virtual object 1304a to virtual object 1307a as shown in FIG. 13C (e.g., without generating another object for containing the first object, such as without generating a fourth object). For example, the second object receives and/or displays the first object in the three-dimensional environment (e.g., the second object is optionally a user interface of a messaging application that includes a text entry field into which the first object (e.g., the photograph) can be dropped to be added to the messaging conversation displayed in the second object). Displaying an object in the three-dimensional environment when the object is dropped in empty space within the three-dimensional environment or adding the object to an existing object when the object is dropped into the existing object facilitates user input for freely moving objects in the three-dimensional environment, whether or not a valid drop target exits at the drop location in the three-dimensional environment, thereby improving the user-device interaction.

In some embodiments, before receiving the first input, the first object is contained within a third object at the first location in the three-dimensional environment (1404) (e.g., virtual object 1311a containing virtual object 1304a and/or virtual object 1313a containing virtual object 1306a as shown in FIG. 13A). For example, the third object is optionally a container that contains the first object, which is optionally a photograph (or a representation of a photograph). The third object is optionally displaying the first object (e.g., the third object is a web page of a web browser application that is displaying the photograph, the third object is a user interface of a messaging application for messaging different users and is displaying the photograph within a conversation, etc.). Allowing movement of an object from an existing object to empty space within the three-dimensional environment or to another existing object in the three-dimensional environment facilitates copying/extraction of information corresponding to the object for utilization of the information, thereby improving the user-device interaction.

In some embodiments, moving the first object away from the first location in the three-dimensional environment in accordance with the first input includes (1406a) removing the representation of the first object from the third object at the first location in the three-dimensional environment in accordance with a first portion of the first input, and moving the representation of the first object in the three-dimensional environment in accordance with a second (e.g., subsequent) portion of the first input while the third object remains at the first location in the three-dimensional environment (1406b) (e.g., removal of virtual object 1306a from virtual object 1313a as shown in FIG. 13B). For example, the first object is removed from the third object (e.g., the first object becomes visually separated from the third object, such as by 0.1, 0.2, 0.5, 1, 2, 3, 5, or 10 cm), such that the user is able to selectively move the first object to/toward another object within the three-dimensional environment and/or to/toward a respective location within the three-dimensional environment without moving the third object. In some embodiments, the first portion of the first input includes detecting the hand of the user performing a pinch gesture and holding the pinch hand shape while moving the hand away from the third object (e.g., by more than a threshold amount, such as 0.1, 0.2, 0.5, 1, 2, 3, 5, 10, 20, or 40 cm), and the second portion includes while continuing to hold the pinch hand shape, moving the hand in a manner that corresponds to movement of the first object away from the third object. Allowing movement of an object from an existing object to empty space within the three-dimensional environment or to another existing object in the three-dimensional environment facilitates copying/extraction of information corresponding to the object for utilization of the information, thereby improving the user-device interaction.

In some embodiments, while moving the representation of the first object away from the first location in the three-dimensional environment in accordance with the first input, the electronic device displays, via the display generation component, a second representation of the first object (e.g., a deemphasized representation of the first object such as a partially translucent or reduced saturation or reduced contrast representation of the first object), different from the representation of the first object, within the third object at the first location in the three-dimensional environment (1408) (e.g., display of ghost representation 1304c and/or ghost representation 1306c as shown in FIG. 13B). In some embodiments, as the first object is moved to/toward a respective location within the three-dimensional environment, a second representation of the first object is displayed within the third object at the first location in the three-dimensional environment. For example, the first object is optionally a photograph and the third object is optionally a web page of a web browser application, and while the photograph is moved away from the web page, a ghosted/faded representation of the photograph is optionally displayed within the web page. Displaying a ghost of an object in an existing object from which the object originated as the object is moved to empty space within the three-dimensional environment or to another existing object in the three-dimensional environment facilitates discovery that information corresponding to the object will be copied/extracted, thereby improving the user-device interaction.

In some embodiments, after moving the representation of the first object away from the first location in the three-dimensional environment in accordance with the first input and in response to detecting an end of the first input (1410a) (e.g., the first object is located at a respective location in the three-dimensional environment after being moved away from the first location in the three-dimensional environment. In some embodiments, the end of the first input includes detecting a release of the pinch hand shape by the hand of the user (e.g., the tip of the index finger of the user moves away from the tip of the thumb of the user such that the index finger and thumb are no longer touching), in accordance with a determination that a current location of the first object satisfies one or more second criteria, including a criterion that is satisfied when the current location in the three-dimensional environment is an invalid location for the first object, the electronic device displays (1410b) an animation of the first representation of the first object moving to the first location in the three-dimensional environment, such as an animation of the movement of virtual object 1306a shown in FIG. 13C (e.g., without detecting corresponding user input for doing so). In some embodiments, movement of the first object within the three-dimensional environment to a respective location and/or target (e.g., an object) is unsuccessful if the respective location and/or target is an invalid location for the first object. For example, the respective location is optionally an invalid location for the first object and/or the target is an invalid drop target for the first object. The first object is optionally a photograph, the respective location is optionally a location outside a boundary of the field of view of the user, and the target is optionally an object that cannot accept and/or contain the first object, such as a web page of a web browsing application containing no input field into which the photograph can be added. Accordingly, movement of the photograph to the location outside the boundary of the field of view of the user or to the web page of the web browsing application is invalid. In some embodiments, in response to detecting that movement to the respective location and/or target is unsuccessful, the first object is optionally moved back to the first location in the three-dimensional environment (e.g., back to an object from which the first object originated). Moving an object back to an existing object from which the object originated when the target of movement of the object is invalid facilitates discovery that the target of the movement of the object is invalid, thereby improving the user-device interaction.

In some embodiments, after moving the representation of the first object to the third location in the three-dimensional environment in accordance with the first input because the third location in the three-dimensional environment does not include an object and in response to detecting an end of the first input (1412a) (e.g., the first object is located at the third location within the three-dimensional environment after being moved away from the first location in the three-dimensional environment because the third location does not contain an object (e.g., an application window that can accept and/or display the first object. In some embodiments, the end of the first input includes detecting a release of the pinch hand shape by the hand of the user (e.g., the tip of the index finger of the user moves away from the tip of the thumb of the user such that the index finger and thumb are no longer touching).), the electronic device generates (1412b) a third object at the third location in the three-dimensional environment, such as virtual object 1317a in FIG. 13D (e.g., a third object is generated at the third location (within the empty space), where the third object did not exist in the three-dimensional environment before detecting the end of the first input, and the third object is optionally a container that can accept and/or display the first object, such as a window, a wrapper or user interface of a content application via which content (e.g., images, videos, songs, etc.) is displayed or accessible.).

In some embodiments, the electronic device displays (1412c) the first object within the third object at the third location in the three-dimensional environment (e.g., display of virtual object 1306a within virtual object 1317a as shown in FIG. 13D). For example, the third object is a quick look window in which the first object (e.g., the photograph) is optionally displayed and contained for later retrieval by the user. In some embodiments, the first object occupies the entire surface of or a substantial amount of the surface of the third object. In some embodiments, the quick look window is optionally associated with one or more controls for controlling the placement, display, or other characteristics of the photograph or other content, as described above. In some embodiments, display of the quick look window containing the photograph in the three-dimensional environment is optionally temporary, such that movement of the photograph from the quick look window to a new location (e.g., to an existing object that is a valid drop target for the photograph) causes the quick look window that was containing the photograph to be closed. In some embodiments, the one or more controls are optionally displayed above and/or atop the quick look window within a toolbar. In some embodiments, intent is required for the toolbar containing the one or more controls to be displayed in the three-dimensional environment (e.g., in response to detecting that the user's gaze is directed at the third object). Displaying an object in a new object when the object is dropped in empty space within the three-dimensional environment facilitates user input for manipulating the object and/or facilitates user input for moving the object from the new object to empty space within the three-dimensional environment or to an existing object in the three-dimensional environment, thereby improving the user-device interaction.

In some embodiments, the one or more criteria include a criterion that is satisfied when the second object is a valid drop target for the first object (1414a), such as virtual object 1307a being a valid drop target for virtual object 1304a in FIG. 13A (e.g., the first object is a photograph and the second object is a user interface of a messaging application including a text entry field into which the photograph can be added to add the photograph to the messaging conversation displayed on the second object.).

In some embodiments, after moving the representation of the first object to the second location in the three-dimensional environment in accordance with the first input because the first input corresponds to movement of the first object to the second location in the three-dimensional environment (1414b), in accordance with a determination that the one or more criteria are satisfied because the second object is a valid drop target for the first object (1414c) (e.g., the second object is a valid drop target for the first object, such as an object that can accept and/or contain the first object. In some embodiments, one or more criteria include a criterion that is satisfied when the first object is within a threshold distance of the second object, such as 0.5, 1, 1.5, 2, 2.5, 3, or 5 cm. In some embodiments, the one or more criteria are not satisfied if the second object is not a valid drop target for the first object.), the electronic device displays (1414d), via the display generation component, a visual indicator overlaid on the first object indicating that the second object is the valid drop target for the first object, such as badge 1325 in FIG. 13B (e.g., a visual indicator (e.g., a change in appearance of the first object, such as display of a badge on the first object) is displayed indicating to the user that the second object can accept and/or contain the first object. In some embodiments, the visual indicator is displayed a threshold amount of time (e.g., 0.5, 0.7, 0.9, 1, 1.5, or 2 seconds) after the first object is moved to, and maintained at, the second object. In some embodiments, the badge is optionally displayed before detecting the end of the first input (e.g., while the pinch hand gesture is being held and directed toward the first object at the second location in the three-dimensional environment). In some embodiments, the badge optionally includes a symbol or character (e.g., a “+” sign) indicating that release of the first object will add the first object to the second object. For example, the badge is optionally displayed in an upper corner or along an edge/boundary of the first object.).

In some embodiments, the electronic device forgoes (1414e) generation of the third object at the second location in the three-dimensional environment (e.g., forgoing of generation of virtual object 1317a in FIG. 13C). For example, a third object (e.g., a quick look window) is not generated and displayed at the second location in the three-dimensional environment for containing/displaying the first object. In some embodiments, the first object is added to the second object and not to the (e.g., un-generated) third object. Providing a visual indicator indicating that an object will be added to an existing object facilitates discovery that the existing object is a valid drop target for the object and/or facilitates user input for adding the object to the existing object, thereby improving the user-device interaction.

In some embodiments, the one or more criteria include a criterion that is satisfied when the second object is a valid drop target for the first object (1416a), such as virtual object 1307a being a valid drop target for virtual object 1304a in FIG. 13A (e.g., the first object is a photograph and the second object is a user interface of a messaging application including a text entry field into which the photograph can be added to add the photograph to the messaging conversation displayed on the second object.).

In some embodiments, after moving the representation of the first object to the second location in the three-dimensional environment in accordance with the first input because the first input corresponds to movement of the first object to the second location in the three-dimensional environment and in response to detecting an end of the first input (1416b) (e.g., the first object is located at the second location in the three-dimensional environment after being moved away from the first location in the three-dimensional environment. In some embodiments, the end of the first input includes detecting a release of the pinch hand shape by the hand of the user (e.g., the tip of the index finger of the user moves away from the tip of the thumb of the user such that the index finger and thumb are no longer touching.), in accordance with a determination that the one or more criteria are not satisfied because the second object is an invalid drop target for the first object (1416c) (e.g., the one or more criteria are not satisfied because second object cannot accept and/or contain the first object. For example, the second object is a web page of a web browsing application that contains no input field into which the first object (e.g., the photograph) can be added. Alternatively, the web page of the web browsing applications is configured to only accept text input, and thus cannot accept and/or contain the photograph. In some embodiments, the first object is within a threshold distance of the second object, such as 0.5, 1, 1.5, 2, 2.5, 3, or 5 cm, when the one or more criteria are evaluated. In some embodiments, the one or more criteria are satisfied if the second object is a valid drop target for the first object.), the electronic device ceases (1416d) display of the representation of the first object at the second location in the three-dimensional environment, such as ceasing display of virtual object 1306a at virtual object 1309a as shown in FIG. 13C (e.g., the representation if the first object is no longer displayed at the second location in the three-dimensional environment because the second object is an invalid drop target for the first object. In some embodiments, the representation of the first object is moved back to the first location in the three-dimensional environment (e.g., back to an object and/or location from which the first object originated).).

In some embodiments, the electronic device forgoes (1416e) generation of the third object at the second location in the three-dimensional environment (e.g., forgoing generation of virtual object 1317a in FIG. 13D at a location of virtual object 1309a as shown in FIG. 13C). For example, a third object (e.g., a quick look window) is not generated and displayed at the second location in the three-dimensional environment for containing/displaying the first object. In some embodiments, the first object is not added to the second object and is not added to the (e.g., un-generated) third object. Forgoing generation of a new object when an existing object at a respective location is an invalid drop target for an object after movement of the object to the respective location facilitates discovery that the existing object is not a valid drop target for the object and/or facilitates user input for moving the object to empty space in the three-dimensional environment or to another existing object in the three-dimensional environment that is a valid drop target for the object, thereby improving user-device interaction.

In some embodiments, after moving the representation of the first object to the second location in the three-dimensional environment in accordance with the first input because the first input corresponds to movement of the first object to the second location in the three-dimensional environment and in accordance with the determination that the one or more criteria are not satisfied because the second object is an invalid drop target for the first object (e.g., the first object is located at the second location in the three-dimensional environment after being moved away from the first location in the three-dimensional environment because the first input corresponded to movement of the first object to the second location. In some embodiments, the second object is an invalid drop target for the first object, such as an object that cannot accept and/or contain the first object.), the electronic device displays (1418), via the display generation component, a visual indicator overlaid on the first object indicating that the second object is an invalid drop target for the first object (e.g., display of badge 1327 as shown in FIG. 13B). For example, a visual indicator (e.g., a change in appearance of the first object, such as display of a badge on the first object) is displayed indicating to the user that the second object cannot accept and/or contain the first object. In some embodiments, the visual indicator is displayed a threshold amount of time (e.g., 0.5, 0.7, 0.9, 1, 1.5, or 2 seconds) after the first object is moved to, and maintained at, the second object. In some embodiments, the badge is optionally displayed before detecting the end of the first input (e.g., while the pinch hand gesture is being held and directed toward the first object at the second location in the three-dimensional environment). In some embodiments, the badge optionally includes a symbol or character (e.g., an “X”) indicating that release of the first object will not add the first object to the second object. For example, the badge is optionally displayed in an upper corner or along an edge/boundary of the first object. Providing a visual indicator indicating that an object will not be added to an existing object facilitates discovery that the existing object is an invalid drop target for the object and/or facilitates user input for moving the object to empty space or to another existing object in the three-dimensional environment that is a valid drop target for the object, thereby improving the user-device interaction.

In some embodiments, the second object comprises a three-dimensional drop zone for receiving an object when the second object is a valid drop target for the object, and the drop zone extends out from the second object toward a viewpoint of the user in the three-dimensional environment (1420) (e.g., drop zone 1318 in FIG. 13B). In some embodiments, the second object is optionally a container that can accept and/or display an object (e.g., a photograph). For example, the second object is optionally a user interface of a messaging application, and the three-dimensional drop zone optionally includes a text entry field in the user interface of the messaging application into which the photograph can be dropped to be added to the text entry field/messaging conversation displayed in the second object. The drop zone optionally extends out from the surface of the second object into the three-dimensional environment toward a viewpoint of the user to receive the photograph when the photograph is moved to within a threshold distance (e.g., 0.5, 1, 1.5, 2, 2.5, 3, or 5 cm) of the second object. In some embodiments, the drop zone is not displayed in the three-dimensional environment. For example, the second object optionally comprises the three-dimensional drop zone for receiving the first object (e.g., the photograph), but the drop zone is not visible to a user of the electronic device. Providing a volumetric drop zone for a drop target that is a valid drop target for an object facilitates user input for adding the object to the drop zone and thus the drop target, thereby improving the user-device interaction.

In some embodiments, before the first object reaches the drop zone of the second object in accordance with the first input, the first object has a first size within the three-dimensional environment (1422a), such as the size of virtual object 1304a in FIG. 13A (e.g., the first object is optionally a photograph having a first width, such as 0.2, 0.5, 1, 2, 3, 5, 10, 12, 24, or 26 cm, and a first height, such as 0.2, 0.5, 1, 2, 3, 5, 10, 12, 24, or 26 cm, in the three-dimensional environment just before reaching the drop zone of the second object).

In some embodiments, in response to moving the representation of the first object to within the drop zone of the second object as part of the first input, the electronic device resizes (1422b) the first object in the three-dimensional environment to have a second size different from (e.g., smaller or larger than) the first size (e.g., resize of virtual object 1304a within drop zone 1318 as shown in FIG. 13B). In some embodiments, the second object is optionally a container that can accept and/or display the first object. For example, the second object is optionally a user interface of a messaging application, and optionally has a drop zone into which the photograph can be dropped. In some embodiments, when the first object is moved to within the (e.g., three-dimensional) drop zone, the first object is resized to have a smaller size in the three-dimensional environment (e.g., to fit within the second object and/or an element within the second object). For example, when the photograph is moved to within the (e.g., text) entry field of the user interface of a messaging application, the photograph is resized to have a second width and a second length that are smaller than the first width and the first length, respectively, to fit within the (e.g., text) entry field. In some embodiments, resizing of an object when the object reaches a drop zone has one or more of the characteristics described with reference to method 1000. Resizing an object within a drop zone of a drop target that is a valid drop target for that object facilitates user input for adding the object to the visual drop zone and thus the drop target, and/or facilitates discovery that the drop target is a valid drop target for that object, thereby improving user-device interaction.

In some embodiments, the three-dimensional environment includes a fifth object at a fourth location in the three-dimensional environment, the fifth object containing a sixth object (1424a), such as virtual object 1311a containing virtual object 1304a as shown in FIG. 13A (e.g., the fifth object is optionally a container that displays the sixth object at the fourth location in the three-dimensional environment. The fifth object is optionally a web page of a web browsing application and the sixth object is optionally a photograph displayed on the web page of the web browsing application. In some embodiments, the fifth object is optionally a quick look window in which the sixth object (e.g., the photograph) is optionally displayed and contained for later retrieval by the user. In some embodiments, display of the quick look window containing the photograph in the three-dimensional environment is optionally temporary, such that movement of the photograph from the quick look window to a new location (e.g., to an existing object that is a valid drop target for the photograph) causes the quick look window that was containing the photograph to be closed. In some embodiments, the quick look window is optionally associated with one or more controls for controlling the placement, display, or other characteristics of the photograph. In some embodiments, the one or more controls are optionally displayed above and/or atop the quick look window within a toolbar. In some embodiments, intent is required for the toolbar containing the one or more controls to be displayed in the three-dimensional environment (e.g., in response to detecting that the user's gaze is directed at the third object.).

In some embodiments, while displaying the three-dimensional environment including the fifth object that contains the sixth object at the fourth location in the three-dimensional environment, the electronic device receives (1424b), via the one or more input devices, a second input corresponding to a request to move the fifth object to the second location in the three-dimensional environment, such as movement of virtual object 1304a by hand 1303a as shown in FIG. 13A (e.g., while the gaze of the user is directed to the fifth object, a pinch gesture of an index finger and thumb of a hand of the user, subsequently followed by movement of the hand in the pinched hand shape toward the second location (e.g., away from the fourth location and to the second object at the second location) in the three-dimensional environment. In some embodiments, during the second input, the hand of the user is greater than a threshold distance (e.g., 0.2, 0.5, 1, 2, 3, 5, 10, 12, 24, or 26 cm) from the fifth object. In some embodiments, the second input is a pinch of the index finger and thumb of the hand of the user followed by movement of the hand in the pinched hand shape toward the second location in the three-dimensional environment, irrespective of the location of the gaze of the user when the hand of the user is less than the threshold distance from the first object. In some embodiments, the second input has one or more of the characteristics of the input(s) described with reference to methods 800, 1000, 1200, 1600 and/or 1800.).

In some embodiments, in response to receiving the second input (1424c) (e.g., and in accordance with a determination that the second object is a valid drop target for the sixth object. In some embodiments, the second object is a container that can accept and/or display the sixth object (e.g., the photograph). For example, the second object is optionally a user interface of a messaging application including a text entry field into which the photograph can be added. In some embodiments, in accordance with a determination that the second object is not a valid drop target for the sixth object, the sixth object is not moved to the second object at the second location and the sixth object continues to be contained and/or displayed in the fifth object.), in accordance with a determination that the fifth object has a respective characteristic (1424d) (e.g., in accordance with a determination that the fifth object is a quick look window containing and/or displaying an object (e.g., the sixth object)), the electronic device adds (1424e) the sixth object to the second object at the second location in the three-dimensional environment, such as display of virtual object 1304a within virtual object 1307a in FIG. 13C (e.g., without generating another object for containing the sixth object, such as without generating a seventh object). For example, the second object receives and/or displays the sixth object in the three-dimensional environment (e.g., the second object is optionally a user interface of a messaging application to which the sixth object (e.g., the photograph) has been added to the messaging conversation displayed in the second object.).

In some embodiments, the electronic device ceases (14240 display of the fifth object in the three-dimensional environment, such as ceasing display of virtual object 1311a as shown in FIG. 13C (e.g., the quick look window that was containing and/or displaying the sixth object (e.g., the photograph) in the three-dimensional environment is closed/no longer exists in the three-dimensional environment after the sixth object is added to the second object.). Closing placeholder objects containing respective objects after adding the respective objects to drop targets facilitates user input for temporarily moving and/or dropping objects in empty space and for then adding the objects to drop targets, thereby improving user-device interaction.

In some embodiments, in response to receiving the second input (1426a) (e.g., and in accordance with a determination that the second object is a valid drop target for the fifth object. In some embodiments, the second object is a container that can accept and/or display the fifth object and/or the sixth object. For example, the fifth object is optionally an images folder and/or user interface and/or window containing and/or displaying the sixth object, which is optionally a photograph, and the second object is optionally a user interface of a messaging application including a text entry field into which the images folder and/or user interface and/or window including the photograph can be added. In some embodiments, in accordance with a determination that the second object is not a valid drop target for the sixth object, the sixth object is not moved to the second object at the second location and the sixth object continues to be contained and/or displayed in the fifth object.), in accordance with a determination that the fifth object does not have the respective characteristic (1426b) (e.g., in accordance with a determination that the fifth object is not a quick look window containing and/or displaying an object (e.g., the sixth object). In some embodiments, the fifth object is optionally an images folder and/or user interface and/or window containing and/or displaying the sixth object (e.g., the photograph).), the electronic device adds (1426c) the fifth object, including the sixth object contained in the fifth object, to the second object at the second location in the three-dimensional environment, as described previously with reference to FIG. 13D (e.g., without generating another object for containing the fifth object and the sixth object, such as without generating a seventh object). For example, the second object receives and/or displays the fifth object that contains the sixth object in the three-dimensional environment (e.g., the second object is optionally a user interface of a messaging application to which the fifth object (e.g., the images folder and/or user interface and/or window including the sixth object (e.g., the photograph)) has been added to the messaging conversation displayed in the second object.). Displaying a first object and a second object containing the first object in a drop target when the second object is added to the drop target facilitates user input for adding multiple nested objects to a single drop target, thereby improving user-device interaction.

In some embodiments, the three-dimensional environment includes a fifth object at a fourth location in the three-dimensional environment, the fifth object containing a sixth object (1428a), such as virtual object 1311a containing virtual object 1304a as shown in FIG. 13A and/or virtual object 1317a containing virtual object 1306a as shown in FIG. 13D (e.g., the fifth object is optionally a container that displays the sixth object at the fourth location in the three-dimensional environment. In some embodiments, the fifth object is optionally a quick look window in which the sixth object (e.g., a photograph) is optionally displayed and contained for later retrieval by the user. In some embodiments, display of the quick look window containing the photograph in the three-dimensional environment is optionally temporary, such that movement of the photograph from the quick look window to a new location (e.g., to an existing object that is a valid drop target for the photograph) causes the quick look window that was containing the photograph to be closed. In some embodiments, the quick look window is optionally associated with one or more controls for controlling the placement, display, or other characteristics of the photograph. In some embodiments, the one or more controls are optionally displayed above and/or atop the quick look window within a toolbar. In some embodiments, intent is required for the toolbar containing the one or more controls to be displayed in the three-dimensional environment (e.g., in response to detecting that the user's gaze is directed at the third object.).

In some embodiments, while displaying the three-dimensional environment including the fifth object that contains the sixth object at the fourth location in the three-dimensional environment (1428b), in accordance with a determination that one or more second criteria are satisfied, including a criterion that is satisfied when a gaze (e.g., gaze 1321) of a user of the electronic device is directed to the fifth object (e.g., and without regard to whether a hand of the user is performing a pinch gesture or pinch hand shape of an index finger and thumb of the hand of the user directed at the fifth object), the electronic device displays (1428c), via the display generation component, one or more interface elements associated with the fifth object at the fourth location in the three-dimensional environment, such as display of toolbar 1323 as shown in FIG. 13D (e.g., the fifth object is optionally a quick look window, and the one or more interface elements associated with the fifth object are optionally one or more controls for controlling the placement, display, or other characteristics of the sixth object (e.g., the photograph). In some embodiments, the one or more interface elements are displayed horizontally above and/or atop the fifth object in the three-dimensional environment. In some embodiments, the one or more interface elements are displayed horizontally below the fifth object in the three-dimensional environment, or vertically to a side of the fifth object in the three-dimensional environment. In some embodiments, the one or more controls include a “grabber bar” that is selectable by a user to move the fifth and sixth objects in the three-dimensional environment. In some embodiments, displaying the one or more controls includes displaying a boundary/outer edges of the quick look window, such that an appearance of the quick look window is differentiable from the object (e.g., the sixth object) the quick look contains.).

In some embodiments, in accordance with a determination that the one or more second criteria are not satisfied (e.g., in accordance with a determination that the gaze of the user of the electronic device is not directed to the fifth object), the electronic device forgoes (1428d) display of the one or more interface elements associated with the fifth object, such as forgoing display of toolbar 1323 as shown in FIG. 13A (e.g., the one or more controls for controlling the placement, display, or other characteristics of the sixth object (e.g., the photograph) are not displayed in the three-dimensional environment. In some embodiments, the boundary/outer edges of the quick look window that differentiate the quick look window from the object (e.g., the sixth object) the quick look window contains is not displayed in the three-dimensional environment.). Displaying controls associated with an object in the three-dimensional environment based on gaze facilitates user input for manipulating the object using one or more of the controls, without consuming space when the user is not looking at the object, thereby improving user-device interaction.

In some embodiments, the one or more second criteria include a criterion that is satisfied when a predefined portion of the user of the electronic device has a respective pose (e.g., a head of the user is angled/tilted/oriented towards at least a portion of the fifth object (e.g., toward at least a portion (e.g., a corner, edge, or middle region of the quick look window), and/or a hand of the user is raised and in a pre-pinch hand shape in which the index finger and thumb of the hand are not touching each other but are within a threshold distance (e.g., 0.1, 0.2, 0.5, 1, 2, 3, 5, 10, or 20 cm) of each other, etc.), and not satisfied when the predefined portion of the user of the electronic device does not have the respective pose (1430), as described previously with reference to FIG. 13D (e.g., the head of the user is not angled/tilted/oriented towards the fifth object, and/or the hand of the user is not raised and/or is not in the pre-pinch hand shape, etc.). Requiring that the display of controls associated with an object is intentional avoids unintentional display of the controls associated with the object in the three-dimensional environment, thereby improving user-device interaction and avoiding accidental interaction with the controls.

In some embodiments, in response to receiving the first input (1432a), in accordance with the determination that the first input corresponds to movement of the first object to the third location in the three-dimensional environment that does not include the object, such as movement of virtual object 1306a by hand 1305c as shown in FIG. 13C (e.g., the movement of the hand corresponds to movement of the first object to the third location in the three-dimensional environment, where the third location optionally corresponds to “empty” space within the three-dimensional environment. In some embodiments, the movement of the hand alternatively corresponds to movement of the first object to a location that does include an object, but the object is not a valid drop target for the first object (e.g., the object is not an object that can contain, accept and/or display the first object). In some embodiments, the first object, which is optionally a photograph, is displayed within the three-dimensional environment in an object that has a respective characteristic (e.g., the photograph is displayed in a quick look window).), the first object is displayed at the third location with a first respective user interface element associated with the first object for moving the first object in the three-dimensional environment (1432b), such as display of grabber or handlebar 1315 as shown in FIG. 13D (e.g., the first respective user interface element is a grabber or handlebar configured to be selectable for moving the first object (e.g., the photograph) to a respective location in the three-dimensional environment. In some embodiments, the grabber or handlebar is displayed below the first object. In some embodiments, the grabber or handlebar is displayed atop/above, or to a side of, the first object. In some embodiments, a pinch gesture of an index finger and thumb of a hand of the user directed to/toward the grabber or handlebar, subsequently followed by movement of the hand in the pinched hand shape, optionally moves the first object toward the respective location in the three-dimensional environment. In some embodiments in which the first object is displayed in a quick look window at the third location in the three-dimensional environment, the grabber or handlebar is displayed as a portion of the quick look window (e.g., at or along the bottom portion/edge of the quick look window) for moving the quick look window, and thus the first object, to the respective location in the three-dimensional environment.).

In some embodiments, in accordance with the determination that that first input corresponds to movement of the first object to the second location in the three-dimensional environment, such as movement of virtual object 1304a by hand 1303a as shown in FIG. 13A (e.g., the movement of the hand corresponds to movement of the first object to/toward the second object at the second location in the three-dimensional environment) and in accordance with a determination that the one or more criteria are satisfied (e.g., the second object is a valid drop target for the first object, such as an object that can accept and/or contain the first object. For example, the second object is optionally a user interface of a messaging application that includes a text entry field into which the photograph can be dropped to be added to the messaging conversation displayed in the second object. In some embodiments, the one or more criteria are not satisfied if the second object is not a valid drop target for the first object), the first object is displayed at the second location without the first respective user interface element associated with the first object for moving the first object in the three-dimensional environment (1432c), such as display of virtual object 1304a within virtual object 1307a as shown in FIG. 13C without the grabber or handlebar 1315 (e.g., the first object is moved from the first location in the three-dimensional environment to the second location in the three-dimensional environment in accordance with the input, where the second location includes the second object. For example, the second object receives and/or displays the first object in the three-dimensional environment (e.g., the second object is optionally a user interface of a messaging application that includes a text entry field into which the first object (e.g., the photograph) was dropped and added to the messaging conversation displayed in the second object). In some embodiments, the first object that is displayed in the second object is not displayed with a grabber or handlebar configured to be selectable for moving the first object (e.g., the photograph) to a respective location in the three-dimensional environment. For example, the grabber or handlebar is optionally not displayed because the first object is displayed in an object (e.g., the second object) that is not a quick look window. In some embodiments, the second object, rather than the first object, is displayed with its own grabber bar for moving the second object in the three-dimensional environment). In some embodiments, selection of the grabber or handlebar is not required for movement of the first object, but nonetheless indicates that the first object can be moved independently of other objects in the three-dimensional environment. For example, movement input directed to the first object itself, and not necessarily the grabber or handlebar, is optionally sufficient for movement of the first object in the three-dimensional environment. In some embodiments, the grabber or handlebar changes appearance (e.g., becomes faded, or becomes translucent, or is displayed with less contrast, etc.) in response to selection and/or movement of the first object and/or changes in appearance (e.g., becomes less faded, or becomes less translucent or more opaque, or is displayed with more contrast, etc.) in response to a hand of the user moving to within a threshold distance (e.g., 0.1, 0.3, 0.5, 1, 2, 3, 5, 10, 20, 50, or 100 cm) of the first object to indicate that the first object and/or the grabber is selectable (e.g., for subsequent movement of the first object). In some embodiments, the grabber or handlebar is selectable to display management controls for the first object (e.g., the one or more interface elements described above) for the first object (e.g., minimize tool that is selectable to minimize the first object, share tool that is selectable to share the first object with another user, close tool that is selectable to close the first object, etc.). Displaying a grabber for a placeholder object containing an object facilitates user input for moving the placeholder object and the object within the three-dimensional environment, and/or facilitates discovery that the placeholder object containing the object can be moved within the three-dimensional environment, thereby improving user-device interaction.

In some embodiments, while displaying the first object at the third location with the first respective user interface element associated with the first respective object for moving the first respective object in the three-dimensional environment, such as display of virtual object 1304a with grabber or handlebar 1315 as shown in FIG. 13A (e.g., the first object is a photograph contained and/or displayed within a quick look window at the third location in the three-dimensional environment. In some embodiments, the photograph is displayed in the quick look window after being moved to and dropped in the third location, which optionally corresponds to “empty” space in the three-dimensional environment. In some embodiments, the first respective user interface element is a grabber or handlebar configured to be selectable for moving the quick look window containing the first object. For example, the grabber or handlebar is displayed as a portion of the quick look window (e.g., at or along a bottom portion/edge of the quick look window) for moving the quick look window, and thus the first object, to the respective location in the three-dimensional environment. In some embodiments, movement of the quick look window using the handlebar or grabber bar concurrently causes movement of the first object (e.g., the photograph) with the movement of the quick look window.), the electronic device receives (1434a), via the one or more input devices, a second input corresponding to a request to move the first object in the three-dimensional environment, such as movement of virtual object 1304a by hand 1303a as shown in FIG. 13A (e.g., while the gaze of the user is directed to the first object, the quick look window and/or the grabber bar for the quick look window, a pinch gesture of an index finger and thumb of a hand of the user directed to/toward the first object and/or the first respective user interface element (e.g., the grabber/handlebar), subsequently followed by movement of the hand in the pinched hand shape toward a respective location (e.g., away from the third location) in the three-dimensional environment. In some embodiments, during the second input, the hand of the user is greater than a threshold distance (e.g., 0.2, 0.5, 1, 2, 3, 5, 10, 12, 24, or 26 cm) from the first object and/or the grabber/handlebar. In some embodiments, a pinch gesture directed at either the first respective user interface element or the first object causes selection of the first object and/or the quick look window containing the first object for movement of the first object to the respective location in the three-dimensional environment. In some embodiments, the second input is a pinch of the index finger and thumb of the hand of the user followed by movement of the hand in the pinched hand shape toward the respective location in the three-dimensional environment, irrespective of the location of the gaze of the user when the hand of the user is less than the threshold distance from the first respective user interface element and/or the first object. In some embodiments, the second input has one or more of the characteristics of the input(s) described with reference to methods 800, 1000, 1200, 1600 and/or 1800.).

In some embodiments, while receiving the second input (1434b), the electronic device ceases (1434c) display of the first respective user interface element, such as ceasing display of grabber or handlebar 1315 as shown in FIG. 13C (e.g., the grabber or handlebar is no longer displayed in the three-dimensional environment as the quick look window containing the first object is moved toward a respective location in the three-dimensional environment. In some embodiments, the grabber or handlebar is no longer displayed irrespective of whether the pinch gesture of the index finger and thumb of the hand of the user is directed to/toward the grabber or handlebar (e.g., even if the pinch gesture is directed to the first object, and not to the grabber/handlebar, the grabber/handlebar is no longer displayed in the three-dimensional environment).).

In some embodiments, the electronic device moves (1434d) a representation of the first object in the three-dimensional environment in accordance with the second input, such as movement of virtual object 1304a as shown in FIG. 13B (e.g., the quick look window containing and/or displaying the photograph is moved within the three-dimensional environment to the respective location. In some embodiments, the photograph is moved concurrently with the quick look window because the quick look window contains the photograph.). Ceasing display of a grabber bar of an object when the object is being moved within the three-dimensional environment prevents the grabber bar from obstructing a field of view of the user as the object is moved within the three-dimensional environment, thereby improving user-device interaction.

In some embodiments, the three-dimensional environment includes a third object at a fourth location in the three-dimensional environment (1436a), such as virtual object 1306a in FIG. 13A (e.g., the third object is optionally not a container that can accept and/or display the first object. The third object is optionally a web page of a web browsing application displaying one or more objects (e.g., images, text, etc.), but is not configured to accept and/or contain the first object (e.g., the photograph).).

In some embodiments, while displaying the three-dimensional environment including the second object containing the first object at the second location in the three-dimensional environment and the third object at the fourth location in the three-dimensional environment, the electronic device receives (1436b), via the one or more input devices, a second input, including a first portion of the second input corresponding to a request to move the first object away from the second object at the second location in the three-dimensional environment followed by a second portion of the second input, such as movement of virtual object 1306a by hand 1305a as shown in FIG. 13A (e.g., while the gaze of the user is directed to the first object, a pinch gesture of an index finger and thumb of a hand of the user directed to/toward the first object in the second object, subsequently followed by movement of the hand in the pinched hand shape toward a respective location (e.g., away from second location) in the three-dimensional environment. For example, the first portion of the second input optionally moves the first object away from the second object, and the second portion of the second input after the first portion optionally moves the first object to the respective location in the three-dimensional environment. In some embodiments, during the second input, the hand of the user is greater than a threshold distance (e.g., 0.2, 0.5, 1, 2, 3, 5, 10, 12, 24, or 26 cm) from the first object contained in the second object. In some embodiments, the second input is a pinch of the index finger and thumb of the hand of the user followed by movement of the hand in the pinched hand shape toward the respective location in the three-dimensional environment, irrespective of the location of the gaze of the user when the hand of the user is less than the threshold distance from the first object. In some embodiments, the second input has one or more of the characteristics of the input(s) described with reference to methods 800, 1000, 1200, 1600 and/or 1800.).

In some embodiments, while receiving the first portion of the second input, the electronic device moves (1436c) the representation of the first object away from the second object at the second location in the three-dimensional environment in accordance with the first portion of the second input, such as movement of virtual object 1306a as shown in FIG. 13B (e.g., the first object is removed from the second object at the second location in the three-dimensional environment (e.g., and moved towards the viewpoint of the user), and subsequently moved following the pinch gesture of the index finger and the thumb of the hand of the user. The second object is optionally a user interface of a messaging application displaying a messaging conversation including the first object, which is optionally the photograph, and the first portion of the second input optionally removes a representation of the photograph from the messaging conversation.).

In some embodiments, in response to detecting an end of the second portion of the second input (1436d), such as release of virtual object 1306a by hand 1305b as shown in FIG. 13B (e.g., in response to detecting an end to movement of the first object to the respective location in the three-dimensional environment, such as detecting the hand of the user releasing the pinch hand shape (e.g., the index finger and thumb of the hand of the user move apart from one another)), in accordance with a determination that the second portion of the second input corresponds to movement of the first object to the fourth location in the three-dimensional environment and that one or more second criteria are not satisfied because the third object is not a valid drop target for the first object, such as virtual object 1309a being an invalid drop target for virtual object 1306a in FIG. 13B (e.g., the second portion of the second input optionally moves the first object (e.g., the photograph) to the third object at the fourth location in the three-dimensional environment, which is optionally not a container that can contain and/or accept the first object. The third object is optionally a web page of a web browsing application that cannot accept the photograph.), the electronic device maintains (1436e) display of the first object in the second object at the second location in the three-dimensional environment, such as display of virtual object 1306a within virtual object 1313a as shown in FIG. 13C (e.g., the first object is not added to and/or displayed in the third object. In some embodiments, the representation of the first object moves back to the second object (e.g., the originating object) and is displayed in the second object at the second location in the three-dimensional environment. For example, the photograph remains displayed at the same location in the messaging conversation displayed in the second object at which it was displayed before the second input was detected.).

In some embodiments, in accordance with a determination that the second portion of the second input corresponds to movement of the first object to the second location in the three-dimensional environment, as described previously with reference to FIG. 13D (e.g., after the first portion of the second input removes the representation of the first object from the second object, the second portion moves the representation of the first object back to the second object (e.g., the originating object). The second object is optionally a container that can accept and/or contain the first object, even after the first object is removed from the second object.), the electronic device maintains (14360 display of the first object in the second object at the second location in the three-dimensional environment, such as display of virtual object 1306a within virtual object 1313a as shown in FIG. 13C (e.g., the first object is not added to and/or displayed in the second object as a new object, but is displayed in the second object as the original first object. The photograph is optionally maintained at the original location in the messaging conversation (e.g., prior to the first portion of the second input), and is not added to the messaging conversation as a new message containing the photograph.). Providing functionality for cancelling movement of an object (e.g., to empty space in the three-dimensional environment or to a drop target) in the three-dimensional environment avoids movements of objects that are no longer desired, thereby improving user-device interaction.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

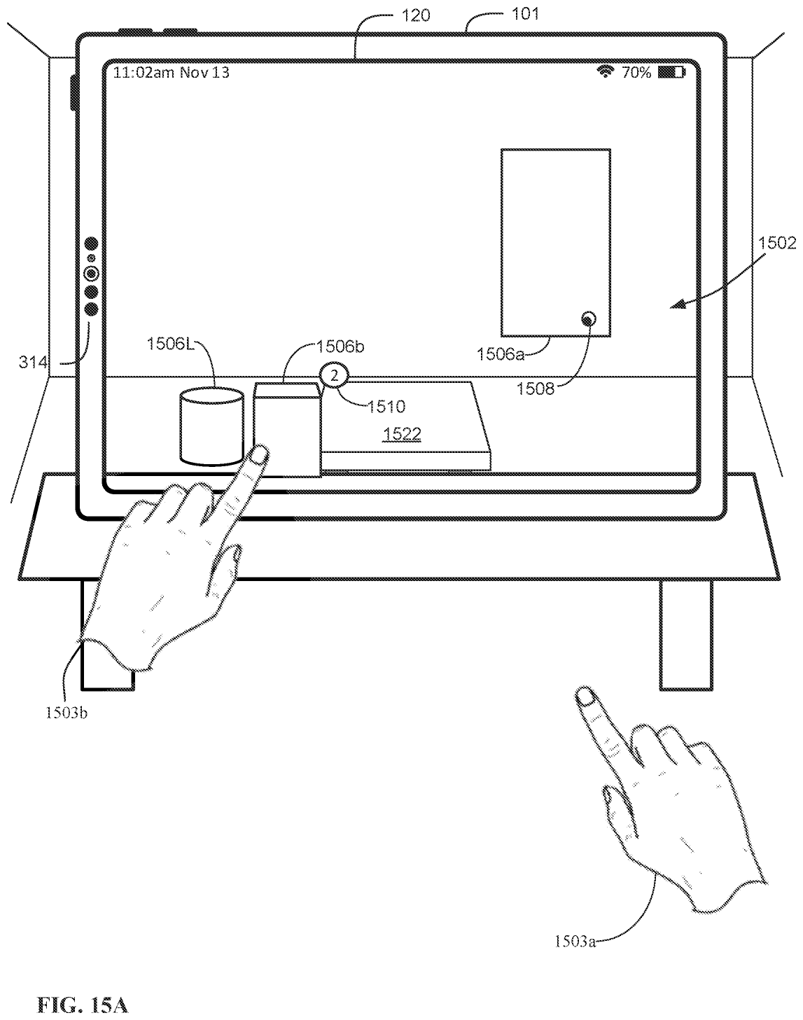

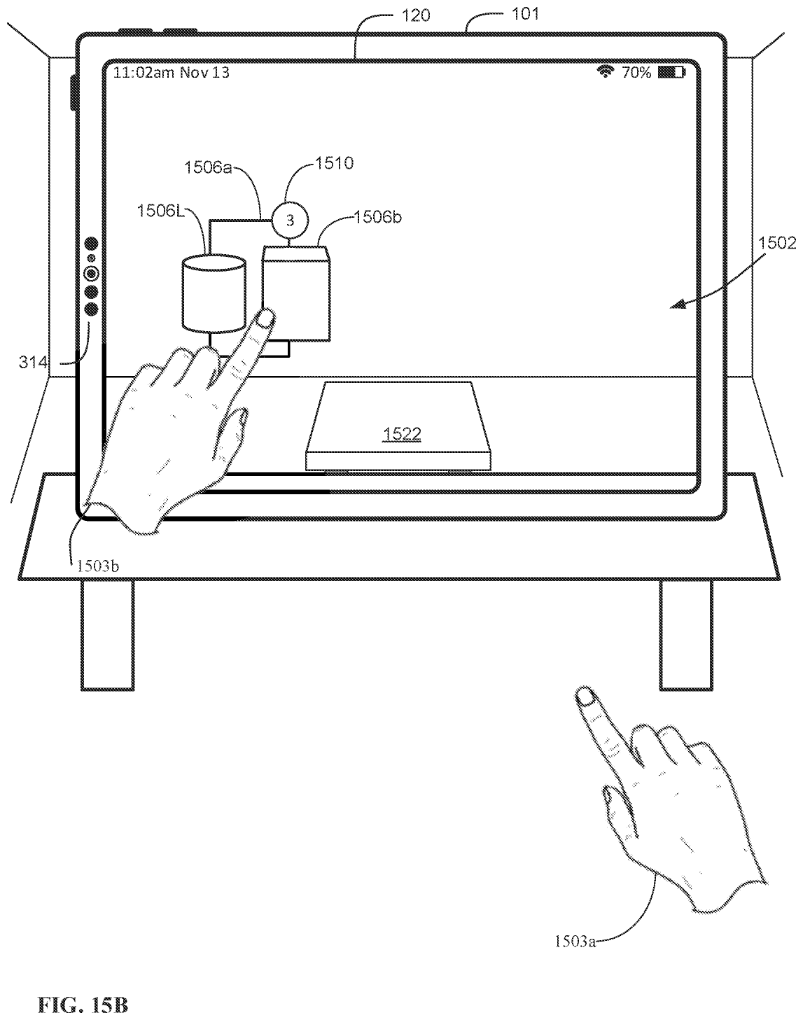

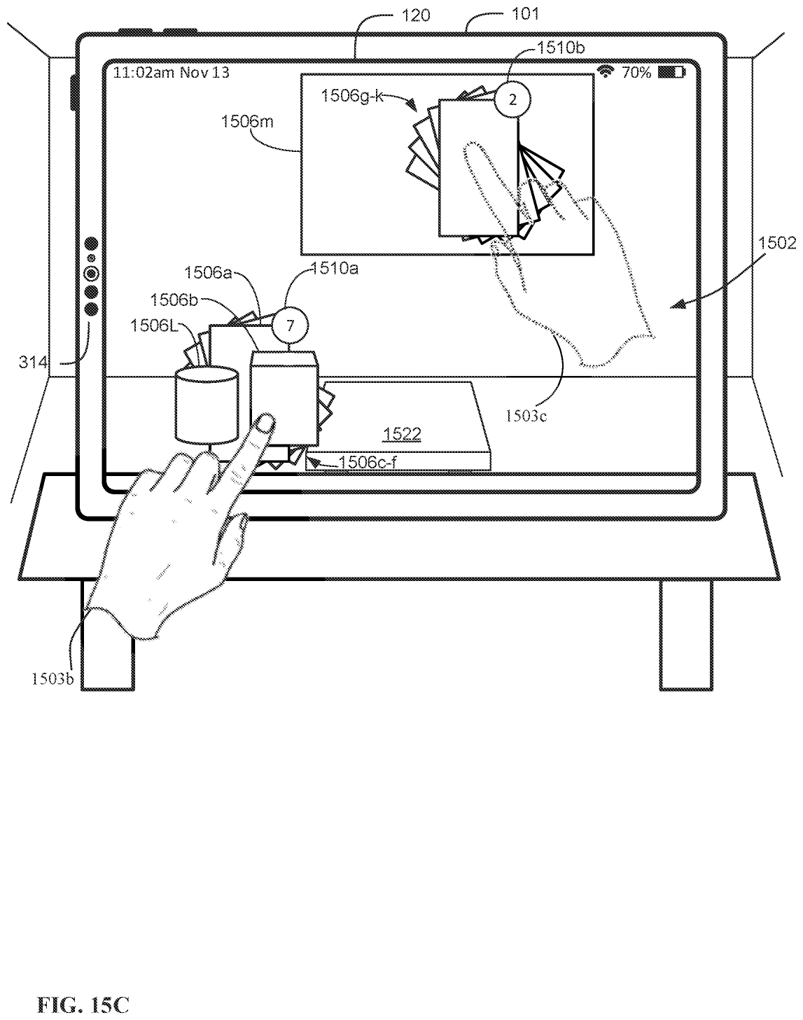

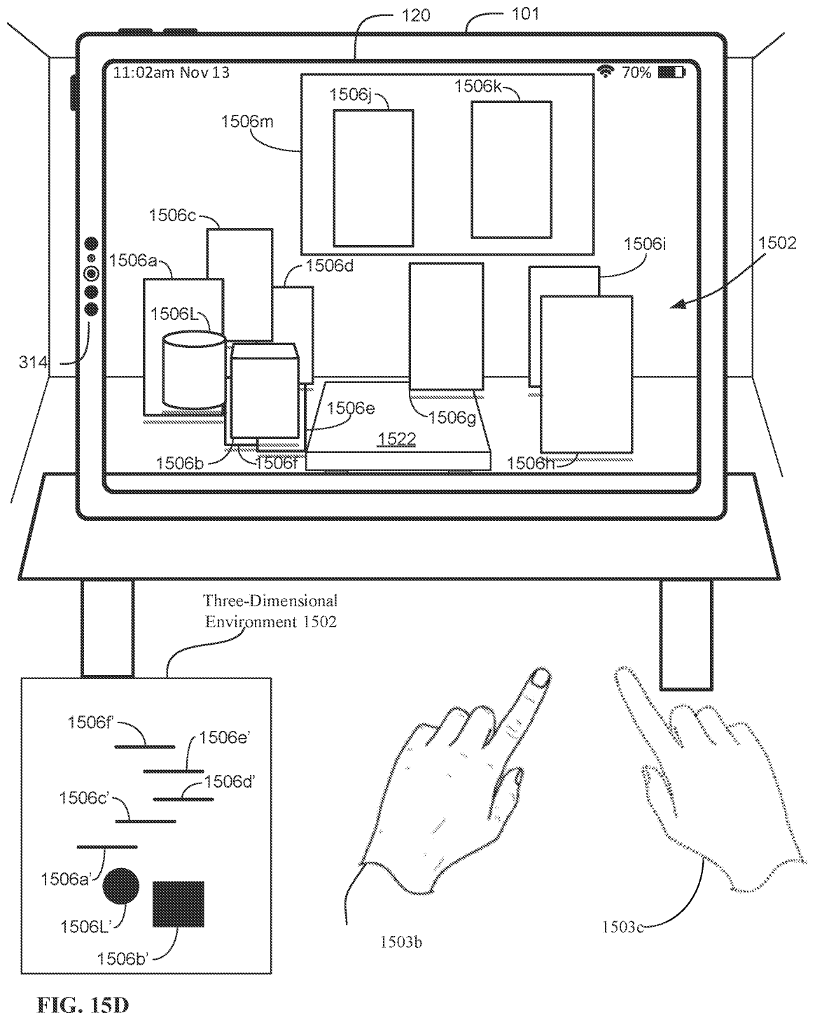

FIGS. 15A-15D illustrate examples of an electronic device facilitating the movement and/or placement of multiple virtual objects in a three-dimensional environment in accordance with some embodiments.

FIG. 15A illustrates an electronic device 101 displaying, via a display generation component (e.g., display generation component 120 of FIG. 1), a three-dimensional environment 1502 from a viewpoint of a user of the electronic device 101. As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user).

As shown in FIG. 15A, device 101 captures one or more images of the physical environment around device 101 (e.g., operating environment 100), including one or more objects in the physical environment around device 101. In some embodiments, device 101 displays representations of the physical environment in three-dimensional environment 1502. For example, three-dimensional environment 1502 includes a representation 1522 of a table, which is optionally a representation of a physical table in the physical environment, and three-dimensional environment 1502 includes a portion of a table on which device 101 is disposed or resting in the physical environment. Three-dimensional environment 1502 also includes representations of the physical floor and back wall of the room in which device 101 is located.

In FIG. 15A, three-dimensional environment 1502 also includes virtual objects 1506a, 1506b and 1506L. Virtual objects 1506a, 1506b and 1506L are optionally one or more of user interfaces of applications (e.g., messaging user interfaces, content browsing user interfaces, etc.), three-dimensional objects (e.g., virtual clocks, virtual balls, virtual cars, etc.) or any other element displayed by device 101 that is not included in the physical environment of device 101. In FIG. 15A, virtual object 1506a is a two-dimensional object, and virtual objects 1506b and 1506L are three-dimensional objects.

In some embodiments, a user of device 101 is able to provide input to device 101 to move one or more virtual objects in three-dimensional environment 1502. For example, a user is optionally able to provide input to add, using a first hand of the user (e.g., right hand), one or more objects to a collection of one or more objects that are moved together in three-dimensional environment 1502 based on the movement of the other hand of the user (e.g., left hand). In particular, in some embodiments, in response to a pinch gesture (e.g., thumb and tip of index finger coming together and touching) performed by hand 1503b while hand 1503b is closer than a threshold distance (e.g., 0.1, 0.3, 0.5, 1, 3, 5, 10, 20, 30, or 50 cm) from object 1506L, and subsequent maintenance of the pinch hand shape (e.g., thumb and tip of index finger remaining touching) by hand 1503b, device 101 moves object 1506L in three-dimensional environment 1502 in accordance with movement of hand 1503b while maintaining the pinch hand shape. In some embodiments, the input to control the movement of object 1506L is instead the pinch gesture performed by hand 1503b while hand 1503b is further than the threshold distance from object 1506L while the gaze 1508 of the user is directed to object 1506L, and subsequent maintenance of the pinch hand shape by hand 1503b. Movement of object 1506L then optionally results from movement of hand 1503b while maintaining the pinch hand shape.

Additional virtual objects can be added to the collection of virtual object(s) being controlled by hand 1503b. For example, while hand 1503b is controlling object 1506L, detection by device 101 of the pinch gesture performed by hand 1503a while the gaze 1508 of the user is directed to object 1506b, followed by release of the pinch gesture (e.g., the thumb and tip of the index finger moving apart) optionally causes device 101 to move object 1506b near/proximate to/adjacent to object 1506L in three-dimensional environment 1502, such that both objects 1506b and 1506L will be now be moved, together, in three-dimensional environment 1502 in accordance with the movement of hand 1503b while hand 1503b maintains the pinch hand shape. In some embodiments, adding an object to the collection of virtual objects being controlled by hand 1503b causes the relative position(s) of the pre-existing virtual object(s) in the collection relative to a portion of hand 1503b (e.g., the pinch point between the tip of the index finger and thumb) to change, such that the portion of the hand remains centered (or relatively centered or having another predefined relative position) in the collection of virtual objects.

In FIG. 15A, objects 1506L and 1506b are both being controlled by hand 1503b, as previously described. In some embodiments, when more than one (or more than another threshold, such as zero, two, three, five, seven, or ten) objects are being controlled by hand 1503b, device 101 displays, in three-dimensional environment 1502, an indication 1510 of the number of objects being controlled by hand 1503b. Indication 1510 is optionally displayed on a predefined portion (e.g., upper right portion) of one of the objects being controlled by hand 1503b, on a boundary of a bounding box or volume surrounding one of the objects being controlled by hand 1503b, or on a boundary of a bounding box or volume surrounding a plurality of (e.g., all of the) objects being controlled by hand 1503b. In some embodiments, the bounding box or volume is not displayed in three-dimensional environment 1502, and in some embodiments, the bounding box or volume is displayed in three-dimensional environment 1502. Additional details about indication 1510 and/or the placement of indication 1510 are provided with reference to method 1600.

In FIG. 15A, device 101 detects an input to add another object—object 1506a—to the collection of objects being controlled by hand 1503b. For example, device 101 detects hand 1503a perform a pinch and release gesture while gaze 1508 of the user is directed to object 1506a, and while hand 1503b is controlling objects 1506L and 1506b. In response, device 101 adds object 1506a to the collection of objects being controlled by hand 1503b, as shown in FIG. 15B. In FIG. 15B, hand 1503b is now controlling objects 1506L, 1506b and 1506a. In some embodiments, when device 101 adds an object to the stack of objects being controlled by hand 1503b, device 101 scales the added object (e.g., while that object remains in the stack) to correspond to the dimensions of other objects in the stack of objects—additional details about the scaling of objects added to the stack of objects are provided with reference to method 1600. In FIG. 15B, hand 1503b has also moved relative to FIG. 15A—as such, objects 1506L, 1506b and 1506a have moved together to a new location in three-dimensional environment 1502. Further, device 101 has updated indication 1510 to indicate that there are now three objects being controlled by hand 1503b.

In some embodiments, three-dimensional objects that are being controlled by hand 1503b are displayed at the top (e.g., closest to the viewpoint of the user) of the stack of objects being controlled by hand 1503b, even if some two-dimensional objects have been added to the stack after the three-dimensional objects were added to the stack. Ordinarily, in some embodiments, more recently added objects are displayed closer to the top of the stack, and less recently added objects are displayed closer to the bottom (e.g., furthest from the viewpoint of the user) of the stack. However, three-dimensional objects are optionally promoted to the top of the stack independent of the order in which they were added to the stack—though in some embodiments, three-dimensional objects are ordered based on recency of being added to the stack amongst themselves, and two-dimensional objects are ordered based on recency of being added to the stack amongst themselves. Because of the above, as shown in FIG. 15B, object 1506a—which is a two-dimensional object—is added behind objects 1506L and 1506b—which are three-dimensional objects—in the stack of objects being controlled by hand 1503b. Further, in some embodiments, the bottom planes or surfaces of objects 1506L and 1506b (e.g., the planes or surfaces of those objects oriented towards the floor in three-dimensional environment 1502) are perpendicular or substantially perpendicular to object 1506a. In some embodiments, indication 1510 is displayed on a predefined portion (e.g., upper right portion) of the top object in the stack being controlled by hand 1503b, or on a boundary of a bounding box or volume surrounding the top object in the stack being controlled by hand 1503b.

In FIG. 15C, hand 1503b is now controlling objects 1506L and 1506a-f. For example, relative to FIG. 15B, device 101 has optionally detected one or more inputs—as previously described—for adding objects 1506c-f to the stack of objects being controlled by hand 1503b. Hand 1503b has also moved relative to FIG. 15B—as such, objects 1506L 1506a-f have moved together to a new location in three-dimensional environment 1502. Further, device 101 has updated indication 1510a to indicate that there are now seven objects being controlled by hand 1503b. Additionally, when the stack of objects being controlled by hand 1503b includes more than one two-dimensional object, the two-dimensional objects are optionally arranged, from top to bottom, in a fanning out manner such that objects are rotated about the axis of the viewpoint of the user with respect to one another along the sequence of positions in the stack of objects, as shown for objects 1506a and 1506c-f. Further, objects 1506a and 1506c-f are optionally parallel with one another, and/or are optionally in contact with one another (or having a small amount of separation from one another, such as 0.01, 0.05, 0.1, 0.3, 0.5, 1, 2, 3, 5, 10, 20, 30, or 50 cm).

FIG. 15C also illustrates hand 1503c controlling a stack of objects 1506g-k. In some embodiments, hand 1503c is the same hand as hand 1503b, but detected by device 101 at a different time than what is shown with reference to hand 1503b. In some embodiments, hand 1503c is a different hand than hand 1503b and detected at the same time as what is shown with reference to hand 1503b, or detected at a different time than what is shown with reference to hand 1503b. Virtual object 1506m is optionally a drop target for one or more virtual objects (e.g., those one or more virtual objects can be added to object 1506m). For example, object 1506m is optionally a user interface of a messaging application into which virtual objects can be added to add those virtual objects to a messaging conversation being displayed and/or facilitated by object 1506m. In FIG. 15C, hand 1503c has moved the stack of objects 1506g-k over object 1506m. In some embodiments, in response to stack of objects 1506g-k being moved over object 1506m, device 101 updates indication 1510b displayed with the stack of objects 1506g-k, not to indicate the total number of objects included in the stack, but rather to indicate the total number of objects in the stack for which object 1506m is a valid drop target. Thus, in FIG. 15C, device 101 has updated indication 1510b to indicate that object 1506m is a valid drop target for two objects in the stack of objects 1506g-k—therefore, object 1506m is optionally not a valid drop target for the remaining five objects in the stack of objects 1506g-k. If hand 1503c were to provide an input to drop the stack of objects 1506g-k (e.g., release of the pinch hand shape) while the stack is over/on object 1506m, only two of the objects in the stack would optionally be added to object 1506m, while the other objects in the stack would not be, as will be described in more detail below and with reference to method 1600.

In some embodiments, device 101 places objects in three-dimensional environment 1502 differently when those objects are dropped in empty space (e.g., not containing any virtual and/or physical objects) as opposed to being dropped in another object (e.g., a drop target). For example, in FIG. 15D, device 101 has detected hand 1503b drop (e.g., via a release of the pinch hand shape) objects 1506a-f and 1506L in empty space in three-dimensional environment 1502. In response to the drop input, objects 1506a-f and 1506L are optionally dispersed and/or spaced apart in three-dimensional environment 1502 in a spiral pattern, as shown on device 101 and in the overhead view of three-dimensional environment 1502 including objects 1506a′-f and 1506L′ (corresponding to objects 1506a-f and 1506L, respectively) in FIG. 15D. In some embodiments, device 101 rescales objects 1506a-f and 1506L to the respective sizes those objects had before and/or when those objects were added to the stack of objects being controlled by hand 1503b. Device 101 also optionally ceases display of indication 1510a. The tip of the spiral pattern (e.g., closest to the viewpoint of the user) is optionally defined by the location in three-dimensional environment 1502 corresponding to the pinch point of hand 1503b (e.g., the location corresponding to the point between the tip of the thumb and the tip of the index finger when the thumb and index finger were touching) when the pinch hand shape was released; in some embodiments, the object that was at the top of the stack (e.g., object 1506b) is placed at that location. The remaining objects in the stack are optionally placed at successively greater distances from the viewpoint of the user, fanning out horizontally and/or vertically by greater amounts, in accordance with a spiral pattern that optionally widens as a function of the distance from the viewpoint of the user.

Further, the remaining objects are optionally placed in the spiral pattern (e.g., further and further from the viewpoint of the user) in accordance with the positions of those objects in the stack of objects. For example, object 1506L was optionally the second-highest object in the stack, and it is optionally placed behind object 1506b in accordance with the spiral pattern. Objects 1506a, c, d, e, f were optionally the subsequently ordered objects in the stack, and they are optionally sequentially placed behind object 1506L at further and further distances from the viewpoint of the user in accordance with the spiral pattern. The separation of objects 1506L and 1506a-f in the spiral pattern along the axis of the viewpoint of the user is optionally greater than the separation the objects had from one another along the axis of the viewpoint of the user when the objects were arranged in the stack of objects. Placing the dropped objects according to a spiral pattern optionally facilitates visibility of the objects for the user, thereby allowing for individual interaction with objects after they have been dropped.

In FIG. 15D, device 101 has additionally or alternatively detected hand 1503c drop (e.g., via release of the pinch hand shape) objects 1506g-k in object 1506m. In response to the drop input, objects 1506j-k have been added to object 1506m (e.g., because object 1506m is a valid drop target for objects 1506j-k), and objects 1506g-i have not been added to object 1506m (e.g., because object 1506m is not a valid drop target for objects 1506g-i). Additional details relating to valid and invalid drop targets are provided with reference to method 1600. Device 101 also optionally ceases display of indication 1510b. Objects 1506g-i for which object 1506m is not a valid drop target are optionally moved by device 101 to locations in three-dimensional environment 1502 at which objects 1506g-i were located before and/or when those objects were added to the stack of objects being controlled by hand 1503c. In some embodiments, device 101 rescales objects 1506g-i to the respective sizes those objects had before and/or when those objects were added to the stack of objects being controlled by hand 1503c. In some embodiments, device 101 rescales objects 1506j-k based on the size of object 1506m, as described in more detail with reference to method 1000.

In some embodiments, when objects are displayed in empty space in three-dimensional environment 1502, they are displayed with respective grabber bars, as shown in FIG. 15D. Grabber bars are optionally elements to which user-provided input is directed to control the locations of their corresponding objects in three-dimensional environment 1502, though in some embodiments, input is directed to the objects themselves (and not directed to the grabber bars) to control the locations of the objects in the three-dimensional environment. Thus, in some embodiments, the existence of a grabber bar indicates that an object is able to be independently positioned in the three-dimensional environment, as described in more detail with reference to method 1600. In some embodiments, the grabber bars are displayed underneath and/or slightly in front of (e.g., closer to the viewpoint of the user than) their corresponding objects. For example, in FIG. 15D, objects 1506a-i and 1506L are displayed with grabber bars for individually controlling the locations of those objects in three-dimensional environment 1502. In contrast, when objects are displayed within another object (e.g., a drop target), those objects are not displayed with grabber bars. For example, in FIG. 15D, objects 1506j-k—which are displayed within object 1506m—are not displayed with grabber bars.

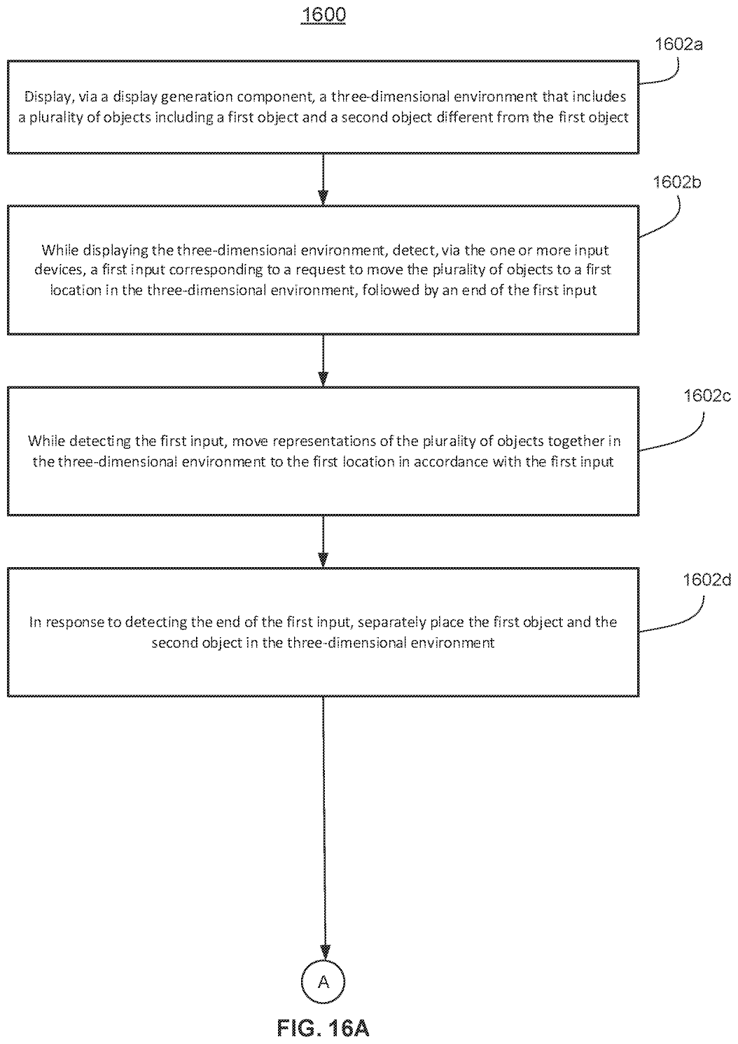

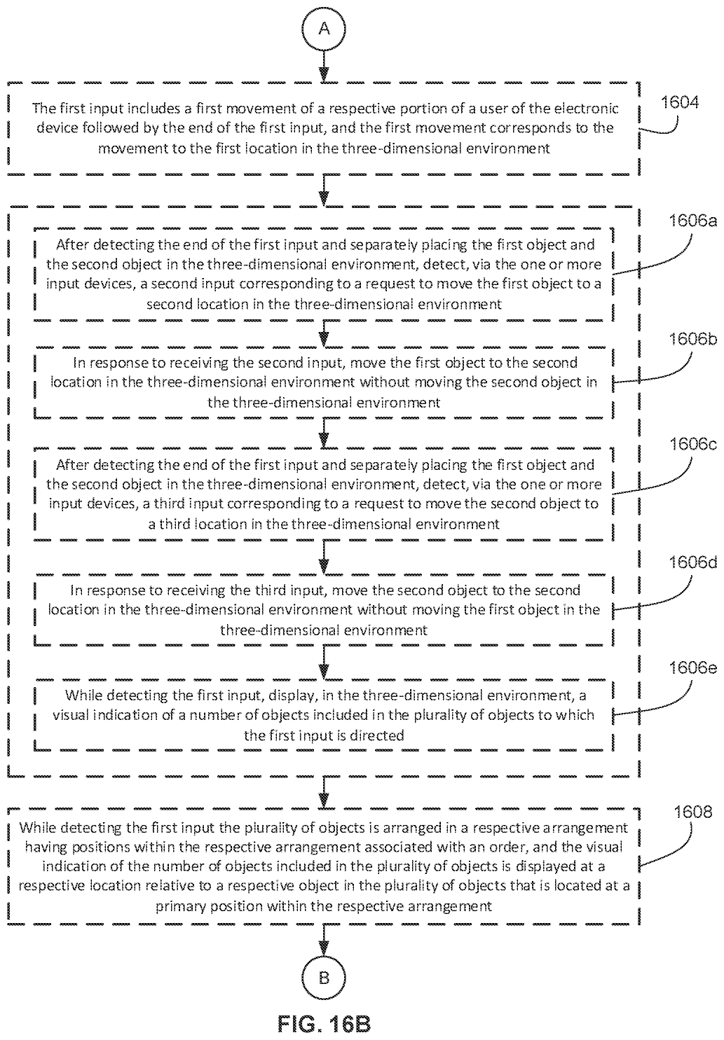

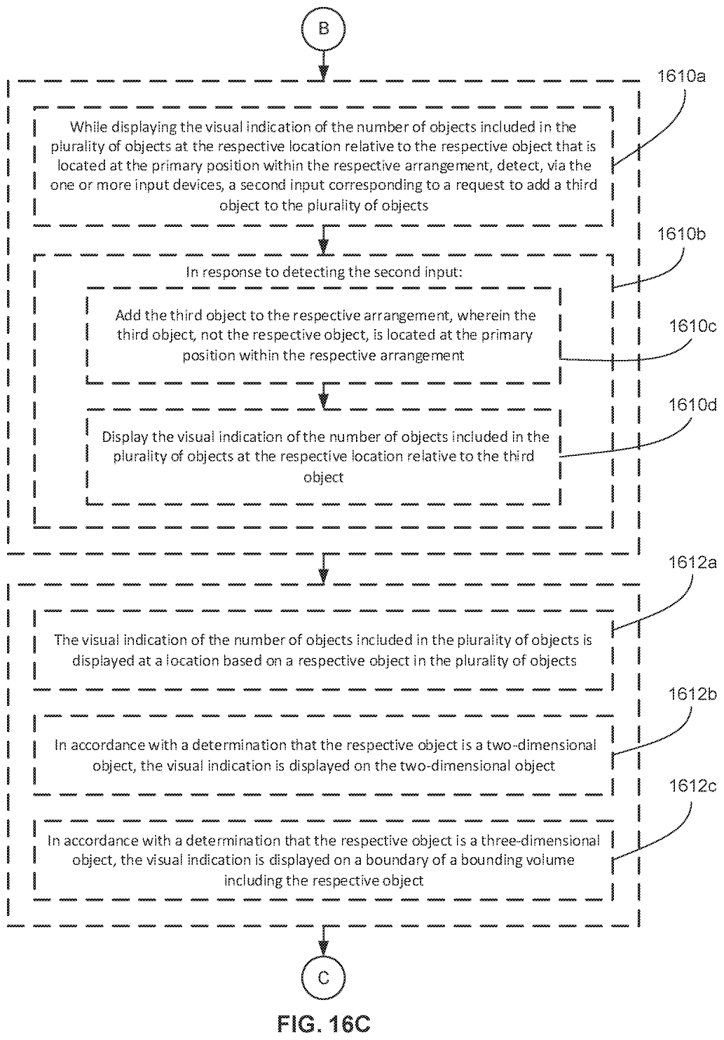

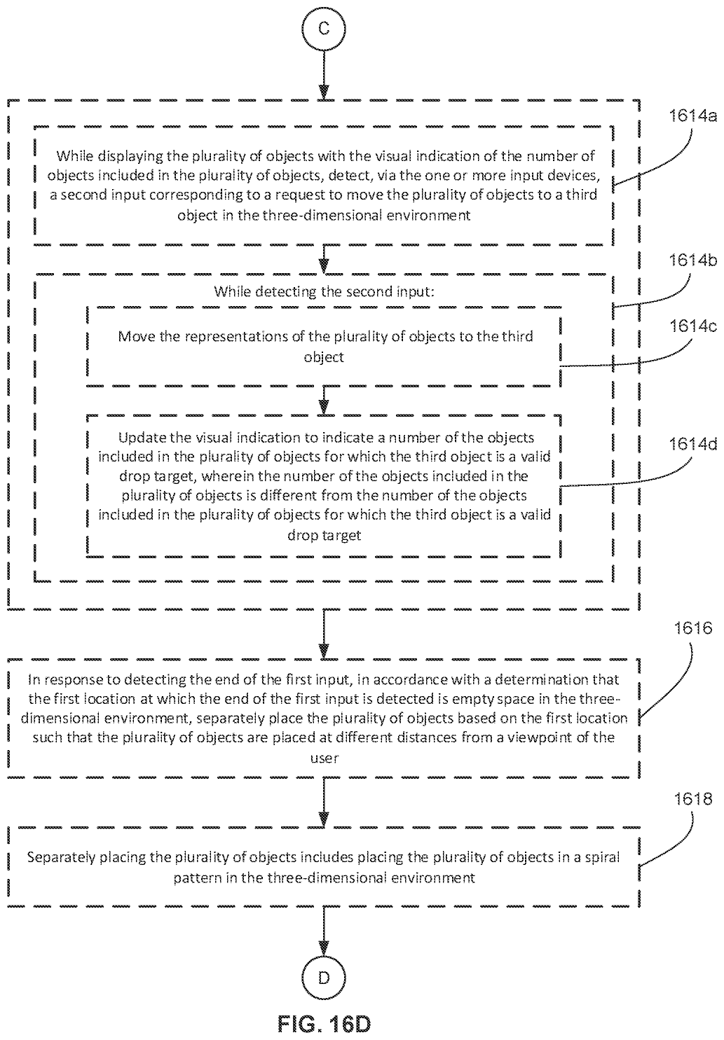

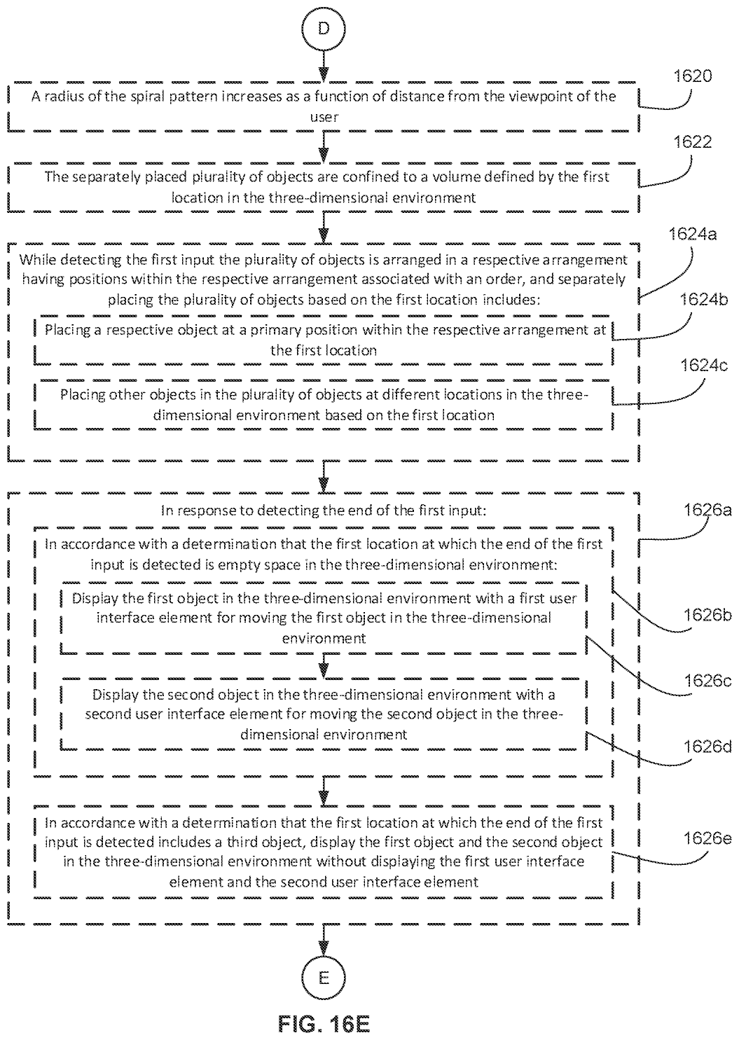

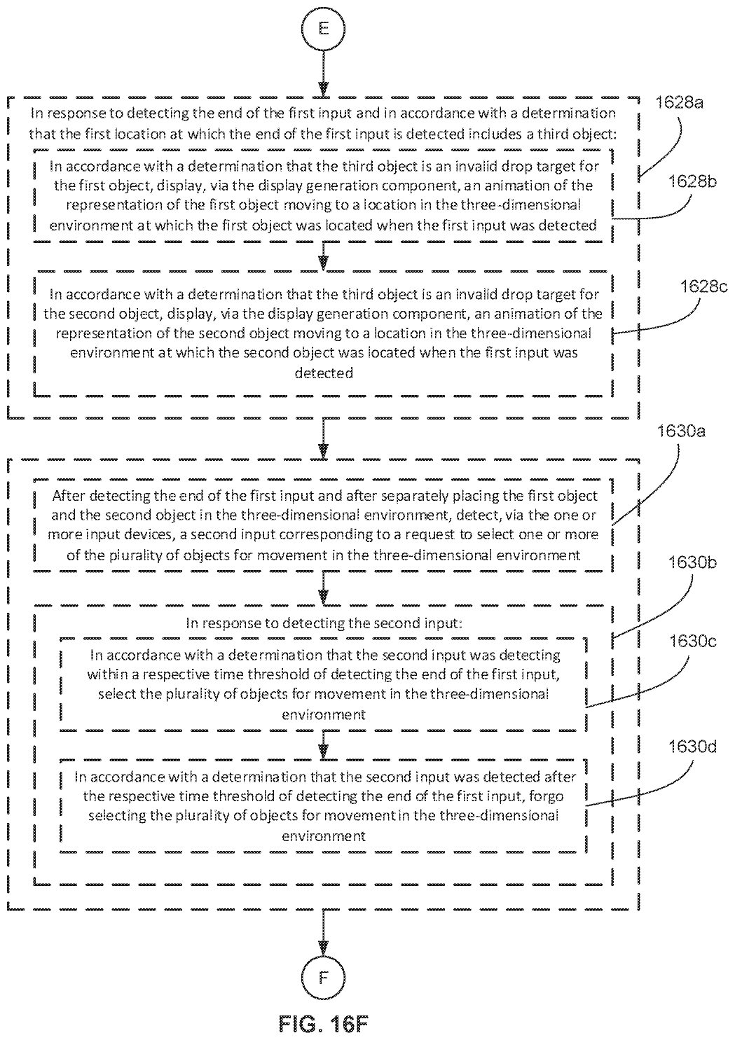

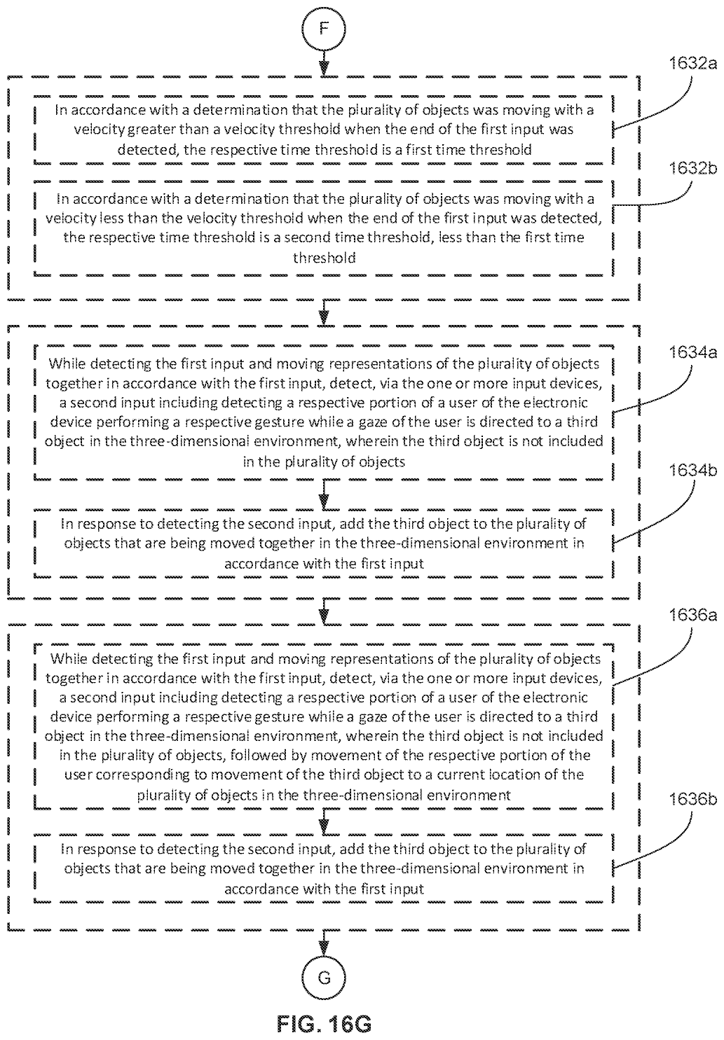

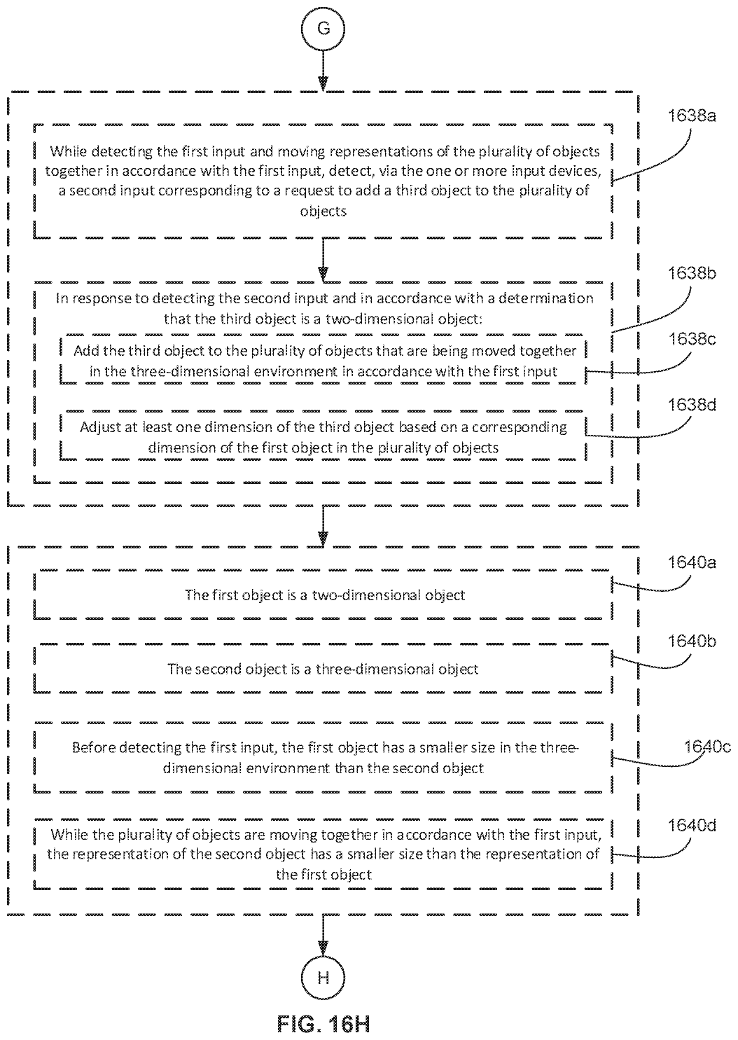

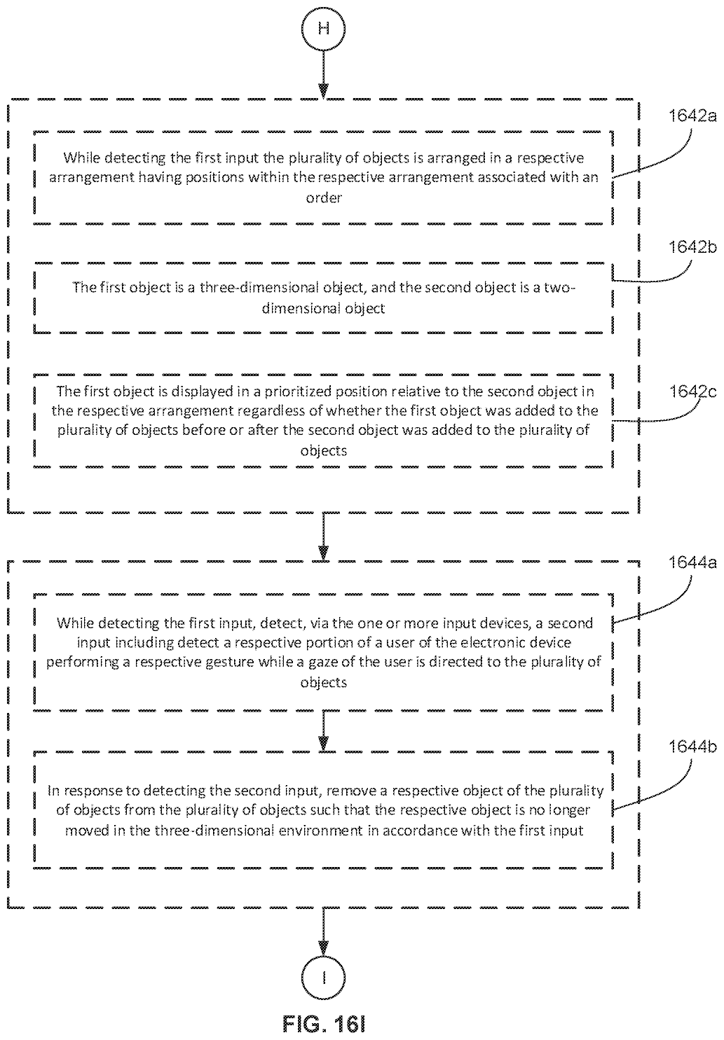

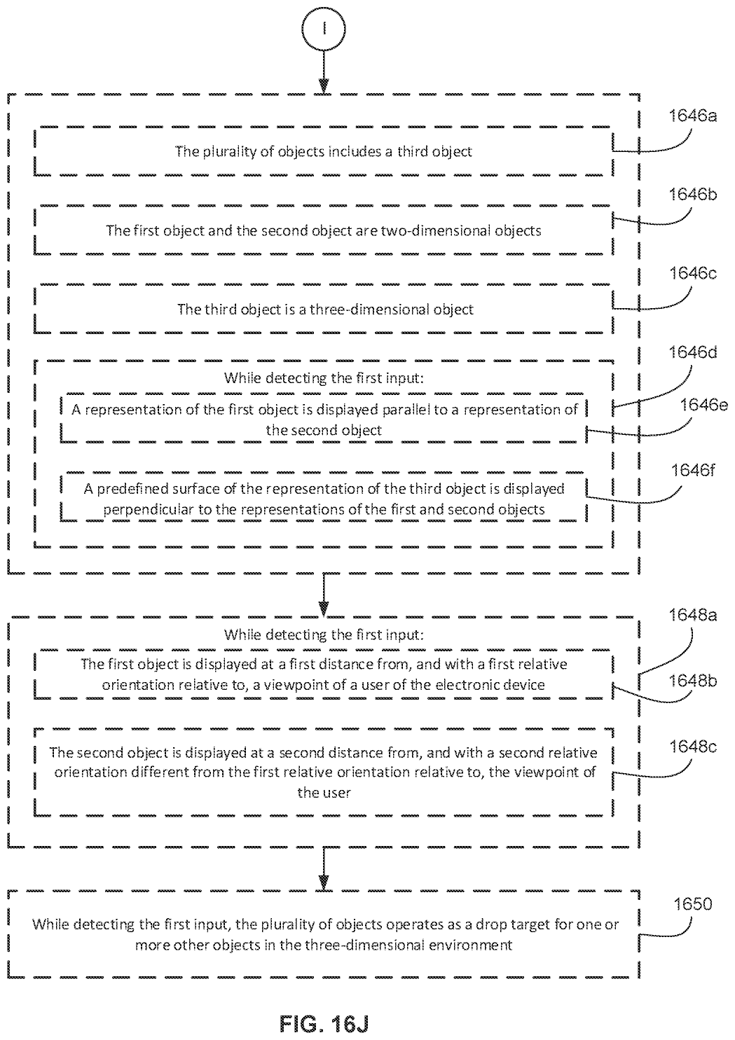

FIGS. 16A-16J is a flowchart illustrating a method 1600 of facilitating the movement and/or placement of multiple virtual objects in accordance with some embodiments. In some embodiments, the method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, method 1600 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1602a), via the display generation component, a three-dimensional environment that includes a plurality of objects (e.g., two-dimensional and/or three-dimensional objects) including a first object and a second object different from the first object, such as objects 1506b and 1506L in FIG. 15A. In some embodiments, the three-dimensional environment is generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.). In some embodiments, the three-dimensional environment includes one or more two-dimensional objects, such as user interfaces of applications installed on the electronic device (e.g., a user interface of a messaging application, a user interface of a video call application, etc.) and/or representations of content (e.g., representations of photographs, representations of videos, etc.). The two-dimensional objects are optionally primarily two-dimensional, but might occupy some (e.g., non-zero) volume in the three-dimensional environment by being displayed with or on or incorporated into a three-dimensional material or material property such as a pane of glass. In some embodiments, the three-dimensional environment includes one or more three-dimensional objects, such as a three-dimensional model of a car, a three-dimensional model of an alarm clock, etc.

In some embodiments, while displaying the three-dimensional environment, the electronic device detects (1602b), via the one or more input devices, a first input corresponding to a request to move the plurality of objects to a first location in the three-dimensional environment, followed by an end of the first input, such as the movement of hand 1503b from FIGS. 15A-15D and the end of the movement input from hand 1503b in FIG. 15D. For example, the first input optionally includes a pinch gesture of an index finger and thumb of a hand of the user followed by movement of the hand in the pinch hand shape while the plurality of objects have been selected for movement (which will be described in more detail below) while the hand of the user is greater than a threshold distance (e.g., 0.2, 0.5, 1, 2, 3, 5, 10, 12, 24, or 26 cm) from the plurality of objects, or a pinch of the index finger and thumb of the hand of the user followed by movement of the hand in the pinch hand shape irrespective of the location of the gaze of the user when the hand of the user is less than the threshold distance from the plurality of objects. In some embodiments, the end of the first input is a release of the pinch hand shape (e.g., the index finger and the thumb of the hand of the user moving apart from one another). In some embodiments, the movement of the hand of the user while maintaining the pinch hand shape corresponds to movement of the plurality of objects to the first location in the three-dimensional environment. In some embodiments, the first input has one or more of the characteristics of the input(s) described with reference to methods 800, 1000, 1200, 1400 and/or 1800.

In some embodiments, while detecting the first input, the electronic device moves (1602c) representations of the plurality of objects together in the three-dimensional environment to the first location in accordance with the first input, such as shown in FIGS. 15A-15C. For example, the plurality of objects are displayed in a group, collection, arrangement, order, and/or cluster in the three-dimensional environment at a relative location relative to the location of the hand of the user in the pinch hand shape as the hand moves, which optionally results in the plurality of objects being moved concurrently and in accordance with the movement of the hand of the user to the first location in the three-dimensional environment.

In some embodiments, in response to detecting the end of the first input (e.g., detecting release of the pinch hand shape (e.g., the index finger and the thumb of the hand of the user moving apart from one another)), the electronic device separately places (1602d) the first object and the second object in the three-dimensional environment, such as shown with objects 1506a-f and L in FIG. 15D (e.g., at or near or proximate to the first location). For example, upon detecting the end of the first input, the electronic device drops the first and second objects at or near or proximate to the first location in the three-dimensional environment. In response to the objects being dropped at the first location, the electronic device optionally rearranges the group, collection, arrangement, order, and/or cluster in which the sets of objects were displayed while being moved, as will be described in more detail below. Facilitating movement of a plurality of objects concurrently in response to the same movement input improves the efficiency of object movement interactions with the device, thereby improving user-device interaction.

In some embodiments, the first input includes a first movement of a respective portion of a user of the electronic device followed by the end of the first input, and the first movement corresponds to the movement to the first location in the three-dimensional environment (1604), such as described with respect to hand 1503b in FIGS. 15A-15D. For example, the first input optionally includes a pinch gesture of an index finger and thumb of a hand of the user followed by movement of the hand in the pinch hand shape while the plurality of objects have been selected for movement (which will be described in more detail below) while the hand of the user is greater than a threshold distance (e.g., 0.2, 0.5, 1, 2, 3, 5, 10, 12, 24, or 26 cm) from the plurality of objects, or a pinch of the index finger and thumb of the hand of the user followed by movement of the hand in the pinch hand shape irrespective of the location of the gaze of the user when the hand of the user is less than the threshold distance from the plurality of objects. In some embodiments, the end of the first input is a release of the pinch hand shape (e.g., the index finger and the thumb of the hand of the user moving apart from one another). In some embodiments, the movement of the hand of the user while maintaining the pinch hand shape corresponds to movement of the plurality of objects to the first location in the three-dimensional environment. In some embodiments, the first input has one or more of the characteristics of the input(s) described with reference to methods 800, 1000, 1200, 1400 and/or 1800. Facilitating movement of a plurality of objects concurrently in response to the same movement of a respective portion of the user improves the efficiency of object movement interactions with the device, thereby improving user-device interaction.

In some embodiments, after detecting the end of the first input and separately placing the first object and the second object in the three-dimensional environment, the electronic device detects (1606a), via the one or more input devices, a second input corresponding to a request to move the first object to a second location in the three-dimensional environment, such as an input directed to object 1506L after being placed in environment 1502 in FIG. 15D. The second input optionally includes a pinch hand gesture performed by the user while a gaze of the user is directed to the first object, and movement of the hand of the user in a pinch hand shape. The second input optionally has one or more of the characteristics of the first input described above.

In some embodiments, in response to receiving the second input, the electronic device moves (1606b) the first object to the second location in the three-dimensional environment without moving the second object in the three-dimensional environment, such as moving object 1506L in FIG. 15D without moving object 1506b in FIG. 15D. In some embodiments, after having been separately placed in the three-dimensional environment, the first object is able to be moved separately from the second object in the three-dimensional environment in accordance with the second input.

In some embodiments, after detecting the end of the first input and separately placing the first object and the second object in the three-dimensional environment, the electronic device detects (1606c), via the one or more input devices, a third input corresponding to a request to move the second object to a third location in the three-dimensional environment, such as an input directed to object 1506b after being placed in environment 1502 in FIG. 15D. The third input optionally includes a pinch hand gesture performed by the user while a gaze of the user is directed to the second object, and movement of the hand of the user in a pinch hand shape. The third input optionally has one or more of the characteristics of the first input described above.

In some embodiments, in response to receiving the third input, the electronic device moves (1606d) the second object to the second location in the three-dimensional environment without moving the first object in the three-dimensional environment, such as moving object 1506b in FIG. 15D without moving object 1506L in FIG. 15D. In some embodiments, after having been separately placed in the three-dimensional environment, the second object is able to be moved separately from the first object in the three-dimensional environment in accordance with the third input. Facilitating separate, independent movement of the plurality of objects improves the robustness of object movement interactions with the device, thereby improving user-device interaction.

In some embodiments, while detecting the first input, the electronic device displays (1606e), in the three-dimensional environment, a visual indication of a number of objects included in the plurality of objects to which the first input is directed, such as indication 1510a in FIG. 15C. For example, the plurality of objects is displayed as a stack of objects while the movement input is being detected and/or while representations of the objects are being moved in the three-dimensional environment in accordance with the movement input. In some embodiments, when more than one object is included in the set of objects being moved, the electronic device displays a badge with the set/stack of objects that indicates the number of objects included in the stack (e.g., a badge displaying the number 3, or a badge displaying the number 5, when there are 3 or 5, respectively, objects in the stack). Displaying the number of objects being moved together in the three-dimensional environment provides feedback to the user about the movement that is occurring, thereby improving user-device interaction.

In some embodiments, while detecting the first input the plurality of objects is arranged in a respective arrangement having positions within the respective arrangement associated with an order, such as in the stack of objects controlled by hand 1503b in FIG. 15C (e.g., the plurality of objects is displayed as a stack of objects, with the first position in the stack being closest to the viewpoint of the user, the second position in the stack (e.g., behind the object in the first position) being second closest to the viewpoint of the user, etc.), and the visual indication of the number of objects included in the plurality of objects is displayed at a respective location relative to a respective object in the plurality of objects that is located at a primary position within the respective arrangement (1608), such as on an upper-right portion of an object in the stack of objects controlled by hand 1503b in FIG. 15C. In some embodiments, the location at which the visual indication is displayed is controlled by the object that is at the top of the stack; for example, the visual indication is optionally displayed at some respective location relative to that object that is at the top of the stack (e.g., as will be described in more detail below). Displaying the visual indication relative to the primary object in the plurality of objects ensures that the visual indication is clearly visible, thereby improving user-device interaction.

In some embodiments, while displaying the visual indication of the number of objects included in the plurality of objects at the respective location relative to the respective object that is located at the primary position within the respective arrangement, the electronic device detects (1610a), via the one or more input devices, a second input corresponding to a request to add a third object to the plurality of objects, such as while displaying indication 1510 in FIG. 15A (e.g., detecting a hand of the user of the device performing a pinching gesture with their index finger and thumb while the gaze of the user is directed to the third object. In some embodiments, the other hand of the user is in a pinch hand shape, and input from that other hand is directed to moving the plurality of objects in the three-dimensional environment).

In some embodiments, in response to detecting the second input (1610b), the electronic device adds (1610c) the third object to the respective arrangement, wherein the third object, not the respective object, is located at the primary position within the respective arrangement, such as adding another three-dimensional object to the stack of objects controlled by hand 1503b in FIG. 15A (e.g., the newly added object to the stack of objects is added to the top/primary position in the stack, displacing the former primary position object to the secondary position, and so on).

In some embodiments, the electronic device displays (1610d) the visual indication of the number of objects included in the plurality of objects at the respective location relative to the third object, such as displaying indication 1510 in FIG. 15A at the respective location relative to the newly added three-dimensional object to the stack of objects controlled by hand 1503b. For example, because the third object is now in the primary position, the badge indicating the number of objects in the stack is now displayed at a position based on the third object rather than the former primary object. Further, the badge is optionally updated (e.g., increased by one) to reflect that the third object has now been added to the stack of objects. Adding new objects to the top of the stack of objects provides feedback that the new objects have indeed been added to the stack (e.g., because they are easily visible at the top of the stack), thereby improving user-device interaction.

In some embodiments, the visual indication of the number of objects included in the plurality of objects is displayed at a location based on a respective object in the plurality of objects (1612a) (e.g., based on the object that is at the top, or in the primary position of, the stack of objects. The respective object is optionally at the top of, or in the primary position of, the stack of objects.).

In some embodiments, in accordance with a determination that the respective object is a two-dimensional object, the visual indication is displayed on the two-dimensional object (1612b), such as indication 1510 on object 1506a in FIG. 15B (e.g., the badge is displayed overlaid on and/or in contact with the upper-right corner (or other location) of the two-dimensional object).

In some embodiments, in accordance with a determination that the respective object is a three-dimensional object, the visual indication is displayed on a boundary of a bounding volume including the respective object (1612c), such as indication 1510 with respect to object 1506b in FIG. 15A. For example, the three-dimensional object is associated with a bounding volume that encompasses the three-dimensional object. In some embodiments, the bounding volume is larger in one or more dimensions than the three-dimensional object and/or has a volume greater than the volume of the three-dimensional object. In some embodiments, the badge is displayed on the upper-right corner (or other location) of the surface/boundary of the bounding volume. The bounding volume, surface and/or boundary of the bounding volume is optionally not displayed in the three-dimensional environment. In some embodiments, even if the object at the top of the stack is a three-dimensional object, the badge is displayed overlaid on and/or in contact with the upper-right corner (or other location) of the two-dimensional object in the stack that is closest to the top of the stack. Displaying the badge at different relative locations depending on the type of object that is displaying the badge ensures that the badge is displayed visibly and consistently for different types of objects, thereby improving user-device interaction.

In some embodiments, while displaying the plurality of objects with the visual indication of the number of objects included in the plurality of objects, the electronic device detects (1614a), via the one or more input devices, a second input corresponding to a request to move the plurality of objects to a third object in the three-dimensional environment, such as the input from hand 1503c in FIG. 15C. For example, a hand of the user in a pinch hand shape that is moving the stack of the objects in the three-dimensional environment moves in a manner corresponding to moving the stack of objects to the third object. The third object is optionally able to accept, contain and/or display one or more of the objects in the stack of objects. For example, the third object is optionally a user interface for a messaging application for messaging other users, and is able to accept objects corresponding to text content, image content, video content and/or audio content (e.g., to share with other users).

In some embodiments, while detecting the second input (1614b), the electronic device moves (1614c) the representations of the plurality of objects to the third object (e.g., displaying the stack of objects moving to the third object in the three-dimensional environment in accordance with the second input).

In some embodiments, the electronic device updates (1614d) the visual indication to indicate a number of the objects included in the plurality of objects for which the third object is a valid drop target, wherein the number of the objects included in the plurality of objects is different from the number of the objects included in the plurality of objects for which the third object is a valid drop target, such as described with reference to indication 1510b in FIG. 15C. For example, updating the badge to indicate how many of the objects in the stack of objects can be dropped in/added to the third object (e.g., updating the badge from indicating the number 10 to indicating the number 8, because of the 10 objects in the stack, only 8 can be accepted by the third object and 2 cannot be accepted by the third object). For example, a messaging user interface is optionally able to accept an object corresponding to image content, but not an object corresponding to an application. Additional details of valid and invalid drop targets are described with reference to methods 800, 1000, 1200, 1400 and/or 1800. Updating the badge to indicate the number of valid drop objects provides feedback to the user about what result will occur if the user drops the stack of objects at their current location, thereby improving user-device interaction.

In some embodiments, in response to detecting the end of the first input, in accordance with a determination that the first location at which the end of the first input is detected is empty space in the three-dimensional environment (e.g., the stack of objects is dropped in a location that does not include an object in the three-dimensional environment), the electronic device separately places (1616) the plurality of objects based on the first location such that the plurality of objects are placed at different distances from a viewpoint of the user, such as with respect to the objects controlled by hand 1503b in FIG. 15D. For example, the objects in the stack of objects are optionally separately placed in the three-dimensional environment, and are visually separated from one another with respect to the distance of the objects from the viewpoint of the user (e.g., the first object is placed at a first distance from the viewpoint of the user, the second object is placed at a second distance, different from the first distance, from the viewpoint of the user, etc.). In some embodiments, the distance differences between the objects with respect to the viewpoint of the user after the objects are dropped in the empty space are greater than the distance differences between the objects with respect to the viewpoint of the user while the objects are located within the stack of objects (e.g., the objects are spaced apart in the direction corresponding to the viewpoint of the user in response to being dropped in empty space at the end of the first input). Spreading the objects apart relative to the viewpoint of the user facilitates individual accessibility of and/or interaction with the objects after they have been dropped, thereby improving user-device interaction.

In some embodiments, separately placing the plurality of objects includes placing the plurality of objects in a spiral pattern in the three-dimensional environment (1618), such as with objects 1506a-f and L in FIG. 15D. For example, upon being dropped in empty space, the objects are optionally spaced apart according to a spiral pattern that extends away from the viewpoint of the user, starting from the location in the three-dimensional environment at which the objects were dropped. In some embodiments, the placement of the objects in the spiral pattern corresponds to the placement of the objects in the stack of objects while they are being moved (e.g., the primary object in the stack has the primary position in the spiral (e.g., closest to the viewpoint of the user), the secondary object in the stack has the secondary position in the spiral (e.g., next closest to the viewpoint of the user), etc.). Spreading the objects apart relative to the viewpoint of the user facilitates individual accessibility of and/or interaction with the objects after they have been dropped, thereby improving user-device interaction.

In some embodiments, a radius of the spiral pattern increases as a function of distance from the viewpoint of the user (1620), such as with objects 1506a-f and L in FIG. 15D. For example, the spiral pattern of the placement of the objects gets wider (e.g., the objects are placed further and further away from the axis connecting the viewpoint of the user and the drop location in the three-dimensional environment) the further the objects are from the viewpoint of the user. Spreading the objects further apart normal to the viewpoint of the user as a function of the distance from the viewpoint of the user facilitates individual accessibility of and/or interaction with the objects after they have been dropped, thereby improving user-device interaction.

In some embodiments, the separately placed plurality of objects are confined to a volume defined by the first location in the three-dimensional environment (1622), such as objects 1506a-f and L being confined to a volume in FIG. 15D. In some embodiments, the spiral pattern of objects is bounded in size/volume in the three-dimensional environment such that the spiral pattern of objects cannot consume more than a threshold size (e.g., 1%, 3%, 5%, 10%, 20%, 30%, 50%, 60%, or 70%) of the three-dimensional environment and/or of the field of view of the user. Thus, in some embodiments, the greater number of objects in the plurality of objects, the less the objects are spaced apart from each other with respect to the distance from the viewpoint of the user and/or normal to the viewpoint of the user to ensure the objects remain bounded in the bounded volume. In some embodiments, the bounded volume includes the drop location in the three-dimensional environment. In some embodiments, the drop location is a point on the surface of the bounded volume. Spreading the objects apart relative to the viewpoint of the user while maintaining the objects within a bounded volume ensures the objects do not overwhelm the field of view of the user after they have been dropped, thereby improving user-device interaction.

In some embodiments, while detecting the first input the plurality of objects is arranged in a respective arrangement having positions within the respective arrangement associated with an order (e.g., the plurality of objects is displayed as a stack of objects, with the first position in the stack being closest to the viewpoint of the user, the second position in the stack (e.g., behind the object in the first position) being second closest to the viewpoint of the user, etc.), and separately placing the plurality of objects based on the first location includes (1624a), placing a respective object at a primary position within the respective arrangement at the first location (1624b), such as object 1506b in FIG. 15D.

In some embodiments, the electronic device places other objects in the plurality of objects at different locations in the three-dimensional environment based on the first location (1624c), such as objects 1506a, 1506c-f and 1506L in FIG. 15D. For example, the object at the top of/primary position in the stack of objects is placed at the drop location in the three-dimensional environment when the objects are dropped. In some embodiments, the remaining objects are placed behind the first object in the spiral pattern (e.g., according to their order in the stack), with the first object defining the tip of the spiral pattern. Placing the top item in the stack at the drop location ensures that placement of the objects corresponds to the input provided by the user, thus avoiding a disconnect between the two, thereby improving user-device interaction.

In some embodiments, in response to detecting the end of the first input (1626a), in accordance with a determination that the first location at which the end of the first input is detected is empty space in the three-dimensional environment (1626b) (e.g., the stack of objects is dropped in a location that does not include an object in the three-dimensional environment), the electronic device displays (1626c) the first object in the three-dimensional environment with a first user interface element for moving the first object in the three-dimensional environment, such as the grabber bars displayed with objects 1506a-f and L in FIG. 15D.

In some embodiments, the electronic device displays (1626d) the second object in the three-dimensional environment with a second user interface element for moving the second object in the three-dimensional environment, such as the grabber bars displayed with objects 1506a-f and L in FIG. 15D. For example, if the stack of objects is dropped in empty space, multiple objects (e.g., each object) in the stack of objects are optionally separately placed in the three-dimensional environment at or near the drop location (e.g., in a spiral pattern), and multiple objects (e.g., each object) are displayed with their corresponding own grabber bar elements that are interactable to separately move the corresponding objects in the three-dimensional environment. In some embodiments, a user need not interact with the grabber bar element to move the object, but could instead move the object using inputs directed to the object itself even when the object is displayed with a grabber bar element. Therefore, in some embodiments, the grabber bar element indicates that an object is separately movable in the three-dimensional environment. In some embodiments, the objects that were dropped are additionally or alternatively displayed in their own quick look windows, which are described in more detail with reference to method 1400.

In some embodiments, in accordance with a determination that the first location at which the end of the first input is detected includes a third object (e.g., and in accordance with a determination that the third object is a valid drop target for one or more of the plurality of objects in the stack of objects, such as described in more detail with reference to method 1400), the electronic device displays (1626e) the first object and the second object in the three-dimensional environment (e.g., within the third object) without displaying the first user interface element and the second user interface element, such as objects 1506j and 1506k in FIG. 15D being displayed without grabber bars. For example, if objects are dropped in another object rather than in empty space, the objects are added to the other object (e.g., subject to the validity of the receiving object as a drop target), and displayed within the other object without being displayed with individual grabber bars for moving the objects in the three-dimensional environment. In some embodiments, instead, the receiving object is displayed with a grabber bar for moving the receiving object—and the objects contained within the receiving object—in the three-dimensional environment. Displaying objects with or without individual grabber bars based on whether the objects are placed in empty space or in another object ensures that objects that can be interacted with individually after being dropped are clearly conveyed without cluttering the three-dimensional environment with such grabber bars for objects included in a receiving object, thereby improving user-device interaction.

In some embodiments, in response to detecting the end of the first input and in accordance with a determination that the first location at which the end of the first input is detected includes a third object (1628a) (e.g., the stack of objects is dropped in a receiving object), in accordance with a determination that the third object is an invalid drop target for the first object (e.g., the first object is of a type that cannot be added to and/or displayed within the third object. Details of valid and invalid drop targets are described with reference to method 1400), the electronic device displays (1628b), via the display generation component, an animation of the representation of the first object moving to a location in the three-dimensional environment at which the first object was located when (e.g., a beginning of) the first input was detected, such as described with reference to objects 1506g-I in FIG. 15D.

In some embodiments, in accordance with a determination that the third object is an invalid drop target for the second object (e.g., the second object is of a type that cannot be added to and/or displayed within the third object. Details of valid and invalid drop targets are described with reference to method 1400), the electronic device displays (1628c), via the display generation component, an animation of the representation of the second object moving to a location in the three-dimensional environment at which the second object was located when (e.g., a beginning of) the first input was detected, such as described with reference to objects 1506g-I in FIG. 15D. For example, if the drop target is invalid for any of the objects within the stack of objects, upon detecting that the user has dropped those objects in the drop target, the invalid objects are animated as flying back to the locations in the three-dimensional environment from which they were picked up and added to the stack of objects. The objects for which the drop target is a valid drop target are optionally added to/displayed within the drop target, and the electronic device optionally does not display an animation of those objects flying back to the locations in the three-dimensional environment from which they were picked up and added to the stack of objects. Displaying an animation of objects not able to be added to the drop target moving to their original locations conveys that they were not able to be added to the drop target, and also avoids applying changes in location to those items, thereby improving user-device interaction.

In some embodiments, after detecting the end of the first input and after separately placing the first object and the second object in the three-dimensional environment (e.g., in empty space and/or within a drop target), the electronic device detects (1630a), via the one or more input devices, a second input corresponding to a request to select one or more of the plurality of objects for movement in the three-dimensional environment, such as an input from hand 1503b in FIG. 15D. For example, before detecting other inputs directed to other objects in the three-dimensional environment, other than the objects that were in the stack of objects, detecting a hand of the user performing a pinch and hold gesture while the gaze of the user is directed to any of the objects that was separately placed in the three-dimensional environment.

In some embodiments, in response to detecting the second input (1630b), in accordance with a determination that the second input was detecting within a respective time threshold (e.g., 0.1, 0.2, 0.5, 1, 2, 3, 4, 5, or 10 seconds) of detecting the end of the first input, the electronic device selects (1630c) the plurality of objects for movement in the three-dimensional environment, such as restacking objects 1506a-f and L to be controlled by hand 1503b in FIG. 15D (e.g., including placing the objects back into a stack arrangement in the order in which they were placed before being dropped, and subsequent movement of the hand of the user while remaining in the pinch hand shape continuing the movement of the stack of objects in the three-dimensional environment in accordance with the subsequent movement).

In some embodiments, in accordance with a determination that the second input was detected after the respective time threshold (e.g., 0.1, 0.2, 0.5, 1, 2, 3, 4, 5, or 10 seconds) of detecting the end of the first input, the electronic device forgoes (1630d) selecting the plurality of objects for movement in the three-dimensional environment (e.g., and only selecting for movement the object to which the gaze of the user was directed without selecting others of the objects for movement, and subsequent movement of the hand of the user while remaining in the pinch hand shape moving the selected object, but not others of the objects, in the three-dimensional environment in accordance with the subsequent movement). Thus, in some embodiments, a relatively quick re-selection of the objects after being dropped causes the device to resume the movement of the stack of objects in the three-dimensional environment. Facilitating re-selection of the dropped objects provides an efficient manner of continuing the movement of the plurality of objects in the three-dimensional environment, thereby improving user-device interaction.

In some embodiments, in accordance with a determination that the plurality of objects was moving with a velocity greater than a velocity threshold (e.g., 0 cm/s, 0.3 cm/s 0.5 cm/s, 1 cm/s, 3 cm/s, 5 cm/s, or 10 cm/s) when the end of the first input was detected (e.g., the hand of the user released the pinch hand shape while the hand of the user was moving with a velocity greater than the velocity threshold while moving the stack of objects in the three-dimensional environment), the respective time threshold is a first time threshold (1632a), such as if hand 1503b was moving with velocity greater than the velocity threshold when hand 1503b dropped the stack of objects in FIG. 15D.

In some embodiments, in accordance with a determination that the plurality of objects was moving with a velocity less than the velocity threshold (e.g., 0 cm/s, 0.3 cm/s 0.5 cm/s, 1 cm/s, 3 cm/s, 5 cm/s, or 10 cm/s) when the end of the first input was detected (e.g., the hand of the user released the pinch hand shape while the hand of the user was moving with a velocity less than the velocity threshold while moving the stack of objects in the three-dimensional environment, or the hand of the user was not moving when the hand of the user released the pinch hand shape), the respective time threshold is a second time threshold, less than the first time threshold (1632b), such as if hand 1503b was moving with velocity less than the velocity threshold when hand 1503b dropped the stack of objects in FIG. 15D. Thus, in some embodiments, the electronic device provides a longer time threshold for re-selecting the plurality of objects for movement if the plurality of objects was dropped while moving and/or provides a longer time threshold for re-selecting the plurality of objects for movement the faster the plurality of objects was moving when dropped, and a shorter time threshold for re-selecting the plurality of objects for movement the slower the plurality of objects was moving when dropped. Allowing for more or less time to reselect the objects for movement makes it easier for the user to continue movement of the plurality of objects when moving quickly and/or potentially accidentally dropping the objects, thereby improving user-device interaction.

In some embodiments, while detecting the first input and moving representations of the plurality of objects together in accordance with the first input (e.g., the first input is input from a first hand of the user maintaining a pinch hand shape, movement of which corresponds to movement of the stack of objects in the three-dimensional environment), the electronic device detects (1634a), via the one or more input devices, a second input including detecting a respective portion of a user of the electronic device (e.g., a second hand of the user) performing a respective gesture while a gaze of the user is directed to a third object in the three-dimensional environment, wherein the third object is not included in the plurality of objects, such as the input directed to object 1506a in FIG. 15A (e.g., a pinch and release gesture performed by the index finger and thumb of the second hand of the user while the user is looking at the third object).

In some embodiments, in response to detecting the second input, the electronic device adds (1634b) the third object to the plurality of objects that are being moved together in the three-dimensional environment in accordance with the first input, such as shown in FIG. 15B with object 1506a having been added to the stack of objects. For example, the third object gets added to the stack of objects, and movement of the first hand now controls movement of the stack of objects in addition to the third object in the three-dimensional environment. Facilitating addition of objects to the stack of objects for concurrent movement improves flexibility for moving multiple objects in the three-dimensional environment, thereby improving user-device interaction.

In some embodiments, while detecting the first input and moving representations of the plurality of objects together in accordance with the first input (e.g., the first input is input from a first hand of the user maintaining a pinch hand shape, movement of which corresponds to movement of the stack of objects in the three-dimensional environment), the electronic device detects (1636a), via the one or more input devices, a second input including detecting a respective portion of a user of the electronic device (e.g., a second hand of the user) performing a respective gesture while a gaze of the user is directed to a third object in the three-dimensional environment (e.g., a pinch and hold gesture performed by the index finger and thumb of the second hand of the user while the user is looking at the third object), wherein the third object is not included in the plurality of objects, followed by movement of the respective portion of the user corresponding to movement of the third object to a current location of the plurality of objects in the three-dimensional environment, such as movement input directed to object 1506a in FIG. 15A from hand 1503a (e.g., the second hand of the user, while maintaining the pinch hand shapes, moves in a way that causes the third object to be moved to the stack of objects that are held by and/or controlled by the first hand of the user).

In some embodiments, in response to detecting the second input, the electronic device adds (1636b) the third object to the plurality of objects that are being moved together in the three-dimensional environment in accordance with the first input, such as if hand 1503a provided movement input to object 1506a to the stack of objects in FIG. 15A. For example, the third object gets added to the stack of objects, and movement of the first hand now controls movement of the stack of objects in addition to the third object in the three-dimensional environment. Facilitating addition of objects to the stack of objects for concurrent movement improves flexibility for moving multiple objects in the three-dimensional environment, thereby improving user-device interaction.

In some embodiments, while detecting the first input and moving representations of the plurality of objects together in accordance with the first input (e.g., the first input is input from a first hand of the user maintaining a pinch hand shape, movement of which corresponds to movement of the stack of objects in the three-dimensional environment), the electronic device detects (1638a), via the one or more input devices, a second input corresponding to a request to add a third object to the plurality of objects (e.g., a pinch and release or a pinch and drag input for adding the third object to the stack of objects, as described above).

In some embodiments, in response to detecting the second input and in accordance with a determination that the third object is a two-dimensional object (1638b), the electronic device adds (1638c) the third object to the plurality of objects that are being moved together in the three-dimensional environment in accordance with the first input, such as adding object 1506a to the stack of objects in FIG. 15B (e.g., adding the third object to the stack of objects, as described herein).

In some embodiments, the electronic device adjusts (1638d) at least one dimension of the third object based on a corresponding dimension of the first object in the plurality of objects, such as scaling a width and/or height of object 1506a in FIG. 15B. In some embodiments, when two-dimensional objects are added to the stack of objects, the electronic device scales the added two-dimensional objects such that at least one dimension of the added object matches, is greater than, is less than or is otherwise based on a corresponding dimension of at least one existing object (e.g., of matching type, such as two-dimensional or three-dimensional) in the stack. For example, if the stack of objects has two-dimensional objects that have a height of X, the electronic device optionally scales the added two-dimensional object to have a height of X (e.g., while the added object is in the stack). In some embodiments, when the object is removed from the stack and/or placed in the three-dimensional environment, the electronic device optionally rescales the object to its original dimensions before being added to the stack. Scaling an added object based on object(s) already in the stack reduces the likelihood that a given object in the stack will obscure (e.g., all) other objects in the stack, thereby improving user-device interaction.

In some embodiments, the first object is a two-dimensional object (1640a). In some embodiments, the second object is a three-dimensional object (1640b). In some embodiments, before detecting the first input, the first object has a smaller size in the three-dimensional environment than the second object (1640c), such as object 1506b having a larger size than object 1506a in environment 1502 before those objects are added to the stack of objects (e.g., the (e.g., largest) cross-sectional area of the second object is larger than the cross-sectional area of the first object while the first and second objects are outside of the stack of objects in the three-dimensional environment).

In some embodiments, while the plurality of objects are moving together in accordance with the first input, the representation of the second object has a smaller size than the representation of the first object (1640d), such as object 1506b having a smaller size than object 1506a when those objects are added to the stack of objects (e.g., the (e.g., largest) cross-sectional area of the second object is smaller than the cross-sectional area of the first object while the first and second objects are included in a stack of objects in the three-dimensional environment). Thus, in some embodiments, three-dimensional objects are displayed at a smaller size in the stack of objects than two-dimensional objects in the stack of objects (e.g., irrespective of their respective sizes in the three-dimensional environment before/after being dragged in the stack of objects). In some embodiments, three-dimensional objects are placed in front of/on top of the stack of objects that are being moved, as will be described below. Therefore, in some embodiments, a three-dimensional object that is larger than a two-dimensional object that is in the stack will be reduced in size once added to the stack to become smaller than the two-dimensional object in the stack. Displaying three-dimensional objects in the stack of objects at smaller sizes than the two-dimensional objects reduces the likelihood that a given three-dimensional object in the stack will obscure (e.g., all) other objects in the stack, thereby improving user-device interaction.

In some embodiments, while detecting the first input the plurality of objects is arranged in a respective arrangement having positions within the respective arrangement associated with an order (1642a), such as shown in FIG. 15B (e.g., the plurality of objects is displayed in a stack of objects during the first input, as previously described). In some embodiments, the first object is a three-dimensional object, and the second object is a two-dimensional object (1642b), such as objects 1506a and 1506b in FIG. 15B.

In some embodiments, the first object is displayed in a prioritized position relative to the second object in the respective arrangement regardless of whether the first object was added to the plurality of objects before or after the second object was added to the plurality of objects (1642c), such as shown in FIG. 15B with objects 1506a, b and L. In some embodiments, three-dimensional objects are always displayed at the top of the stack of objects, even if a two-dimensional object is added to the stack after the three-dimensional object(s). Placing three-dimensional objects at the top of the stack of objects ensures visibility of objects further down in the stack while providing an organized arrangement of the objects in the stack, thereby improving user-device interaction.

In some embodiments, while detecting the first input (e.g., the first input is input from a first hand of the user maintaining a pinch hand shape, movement of which corresponds to movement of the stack of objects in the three-dimensional environment), the electronic device detects (1644a), via the one or more input devices, a second input including detecting a respective portion of a user of the electronic device performing a respective gesture while a gaze of the user is directed to the plurality of objects, such as in FIG. 15B if the gaze of the user were directed to the stack of objects and hand 1503a were performing the respective gesture (e.g., a pinch and release gesture performed by the index finger and thumb of the second hand of the user while the user is looking at the stack of objects and/or a particular object in the stack of objects. In some embodiments, the second input is a pinch and release gesture without a corresponding movement of the second hand of the user being detected. In some embodiments, the second input is a pinch and hold gesture performed by the second hand of the user, followed by movement of the second hand (e.g., corresponding to movement away from the stack of objects) while the second hand is maintaining the pinch hand shape).

In some embodiments, in response to detecting the second input, the electronic device removes (1644b) a respective object of the plurality of objects from the plurality of objects such that the respective object is no longer moved in the three-dimensional environment in accordance with the first input, such as removing one of objects 1506a, b or L from the stack of objects in FIG. 15B. In some embodiments, the object on the top of the stack is removed from the stack and displayed in the three-dimensional environment irrespective of which object the gaze of the user was directed to when the second input was detected. In some embodiments, the object in the stack to which the gaze of the user was directed is removed from the stack and displayed in the three-dimensional environment. In some embodiments, the respective object is controllable in the three-dimensional environment with the second hand of the user while the first hand of the user continues to control the remaining objects in the stack of objects. Facilitating removal of objects from the stack of objects improves flexibility for moving multiple objects in the three-dimensional environment, thereby improving user-device interaction.

In some embodiments, the plurality of objects includes a third object (1646a) (e.g., the plurality of objects in the stack includes at least the first object, the second object and the third object). In some embodiments, the first object and the second object are two-dimensional objects (1646b). In some embodiments, the third object is a three-dimensional object (1646c), such as shown in the stack of objects controlled by hand 1503b in FIG. 15C.

In some embodiments, while detecting the first input (1646d), a representation of the first object is displayed parallel to a representation of the second object (1646e), such as shown with objects 1506a and 1506c in FIG. 15C (e.g., two-dimensional objects are displayed parallel to one another in the stack of objects).

In some embodiments, a predefined surface of the representation of the third object is displayed perpendicular (e.g., or substantially perpendicular, such as within 1, 2, 5, 10, 15, 20, or 30 degrees of being perpendicular) to the representations of the first and second objects (16460, such as shown with object 1506b in FIG. 15C. For example, three-dimensional objects are oriented such that a particular surface of those objects is perpendicular to the planes of the two-dimensional objects in the stack. In some embodiments, the particular surface is the surface defined as the bottom surface of the three-dimensional objects (e.g., the surface of the object that the device maintains as parallel to the virtual and/or physical floor when the user is separately moving the object in the three-dimensional environment, such as described with reference to method 800). Thus, in some embodiments, the bottom surface of the three-dimensional object(s) is parallel to the floor when being moved individually in the three-dimensional environment, but perpendicular to two dimensional objects in the stack of objects (e.g., and optionally not parallel to the floor) when being moved as part of the stack of objects. Aligning two-dimensional and three-dimensional objects as described ensures visibility of objects further down in the stack while providing an organized arrangement of the objects in the stack, thereby improving user-device interaction.

In some embodiments, while detecting the first input (1648a), the first object is displayed at a first distance from, and with a first relative orientation relative to, a viewpoint of a user of the electronic device (1648b).

In some embodiments, the second object is displayed at a second distance from, and with a second relative orientation different from the first relative orientation relative to, the viewpoint of the user (1648c), such as the fanned-out objects in the stacks of objects in FIG. 15C (e.g., the second object is lower in the stack than the first object, and therefore further from the viewpoint of the user). For example, objects in the stack are optionally slightly rotated (e.g., by 1, 3, 5, 10, 15, or 20 degrees) with respect to the immediately adjacent objects in the stack in a fanning-out pattern moving down the stack so that at least a portion of the objects in the stack is visible, even when multiple objects are stacked on top of each other in the stack. In some embodiments, the further down in the stack an object is, the more it is rotated relative to the viewpoint of the user. In some embodiments, the rotation is about the axis defined as connecting the viewpoint of the user and the stack of objects. In some embodiments, such rotation is applied to both two-dimensional and three-dimensional objects in the stack. In some embodiments, such rotation is applied to two-dimensional objects but not three-dimensional objects in the stack. Orienting objects as described ensures visibility of objects further down in the stack while providing an organized arrangement of the objects in the stack, thereby improving user-device interaction.

In some embodiments, while detecting the first input, the plurality of objects operates as a drop target for one or more other objects in the three-dimensional environment (1650), such as the stacks of objects in FIG. 15C operating as drop zones for adding objects to the stacks of objects. For example, the stack of objects has one or more characteristics relating to receiving objects of valid and/or invalid drop zones for different types of objects, such as described with reference to methods 1200 and/or 1400. Thus, in some embodiments, the stack of objects is a temporary drop zone at the location of the stack of objects (e.g., wherever the stack of objects is moved in the three-dimensional environment) that ceases to exist when the electronic device detects an input dropping the stack of objects in the three-dimensional environment. Operating the stack of objects with one or more characteristics of a drop zone provides consistent and predictable object movement and placement interaction in the three-dimensional environment, thereby improving user-device interaction.

It should be understood that the particular order in which the operations in method 1600 have been described is merely exemplary and is not intended to indicate that the described order is the only order in which the operations could be performed. One of ordinary skill in the art would recognize various ways to reorder the operations described herein.

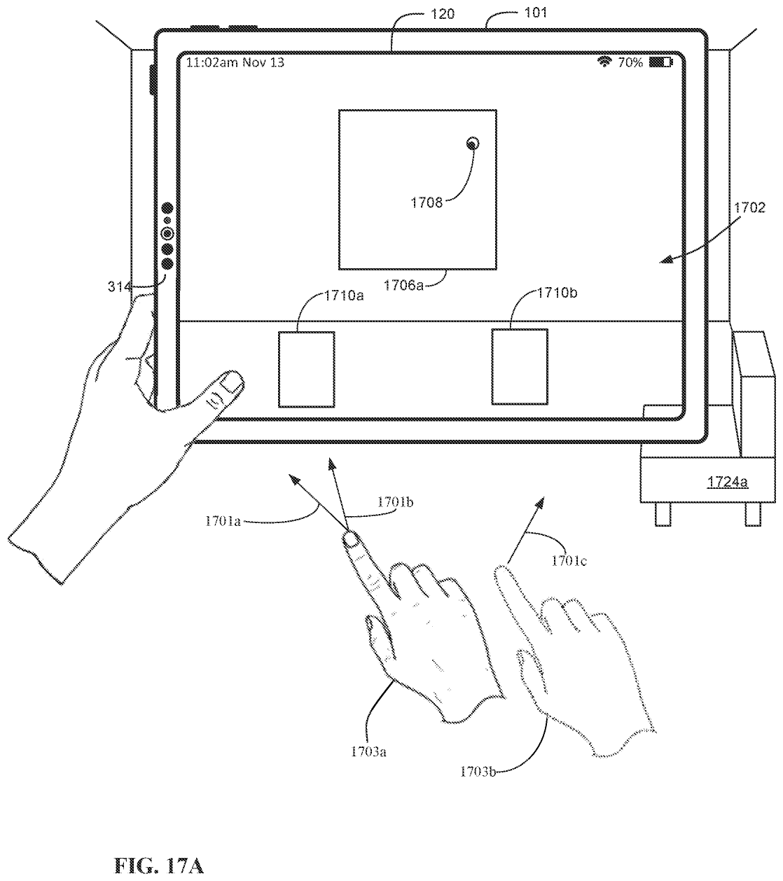

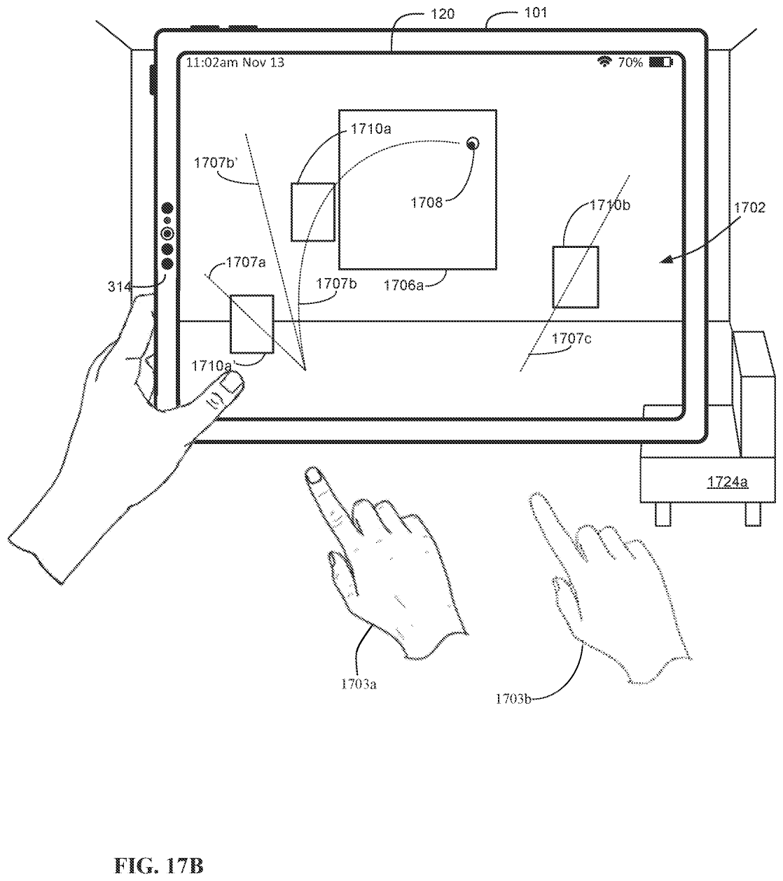

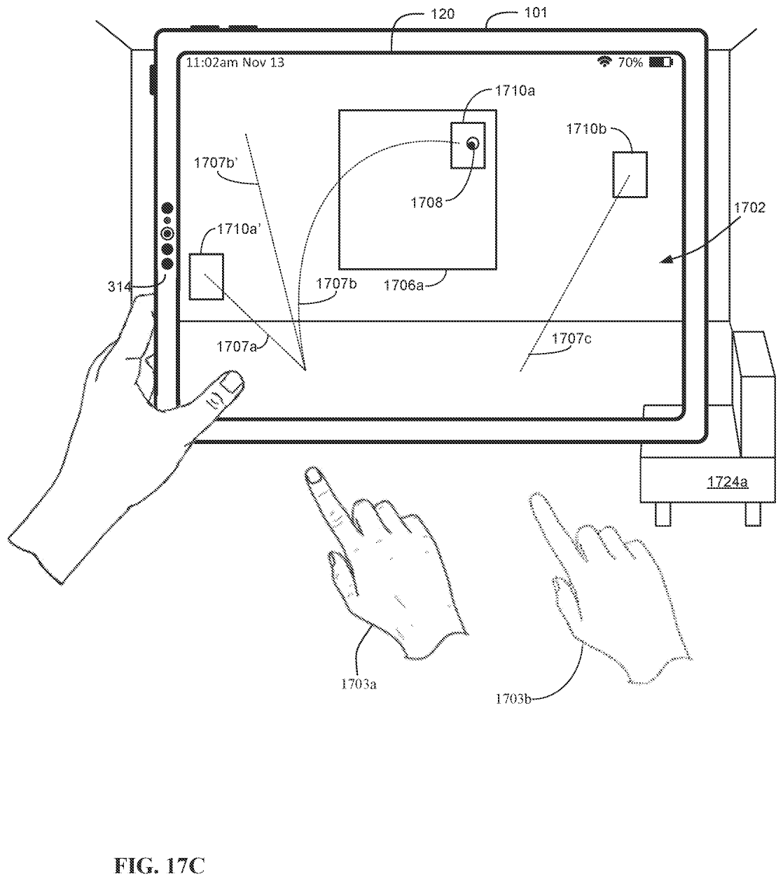

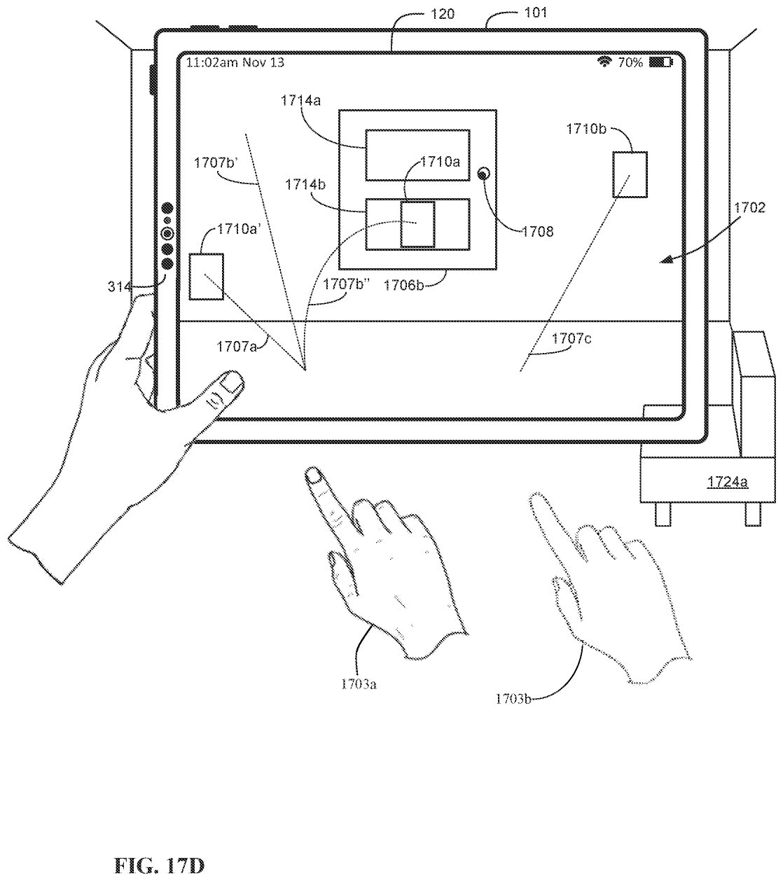

FIGS. 17A-17D illustrate examples of an electronic device facilitating the throwing of virtual objects in a three-dimensional environment in accordance with some embodiments.

FIG. 17A illustrates an electronic device 101 displaying, via a display generation component (e.g., display generation component 120 of FIG. 1), a three-dimensional environment 1702 from a viewpoint of a user of the electronic device 101. As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or gaze of the user (e.g., internal sensors facing inwards towards the face of the user).

As shown in FIG. 17A, device 101 captures one or more images of the physical environment around device 101 (e.g., operating environment 100), including one or more objects in the physical environment around device 101. In some embodiments, device 101 displays representations of the physical environment in three-dimensional environment 1702. For example, three-dimensional environment 1702 includes a representation 1724a of a sofa, which is optionally a representation of a physical sofa in the physical environment. Three-dimensional environment 1702 also includes representations of the physical floor and back wall of the room in which device 101 is located.

In FIG. 17A, three-dimensional environment 1702 also includes virtual objects 1706a, 1710a and 1710b. Virtual objects 1706a, 1710a and 1710b are optionally one or more of user interfaces of applications (e.g., messaging user interfaces, content browsing user interfaces, etc.), three-dimensional objects (e.g., virtual clocks, virtual balls, virtual cars, etc.), representations of content (e.g., representations of photographs, videos, movies, music, etc.) or any other element displayed by device 101 that is not included in the physical environment of device 101. In FIG. 17A, virtual objects 1706a, 1710a and 1710b are two-dimensional objects, but the examples described herein could apply analogously to three-dimensional objects.

In some embodiments, a user of device 101 is able to provide input to device 101 to throw one or more virtual objects in three-dimensional environment 1702 (e.g., in a manner analogous to throwing a physical object in the physical environment). For example, an input to throw an object optionally includes a pinch hand gesture including the thumb and index finger of a hand of a user coming together (e.g., to touch) when the hand is within a threshold distance (e.g., 0.1, 0.5, 1, 2, 3, 5, 10, 20, 50, or 100 cm) of the object, followed by movement of the hand while the hand maintains the pinch hand shape and release of the pinch hand shape (e.g., the thumb and index finger moving apart) while the hand is still moving. In some embodiments, the input to throw is a pinch hand gesture including the thumb and index finger of the hand of the user coming together while the hand is further than the threshold distance from the object and while the gaze of the user is directed to the object, followed by movement of the hand while the hand maintains the pinch hand shape and release of the pinch hand shape (e.g., the thumb and index finger moving apart) while the hand is still moving. In some embodiments, the throwing input defines a direction in the three-dimensional environment 1702 to throw the object (e.g., corresponding to a direction of movement of the hand during the input and/or at the release of the pinch hand shape) and/or speed with which to throw the object (e.g., corresponding to a speed of the movement of the hand during the input and/or at the release of the pinch hand shape).

For example, in FIG. 17A, device 101 detects hand 1703a performing one or more throwing inputs directed to object 1710a, and hand 1703b performing a throwing input directed to object 1710b. It should be understood that while multiple hands and corresponding inputs are illustrated in FIGS. 17A-17D, such hands and inputs need not be detected by device 101 concurrently; rather, in some embodiments, device 101 independently responds to the hands and/or inputs illustrated and described in response to detecting such hands and/or inputs independently.

In some embodiments, the trajectory of an object in the three-dimensional environment depends on whether an object in the three-dimensional environment has been targeted by the throwing input. For example, targeting is optionally based on gaze information for the user providing the throwing input and/or the direction specified by the throwing input. In some embodiments, if the gaze of the user is directed to a particular object in the three-dimensional environment, the particular object is a valid container for the object being thrown (e.g., the particular object can contain/include the object being thrown, such as the particular container being a user interface of a messaging conversation and the object being thrown being a representation of a photograph to be added to the messaging conversation), and/or the direction of the throwing input is within a range of orientations (e.g., within 3, 5, 10, 15, 20, 30, 45, 60, 90, or 120 degrees) of being directed to the particular object, the particular object is designated by device 101 as being targeted by the throwing input. In some embodiments, if one or more of the above conditions are not satisfied, the particular object is not designated by device 101 as being targeted by the throwing input. If the particular object is targeted by the throwing input, the trajectory of the thrown object in the three-dimensional environment is optionally based on the location of the target object, and is different from the trajectory the thrown object would have if the particular object had not been targeted (e.g., if no object had been targeted).

In FIG. 17A, gaze 1708 of the user is directed to object 1706a, which is optionally a valid container for objects 1710a and/or 1710b. Hand 1703a is illustrated as providing two alternative throwing inputs to object 1710a: one with a direction 1701a, and one with a direction 1701b. It should be understood that while multiple throwing inputs from hand 1703a are illustrated in FIG. 17A, such inputs are optionally not detected by device 101 concurrently; rather, in some embodiments, device 101 independently detects and responds to those inputs in the manners described below. Other than direction, the two alternative throwing inputs are optionally the same (e.g., same speed, same movement of the hand, etc.). Direction 1701a is optionally outside of the range of orientations that would allow for targeting of object 1706a, and direction 1701b is optionally inside of the range of orientations that would allow for targeting of object 1706a.

FIG. 17A also illustrates hand 1703b providing a throwing input to object 1710b with a direction 1701c. The throwing input directed to object 1710b by hand 1703b optionally does not target an object in three-dimensional environment 1702.

In response to the various throwing inputs detected by device 101, device 101 moves objects 1710a and 1710b in three-dimensional environment 1702 in various ways, as illustrated in FIG. 17B. For example, because the throwing input in direction 1701c provided by hand 1703b to object 1710b was not targeted at an object in three-dimensional environment 1702, device 101 optionally animates object 1710b moving away from the viewpoint of the user along trajectory 1707c, as shown in FIG. 17B, which is a trajectory that corresponds to the speed and/or direction of the throwing input provided to object 1710b. Object 1710b optionally does not deviate from trajectory 1707c as it continues moving further from the viewpoint of the user in three-dimensional environment 1702, and continues moving along trajectory 1707c until it reaches its ending location in three-dimensional environment 1702, as shown in FIG. 17C.

Returning to FIG. 17B, because the throwing input in direction 1701a provided by hand 1703a to object 1710a was outside of the range of orientations that would allow for targeting of object 1706a (e.g., even though gaze 1708 of the user was directed to object 1706a when the throwing input was detected), device 101 displays object 1710a′ (corresponding to object 1710a thrown in direction 1701a in FIG. 17A) moving away from the viewpoint of the user along trajectory 1707a, as shown in FIG. 17B, which is a trajectory that corresponds to the speed and/or direction of the throwing input in direction 1701a provided to object 1710a′, and is optionally not based on the location of object 1706a in three-dimensional environment 1702. Object 1710a′ optionally does not deviate from trajectory 1707a as it continues moving further from the viewpoint of the user in three-dimensional environment 1702, and continues moving along trajectory 1707a until it reaches its ending location in three-dimensional environment 1702, as shown in FIG. 17C.

In contrast, because the throwing input in direction 1701b provided by hand 1703a to object 1710a did target object 1706a, device 101 displays object 1710a moving away from the viewpoint of the user along a trajectory that is based on the location of object 1706a in three-dimensional environment 1702. Further, in some embodiments, the trajectory is further based on the location of the gaze 1708 of user. For example, in FIG. 17B, trajectory 1707b′ is optionally the trajectory that object 1710a would follow based on direction 1701b of the throwing input provided to it if object 1706a had not been targeted by the throwing input. Trajectory 1707b′ is optionally a trajectory that corresponds to the speed and/or direction of the throwing input in direction 1701b provided to object 1710a, and is optionally not based on the location of object 1706a in three-dimensional environment 1702.

However, because object 1706a was targeted by the throwing input, device 101 optionally displays object 1710a moving away from the viewpoint of the user along trajectory 1707b, as shown in FIG. 17B, which is optionally a different trajectory than trajectory 1707b′. Trajectory 1707b optionally follows trajectory 1707b′ during an initial portion of the trajectory, but then deviates from trajectory 1707b′ towards object 1706a. In some embodiments, trajectory 1707b deviates from trajectory 1707b′ towards the location of gaze 1708 within object 1706a (e.g., as shown in FIG. 17B). For example, if object 1706a is an object that includes a plurality of valid positions at which to place object 1710a (e.g., a blank canvas on which object 1710a can be placed freely), the position within object 1706a to which trajectory 1707b is directed (e.g., and thus the position within object 1706a at which object 1710a comes to rest) is optionally defined by gaze 1708. Object 1710a optionally follows trajectory 1707b as it continues moving further from the viewpoint of the user in three-dimensional environment 1702, and continues moving along trajectory 1707b until it reaches its ending location in object 1706a, as shown in FIG. 17C.

In some embodiments, if the object that is targeted by the throwing input includes one or more discrete locations into which the thrown object can be placed, the trajectory for the object determined by device 101 is optionally not directed towards the gaze of the user within the targeted object, but rather directed towards one of the one or more discrete locations; in some embodiments, the selected one of the one or more discrete locations is based on the gaze of the user (e.g., the discrete location that is closest to the gaze of the user in the targeted object). For example, FIG. 17D illustrates an example in which object 1706b is targeted by the throwing input directed to object 1710a in direction 1701b by hand 1703a (e.g., in FIG. 17A), and object 1706b includes location 1714b that is a valid target location for object 1710a. For example, location 1714b is a content or text entry field (e.g., of a messaging user interface for adding content or text to a messaging conversation) into which content or text—optionally corresponding to object 1710b—can be placed. Object 1706b also optionally includes another region 1714a that is not a valid target location for object 1710a. For example, region 1714a is optionally a content display region that displays content or text, but that is not editable (e.g., content and/or text cannot be placed in region 1714a).

In the example of FIG. 17D, gaze 1708 of the user was directed to a portion of object 1706b that is outside of location or region 1714b; however, because object 1706b includes location or region 1714b that is the valid target location and/or because location or region 1714b is the valid target location that is closest to gaze 1708 within object 1706b, device 101 has moved object 1710a along trajectory 1707b″—which is optionally different from trajectory 1707b in FIG. 17C—as object 1710a moved further from the viewpoint of the user in three-dimensional environment 1702 to its ending location within location or region 1714b in object 1706b shown in FIG. 17D. Similar to trajectory 1707b, trajectory 1707b″ is optionally a different trajectory than trajectory 1707b′. Further, trajectory 1707b″ optionally follows trajectory 1707b′ during an initial portion of the trajectory, but then deviates from trajectory 1707b′ towards location or region 1714b in object 1706b. In some embodiments, trajectory 1707b″ deviates from trajectory 1707b′ towards a fixed or default location within location or region 1714b (e.g., a location that does not change based on the location of gaze 1708); and in some embodiments, trajectory 1707b″ deviates from trajectory 1707b′ towards a location within location or region 1714b that is defined by gaze 1708 (e.g., a location within location or region 1714b that is closest to gaze 1708).

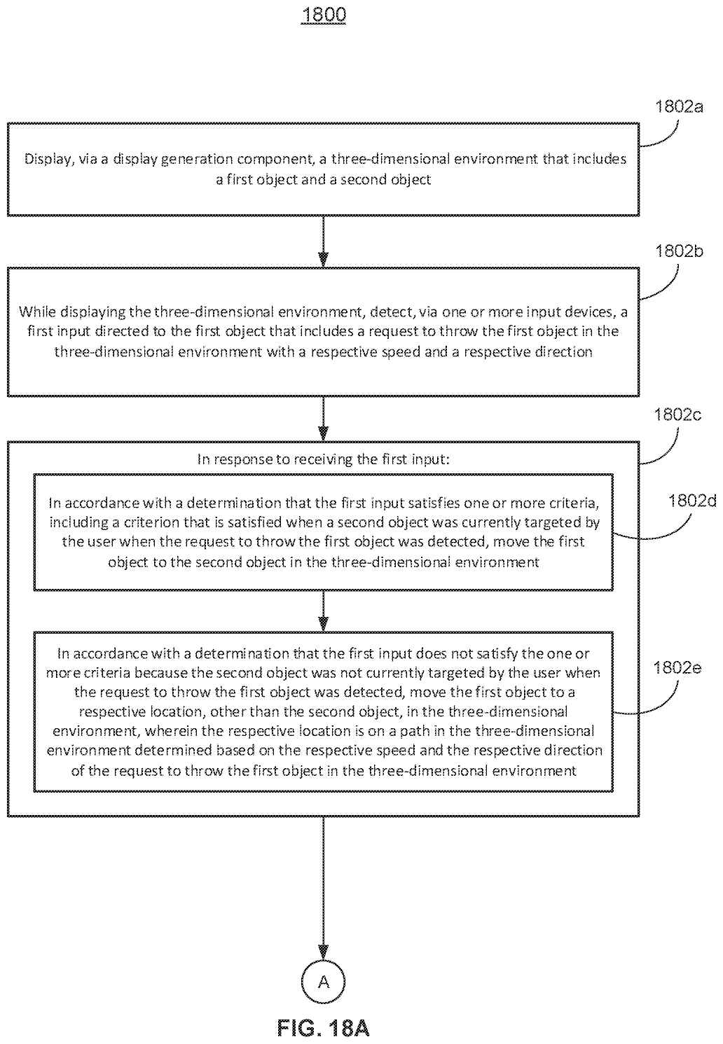

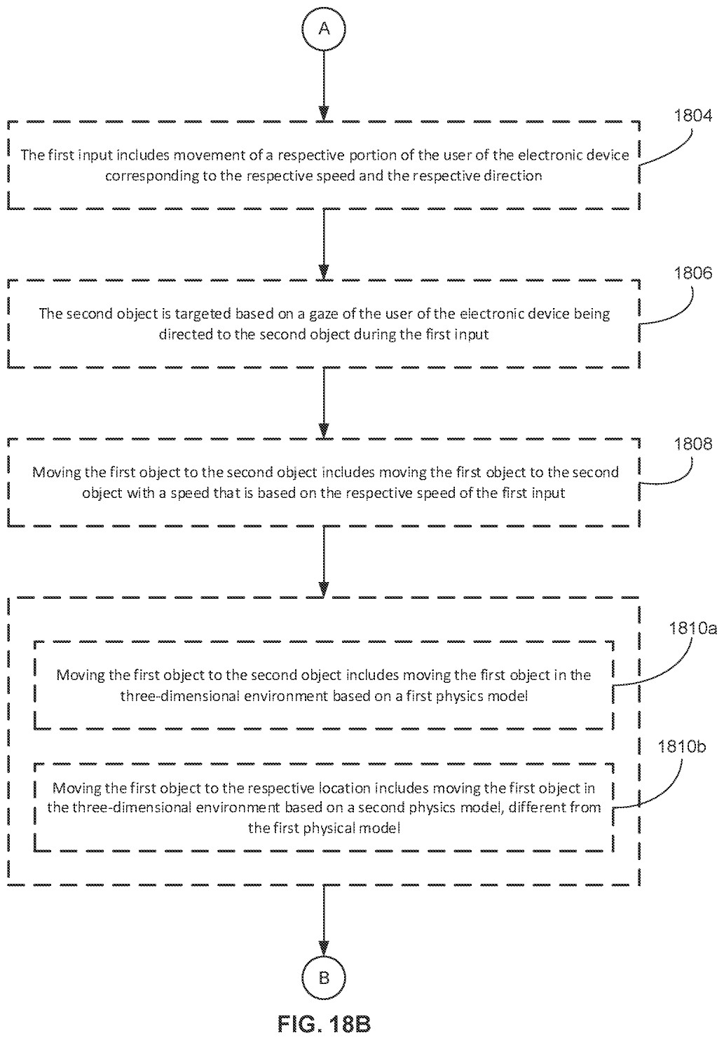

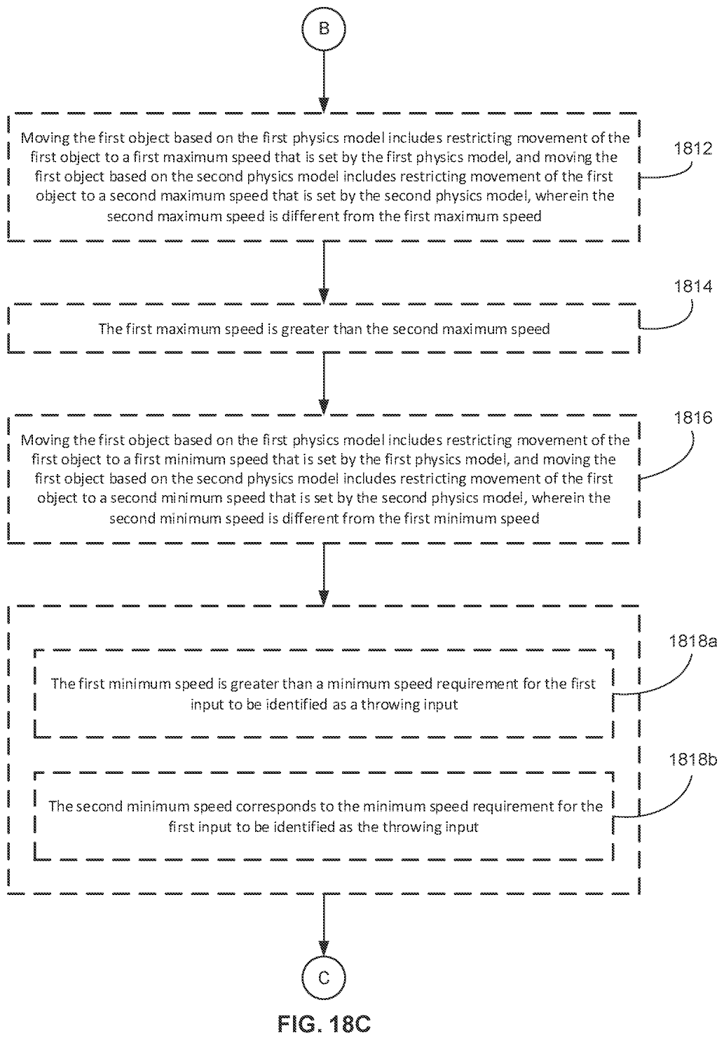

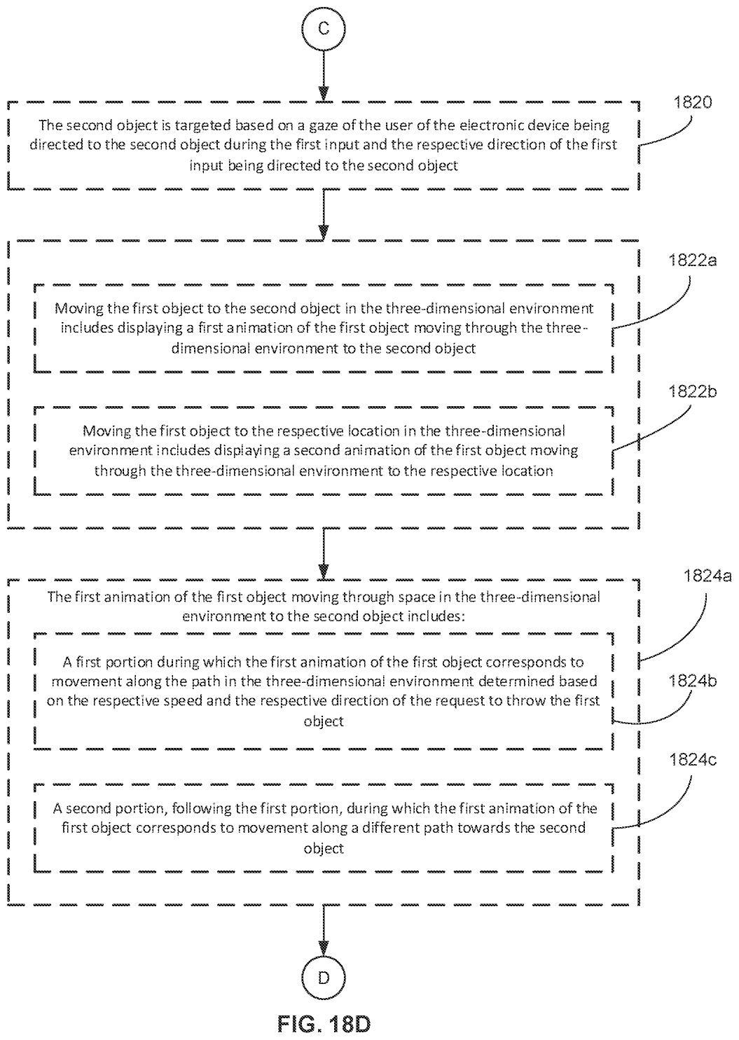

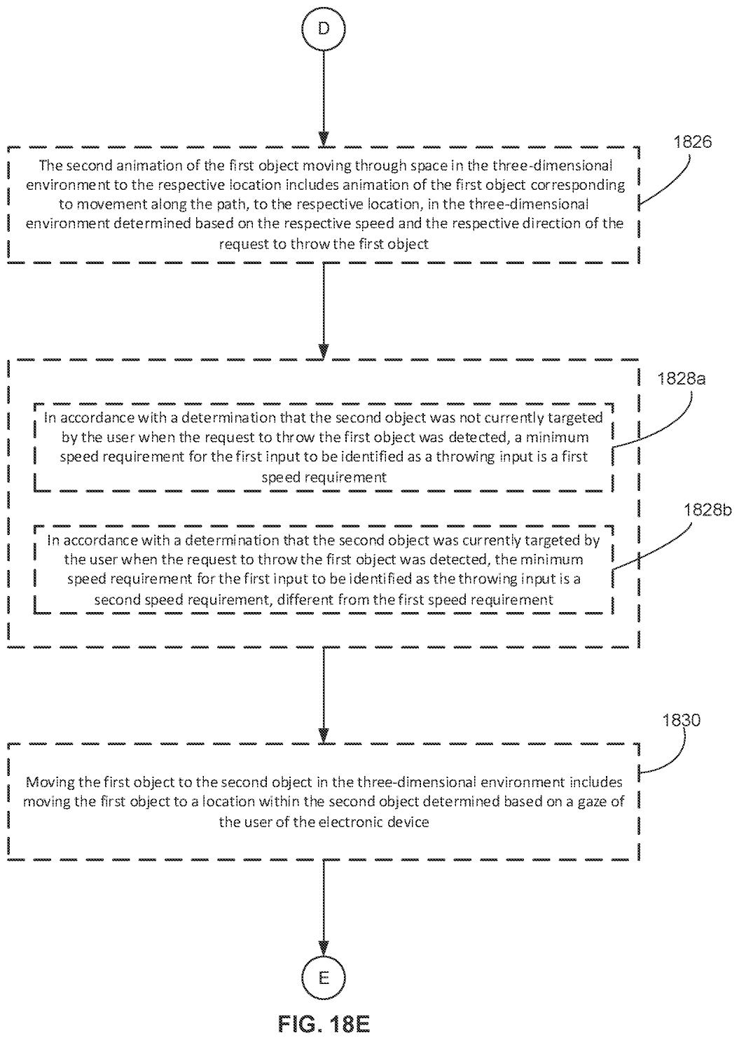

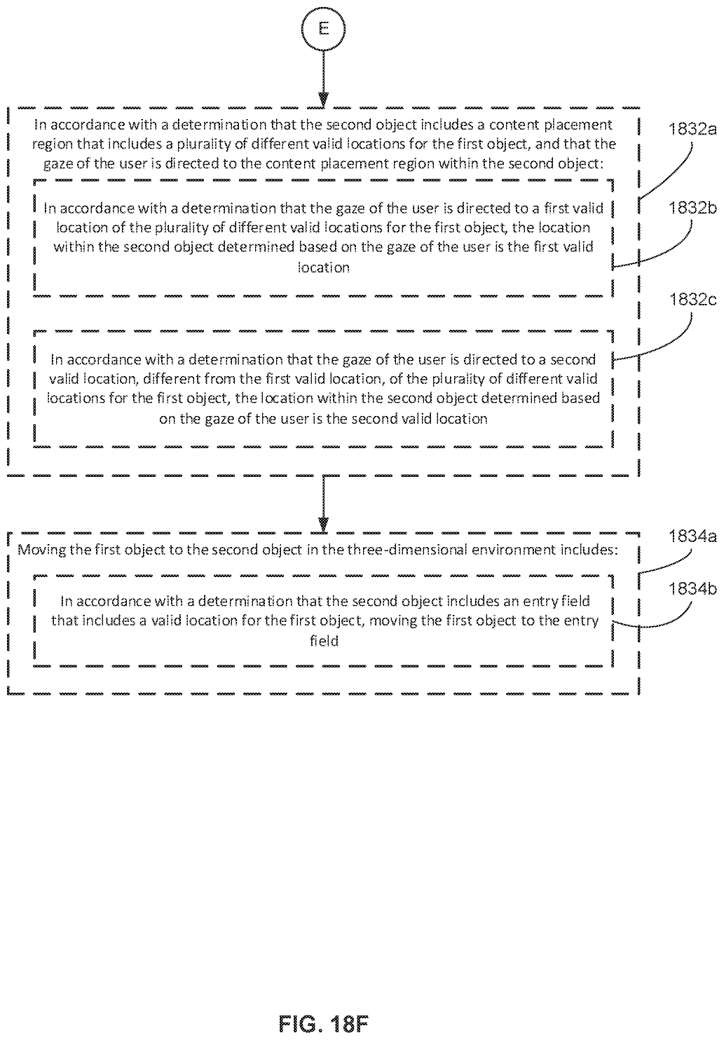

FIGS. 18A-18F is a flowchart illustrating a method 1800 of facilitating the throwing of virtual objects in a three-dimensional environment in accordance with some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, method 1800 is performed at an electronic device (e.g., 101) in communication with a display generation component (e.g., 120) and one or more input devices (e.g., 314). For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1802a), via the display generation component, a three-dimensional environment that includes a first object and a second object, such as objects 1710a and 1706a in FIG. 17A. In some embodiments, the three-dimensional environment is generated, displayed, or otherwise caused to be viewable by the electronic device (e.g., a computer-generated reality (CGR) environment such as a virtual reality (VR) environment, a mixed reality (MR) environment, or an augmented reality (AR) environment, etc.). In some embodiments, the first and/or second objects are objects such as described with reference to method 1600. In some embodiments, the first and/or second objects are two-dimensional objects, such as user interfaces of applications installed on the electronic device (e.g., a user interface of a messaging application, a user interface of a video call application, etc.) and/or representations of content (e.g., representations of photographs, representations of videos, etc.). In some embodiments, the first and/or second objects are three-dimensional objects, such as a three-dimensional model of a car, a three-dimensional model of an alarm clock, etc.

In some embodiments, while displaying the three-dimensional environment, the electronic device detects (1802b), via the one or more input devices, a first input directed to the first object that includes a request to throw the first object in the three-dimensional environment with a respective speed and a respective direction, such as the input from hand 1703a directed to object 1710a in FIG. 17A. For example, the first input is optionally a pinch hand gesture of the thumb and index finger of a hand of a user coming together (e.g., to touch) when the hand is within a threshold distance (e.g., 0.1, 0.5, 1, 2, 3, 5, 10, 20, 50, or 100 cm) of the first object, followed by movement of the hand while the hand maintains the pinch hand shape and release of the pinch hand shape (e.g., the thumb and index finger moving apart) while the hand is still moving. In some embodiments, the first input is a pinch hand gesture of the thumb and index finger of the hand of the user coming together while the hand is further than the threshold distance from the first object and while the gaze of the user is directed to the first object, followed by movement of the hand while the hand maintains the pinch hand shape and release of the pinch hand shape (e.g., the thumb and index finger moving apart) while the hand is still moving. In some embodiments, the first input defines a direction in the three-dimensional environment to throw the first object (e.g., corresponding to a direction of movement of the hand during the first input and/or at the release of the pinch hand shape) and/or speed with which to throw the first object (e.g., corresponding to a speed of the movement of the hand during the first input and/or at the release of the pinch hand shape).

In some embodiments, in response to detecting the first input (1802c), in accordance with a determination that the first input satisfies one or more criteria, including a criterion that is satisfied when a second object was currently targeted by the user when the request to throw the first object was detected, such as object 1706a being targeted by the input from hand 1703a in FIG. 17A (e.g., at a time that corresponds to a time that a portion of the first input corresponding to a release of the first object was detected, such as when a user unpinches their fingers (e.g., moves the tip of their thumb and index finger apart from each other when they were previously touching) or opens their hand while or just after moving their hand or arm in the first input. In some embodiments, the determination of whether the second object was currently targeted is based on characteristics (e.g., characteristics of the throwing input, characteristics of the three-dimensional environment, etc.) at the moment of release of the pinch hand shape by the user, at some time before the release of the pinch hand shape by the user and/or at some time after the release of the pinch hand shape by the user. In some embodiments, the second object was currently targeted when one or more of the following are true: the gaze of the user during the first input, such as at release of the pinch hand shape in the first input, is directed to the second object, even if the direction of the movement of the hand of the user is not directed to the second object; the direction of the movement of the hand of the user (e.g., at the end of the first input) is not directed to the second object, but is within a threshold range of angles (e.g., within 5, 10, 30, 45, 90, or 180 degrees) of being directed to the second object; or the direction of the movement of the hand (e.g., at the end of the first input) is directed to the second object. In some embodiments, the second object was currently targeted based on explicit selection of the second object in response to user input (e.g., highlighting and/or selection of the second object prior to detecting the request to throw the first object) and/or implicit selection (e.g., based on the gaze of the user being directed to the second object, based on one or more of the characteristics described above, etc.).), the electronic device moves (1802d) the first object to the second object in the three-dimensional environment, such as shown from FIGS. 17B-17C with respect to object 1710a (wherein the second object is not moved on a path in the three-dimensional environment determined based on the respective speed and/or respective direction of the request to throw the first object in the three-dimensional environment). For example, if the second object were not targeted (e.g., if no object were targeted), the first object would optionally be moved along a respective path in the three-dimensional environment defined by the direction of the throwing input, without deviating from that respective path by an attraction to a particular object. In some embodiments, the respective path does not lead to/intersect with the second object. However, if the second object is targeted, the first object optionally starts along the respective path, but then deviates from that respective path to reach the second object. Thus, in some embodiments, the path along which the first object moves is different for the same first input from the hand of the user depending on whether an object is currently targeted when the request to throw the first object is detected.). For example, if the second object is targeted, throwing the first object in the three-dimensional environment causes the electronic device to move the first object to the second object through the three-dimensional environment after the end of the first input (e.g., release of the pinch hand shape). In some embodiments, the first object gets added to and/or contained by the second object if the second object is a valid container for the first object. For example, if the second object is a messaging user interface that includes a content entry field for adding content to a messaging conversation displayed by the second object, if the one or more criteria are satisfied, throwing the first object (e.g., a representation of a photo, image, video, song, etc.) in the three-dimensional environment causes the first object to be added to the content entry field and/or the messaging conversation. In some embodiments in which the direction of the movement of the hand of the user is not directed to the second object, but the second object is targeted as described above, the initial portion of the movement of the first object to the second object is based on the direction of the movement of the hand, but subsequent portions of the movement of the first object to the second object are not (e.g., the first object deviates from a path defined by the direction of the throwing input in order to reach the second object based on satisfaction of the one or more criteria.

In some embodiments, in accordance with a determination that the first input does not satisfy the one or more criteria because the second object was not currently targeted by the user when the request to throw the first object was detected, such as the input in direction 1701a by hand 1703a in FIG. 17A (e.g., the second object was targeted, but not when the request to throw the first object was detected (e.g., the gaze of the user was previously directed to the second object, but not at or during the moment in time during the first input when targeting is determined), a different object in the three-dimensional environment was targeted, or no object was targeted. In some embodiments, the second object is not targeted when one or more of the following are true: the gaze of the user during the first input, such as at release of the pinch hand shape in the first input, is not directed to the second object; the direction of the movement of the hand of the user (e.g., at the end of the first input) is not directed to the second object and is outside of a threshold range of angles (e.g., within 5, 10, 30, 45, 90, or 180 degrees) of being directed to the second object; or the direction of the movement of the hand (e.g., at the end of the first input) is not directed to the second object), the electronic device moves the first object to a respective location, other than the second object, in the three-dimensional environment, wherein the respective location is on a path in the three-dimensional environment determined based on the respective speed and the respective direction of the request to throw the first object in the three-dimensional environment, such as shown with object 1710a′ in FIGS. 17B-17C (e.g., causing the electronic device to move the first object in the three-dimensional environment after the end of the first input based on the direction of the movement of the hand and/or the speed of the movement of the hand at the time of the end of the first input, without adding the first object to the second object or without adding the first object to any other object). In some embodiments, the respective location does not include an object, and thus the first object is moved in space in accordance with the throwing input. Facilitating movement of objects to targeted objects in the three-dimensional environment improves the efficiency of object movement inputs to the device and avoids erroneous object movement results, thereby improving user-device interaction.

In some embodiments, the first input includes movement of a respective portion of the user of the electronic device corresponding to the respective speed and the respective direction (1804), such as described with reference to hands 1703a and 1703b in FIG. 17A. For example, the throwing input is an input provided by a hand of the user while in a pinch hand shape, with the hand moving with a speed and in a direction corresponding to the respective speed and the respective direction. Facilitating movement of objects to targeted objects based on hand movement in the three-dimensional environment improves the efficiency of object movement inputs to the device, thereby improving user-device interaction.

In some embodiments, the second object is targeted based on a gaze of the user of the electronic device being directed to the second object during the first input (1806), such as gaze 1708 in FIG. 17A. For example, if the gaze of the user is directed to the second object (e.g., during a time during which the object targeting is determined, such as before the release of the pinch gesture of the throwing input, at the release of the pinch gesture of the throwing input, after the release of the pinch gesture of the throwing input), the second object is optionally determined to be targeted by the throwing input. In some embodiments, if the gaze of the user is not directed to the second object, the second object is optionally determined to not be targeted. Targeting objects based on gaze improves the efficiency of object movement inputs to the device, thereby improving user-device interaction.

In some embodiments, moving the first object to the second object includes moving the first object to the second object with a speed that is based on the respective speed of the first input (1808), such as described with reference to the inputs from hands 1703a and/or 1703b in FIG. 17A. For example, the electronic device optionally displays an animation of the first object moving to the second object in the three-dimensional environment. In some embodiments, the speed with which the first object is animated as moving in the three-dimensional environment is based on the speed of the throwing input (e.g., the hand providing the throwing input), such as being higher if the throwing input has a higher speed, and lower if the throwing input has a lower speed. Moving objects with speed based on the speed of the throwing input matches device response with user input, thereby improving user-device interaction.

In some embodiments, moving the first object to the second object includes moving the first object in the three-dimensional environment based on a first physics model (1810a), such as moving object 1710a along trajectory 1707b in FIGS. 17A-17C (e.g., using first velocities, first accelerations, first paths of movement, etc.).

In some embodiments, moving the first object to the respective location includes moving the first object in the three-dimensional environment based on a second physics model, different from the first physical model (1810b), such as moving object 1710a along trajectory 1707a in FIGS. 17B-17C (e.g., using second velocities, second accelerations, second paths of movement, etc.). In some embodiments, the first physics model, which optionally controls how the first object moves through space to the second object and/or the relationship of the first input to how the first object moves to the second object, is different from the second physics model, which optionally controls how the first object moves through space to the respective location and/or the relationship of the first input to how the first object moves to the respective location. Thus, in some embodiments, outside of the fact that the first object is moving to different locations in the two scenarios described above, the first object moves differently to those different locations given the same throwing input. Utilizing different physics models for the movement of the first object ensures that object movement in the three-dimensional environment is well-suited to the target of such movement, thereby improving user-device interaction.

In some embodiments, moving the first object (e.g., 1710a) based on the first physics model includes restricting movement of the first object to a first maximum speed that is set by the first physics model (e.g., at some point in the animation of moving the first object to the second object and/or applying a first maximum speed threshold to the throwing input that controls the maximum speed at which the first object moves), and moving the first object (e.g., 1710a′) based on the second physics model includes restricting movement of the first object to a second maximum speed that is set by the second physics model, wherein the second maximum speed is different from the first maximum speed (1812) (e.g., at some point in the animation of moving the first object to the respective location and/or applying a second maximum speed threshold to the throwing input that controls the maximum speed at which the first object moves). In some embodiments, the speed threshold over which further input speed will not result in increased speed in the movement of the first object (and/or increased distance that the first object moves in the three-dimensional environment) is different for the first physics model and the second physics model. In some embodiments, below the respective input speed threshold for a given physics model, a faster input speed results in faster object movement, and a slower input speed results in slower object movement. In some embodiments, restricting the maximum speed of movement of the first object similarly restricts the maximum simulated inertia for the first object in the three-dimensional environment (e.g., for a given mass of the first object). Utilizing different maximum speed thresholds for different types of object movement ensures that object movement in the three-dimensional environment is well-suited to the target of such movement, thereby improving user-device interaction.

In some embodiments, the first maximum speed is greater than the second maximum speed (1814). In some embodiments, the maximum input speed threshold for inputs targeting an object is higher than for inputs not targeting an object (e.g., inputs directed to empty space in the three-dimensional environment). In some embodiments, this is the case to limit the distance to which an object can be thrown in the case that an object is not targeted with the throwing input, ensuring that the object is still at a distance at which it is interactable by the user after being thrown. Thus, in some embodiments, a user will be able to cause an object to move to an object more quickly than to a location in empty space. Utilizing higher maximum speed thresholds for object-targeted movement allows for increased speed of movement when appropriate while avoiding objects being thrown to distances at which they are no longer interactable, thereby improving user-device interaction.

In some embodiments, moving the first object (e.g., 1710a) based on the first physics model includes restricting movement of the first object to a first minimum speed that is set by the first physics model (e.g., at some point in the animation of moving the first object to the second object and/or applying a first minimum speed threshold to the throwing input that controls the minimum speed at which the first object moves), and moving the first object (e.g., 1710a′) based on the second physics model includes restricting movement of the first object to a second minimum speed that is set by the second physics model, wherein the second minimum speed is different from the first minimum speed (1816) (e.g., at some point in the animation of moving the first object to the respective location applying a second minimum speed threshold to the throwing input that controls the minimum speed at which the first object moves). In some embodiments, the speed threshold under which less input speed will not result in decreased speed in the movement of the first object (and/or decreased distance that the first object moves in the three-dimensional environment), and/or under which less input speed will not be identified as a throwing input, is different for the first physics model and the second physics model. In some embodiments, above the respective input speed threshold for a given physics model, a faster input speed results in faster object movement, and a slower input speed results in slower object movement. In some embodiments, restricting the minimum speed of movement of the first object similarly restricts the minimum simulated inertia for the first object in the three-dimensional environment (e.g., for a given mass of the first object). Utilizing different minimum speed thresholds for different types of object movement ensures that object movement in the three-dimensional environment is well-suited to the target of such movement, thereby improving user-device interaction.

In some embodiments, the first minimum speed is greater than a minimum speed requirement for the first input to be identified as a throwing input (1818a), such as the speed of the movement of hand 1703a required for the input from hand 1703a to be identified as a throwing input. For example, when an object (e.g., the second object) is targeted by the user input, the user input is required to have the first minimum speed in order for the electronic device to respond to the input as a throwing or flinging input directed to the first object that causes the first object to move to the second object in the three-dimensional environment (e.g., with the first minimum speed). In some embodiments, if the input has a speed less than the first minimum speed, the first object does not move to the second object (e.g., even though the second object is otherwise targeted by the input); in some embodiments, the input is not recognized as a throwing input, and the first object remains at its current location in the three-dimensional environment and/or its position remains controlled by the movements of the hand of the user; in some embodiments, the input is recognized as a throwing input, but the first object is thrown to a location in the three-dimensional environment that is short of the second object. In some embodiments, this first minimum speed is greater than the minimum input speed required by the device to recognize an input as a throwing input in the case that no object is targeted by the input (e.g., in the case that the input is directed to empty space in the three-dimensional environment).

In some embodiments, the second minimum speed corresponds to the minimum speed requirement for the first input to be identified as the throwing input (1818b), such as the speed of the movement of hand 1703a required for the input from hand 1703a to be identified as a throwing input. For example, when an object (e.g., the second object) is not targeted by the user input, the user input is required to have the second minimum speed in order for the electronic device to respond to the input as a throwing or flinging input directed to the first object that causes the first object to move to the respective location in the three-dimensional environment (e.g., with the second minimum speed). In some embodiments, if the input has a speed less than the second minimum speed, the first object does not move to the respective location; in some embodiments, the input is not recognized as a throwing input, and the first object remains at its current location in the three-dimensional environment and/or its position remains controlled by the movements of the hand of the user; in some embodiments, the input is recognized as a throwing input, but the first object is thrown to a location in the three-dimensional environment that is short of the respective location. In some embodiments, this second minimum speed is the same as the minimum input speed required by the device to recognize an input as a throwing input (e.g., in the case that the input is directed to empty space in the three-dimensional environment). Utilizing higher minimum speed thresholds for object-targeted movement ensures that the input has sufficient speed for the object being thrown to reach the targeted object, thereby improving user-device interaction.

In some embodiments, the second object is targeted based on a gaze of the user of the electronic device being directed to the second object during the first input and the respective direction of the first input being directed to the second object (1820), such as gaze 1708 and direction 1701b in FIG. 17A. In some embodiments, in order for the second object to be targeted, both the gaze of the user must be directed to the second object (e.g., during the first input, at the end/release of the first input and/or after the first input) and the direction of the first input must be directed to the second object (e.g., during the first input, at the end/release of the first input and/or after the first input). In some embodiments, the gaze of the user is directed to the second object when the gaze of the user is coincident with the second object and/or the gaze of the user is coincident with a volume surrounding the second object (e.g., a volume that is 1, 5, 10, 20, 30, or 50 percent larger than the second object). In some embodiments, the direction of the first input is directed to the second object when the direction is within 0, 1, 3, 5, 10, 15, 30, 45, 60, or 90 degrees of being directed to the second object. In some embodiments, if the gaze or the direction is not directed to the second object, the first object is not moved to the second object. For example, if the gaze of the user is directed to the second object but the direction of the input is not directed to the second object, the first object is moved to a location in the three-dimensional environment based on the speed and/or direction of the input, and is not moved to the second object. Requiring both gaze and direction to be directed to the second object ensures that the input is not erroneously determined to be directed to the second object, thereby improving user-device interaction.

In some embodiments, moving the first object to the second object in the three-dimensional environment includes displaying a first animation of the first object moving through the three-dimensional environment to the second object (1822a), such as an animation of object 1710a moving along trajectory 1707b.

In some embodiments, moving the first object to the respective location in the three-dimensional environment includes displaying a second animation of the first object moving through the three-dimensional environment to the respective location (1822b), such as an animation of object 1710a′ moving along trajectory 1707a. In some embodiments, the first and second animations are different (e.g., in the path the first object traverses, the speed at which it traverses the path, the direction the path is in relative to the viewpoint of the user, the change in the position of the first object over time relative to the viewpoint of the user (e.g., one or more both distance from the viewpoint and lateral position relative to the viewpoint), etc.). In some embodiments, the amount of the field of view of the user occupied by the first object changes as the first and/or second animations progress (e.g., is reduced as the first object moves further away from the viewpoint of the user). In some embodiments, the various characteristics of the first and/or second animations are based on the first input (e.g., the speed of the movement of the first object in the animations, the direction of the movement of the object in the animations, etc.). Animating the movement of the first object through the three-dimensional environment provides feedback to the user of the results of the user's input, thereby improving user-device interaction.

In some embodiments, the first animation of the first object moving through space in the three-dimensional environment to the second object includes (1824a) a first portion during which the first animation of the first object corresponds to movement along the path in the three-dimensional environment determined based on the respective speed and the respective direction of the request to throw the first object (1824b), such as corresponding to the beginning portions of trajectories 1707b and 1707b′ being the same. For example, the first portion of the first animation corresponds to (e.g., is the same as) a corresponding first portion of the second animation. Thus, in some embodiments, the initial part of the animation of the first object matches the speed and/or direction of the first input (e.g. and is not affected by the targeting of the second object). In some embodiments, the first portion of the first animation includes movement of the first object along a straight line path, and the second animation includes movement of the first object along a straight line path (e.g., for the entirety of the second animation)—in some embodiments, the same straight line path.

In some embodiments, the first animation of the first object moving through space in the three-dimensional environment to the second object includes a second portion, following the first portion, during which the first animation of the first object corresponds to movement along a different path towards the second object (1824c), such as object 1710a deviating from trajectory 1707b′ to trajectory 1707b in FIG. 17B. For example, after the first portion of the first animation, the first object deviates from the (e.g., straight line) path that is defined by the speed and/or direction of the first input, and moves along a path that is also defined by the targeting of the second object. In some embodiments, the path of the first object becomes curved after the first portion of the first animation, curving towards the second object and away from the earlier-followed straight line path. Matching the initial portion of the first animation with the speed and/or direction of the first input provides a result that corresponds to and is consistent with the user input, and is not disconnected from the user input, thereby improving user-device interaction.

In some embodiments, the second animation of the first object moving through space in the three-dimensional environment to the respective location includes animation of the first object corresponding to movement along the path, to the respective location, in the three-dimensional environment determined based on the respective speed and the respective direction of the request to throw the first object (1826), such an animation corresponding to movement along trajectory 1707a. In some embodiments, the first object moves along a straight-line path during (e.g., for the entirety of) the second animation. In some embodiments, the direction of the straight-line path corresponds to the direction of the first input (e.g., during the first input, at the end/release of the first input and/or after the first input). In some embodiments, the length of the straight line path corresponds to the speed of the first input (e.g., during the first input, at the end/release of the first input and/or after the first input), where a greater speed of the first input results in a longer path, and a lower speed of the first input results in a shorter path. Defining the path of the first object based on the speed and/or direction of the first input provides a result that corresponds to and is consistent with the user input, and is not disconnected from the user input, thereby improving user-device interaction.

In some embodiments, in accordance with a determination that the second object was not currently targeted by the user when the request to throw the first object was detected (e.g., the first input corresponds to an input to throw the first object to empty space in the three-dimensional environment), a minimum speed requirement for the first input to be identified as a throwing input is a first speed requirement (1828a), such as for the input from hand 1703a in direction 1701a in FIG. 17A (e.g., input speed of at least 0 cm/s, 0.3 cm/s 0.5 cm/s, 1 cm/s, 3 cm/s, 5 cm/s, or 10 cm/s is required (e.g., during the first input, at the end/release of the first input and/or after the first input) for the first input to be identified as a throwing input when an object is not targeted). In some embodiments, if the minimum speed requirement is not met, the input is not identified as a throwing input, and the first object is not thrown in the three-dimensional environment, as previously described.

In some embodiments, in accordance with a determination that the second object was currently targeted by the user when the request to throw the first object was detected (e.g., the first input corresponds to an input to throw the first object to the second object in the three-dimensional environment), the minimum speed requirement for the first input to be identified as the throwing input is a second speed requirement, different from the first speed requirement (1828b), such as for the input from hand 1703a in direction 1701b in FIG. 17A (e.g., greater than or less than the first speed requirement). For example, an input speed of at least 0.1 cm/s, 0.3 cm/s 0.5 cm/s, 1 cm/s, 3 cm/s, 5 cm/s, or 10 cm/s is required (e.g., during the first input, at the end/release of the first input and/or after the first input) for the first input to be identified as a throwing input when an object is targeted. In some embodiments, if the minimum speed requirement is not met, the input is not identified as a throwing input, and the first object is not thrown in the three-dimensional environment, as previously described. Utilizing different minimum speed thresholds for object-targeted movement ensures that the input has sufficient speed for the object being thrown to reach the targeted object, thereby improving user-device interaction.

In some embodiments, moving the first object to the second object in the three-dimensional environment includes moving the first object to a location within the second object determined based on a gaze of the user of the electronic device (1830), such as shown in FIG. 17C. For example, if the second object includes multiple locations (e.g., different entry fields, different locations within the same entry field or region, etc.) at which the first object can be placed/to which the first object can be thrown, which of those locations is selected as the destination of the first object is optionally based on the gaze of the user. For example, if the gaze of the user is directed to or closer to a first of those locations, the first object is optionally moved to the first location in the second object (and not a second location of those locations), and if the gaze of the user is directed to or closer to a second of those locations, the first object is optionally moved to the second location in the second object (and not the first location of those locations). Utilizing gaze within the second object to direct the movement of the first object provides greater control and flexibility to the user to specify targets of throwing, thereby improving user-device interaction.

In some embodiments, in accordance with a determination that the second object includes a content placement region that includes a plurality of different valid locations for the first object (e.g., the second object includes a canvas or other region within which multiple locations are valid locations to throw the first object), and that the gaze of the user is directed to the content placement region within the second object (1832a), in accordance with a determination that the gaze of the user is directed to a first valid location of the plurality of different valid locations for the first object, the location within the second object determined based on the gaze of the user is the first valid location (1832b), such as the location of gaze 1708 in FIG. 17C (e.g., the first object is thrown/moved to the first valid location in the content placement region). In some embodiments, in accordance with a determination that the gaze of the user is directed to a second valid location, different from the first valid location, of the plurality of different valid locations for the first object, the location within the second object determined based on the gaze of the user is the second valid location (1832c), such as if gaze 1708 were directed to another location in object 1706a in FIG. 17C (e.g., the first object is thrown/moved to the second valid location in the content placement region). Thus, in some embodiments, within a content placement region that provides flexibility for the placement of the first object as a result of being thrown to the second object, the gaze of the user is utilized to provide fine control over the ending location of the first object such that the first object lands at the location of the gaze and/or within a threshold proximity of the gaze of the user (e.g., within 0.1, 0.5, 1, 3, 5, 10, 15, 20, 30, 50, or 100 mm of the gaze location of the user). Utilizing gaze within the second object to provide fine control of the target location of the first object provides greater control and flexibility to the user to specify targets of throwing, thereby improving user-device interaction.

In some embodiments, moving the first object to the second object in the three-dimensional environment includes (1834a) in accordance with a determination that the second object includes an entry field that includes a valid location for the first object, moving the first object to the entry field (1834b), such as shown in FIG. 17D. In some embodiments, if the gaze of the user is directed to the second object and/or if the second object is targeted by the user when the request to throw the first object is detected, and if the second object includes an entry field (e.g., only one entry field), the electronic device moves the first object to the entry field even if the gaze of the user is not directed to the entry field but is directed to another portion of the second object. As another example, if the second object includes discrete locations at which the first object can be targeted, such as one or more entry fields where the entry fields can be targeted by the gaze of the user but specific locations within the entry fields cannot be targeted by the gaze of the user (e.g., the first object lands in a default location within the targeted entry field regardless of whether the gaze of the user is directed to a first or second location within the targeted entry field), then the electronic device optionally determines which entry field to which to direct the first object based on which entry field is closest to the gaze of the user during the targeting portion of the first input. For example, if the gaze of the user is closer to a first entry field than a second entry field in the second object (e.g., even if the gaze is not directed to a location within the first entry field, but is directed to a portion of the second object outside of the first entry field), the first entry field is targeted and the first object moves to a location within the first entry field (e.g., and not the second entry field). If the gaze of the user is closer to the second entry field than the first entry field in the second object (e.g., even if the gaze is not directed to a location within the second entry field, but is directed to a portion of the second object outside of the second entry field), the second entry field is targeted and the first object moves to a location within the second entry field (e.g., and not the first entry field). Utilizing gaze within the second object to provide coarse control of the target location of the first object provides control and flexibility to the user to specify targets of throwing even when fine targeting is not available, thereby improving user-device interaction.

It should be understood that the particular order in which the operations in method 1800 have been described is merely exemplary and is not intended to indicate that the described order is the only order in which the operations could be performed. One of ordinary skill in the art would recognize various ways to reorder the operations described herein.

In some embodiments, aspects/operations of methods 800, 1000, 1200, 1400, 1600 and/or 1800 may be interchanged, substituted, and/or added between these methods. For example, the three-dimensional environments of methods 800, 1000, 1200, 1400, 1600 and/or 1800, the objects being moved in methods 800, 1000, 1200, 1400, 1600 and/or 1800, and/or valid and invalid drop targets of methods 800, 1000, 1200, 1400, 1600 and/or 1800 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1.-29. (canceled)

30. A method comprising:
at an electronic device in communication with a display generation component and one or more input devices:
displaying, via the display generation component, a three-dimensional environment that includes a first object at a first location in the three-dimensional environment, wherein the first object has a first size in the three-dimensional environment and occupies a first amount of a field of view from a respective viewpoint;
while displaying the three-dimensional environment that includes the first object at the first location in the three-dimensional environment, receiving, via the one or more input devices, a first input corresponding to a request to move the first object away from the first location in the three-dimensional environment; and
in response to receiving the first input:
in accordance with a determination that the first input corresponds to a request to move the first object away from the respective viewpoint:
moving the first object away from the respective viewpoint from the first location to a second location in the three-dimensional environment in accordance with the first input, wherein the second location is further than the first location from the respective viewpoint; and
scaling the first object such that when the first object is located at the second location, the first object has a second size, larger than the first size, in the three-dimensional environment and occupies a second amount of the field of view from the respective viewpoint, wherein the second amount is smaller than the first amount.

31. The method of claim 30, further comprising:
while receiving the first input and in accordance with the determination that the first input corresponds to the request to move the first object away from the respective viewpoint, continuously scaling the first object to increasing sizes as the first object moves further from the respective viewpoint.

32. The method of claim 30, wherein the first object is an object of a first type, and the three-dimensional environment further includes a second object that is an object of a second type, different from the first type, the method further comprising:
while displaying the three-dimensional environment that includes the second object at a third location in the three-dimensional environment, wherein the second object has a third size in the three-dimensional environment and occupies a third amount of the field of view from the respective viewpoint, receiving, via the one or more input devices, a second input corresponding to a request to move the second object away from the third location in the three-dimensional environment; and
in response to receiving the second input and in accordance with a determination that the second input corresponds to a request to move the second object away from the respective viewpoint:
moving the second object away from the respective viewpoint from the third location to a fourth location in the three-dimensional environment in accordance with the second input, wherein the fourth location is further than the third location from the respective viewpoint, without scaling the second object such that when the second object is located at the fourth location, the second object has the third size in the three-dimensional environment and occupies a fourth amount, less than the third amount, of the field of view from the respective viewpoint.

33. The method of claim 32, wherein:
the second object is displayed with a control user interface for controlling one or more operations associated with the second object;
when the second object is displayed at the third location, the control user interface is displayed at the third location and has a fourth size in the three-dimensional environment, and
when the second object is displayed at the fourth location, the control user interface is displayed at the fourth location and has a fifth size, greater than the fourth size, in the three-dimensional environment.

34. The method of claim 30, further comprising:
while displaying the three-dimensional environment that includes the first object at the first location in the three-dimensional environment, the first object having the first size in the three-dimensional environment, wherein the respective viewpoint is a first viewpoint, detecting movement of a viewpoint of a user from the first viewpoint to a second viewpoint that changes a distance between the viewpoint of the user and the first object; and
in response to detecting the movement of the viewpoint from the first viewpoint to the second viewpoint, updating display of the three-dimensional environment to be from the second viewpoint without scaling a size of the first object at the first location in the three-dimensional environment.

35. The method of claim 34, wherein the first object is an object of a first type, and the three-dimensional environment further includes a second object that is an object of a second type, different from the first type, the method further comprising:
while displaying the three-dimensional environment that includes the second object at a third location in the three-dimensional environment, wherein the second object has a third size in the three-dimensional environment and the viewpoint of the user is the first viewpoint, detecting movement of the viewpoint from the first viewpoint to the second viewpoint that changes a distance between the viewpoint of the user and the second object; and
in response to detecting the movement of the respective viewpoint:
updating display of the three-dimensional environment to be from the second viewpoint; and
scaling a size of the second object at the third location to be a fourth size, different from the third size, in the three-dimensional environment.

36. The method of claim 30, further comprising:
while displaying the three-dimensional environment that includes the first object at the first location in the three-dimensional environment, detecting movement of a viewpoint of a user in the three-dimensional environment from a first viewpoint to a second viewpoint that changes a distance between the viewpoint and the first object;
in response to detecting the movement of the viewpoint, updating display of the three-dimensional environment to be from the second viewpoint without scaling a size of the first object at the first location in the three-dimensional environment;
while displaying the first object at the first location in the three-dimensional environment from the second viewpoint, receiving, via the one or more input devices, a second input corresponding to a request to move the first object away from the first location in the three-dimensional environment to a third location in the three-dimensional environment that is further from the second location than the first location; and
while detecting the second input and before moving the first object away from the first location, scaling a size of the first object to be a third size, different from the first size, based on a distance between the first object and the second viewpoint when a beginning of the second input is detected.

37. The method of claim 30, wherein the three-dimensional environment further includes a second object at a third location in the three-dimensional environment, the method further comprising:
in response to receiving the first input:
in accordance with a determination that the first input corresponds to a request to move the first object to a fourth location in the three-dimensional environment, the fourth location a first distance from the respective viewpoint, displaying the first object at the fourth location in the three-dimensional environment, wherein the first object has a third size in the three-dimensional environment; and
in accordance with a determination that the first input satisfies one or more criteria, including a respective criterion that is satisfied when the first input corresponds to a request to move the first object to the third location in the three-dimensional environment, the third location the first distance from the respective viewpoint, displaying the first object at the third location in the three-dimensional environment, wherein the first object has a fourth size, different from the third size, in the three-dimensional environment.

38. The method of claim 37, wherein the fourth size of the first object is based on a size of the second object.

39. The method of claim 38, further comprising:
while the first object is at the third location in the three-dimensional environment and has the fourth size that is based on the size of the second object, receiving, via the one or more input devices, a second input corresponding to a request to move the first object away from the third location in the three-dimensional environment; and
in response to receiving the second input, displaying the first object at a fifth size, wherein the fifth size is not based on the size of the second object.

40. The method of claim 37, wherein the respective criterion is satisfied when the first input corresponds to a request to move the first object to any location within a volume in the three-dimensional environment that includes the third location.

41. The method of claim 37, further comprising:
while receiving the first input, and in accordance with a determination that the first object has moved to the third location in accordance with the first input and that the one or more criteria are satisfied, changing an appearance of the first object to indicate that the second object is a valid drop target for the first object.

42. The method of claim 37, wherein the one or more criteria include a criterion that is satisfied when the second object is a valid drop target for the first object, and not satisfied when the second object is not a valid drop target for the first object, the method further comprising:
in response to receiving the first input:
in accordance with a determination that the respective criterion is satisfied but the first input does not satisfy the one or more criteria because the second object is not a valid drop target for the first object, displaying the first object at the fourth location in the three-dimensional environment, wherein the first object has the third size in the three-dimensional environment.

43. The method of claim 37, further comprising:
in response to receiving the first input:
in accordance with the determination that the first input satisfies the one or more criteria, updating an orientation of the first object relative to the respective viewpoint based on an orientation of the second object relative to the respective viewpoint.

44. The method of claim 30, wherein the three-dimensional environment further includes a second object at a third location in the three-dimensional environment, the method further comprising:
while receiving the first input:
in accordance with a determination that the first input corresponds to a request to move the first object through the third location and further from the respective viewpoint than the third location:
moving the first object away from the respective viewpoint from the first location to the third location in accordance with the first input while scaling the first object in the three-dimensional environment based on a distance between the respective viewpoint and the first object; and
after the first object reaches the third location, maintaining display of the first object at the third location without scaling the first object while continuing to receive the first input.

45. The method of claim 30, wherein scaling the first object is in accordance with a determination that the second amount of the field of view from the respective viewpoint occupied by the first object at the second size is greater than a threshold amount of the field of view, the method further comprising:
while displaying the first object at a respective size in the three-dimensional environment, wherein the first object occupies a first respective amount of the field of view from the respective viewpoint, receiving, via the one or more input devices, a second input corresponding to a request to move the first object away from the respective viewpoint; and
in response to receiving the second input:
in accordance with a determination that the first respective amount of the field of view from the respective viewpoint is less than the threshold amount of the field of view, moving the first object away from the respective viewpoint in accordance with the second input without scaling a size of the first object in the three-dimensional environment.

46. The method of claim 30, wherein the first input corresponds to the request to move the first object away from the respective viewpoint, the method further comprising:
in response to receiving a first portion of the first input and before moving the first object away from the respective viewpoint:
in accordance with a determination that the first size of the first object satisfies one or more criteria, including a criterion that is satisfied when the first size does not correspond to a current distance between the first object and the respective viewpoint, scaling the first object to have a third size, different from the first size, that is based on the current distance between the first object and the respective viewpoint.

47. An electronic device, comprising:
one or more processors;
memory; and
one or more programs, wherein the one or more programs are stored in the memory and configured to be executed by the one or more processors, the one or more programs including instructions for:
displaying, via a display generation component, a three-dimensional environment that includes a first object at a first location in the three-dimensional environment, wherein the first object has a first size in the three-dimensional environment and occupies a first amount of a field of view from a respective viewpoint;
while displaying the three-dimensional environment that includes the first object at the first location in the three-dimensional environment, receiving, via one or more input devices, a first input corresponding to a request to move the first object away from the first location in the three-dimensional environment; and
in response to receiving the first input:
in accordance with a determination that the first input corresponds to a request to move the first object away from the respective viewpoint:
moving the first object away from the respective viewpoint from the first location to a second location in the three-dimensional environment in accordance with the first input, wherein the second location is further than the first location from the respective viewpoint; and
scaling the first object such that when the first object is located at the second location, the first object has a second size, larger than the first size, in the three-dimensional environment and occupies a second amount of the field of view from the respective viewpoint, wherein the second amount is smaller than the first amount.

48. A non-transitory computer readable storage medium storing one or more programs, the one or more programs comprising instructions, which when executed by one or more processors of an electronic device, cause the electronic device to perform a method comprising:
displaying, via a display generation component, a three-dimensional environment that includes a first object at a first location in the three-dimensional environment, wherein the first object has a first size in the three-dimensional environment and occupies a first amount of a field of view from a respective viewpoint;
while displaying the three-dimensional environment that includes the first object at the first location in the three-dimensional environment, receiving, via one or more input devices, a first input corresponding to a request to move the first object away from the first location in the three-dimensional environment; and
in response to receiving the first input:
in accordance with a determination that the first input corresponds to a request to move the first object away from the respective viewpoint:
moving the first object away from the respective viewpoint from the first location to a second location in the three-dimensional environment in accordance with the first input, wherein the second location is further than the first location from the respective viewpoint; and
scaling the first object such that when the first object is located at the second location, the first object has a second size, larger than the first size, in the three-dimensional environment and occupies a second amount of the field of view from the respective viewpoint, wherein the second amount is smaller than the first amount.

49.-165. (canceled)
